(19) United States
(12) Patent Application Publication
(10) Pub. No.: US 2014/0036033 A1
(43) Pub. Date: Feb. 6, 2014

(54) IMAGE PROCESSING DEVICE AND IMAGE PROCESSING METHOD

(71) Applicants: Yoshitomo Takahashi, Kanagawa (JP); Shinobu Hattori, Tokyo (JP)

(72) Inventors: Yoshitomo Takahashi, Kanagawa (JP); Shinobu Hattori, Tokyo (JP)

(73) Assignee: SONY CORPORATION, Tokyo (JP)

(21) Appl. No.: 14/009,478

(22) PCT Filed: Apr. 19, 2012
(86) PCT No.: PCT/JP2012/060616

§ 371 Date: Oct. 2, 2013

(30) Foreign Application Priority Data
Apr. 28, 2011 (JP) 2011-101798

(51) Int. Cl. H04N 7/32

(52) U.S. Cl. CPC H04N 19/00769
USPC 348/43

(57) ABSTRACT

The present technology relates to an image processing device and image processing method, enabling improvement of prediction efficiency of disparity prediction. A converting unit converts a reference image, of a different viewpoint from an image to be encoded, which is referenced at the time of generating a prediction image of the image to be encoded which is to be encoded, by controlling filter processing applied to the reference image in accordance with the reference image and resolution information relating to resolution of the image to be encoded, so that the reference image is converted in to a converted reference image of a resolution ratio agreeing with a horizontal and vertical resolution ratio of the image to be encoded. A disparity compensating unit generates a prediction image by performing disparity compensation using the converted reference image, and the image to be encoded is encoded using that reference image. The present technology can be applied to, for example, encoding and decoding of images of multiple viewpoints.

### TECHNICAL FIELD

The present invention relates to an image processing device and image processing method, and relates to an image processing device and an image processing method enabling improvement of prediction efficiency of disparity prediction performed in encoding and decoding images with multiple viewpoints.

### BACKGROUND ART

Examples of encoding formats to encode images with multiple viewpoints, such as 3D (Dimension) images and the like include MVC (Multiview Video Coding) which is an extension of AVC (Advanced Video Coding) (H.264/AVC), and so forth.

With MVC, images to be encoded are color images having values corresponding to light from a subject, as pixel values, with each color image of the multiple viewpoints being encoded, referencing color images of other viewpoints as well as to the color images of those viewpoints.

That is to say, with MVC, of the color images of the multiple viewpoints, the color image of one viewpoint is taken as a base view (Base View) image, and the color images of the other viewpoints are taken as non base view (Non Base View) images.

The base view color image is then encoded referencing only that base view color image itself, while the non base view color images are encoding referencing images of other views as necessary, besides the color image of that non base view.

That is to say, regarding the non base view color images, disparity prediction is performed as necessary, where a prediction image is generated referencing a color image of another view (viewpoint), and encoding is performed using that prediction image.

Now, as of recent, there has been proposed a method to employ besides color images of each viewpoint, a disparity information image (depth image) having, as pixel values thereof, disparity information (depth information) relating to disparity for each pixel of the color images of the viewpoints, and encoding the color images of the viewpoints and the disparity information images of the viewpoints separately (e.g., see NPL 1).

### CITATION LIST

### Non Patent Literature

NPL 1: Draft Call for Proposals on 3D Video Coding Technology”, INTERNATIONAL ORGANISATION FOR STANDARDISATION ORGANISATION INTERNATIONALE DE NORMALISATION ISO/IEC JTC1/SC29/WG11 CODING OF MOVING PICTURES AND AUDIO, MPEG2010/N11679 Guangzhou, China, October 2010

### SUMMARY OF INVENTION

### Technical Problem

As described above, with images of multiple viewpoints, disparity prediction can be performed for an image of a certain viewpoint where an image of another viewpoint is referenced in encoding (and decoding) thereof, so prediction efficiency (prediction precision) of the disparity prediction affects encoding efficiency.

The present technology has been made in light of this situation, and aims to enable improvement in prediction efficiency of disparity prediction.

### Solution to Problem

An image processing device according to a first aspect of the present technology includes: a converting unit configured to convert a reference image, of a different viewpoint from an image to be encoded, which is referenced at the time of generating a prediction image of the image to be encoded which is to be encoded, by controlling filter processing applied to the reference image in accordance with the reference image and resolution information relating to resolution of the image to be encoded, so that the reference image is converted into a converted reference image of a resolution ratio agreeing with a horizontal and vertical resolution ratio of the image to be encoded; a compensating unit configured to generate the prediction image by performing disparity compensation using the converted reference image that has been converted by the converting unit; and an encoding unit configured to encode the image to be encoded using the prediction image generated by the compensating unit.

An image processing method according to the first aspect of the present technology includes the steps of: converting a reference image, of a different viewpoint from an image to be encoded, which is referenced at the time of generating a prediction image of the image to be encoded which is to be encoded, by controlling filter processing applied to the reference image in accordance with the reference image and resolution information relating to resolution of the image to be encoded, so that the reference image is converted into a converted reference image of a resolution ratio agreeing with a horizontal and vertical resolution ratio of the image to be encoded; generating the prediction image by performing disparity compensation using the converted reference image; and encoding the image to be encoded using the prediction image.

With the first aspect as described above, a reference image, of a different viewpoint from an image to be encoded, which is referenced at the time of generating a prediction image of the image to be encoded which is to be encoded, is converted by controlling filter processing applied to the reference image in accordance with the reference image and resolution information relating to resolution of the image to be encoded, so that the reference image is converted into a converted reference image of a resolution ratio agreeing with a horizontal and vertical resolution ratio of the image to be encoded. The prediction image is then generated by performing disparity compensation using the converted reference image, and the image to be encoded is encoded using the prediction image.

An image processing device according to a second aspect of the present technology includes: a converting unit configured to convert a reference image, of a different viewpoint from an image to be decoded, which is referenced at the time of generating a prediction image of the image to be decoded which is to be decoded, by controlling filter processing applied to the reference image in accordance with the reference image and resolution information relating to resolution of the image to be decoded, so that the reference image is converted into a converted reference image of a resolution ratio agreeing with a horizontal and vertical resolution ratio of the image to be decoded; a compensating unit configured to generate the prediction image by performing disparity compensation using the converted reference image that has been converted by the converting unit; and a decoding unit configured to decode an encoded stream in which images have been encoded including the image to be decoded, using the prediction image generated by the compensating unit.

An image processing method according to the second aspect of the present technology includes the steps of: converting a reference image, of a different viewpoint from an image to be decoded, which is referenced at the time of generating a prediction image of the image to be decoded which is to be decoded, by controlling filter processing applied to the reference image in accordance with the reference image and resolution information relating to resolution of the image to be decoded, so that the reference image is converted into a converted reference image of a resolution ratio agreeing with a horizontal and vertical resolution ratio of the image to be decoded; generating the prediction image by performing disparity compensation using the converted reference image; and decoding an encoded stream in which images have been encoded including the image to be decoded, using the prediction image.

With the second aspect as described above, a reference image, of a different viewpoint from an image to be decoded, which is referenced at the time of generating a prediction image of the image to be decoded which is to be decoded, is converted by controlling filter processing applied to the reference image in accordance with the reference image and resolution information relating to resolution of the image to be decoded, so that the reference image is converted into a converted reference image of a resolution ratio agreeing with a horizontal and vertical resolution ratio of the image to be decoded. The prediction image is then generated by performing disparity compensation using the converted reference image, and an encoded stream in which images have been encoded including the image to be decoded, is decoded, using the prediction image.

Note that the image processing device may be a standalone device, or may be an internal block configuring one device.

Also, the image processing device can be realized by causing a computer to execute a program, and the program can be provided by being transmitted via a transmission medium or recorded in a recoding medium.

### Advantageous Effects of Invention

According to the present invention, prediction efficiency of disparity prediction can be improved.

### BRIEF DESCRIPTION OF DRAWINGS

FIG. 1 is a block diagram illustrating a configuration example of an embodiment of a transmission system to which the present technology has been applied.

FIG. 2 is a block diagram illustrating a configuration example of a transmission device 11.

FIG. 3 is a block diagram illustrating a configuration example of a reception device 12.

FIG. 4 is a diagram for describing resolution conversion which a resolution conversion device 21C performs.

FIG. 5 is a block diagram illustrating a configuration example of the encoding device 22C.

FIG. 6 is a diagram doe describing a picture reference when generating a prediction image (reference image) with MVC prediction encoding.

FIG. 7 is a diagram for describing an order of picture encoding (and decoding) with MVC.

FIG. 8 is a diagram for describing temporal prediction and disparity prediction performed at encoders 41 and 42.

FIG. 9 is a block diagram illustrating a configuration example of the encoder 42.

FIG. 10 is a diagram for describing macro block types in MVC (AVC).

FIG. 11 is a diagram for describing prediction vectors (PMV) in MVC (AVC).

FIG. 12 is a block diagram illustrating a configuration example of an inter prediction unit 123.

FIG. 13 is a block diagram illustrating a configuration example of a disparity prediction unit 131.

FIG. 14 is a diagram for describing filter processing in MVC to interpolate sub pels in a reference image.

FIG. 15 is a diagram for describing filter processing in MVC to interpolate sub pels in a reference image.

FIG. 16 is a block diagram illustrating a configuration example of a reference image conversion unit 140.

FIG. 17 is a block diagram illustrating a configuration example of a decoding device 32C.

FIG. 18 is a block diagram illustrating a configuration example of a decoder 212.

FIG. 19 is a block diagram illustrating a configuration example of an inter prediction unit 250.

FIG. 20 is a block diagram illustrating a configuration example of a disparity prediction unit 261.

FIG. 21 is a block diagram illustrating another configuration example of the transmission unit 11.

FIG. 22 is a block diagram illustrating another configuration example of the reception unit 12.

FIG. 23 is a diagram for describing resolution conversion which a resolution conversion device 321C performs, and inverse resolution conversion which an inverse resolution conversion device 333C performs.

FIG. 24 is a flowchart for describing processing of the transmission device 11.

FIG. 25 is a flowchart for describing processing of the reception device 12.

FIG. 26 is a block diagram illustrating a configuration example of an encoding device 322C.

FIG. 27 is a block diagram illustrating a configuration example of an encoder 342.

FIG. 28 is a diagram for describing resolution conversion SEI generated at a SEI generating unit 351.

FIG. 29 is a diagram describing values set to parameters num_views_minus_{—}1, view_id[i], frame_packing_info[i], and view_id_in_frame[i].

FIG. 30 is a block diagram illustrating a configuration example of a disparity prediction unit 361.

FIG. 31 is a block diagram illustrating a configuration example of a reference image converting unit 370.

FIG. 32 is a diagram for describing packing by a packing unit 382 following the control of the controller 381.

FIG. 33 is a diagram describing filter processing by a horizontal ½-pixel generating filter processing unit 151 through a horizontal vertical ¼-pixel generating filter processing unit 155.

FIG. 34 is a diagram for describing filter processing by the horizontal ½-pixel generating filter processing unit 151 through the horizontal vertical ¼-pixel generating filter processing unit 155.

FIG. 35 is a diagram illustrating a converted reference image obtained at a reference image converting unit 370.

FIG. 36 is a flowchart for describing encoding processing to encode a packing color image, which the encoder 342 performs.

FIG. 37 is a flowchart for describing disparity prediction processing which the disparity prediction unit 361 performs.

FIG. 38 is a flowchart for describing conversion processing of a reference image which the reference image converting unit 370 performs.

FIG. 39 is a block diagram illustrating a configuration example of a decoding device 332C.

FIG. 40 is a block diagram illustrating a configuration example of a decoder 412.

FIG. 41 is a block diagram illustrating a configuration example of a disparity prediction unit 461.

FIG. 42 is a block diagram illustrating a configuration example of a reference image converting unit 471.

FIG. 43 is a flowchart for describing decoding processing which the decoder 412 performs to decode encoded data of a packing color image.

FIG. 44 is a flowchart for describing disparity prediction processing which the disparity prediction unit 461 performs.

FIG. 45 is a flowchart for describing conversion processing of a reference image which the reference image converting unit 471 performs.

FIG. 46 is a diagram for describing resolution conversion which the resolution conversion device 321C performs, and inverse resolution conversion which the inverse resolution conversion device 333C performs.

FIG. 47 is a diagram describing values set to parameters num_views_minus_{—}1, view_id[i], frame_packing_info[i], and view_id_in_frame[i].

FIG. 48 is a diagram for describing packing by a packing unit 382 following the control of the controller 381.

FIG. 49 is a diagram describing filter processing by the horizontal ½-pixel generating filter processing unit 151 through the horizontal vertical ¼-pixel generating filter processing unit 155.

FIG. 50 is a diagram describing filter processing by the horizontal ½-pixel generating filter processing unit 151 through the horizontal vertical ¼-pixel generating filter processing unit 155.

FIG. 51 is a diagram illustrating a converted reference image obtained at a reference image converting unit 370.

FIG. 52 is a flowchart for describing conversion processing of a reference image in a case where a packing color image has been subjected to side-by-side packing.

FIG. 53 is a diagram for describing resolution conversion which the resolution conversion device 321C performs, and inverse resolution conversion which the inverse resolution conversion device 333C performs.

FIG. 54 is a block diagram illustrating a configuration of the encoding device 322C in a case where a resolution-converted multi-viewpoint color image is a middle viewpoint image, low-resolution left viewpoint image, and low-resolution right viewpoint image.

FIG. 55 is a block diagram illustrating a configuration example of an encoder 511.

FIG. 56 is a diagram for describing resolution conversion SEI generated at a SEI generating unit 551.

FIG. 57 is a diagram describing values set to parameters num_views_minus_{—}1, view_id[i], and resolution_info[i].

FIG. 58 is a block diagram illustrating a configuration example of a disparity prediction unit 561.

FIG. 59 is a block diagram illustrating a configuration example of a reference image converting unit 570.

FIG. 60 is a flowchart for describing encoding processing of encoding a low-resolution left-viewpoint color image, which the encoder 511 performs.

FIG. 61 is a flowchart for describing disparity prediction processing which the disparity prediction unit 561 performs.

FIG. 62 is a flowchart for describing reference image conversion processing which the reference image converting unit 570 performs.

FIG. 63 is a diagram for describing control of filter processing by each of the horizontal ½-pixel generating filter processing unit 151 through the horizontal vertical ¼-pixel generating filter processing unit 155.

FIG. 64 is a block diagram illustrating a configuration example of the decoding device 332C in a case where a resolution-converted multi-viewpoint color image is a middle viewpoint image, low-resolution left viewpoint image, and low-resolution right viewpoint image.

FIG. 65 is a block diagram illustrating a configuration example of a decoder 611.

FIG. 66 is a block diagram illustrating a configuration example of a disparity prediction unit 661.

FIG. 67 is a flowchart for describing decoding processing of decoding encoded data of a low-resolution left-viewpoint color image, which the decoder 611 performs.

FIG. 68 is a flowchart for describing disparity prediction processing which the disparity prediction unit 661 performs.

FIG. 69 is a diagram for describing perspective and depth.

FIG. 70 is a block diagram illustrating a schematic configuration example of an embodiment of a computer to which the present technology has been applied.

FIG. 71 is a diagram illustrating a schematic configuration example of a TV to which the present technology has been applied.

FIG. 72 is a diagram illustrating a schematic configuration example of a cellular telephone to which the present technology has been applied.

FIG. 73 is a diagram illustrating a schematic configuration example of a recording/playback device to which the present technology has been applied.

FIG. 74 is a diagram illustrating a schematic configuration example of an imaging apparatus to which the present technology has been applied.

### DESCRIPTION OF EMBODIMENTS

[Description of Depth Image (Disparity Information Image in Present Specification]

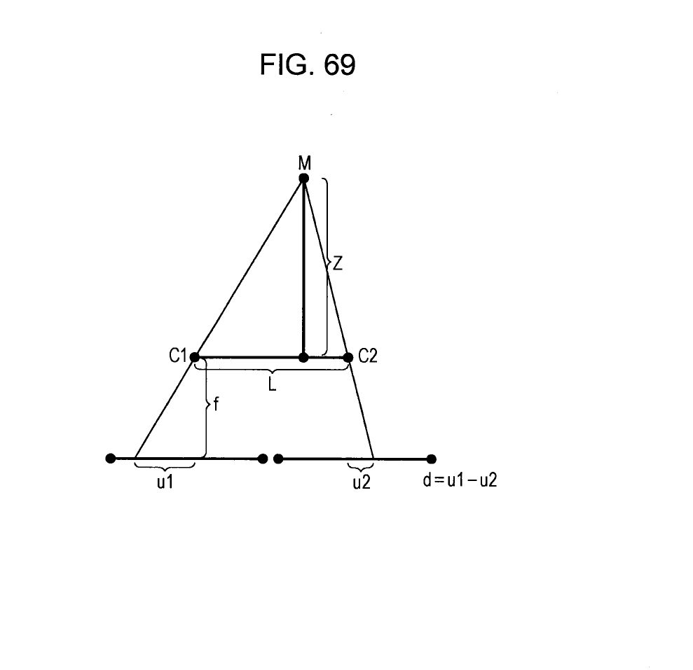

FIG. 69 is a diagram for describing disparity and depth.

As illustrated in FIG. 69, in the event that a color image of a subject M is to be shot by a camera c1 situated at a position C1 and a camera c2 situated at a position C2, depth Z which is the distance from the subject M in the depth direction from the camera c1 (camera c2) is defined with the following Expression (a).

Z=(L/d)×f (a)

Note that L is the distance between the position C1 and position C2 in the horizontal direction (hereinafter referred to as inter-camera distance). Also, d is a value obtained by subtracting a distance u2 of the position of the subject M on the color image shot by the camera c2, in the horizontal direction from the center of the color image, from a distance u1 of the position of the subject M on the color image shot by the camera c1, in the horizontal direction from the center of the color image. Further, f is the focal distance of the camera c1, with Expression (a) assuming that the focal distance of camera c1 and camera c2 are the same.

As illustrated in Expression (a), the disparity d and depth Z are uniquely convertible. Accordingly, with the Present Specification, an image representing disparity d of the two-viewpoint color image shot by camera c1 and camera c2, and an image representing depth Z, will be collectively referred to as depth image (disparity information image).

Note that it is sufficient for the depth image (disparity information image) to be an image representing disparity d or depth Z, and a value where disparity d has been normalized, a value where the inverse of depth Z, 1/Z, has been normalized, etc., may be used for pixel values of the depth image (disparity information image), rather than disparity d or depth Z themselves.

A value I where disparity d has been normalized at 8 bits (0 through 255) can be obtained by the following expression (b). Note that the number of bits for normalization of disparity d is not restricted to 8 bits, and may be another number of bits such as 10 bits, 12 bits, or the like.

$$\begin{matrix}[ Math . 4 ] & \\ I = \frac{255 \times ( d - {D}_{min} )}{{D}_{max} - {D}_{min}} & ( b )\end{matrix}$$

Note that in Expression (b), Dₘₐₓ is the maximal value of disparity d, and Dₘᵢₙ is the minimal value of disparity d. The maximum value Dₘₐₓ and the minimum value Dₘᵢₙ may be set in increments of single screens, or may be set in increments of multiple screens.

Also, a value y obtained by normalization of the inverse of depth Z, 1/Z, at 8 bits (0 through 255) can be obtained by the following expression (c). Note that the number of bits for normalization of inverse 1/Z of depth Z is not restricted to 8 bits, and may be another number of bits such as 10 bits, 12 bits, or the like.

$$\begin{matrix}[ Math . 5 ] & \\ y = 255 \times \frac{\frac{1}{Z} - \frac{1}{{Z}_{far}}}{\frac{1}{{Z}_{near}} - \frac{1}{{Z}_{far}}} & ( c )\end{matrix}$$

Note that in Expression (c), Z_{far} is the maximal value of depth Z, and Zₙₑₐᵣ is the minimal value of depth Z. The maximum value Z_{far} and the minimum value Zₙₑₐᵣ may be set in increments of single screens, or may be set in increments of multiple screens.

This, with the Present Specification, taking into consideration that disparity d and depth Z are uniquely convertible, an image having as the pixel value thereof the value I where disparity d has been normalized, and an image having as the pixel value thereof the a value y where 1/Z which is the inverse of depth Z has been normalized, will be collectively referred to as depth image (disparity information image). Here, we will say that the color format of the depth image (disparity information image) is YUV420 or YUV400, but those may be another color format.

Note that in the event of looking at the information of the value I or value y itself rather than the pixel value of the depth image (disparity information image), the value I or value y is taken as the depth image information (disparity information). Further the value I or value y mapped is taken as a depth map.

[Embodiment of Transmission System to which Image Processing Device of Present Technology has been Applied]

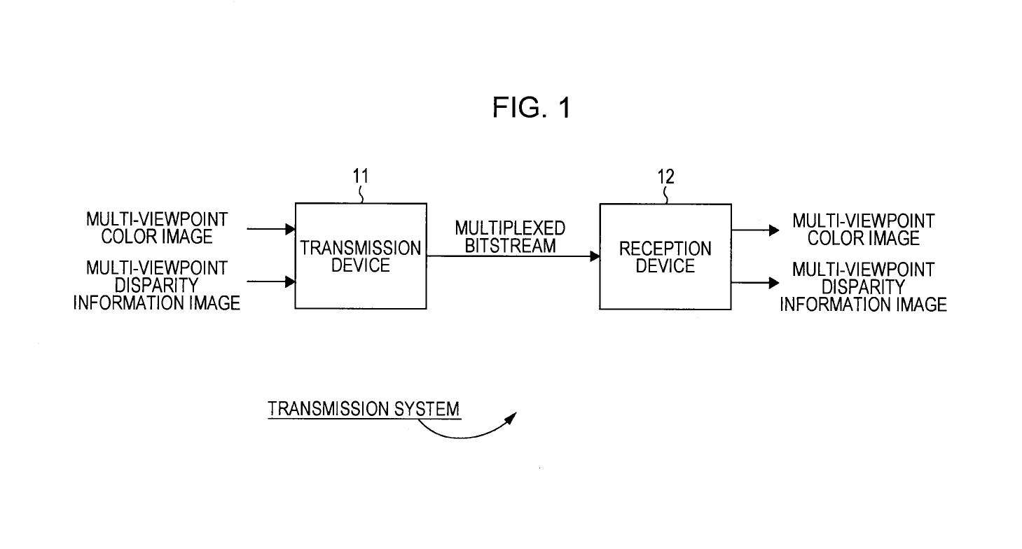

FIG. 1 is a block diagram illustrating a configuration example of a transmission system to which the present technology has been applied.

In FIG. 1, the transmission system has a transmission device 11 and a reception device 12.

The transmission device 11 is provided with a multi-viewpoint color image and a multi-viewpoint disparity information image (multi-viewpoint depth image).

Here, a multi-viewpoint color image includes color images of multiple viewpoints, and a color image of a predetermined one viewpoint of these multiple viewpoints is specified as being a base view image. The color images of the viewpoints other than the base view image are handled as non base view images.

Multi-viewpoint disparity image information includes a disparity information image of each viewpoint of the color images configuring the multi-viewpoint color image, with a disparity information image of a predetermined one viewpoint, for example, being specified as a base view image. The disparity information images of viewpoints other than the base view image are handled as non base view images in the same way as with the case of color images.

The transmission device 11 encodes and multiplexes each of the multi-viewpoint color images and multi-viewpoint disparity information images supplied thereto, and outputs a multiplexed bitstream obtained as a result thereof.

The multiplexed bitstream output from the transmission device 11 is transmitted via an unshown transmission medium, or is recorded in an unshown recording medium.

The multiplexed bitstream output from the transmission device 11 is provided to the reception device 12 via the unshown transmission medium or recording medium.

The reception device 12 receives the multiplexed bitstream, and performs inverse multiplexing on the multiplexed bitstream, thereby separating encoded data of the multi-viewpoint color images and encoded data of the multi-viewpoint disparity images from the multiplexed bitstream.

Further, the reception device 12 decodes each of the encoded data of the multi-viewpoint color images and encoded data of the multi-viewpoint disparity images, and outputs the multi-viewpoint color images and multi-viewpoint disparity information images obtained as a result thereof.

Now, MPEG3DV, of which a primary application is display of naked eye 3D (dimension) images which can be viewed with the naked eye, is being formulated as a standard for transmitting multi-viewpoint color images which are color images of multiple viewpoints, and multi-viewpoint disparity information images which are disparity information images of multiple viewpoints.

With MPEG3DV, besides images (color images, disparity information images) of two viewpoints, there is discussion about transmission of images with three viewpoints or four viewpoints for example, greater than two viewpoints.

With naked eye 3D images (3D images which can be viewed without so-called polarized glasses), the greater the number of (image) viewpoints, the higher the quality of images that can be displayed, and the stronger the stereoscopic effect can be made to be. Accordingly, having a greater number of viewpoints is preferable from the perspective of image quality and stereoscopic effect.

However, increasing the number of viewpoints makes the amount of data handled at baseband to be immense.

That is to say, in the event of transmitting a so-called full-HD (High Definition) resolution image with color images and disparity information images of three viewpoints for example, the data amount thereof is six times that of the data amount of a full-HD 2D image (data amount of an image of one viewpoint).

There is, as a baseband transmission standard, HDMI (High-Definition Multimedia Interface) for example, but even the newest HDMI standard can only handled data equivalent to 4K (four times that of full HD), so color images and disparity information images of three viewpoints cannot be transmitted at baseband in the current state.

Accordingly, in order to transmit full-HD color images and disparity information images of three viewpoints at baseband, there is the need to reduce the resolution of the images at baseband for example, or the like, to reduce the data amount (at baseband) of the multi-viewpoint color images and multi-viewpoint disparity information images.

On the other hand, with the transmission device 11, multi-viewpoint color images and multi-viewpoint disparity information images are encoded, but the bitrate of the encoded data (and consequently the multiplexed bitstream) is restricted, so the bit amount of encoded data allocated to images of one viewpoint (color image and disparity information image) in encoding is also restricted.

When encoding, in the event that the bit amount of encoded data which can be allocated to an image is smaller than the data amount of that image at baseband, encoding noise such as block noise becomes conspicuous, and as a result, the image quality of the decoded image obtained by decoding at the reception device 12 deteriorates.

Accordingly, there is the need to reduce the data amount (at baseband) of multi-viewpoint color images and multi-viewpoint disparity information images, from the perspective of suppressing deterioration in image quality of decoded images, as well.

Accordingly, the transmission device 11 performs encoding after having reduced the data amount of multi-viewpoint color images and multi-viewpoint disparity information images (at baseband).

Now, for disparity information, which is pixel values of a disparity information image, a disparity value (value I) representing disparity between a subject in each pixel of a color image as to a reference viewpoint taking a certain viewpoint as a reference, or a depth value (value y) representing distance (depth) to the subject in each pixel of the color image, can be used.

If the positional relations of the cameras shooting the color images at multiple viewpoints is known, the disparity value and depth value are mutually convertible, and accordingly are equivalent information.

Hereinafter, a disparity information image (depth image) having disparity values as pixel values will also be referred to as a disparity image, and a disparity information image (depth image) having depth values as pixel values will also be referred to as a depth image.

Hereinafter, of the disparity images and depth images, depth images will be used for disparity information images for example, but disparity images can be used for disparity information images as well.

[Configuration Example of Transmission Device 11]

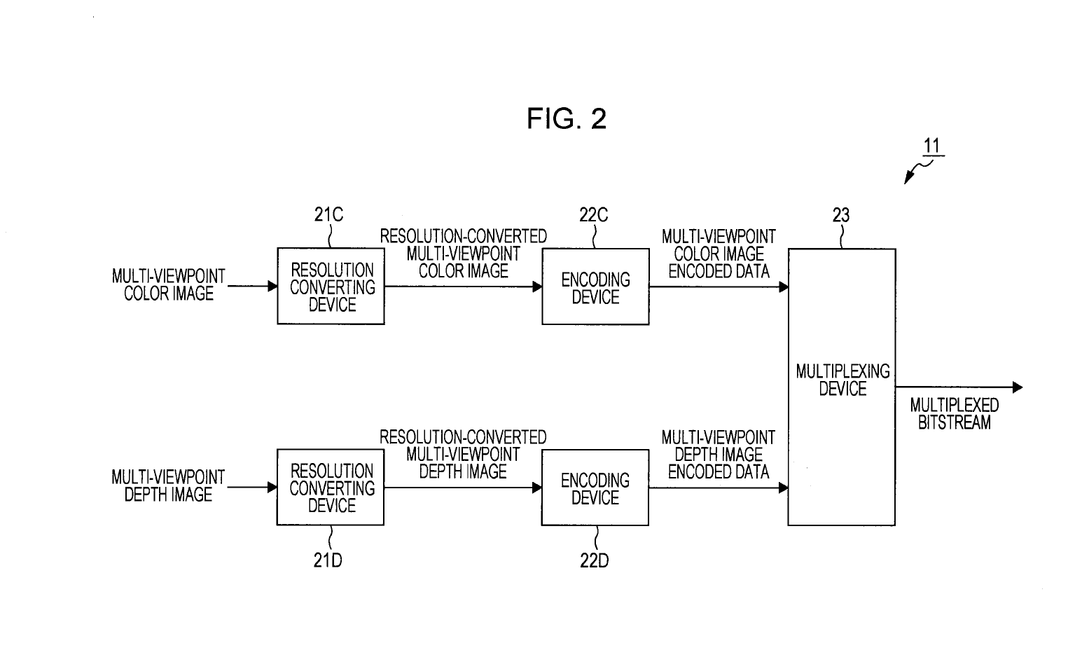

FIG. 2 is a block diagram illustrating a configuration example of the transmission device 11 in FIG. 1.

In FIG. 2, the transmission device 11 has resolution converting devices 21C and 21D, encoding devices 22C and 22D, and a multiplexing device 23.

Multi-viewpoint color images are supplied to the resolution converting device 21C.

The resolution converting device 21C performs resolution conversion to convert a multi-viewpoint color image supplied thereto into a resolution-converted multi-viewpoint color image having lower resolution than the original resolution, and supplies the resolution-converted multi-viewpoint color image obtained as a result thereof to the encoding device 22C.

The encoding device 22C encodes the resolution-converted multi-viewpoint color image supplied from the resolution converting device 21C with MVC, for example, which is a standard for transmitting images of multiple viewpoints, and supplies multi-viewpoint color image encoded data which is encoded data obtained as a result thereof, to the multiplexing device 23.

Now, MVC is an extended profile of AVC, and according to MVC, efficient encoding featuring disparity prediction can be performed for non base view images, as described above.

Also, with MVC, base view images are encoded AVC-compatible. Accordingly, encoded data where a base view image has been encoded with MVC can be decoded with an AVC decoder.

The resolution converting device 21D is supplied with a multi-viewpoint depth image which is a depth images of each viewpoint, having, as pixel values, depth values for each pixel of the color images of each viewpoint making up the multi-viewpoint color image.

In FIG. 2, the resolution converting device 21D and encoding device 22D each perform the same processing as the resolution converting device 21C and resolution converting device 21D, on depth images (multi-viewpoint depth images) instead of color images (multi-viewpoint color images).

That is to say, the resolution converting device 21D performs resolution conversion of a multi-viewpoint depth image supplied thereto into a resolution-converted multi-viewpoint depth image of a low-resolution lower than the original resolution, and supplies this to the encoding device 22D.

The encoding device 22D encodes the resolution-converted multi-viewpoint depth image supplied from the resolution converting device 21D with MVC, and supplies multi-viewpoint depth image encoded data which is encoded data obtained as a result thereof, to the multiplexing device 23.

The multiplexing device 23 multiplexes the multi-viewpoint color image encoded data from the encoding device 22C with the multi-viewpoint depth image encoded data from the encoding device 22D, and outputs a multiplexed bitstream obtained as a result thereof.

[Configuration Example of Reception Device 12]

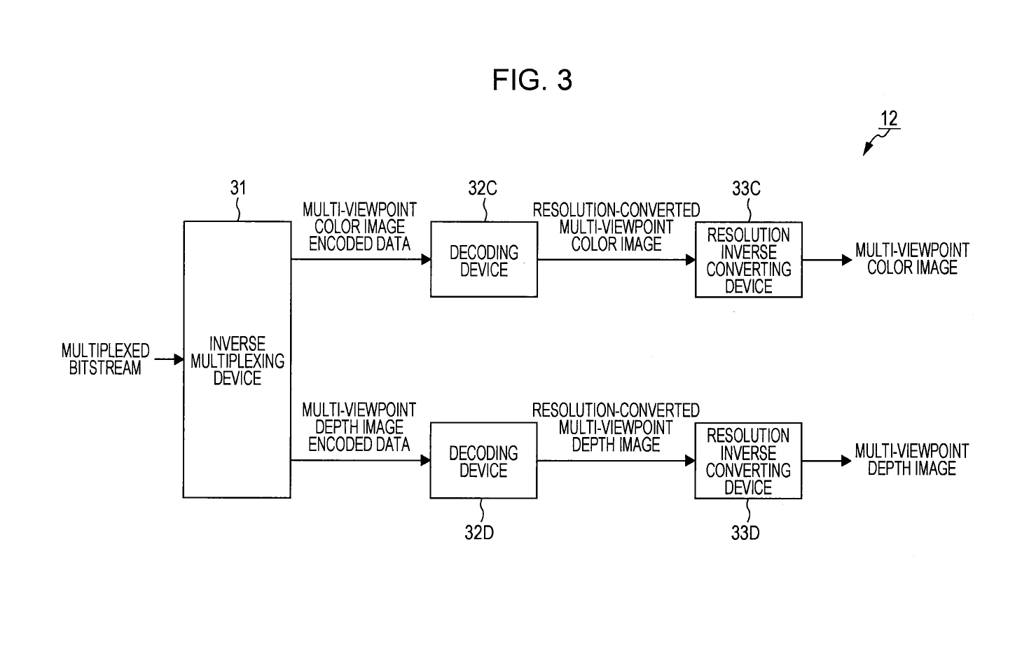

FIG. 3 is a block diagram illustrating a configuration example of the reception device 12 in FIG. 1.

In FIG. 3, the reception device 12 has an inverse multiplexing device 31, decoding devices 32C and 32D, and resolution inverse converting devices 33C and 33D.

A multiplexed bitstream output from the transmission device 11 (FIG. 2) is supplied to the inverse multiplexing device 31.

The inverse multiplexing device 31 receives the multiplexed bitstream supplied thereto, and performs inverse multiplexing of the multiplexed bitstream, thereby separating the multiplexed bitstream into the multi-viewpoint color image encoded data and multi-viewpoint depth image encoded data.

The inverse multiplexing device 31 then supplies the multi-viewpoint color image encoded data to the decoding device 32C, and the multi-viewpoint depth image encoded data to the decoding device 32D.

The decoding device 32C decodes the multi-viewpoint color image encoded data supplied from the inverse multiplexing device 31 by MVC, and supplies the resolution-converted multi-viewpoint color image obtained as a result thereof to the resolution inverse converting device 33C.

The resolution inverse converting device 33C performs resolution inverse conversion to (inverse) convert the resolution-converted multi-viewpoint color image from the decoding device 32C into the multi-viewpoint color image of the original resolution, and outputs the multi-viewpoint color image obtained as the result thereof.

The decoding device 32D and resolution inverse converting device 33D each perform the same processing as decoding device 32C and resolution inverse converting device 33C, on multi-viewpoint depth image encoded data (resolution-converted multi-viewpoint depth images) instead of multi-viewpoint color image encoded data (resolution-converted multi-viewpoint color images).

That is to say, the decoding device 32D decodes the multi-viewpoint depth image encoded data supplied from the inverse multiplexing device 31 by MVC, and supplies the resolution-converted multi-viewpoint depth image obtained as the result thereof to the resolution inverse converting device 33D.

The resolution inverse converting device 33D performs resolution inversion conversion of the resolution-converted multi-viewpoint depth image from the decoding device 32D to the multi-viewpoint depth image of the original resolution, and outputs.

Note that with the present embodiment, depth images are subjected to the same processing as with color images, so processing of depth images will be omitted hereinafter as appropriate.

[Resolution Conversion]

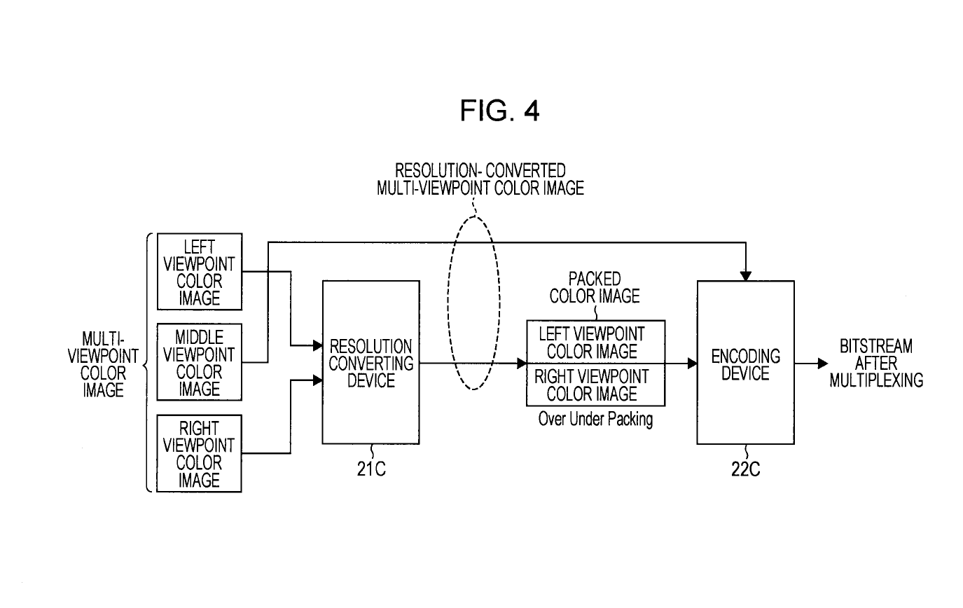

FIG. 4 is a diagram for describing resolution conversion which the resolution converting device 21C in FIG. 2 performs.

Note that hereinafter, we will assume that a multi-viewpoint color image (the same for multi-viewpoint depth images as well) is a color image of three viewpoints, which are a middle viewpoint color image, left viewpoint color image, and right viewpoint color image, for example.

The three viewpoints of middle viewpoint color image, left viewpoint image, and right viewpoint image, which are color images, are images obtained by situating three cameras, at a position to the front of the subject, at a position to the left of the subject facing the subject, and at a position to the right of the subject facing the subject, and shooting the subject.

Accordingly, the middle viewpoint color image is an image of which the viewpoint is a position to the front of the subject; Also, the left viewpoint image is an image of which the viewpoint is a position to the left (left viewpoint) of the viewpoint of the middle viewpoint color image (middle viewpoint), and the right viewpoint image (right viewpoint) is an image of which the viewpoint is a position to the right of the middle viewpoint.

Note that a multi-viewpoint color image (and multi-viewpoint depth image) may be an image with two viewpoints, or an image with four or more viewpoints.

The resolution converting device 21C outputs, of the middle viewpoint color image, left viewpoint color image, and right viewpoint color image, which are the multi-viewpoint color image supplied thereto, the middle viewpoint color image for example, as it is (without performing resolution conversion).

Also, the resolution converting device 21C converts the remaining left viewpoint color image and right viewpoint color image of the multi-viewpoint color image so that the resolution of the images of the two viewpoints is low resolution, and performs packing where these are combined into one viewpoint worth of image, thereby generating a packed color image which is output.

That is to say, the resolution converting device 21C changes the vertical direction resolution (number of pixels) of each of the left viewpoint color image and right viewpoint color image to ½, and vertically arrays the left viewpoint color image and right viewpoint color image of which the vertical direction resolution (vertical resolution) has been made to be ½, thereby generating a packed color image which is one viewpoint worth of image.

Now, with the packed color image in FIG. 4, the left viewpoint color image is situated above, and the right viewpoint color image is situated below.

The middle viewpoint color image and packed color image output from the resolution converting device 21C are supplied to the encoding device 22C as a resolution-converted multi-viewpoint color image.

Now, the multi-viewpoint color image supplied to the resolution converting device 21C is an image of the three viewpoints worth of the middle viewpoint color image, left viewpoint color image, and right viewpoint color image, but the resolution-converted multi-viewpoint color image output from the resolution converting device 21C is an image of the two viewpoints worth of the middle viewpoint color image and packed color image, so data amount at the baseband has been reduced.

Now, in FIG. 4, while of the middle viewpoint color image, left viewpoint color image, and right viewpoint color image, configuring the multi-viewpoint color image, the left viewpoint color image and right viewpoint color image have been packed into one viewpoint worth of packed color image, packing can be performed on color images of any two viewpoints of the middle viewpoint color image, left viewpoint color image, and right viewpoint color image.

Note however, that, in the event that a 2D image is to be displayed at the reception device 12 side, it is predicted that of the middle viewpoint color image, left viewpoint color image, and right viewpoint color image, making up the multi-viewpoint color image, the middle viewpoint color image will be used. Accordingly, with FIG. 4, the middle viewpoint color image is not subjected to packing in where the resolution is converted to low resolution, so as to enable a 2D image to be displayed with high image quality.

That is to say, at the reception device 12 side, all of the middle viewpoint color image, left viewpoint color image, and right viewpoint color image, configuring the multi-viewpoint color image, are used for display of a 3D image, but for display of a 2D image, only the middle viewpoint color image, for example, out of the middle viewpoint color image, left viewpoint color image, and right viewpoint color image, is used. Accordingly, of the middle viewpoint color image, left viewpoint color image, and right viewpoint color image, making up the multi-viewpoint color image, the left viewpoint color image and right viewpoint color image are used at the reception device 12 side only for 3D display, so in FIG. 4, the left viewpoint color image and right viewpoint color image which are only used for this 3D image display are subjected to packing.

[Configuration Example of Encoding Device 22C]

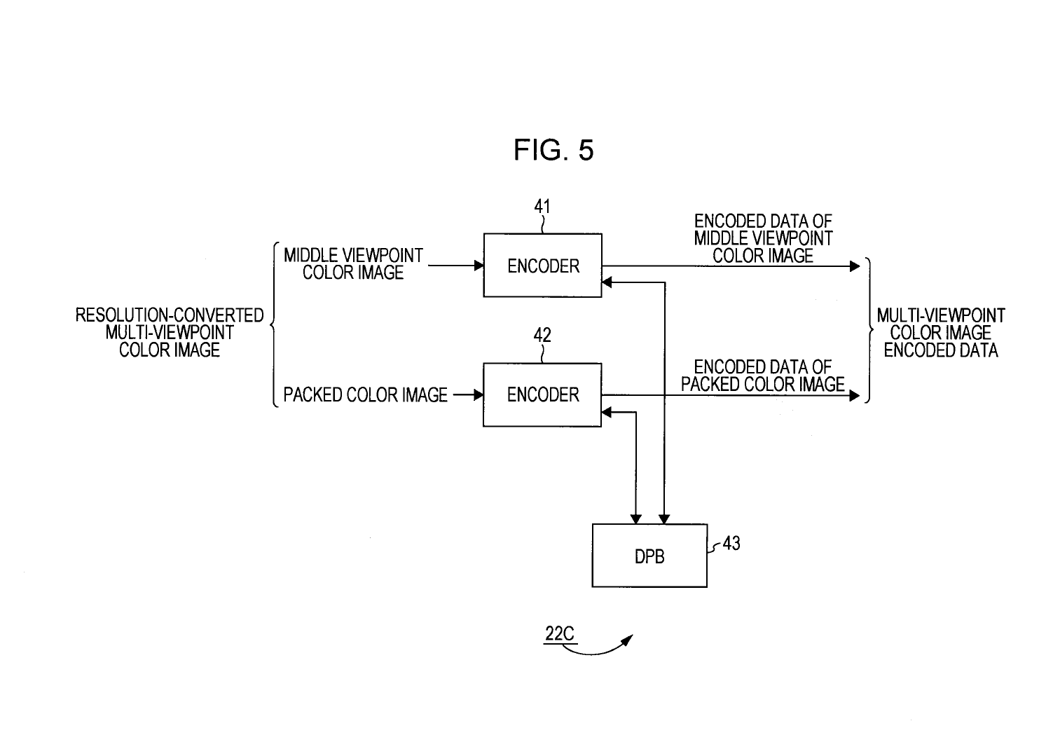

FIG. 5 is a block diagram illustrating a configuration example of the encoding device 22C in FIG. 2.

The encoding device 22C encodes the middle viewpoint color image and packed color image which are the resolution-converted multi-viewpoint color image from the resolution converting device 21C (FIG. 2, FIG. 4) by MVC.

Now hereinafter, unless specifically stated otherwise, the middle viewpoint color image will be taken as the base view image, and the other viewpoint color images, i.e., the packed color image here, will be handled as non base view images.

In FIG. 5, the encoding device 22C has encoders 41, 42, and a DPB (Decode Picture Buffer) 43.

The encoder 41 is supplied with, of the middle viewpoint color image and packed color image configuring the resolution-converted multi-viewpoint color image from the resolution converting device 21C, the middle viewpoint color image.

The encoder 41 takes the middle viewpoint color image as the base view image and encodes by MVC (AVC), and outputs encoded data of the middle viewpoint color image obtained as a result thereof.

The encoder 42 is supplied with, of the middle viewpoint color image and packed color image configuring the resolution-converted multi-viewpoint color image from the resolution converting device 21C, the packed color image.

The encoder 42 takes the packed color image as a non base view image and encodes by MVC, and outputs encoded data of the packed color image obtained as a result thereof.

Note that the encoded data of the middle viewpoint color image output from the encoder 41 and the encoded data of the packed color image output from the encoder 42, are supplied to the multiplexing device 23 (FIG. 2) as multi-viewpoint color image encoded data.

The DPB 43 temporarily stores a post-local-decoded image obtained by encoding images to be encoded at the encoders 41 and 42 and locally decoding (decoded image), as (a candidate for) a reference image to be referenced at the time of generating a prediction image.

That is to say, the encoders 41 and 42 perform prediction encoding of the image to be encoded. Accordingly, in order to generate a prediction image to be used for prediction encoding, the encoders 41 and 42 encode the image to be encoded, and thereafter perform local decoding, thereby obtaining a decoded image.

The DPB 43 is a shared buffer, as if it were, for temporarily storing decoded images obtained at each of the encoders 41 and 42, with the encoders 41 and 42 each selecting reference images to reference when encoding images to encode, from decoded images stored in the DPB 43. The encoders 41 and 42 then each generate prediction images using reference images, and perform image encoding (prediction encoding) using these prediction images.

The DPB 43 is shared between the encoders 41 and 42, so the encoders 41 and 42 can reference, in addition to decoded images obtained at itself, decoded images obtained at the other encoder.

Note however, the encoder 41 encodes the base view image, and accordingly only references a decoded image obtained at the encoder 41.

[Overview of MVC]

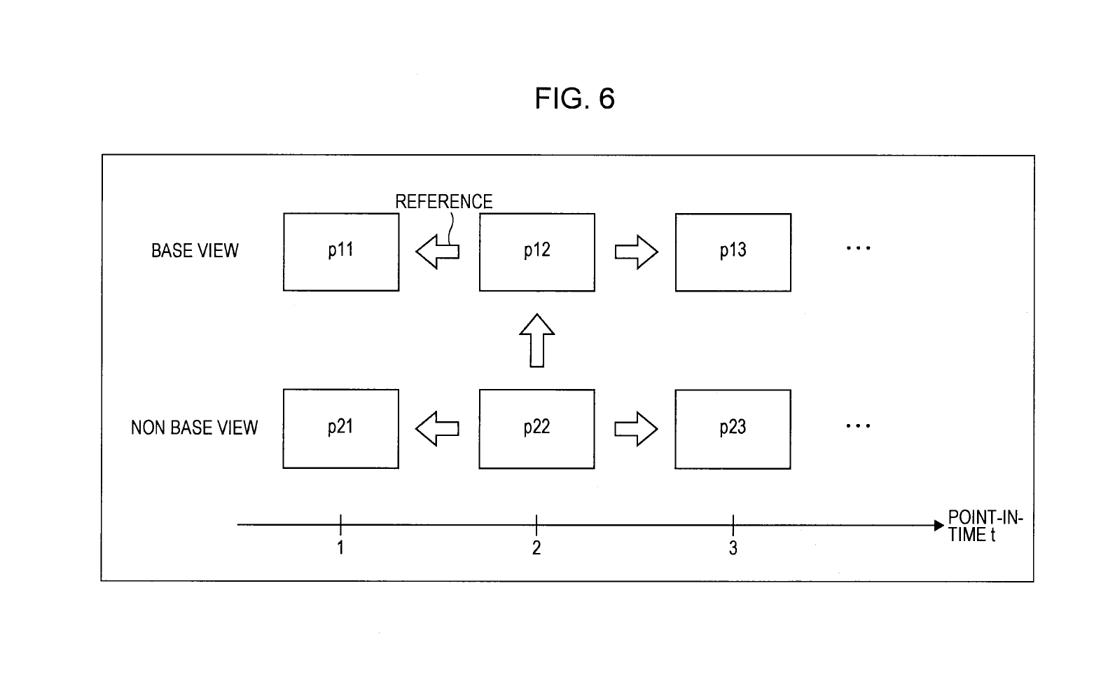

FIG. 6 is a diagram for describing pictures (reference images) referenced when generating a prediction image.

Let us express pictures of base view images as p11, p12, p13, . . . in the order of display point-in-time, and pictures of non base view images as p21, p22, p23, . . . in the order of display point-in-time.

For example, picture p12 which is a base view picture, is prediction-encoded referencing pictures p11 or p13, for example, which are base view pictures thereof, as necessary.

That is to say, with regard to the base view picture p12, prediction (generating of prediction image) can be performed referencing only pictures p11 or p13, which are base view pictures at other points-in-time.

Also, for example, picture p22 which is a non base view picture is prediction encoded referencing pictures p21 or p23, for example, which are non base view pictures thereof, and further the base view picture p12 which is a different view, as necessary.

That is to say, the non base view picture p22 can reference, in addition to the referencing pictures p21 or p23 which are non base view pictures thereof at other points-in-time, the base view picture p12 which is a picture of a different view, and perform prediction.

Note that prediction performed referencing pictures in the same view as the picture to be encoded (at a different point-in-time) is also called temporal prediction, and prediction performed referencing a picture of another view from the picture to be encoded is also called disparity prediction.

As described above, with MVC, only temporal prediction can be performed for base view pictures, and temporal prediction and disparity prediction can be performed for non base view pictures.

Note that with MVC, a picture of a different view from the picture to be encoded which is reference in disparity prediction, must be a picture of the same point-in-time as the picture to be encoded.

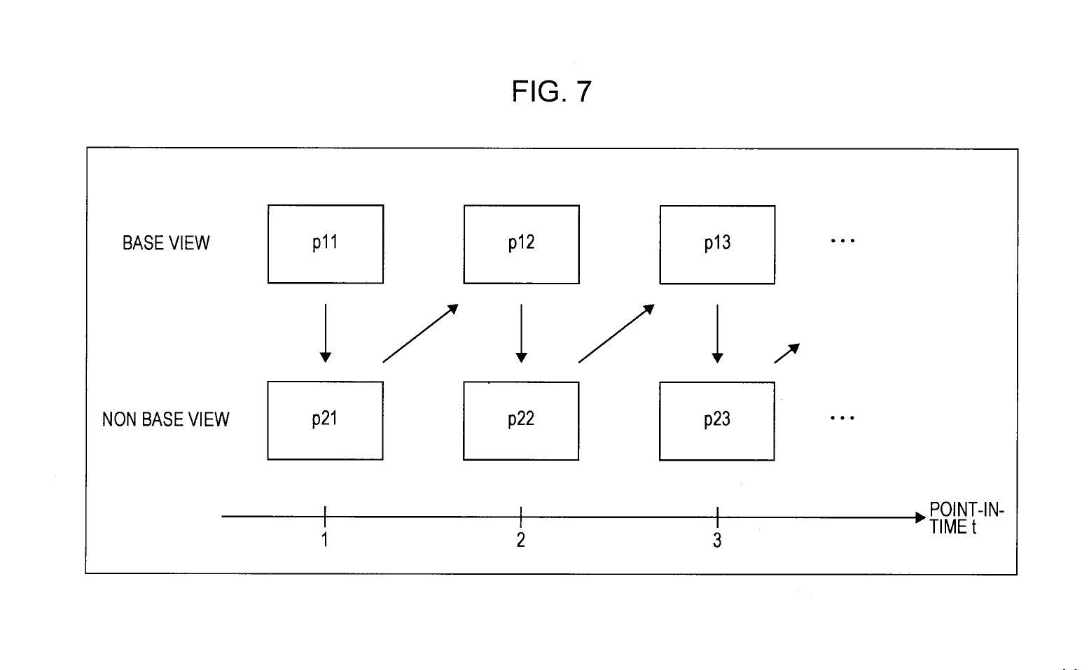

FIG. 7 is a diagram describing the order of encoding (and decoding) of pictures with MVC.

In the same way as with FIG. 6, let us express pictures of base view images as p11, p12, p13, . . . in the order of display point-in-time, and pictures of non base view images as p21, p22, p23, . . . in the order of display point-in-time.

Now, to simplify description, assuming that the pictures of each view are encoded in the order of the display point-in-time, first, the first picture p11 at point-in-time t=1 of the base view is encoded, following which the picture p21 at the same point-in-time t=1 of the non base view is encoded.

Upon encoding of (all) pictures at the same point-in-time t=1 ending, the next picture p12 at point-in-time t=2 of the base view is encoded, following which the picture p22 at the same point-in-time t=2 of the non base view is encoded.

Thereafter, base view pictures and non base view pictures are encoded in similar order.

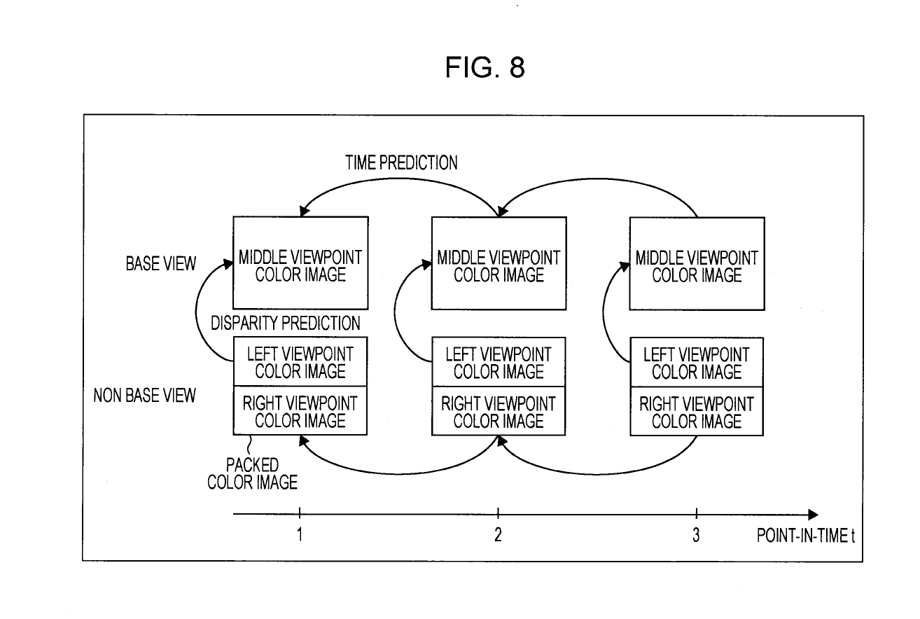

FIG. 8 is a diagram for describing temporal prediction and disparity prediction performed at the encoders 41 and 42 in FIG. 5.

Note that in FIG. 8, the horizontal axis represents the point-in-time of encoding (decoding).

In prediction encoding of a picture of the middle viewpoint color image which is the base view image, the encoder 41 which encodes the base view image can perform temporal prediction, in which another picture of the middle viewpoint color image that has already been encoded is referenced.

In prediction encoding of a picture of the packed color image which is a non base view image, the encoder 42 which encodes the non base view image can perform temporal prediction, in which another picture of the packed color image that has already been encoded is referenced, and disparity prediction referencing an (already encoded) picture of the middle viewpoint color image (a picture with the same point-in-time (same POC (Picture Order Count)) as the pictures of the packed color image to be encoded).

[Configuration Example of Encoder 42]

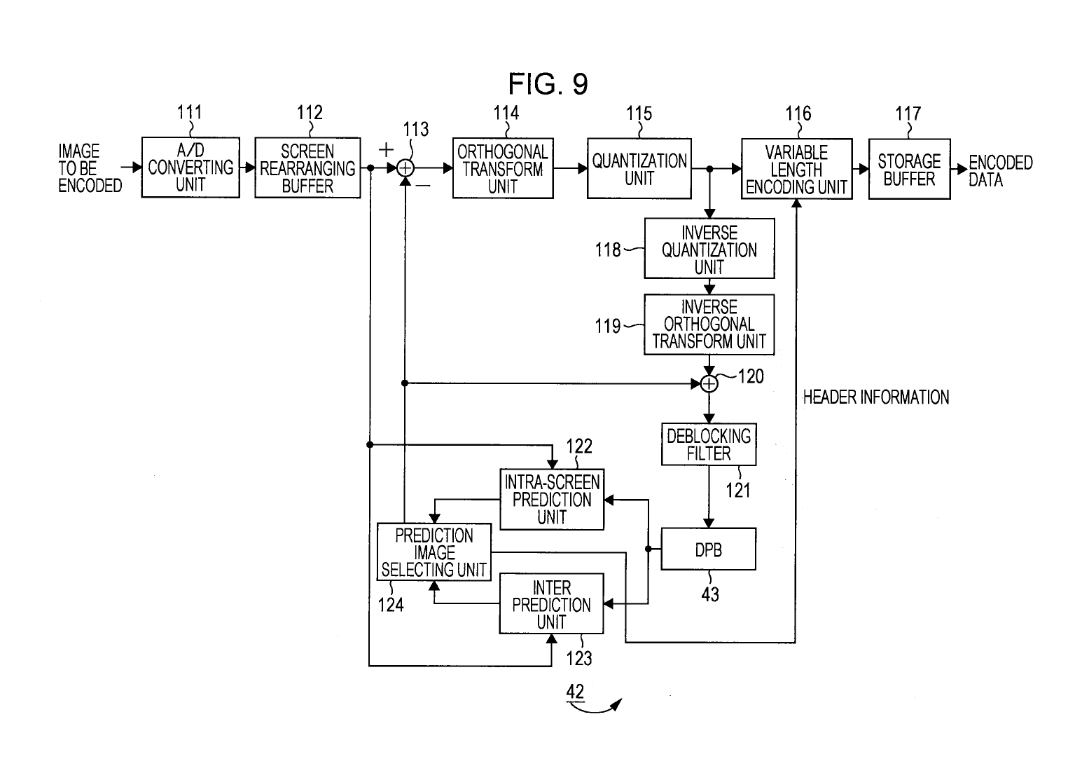

FIG. 9 is a block diagram illustrating a configuration example of the encoder 42 in FIG. 5.

In FIG. 9, the encoder 42 has an A/D (Analog/Digital) converting unit 111, a screen rearranging buffer 112, a computing unit 113, an orthogonal transform unit 114, a quantization unit 115, a variable length encoding unit 116, a storage buffer 117, an inverse quantization unit 118, an inverse orthogonal transform unit 119, a computing unit 120, a deblocking filter 121, an intra-screen prediction unit 122, an inter prediction unit 123, and a prediction image selecting unit 124.

Packed color image pictures which are images to be encoded (moving image) are sequentially supplied in display order to the A/D converting unit 111.

In the event that the pictures supplied thereto are analog signals, the A/D converting unit 111 performs A/D conversion of the analog signals, and supplies to the screen rearranging buffer 112.

The screen rearranging buffer 112 temporarily stores the pictures from the A/D converting unit 111, and reads out the pictures in accordance with a GOP (Group of Pictures) structure determined beforehand, thereby performing rearranging where the order of the pictures is rearranged from display order to encoding order (decoding order).

The pictures read out from the screen rearranging buffer 112 are supplied to the computing unit 113, the intra-screen prediction unit 122, and the inter prediction unit 123.

Pictures are supplied from the screen rearranging buffer 112 to the computing unit 113, and also, prediction images generated at the intra-screen prediction unit 122 or inter prediction unit 123 are supplied from the prediction image selecting unit 124.

The computing unit 113 takes a picture read out from the screen rearranging buffer 112 to be a current picture to be encoded, and further sequentially takes a macroblock making up the current picture to be a current block to be encoded.

The computing unit 113 then computes a subtraction value where a pixel value of a prediction image supplied from the prediction image selecting unit 124 is subtracted from a pixel value of the current block, as necessary, and supplies to the orthogonal transform unit 114.

The orthogonal transform unit 114 subjects (the pixel value, or the residual of the prediction image having been subtracted, of) the current block from the computing unit 113 to orthogonal transform such as discrete cosine transform or Karhunen-Loéve transform or the like, and supplies transform coefficients obtained as a result thereof to the quantization unit 115.

The quantization unit 115 quantizes the transform coefficients supplied from the orthogonal transform unit 114, and supplies quantization values obtained as a result thereof to the variable length encoding unit 116.

The variable length encoding unit 116 performs lossless encoding such as variable-length coding (e.g., CAVLC (Context-Adaptive Variable Length Coding) or the like) or arithmetic coding (e.g., CABAC (Context-Adaptive Binary Arithmetic Coding) or the like) on the quantization values from the quantization unit 115, and supplies the encoded data obtained as a result thereof to the storage buffer 117.

Note that in addition to quantization values being supplied to the variable length encoding unit 116 from the quantization unit 115, header information to be included in the header of the encoded data is also supplied from the prediction image selecting unit 124.

The variable length encoding unit 116 encodes the header information from the prediction image selecting unit 124, and includes in the header of the encoded data.

The storage buffer 117 temporarily stores the encoded data from the variable length encoding unit 116, and outputs (transmits) at a predetermined data rate.

Quantization values obtained at the quantization unit 115 are supplied to the variable length encoding unit 116, and also supplied to the inverse quantization unit 118 as well, and local decoding is performed at the inverse quantization unit 118, inverse orthogonal transform unit 119, and computing unit 120.

That is to say, the inverse quantization unit 118 performs inverse quantization of the quantization values from the quantization unit 115 into transform coefficients, and supplies to the inverse orthogonal transform unit 119.

The inverse orthogonal transform unit 119 performs inverse orthogonal transform of the transform coefficients from the inverse quantization unit 118, and supplies to the computing unit 120.

The computing unit 120 adds pixel values of a prediction image supplied from the prediction image selecting unit 124 to the data supplied from the inverse orthogonal transform unit 119 as necessary, thereby obtaining a decoded image where the current block has been decoded (locally decoded), which is supplied to the deblocking filter 121.

The deblocking filter 121 performs filtering of the decoded image from the computing unit 120, thereby removing (reducing) block noise occurring in the decoded image, and supplies to the DPB 43 (FIG. 5).

Now, the DPB 43 stores a decoded image from the deblocking filter 121, i.e., a picture of a packed color image encoded at the encoder 42 and locally decoded, as (a candidate for) a reference image to be reference when generating a prediction image to be used for prediction encoding (encoding where subtraction of a prediction image is performed at the computing unit 113) later in time.

As described with FIG. 5, the DBP 43 is shared between the encoders 41 and 42, so besides packed color image pictures encoded at the encoder 42 and locally decoded, the picture of the multi-viewpoint color image encoded at the encoder 41 and locally decoded is also stored.

Note that local decoding by the inverse quantization unit 118, inverse orthogonal transform unit 119, and computing unit 120 is performed on referenceable I pictures, P pictures, and Bs pictures which can be reference images (reference pictures), for example, and the DPB 43 stores decoded images of the I pictures, P pictures, and Bs pictures.

In the event that the current picture is an I picture, P picture, or B picture (including Bs picture) which can be intra-predicted (intra-screen predicted), the intra-screen prediction unit 122 reads out, from the DBP 43, the portion of the current picture which has already been locally decoded (decoded image). The intra-screen prediction unit 122 then takes the part of the decoded image of the current picture as a prediction image of the current block of the current picture supplied from the screen rearranging buffer 112.

Further, the intra-screen prediction unit 122 obtains an encoding cost necessary to encode the current block using the prediction image, i.e., an encoding cost necessary to encode the residual of the current block as to the prediction image and so forth, and supplies this to the prediction image selecting unit 124 along with the prediction image.

In the event that the current picture is a P picture or B picture (including Bs picture) which can be inter-predicted, the inter prediction unit 123 reads out from the DPB 43 a picture which has been encoded and locally decoded before the current picture, as a reference image.

Also, the inter prediction unit 123 employs ME (Motion Estimation) using the current block of the current picture from the screen rearranging buffer 112 and the reference image, to detect a shift vector representing shift (disparity, motion) between the current block and a corresponding block in the reference image corresponding to the current block (e.g., a block which minimizes the SAD (Sum of Absolute Differences) or the like as to the current block).

Now, in the event that the reference image is a picture of the same view as the current picture (of a different point-in-time as the current picture), the shift vector detected by ME using the current block and the reference image will be a motion vector representing the motion (temporal shift) between the current block and reference image.

Also, in the event that the reference image is a picture of a different view as the current picture (of the same point-in-time as the current picture), the shift vector detected by ME using the current block and the reference image will be a disparity vector representing the disparity (spatial shift) between the current block and reference image.

The inter prediction unit 123 generates a prediction image by performing shift compensation which is MC (Motion Compensation) of the reference image from the DPB 43 (motion compensation to compensate for motion shift or disparity compensation to compensate for disparity shift), in accordance with the shift vector of the current block.

That is to say, the inter prediction unit 123 obtains a corresponding block, which is a block (region) at a position that has moved (shifted) from the position of the current block in the reference image, in accordance with the shift vector of the current block.

Further, the inter prediction unit 123 obtains the encoding cost necessary to encode the current block using the prediction image, for each inter prediction mode of which the later-described macroblock type differs.

The inter prediction unit 123 then takes the inter prediction mode of which the encoding cost is the smallest as the optimal inter prediction mode which is the inter prediction mode that is optimal, and supplies the prediction image and encoding cost obtained in that optimal inter prediction mode to the prediction image selecting unit 124.

Now, generating a prediction image based on a shift vector (disparity vector, motion vector) will also be called shift prediction (disparity prediction, temporal prediction (motion prediction)) or shift compensation (disparity compensation, motion compensation). Note that shift prediction includes detection of shift vectors as necessary.

The prediction image selecting unit 124 selects the one of the prediction images from each of the intra-screen prediction unit 122 and inter prediction unit 123 of which the encoding cost is smaller, and supplies to the computing units 113 and 120.

Note that the intra-screen prediction unit 122 supplies information relating to intra prediction (prediction mode related information) to the prediction image selecting unit 124, and the inter prediction unit 123 supplies information relating to inter prediction (prediction mode related information including information of shift vectors and reference indices assigned to the reference image) to the prediction image selecting unit 124.

The prediction image selecting unit 124 selects, of the information from each of the intra-screen prediction unit 122 and inter prediction unit 123, the information by which a prediction image with smaller encoding cost has been generated, and provides to the variable length encoding unit 116 as header information.

Note that the encoder 41 in FIG. 5 also is configured in the same way as with the encoder 42 in FIG. 9. However, the encoder 41 which encodes base view images performs temporal prediction alone in the inter prediction, and does not perform disparity prediction.

[Macro Block Type]

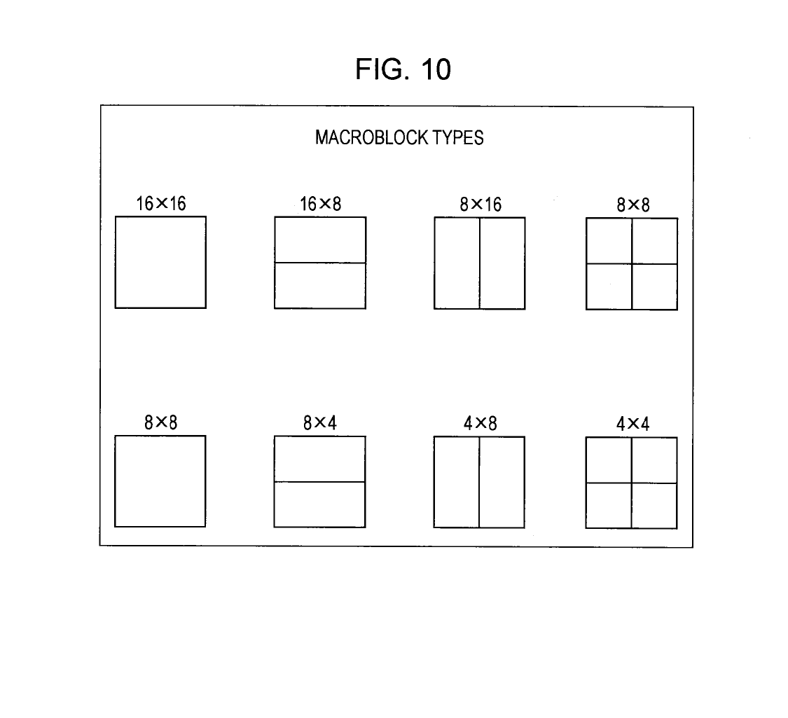

FIG. 10 is a diagram for describing macroblock types in MVC (AVC).

With MVC, a macroblock serving as a current block is a 16×16 pixel block horizontal×vertical, but a macroblock can be divided into partitions and ME (and generating of prediction images) be performed on each partition.

That is to say, with MVC, a macroblock can further be divided into any partition of 16×16 pixels, 16×8 pixels, 8×16 pixels, or 8×8 pixels, with ME performed on each partition to detect shift vectors (motion vectors or disparity vectors).

Also, with MVC, a partition of 8×8 pixels can be divided into any sub-partition of 8×8 pixels, 8×4 pixels, 4×8 pixels, or 4×4 pixels, with ME performed on each partition to detect shift vectors (motion vectors or disparity vectors).

Macroblock type represents what sort of partitions (or further sub-partitions) a macroblock is to be divided into.

With the inter prediction of the inter prediction unit 123 (FIG. 9), the encoding cost of each macroblock types is calculated as the encoding cost of each inter prediction mode, for example, with the inter prediction mode (macro block type) of which the encoding cost is the smallest being selected as the optimal inter prediction mode.

[Prediction Vector (PMV Predicted Motion Vector))]

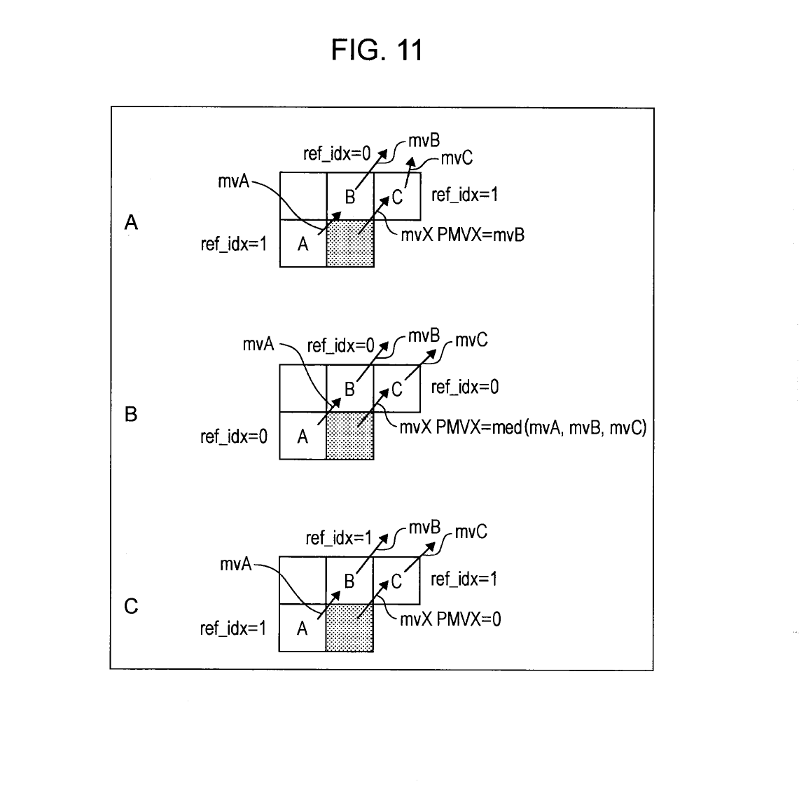

FIG. 11 is a diagram for describing prediction vectors (PMV) with MVC (AVC).

With the inter prediction of the inter prediction unit 123 (FIG. 9), shift vectors (motion vectors or disparity vectors) of the current block are detected by ME, and a prediction image is generated using these shift vectors.

While shift vectors are necessary to decode an image at the decoding side, and thus information of shift vectors needs to be encoded and included in encoded data, but encoding shift vectors as they are results in the amount of code of shift vectors being great, which may deteriorate encoding efficiency.

That is to say, with MVC, a macroblock may be divided into 8×8 pixel partitions, and each of the 8×8 pixel partitions may further be divided into 4×4 pixel sub-partitions, as described with FIG. 10. In this case, one macroblock is ultimately divided into 4×4 sub-partitions, meaning that each macroblock may have 16 (=4×4) shift vectors, and encoding the shift vectors as they are results in the amount of code great, deteriorating encoding efficiency.

Accordingly, with MVC (AVC), vector prediction to predict shift vectors is performed, and the residual of shift vectors as to prediction vectors obtained by the vector prediction (residual vectors) are encoded.

Note however, that prediction vectors generated with MVC differ according to reference indices (hereinafter also referred to as reference index for prediction) assigned to reference images used to generate prediction images of macroblocks in the periphery of the current block.

Now, (a picture which can serve as) a reference image in MVC (AVC), and a reference index, will be described.

With AVC, multiple pictures can be taken as reference images when generating a prediction image.

Also, with an AVC codec, reference images are stored in a buffer called a DPB, following decoding (local decoding).

With the DPB, pictures referenced short term are each marked as being short-term reference images (used for short-term reference), pictures referenced long term as being long-term reference images (used for long-term reference), and pictures not referenced as being unreferenced images (unused for reference).

There are two types of management methods for managing the DPB, which are the sliding window memory management format (Sliding window process) and the adaptive memory management format (Adaptive memory control process).

With the sliding window memory management format, the DPB is managed by FIFO (First In First Out) format, and pictures stored in the DPB are released (become unreferenced) in order from pictures of which the frame_num is small.

That is to say, with the sliding window memory management format, I (Intra) pictures, P (Predictive) pictures, and Bs pictures which are referable B (Bi-directional Predictive) pictures, are stored in the DPB as short-term reference images.

After the DPB has then stored all the (reference images that can become) reference images as it can store reference images, the earliest (oldest) short-term reference image of the short-term reference images stored in the DPB is released.

Note that in the event that long-term reference images are stored in the DPB, the sliding window memory management format does not affect the long-term reference images stored in the DPB. That is to say, with the sliding window memory management format, the only reference images managed by FIFO format are short-term reference images.

With the adaptive memory management format, pictures stored in the DPB are managed using commands called MMCO (Memory management control operation).

MMCO commands enable with regard to reference images stored in the DPB, setting short-term reference images to unreferenced images, setting short-term reference images to long-term reference images by assigning a long-term frame index which is a reference index for managing long-term reference images to short-term reference images, setting the maximum value of long-term frame index, setting all reference images to unreferenced images, and so forth.

With AVC, motion compensation (shift compensation) of reference images stored in the DPB is performed, thereby performing inter prediction where a prediction image is generated, and a maximum of two pictures worth of reference images can be used for inter prediction of B pictures (including Bs pictures). Inter prediction using the reference images of these two pictures are called L0 (List 0) prediction and L1 (List 1) prediction, respectively.

With regard to B pictures (including Bs pictures), L0 prediction, or L1 prediction, or both L0 prediction and L1 prediction are used for inter prediction. With regard to P pictures, only L0 prediction is used for inter prediction.

In inter prediction, reference images to be reference to generate a prediction image are managed by a reference list (Reference Picture List).

With a reference list, a reference index (Reference Index) which is an index for specifying (reference images that can become) reference images referenced to generate a prediction image is assigned to (pictures that can become) reference images stored in the DPB.

In the event that the current picture is a P picture, only L0 prediction is used with P pictures for inter prediction as described above, so assigning of the reference index is performed only regarding L0 prediction.

Also, in the event that the current picture is a B picture (including Bs picture), both L0 prediction and L1 prediction may be used with B pictures for inter prediction as described above, so assigning of the reference index is performed regarding L0 prediction and L1 prediction.

Now, a reference index regarding L0 prediction is also called an L0 index, and a reference index regarding L1 prediction is also called an L1 index.

In the event that the current picture is a P picture, with AVC default (default value) site later in decoding order the reference image is, the smaller a number reference index (L0 index) is assigned to the reference images stored in the DPB.

A reference index is an integer value of 0 or greater, with 0 being the minimal value. Accordingly, in the event that the current picture is a P picture, 0 is assigned to the reference image decoded immediately prior to the current picture, as an L0 index.

In the event that the current picture is a B picture (including Bs picture), with AVC default, a reference index (L0 index and L1 index) is assigned to the reference images stored in the DPB in POC (Picture Order Count) order, i.e., in display order.

That is to say, with regard to L0 prediction, the closer to the current picture a reference image is, the smaller the value of L0 index is that is assigned to reference images temporally before the current picture in display order, and thereafter, the closer to the current picture a reference image is, the smaller the value of L0 index is that is assigned to reference images temporally after the current picture in display order.

Also, with regard to L1 prediction, the closer to the current picture a reference image is, the smaller the value of L1 index is that is assigned to reference images temporally after the current picture in display order, and thereafter, the closer to the current picture a reference image is, the smaller the value of L1 index is that is assigned to reference images temporally before the current picture in display order.

Note that default assignment of the reference index (L0 index and L1 index) with AVC described above is performed as to short-term reference images. Assigning reference indices to long-term reference images is performed after assigning reference indices to the short-term reference images.

Accordingly, by default with AVC, long-term reference images are assigned reference indices with grater values that short-term reference images.

With AVC, assigning of reference indices can be performed as with the default method described above, or optional assigning may be performed using a command called Reference Picture List Reordering (hereinafter also referred to as RPLR command).

Note that in the event that the RPLR command is used to assign reference indices, and thereafter there is a reference image to which a reference index has not bee assigned, a reference index is assigned to the reference image by the default method.

With MVC (AVC), as illustrated in FIG. 11, a prediction vector PMVX of a shift vector mvX of the current block X is obtained differently for each reference index for prediction of the macroblock A adjacent to the current block X to the left, macroblock adjacent above, and macroblock C adjacent to the oblique upper right (reference indices assigned to reference images used for generating he prediction images of each of the macroblocks A, B, and C).

That is, let us now say that a reference index ref_idx for prediction of the current block X is, for example, 0.

As illustrated in A in FIG. 11, in the event that there is only one macroblock of the three macroblocks A through C adjacent to the current block X where the reference index ref_idx for prediction is 0, the same as with the current block X, the shift vector of that one macroblock (the macroblock of which the reference index ref_idx for prediction is 0) is taken as the prediction vector PMVX of the shift vector mvX of the current block X.

Note that here, with A in FIG. 11, only macroblock B of the three macroblocks A through C adjacent to the current block X has a reference index ref_idx for prediction of 0, and accordingly, the shift vector mvB of macroblock A is taken as the prediction vector PMVX (of the shift vector mvX) of the current block X.

Also, as illustrated in B in FIG. 11, in the event that there are two or more macroblocks of the three macroblocks A through C adjacent to the current block X where the reference index ref_idx for prediction is 0, the same as with the current block X, the median of the shift vectors of the two or more macroblocks where the reference index ref_idx for prediction is taken as the prediction vector PMVX of the current block X.

Note that here, with B in FIG. 11, all three macroblocks A through C adjacent to the current block X are macroblocks having a reference index ref_idx for prediction of 0, and accordingly, the median med(mvA, mvB, mvC) of the shift vector mvA of macroblock A, the shift vector mvB of macroblock B, and the shift vector mvC of macroblock C, is taken as the prediction vector PMVX of the current block X. Note that calculation of the median med(mvA, mvB, mvC) is performed separately (independently) for x component and y component.

Also, as illustrated in C in FIG. 11, in the event that there is not even one macroblock of the three macroblocks A through C adjacent to the current block X where the reference index ref_idx for prediction is 0, the same as with the current block X, a 0 vector is taken as the prediction vector PMVX of the current block X.

Note that here, with C in FIG. 11, there is no macroblock of the three macroblocks A through C adjacent to the current block X has a reference index ref_idx for prediction of 0, and accordingly, a 0 vector is taken as the prediction vector PMVX of the current block X.

Note that with MVC (AVC), in the event that the reference index ref_idx for prediction of the current block X is 0, the current block X can be encoded as a skip macroblock (skip mode).

With regard to a skip macroblock, neither residual of the object block nor residual vector is encoded. At the time of decoding, the prediction vector is employed as the shift vector of the skip macroblock without change, and a copy of a block (current block) at a position in the reference image shifted from the position of the skip macroblock by an amount equivalent to the shift vector (prediction vector) is taken as the decoding results of the skip macroblock.

Whether or not to take a current block as a skip macroblock depends on the specifications of the encoder, and is decided (determined) based on, for example, amount of code of the encoded data, encoding cost of the current block, and so forth.

[Configuration Example of Inter Prediction Unit 123]

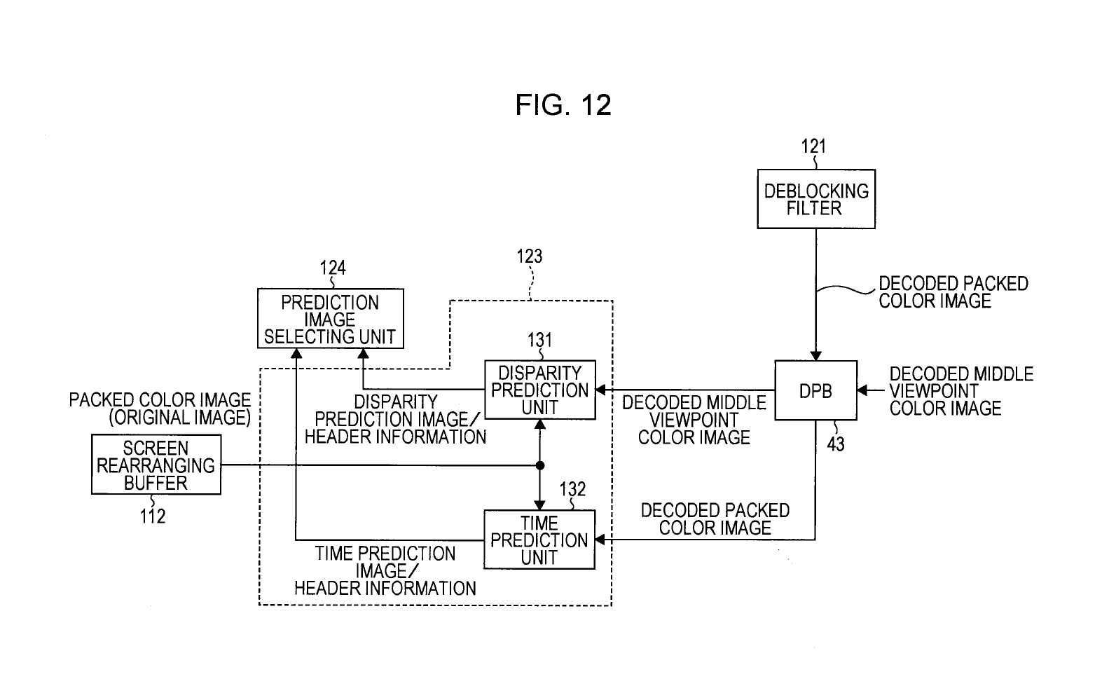

FIG. 12 is a block diagram illustrating a configuration example of the inter prediction unit 123 of the encoder 42 in FIG. 9.

The inter prediction unit 123 has a disparity prediction unit 131 and a temporal prediction unit 132.

Now, in FIG. 12, the DPB 43 is supplied from the deblocking filter 121 with a decoded image, i.e., a picture of a packed color image encoded at the encoder 42 and locally decoded (hereinafter also referred to as decoded packed color image), and stored as (a picture that can become) a reference image.

Also, as described with FIG. 5 and FIG. 9, a picture of a multi-viewpoint color image encoded at the encoder 41 and locally decoded (hereinafter also referred to as decoded middle viewpoint color image) is also supplied to the DPB 43 and stored.

At the encoder 42, in addition to the picture of the decoded packed color image from the deblocking filter 121, the picture of the decoded middle viewpoint color image obtained at the encoder 41 is used to encode the packed color image to be encoded. Accordingly, in FIG. 12, an arrow is shown illustrating that the decoded middle viewpoint color image obtained at the encoder 41 is to be supplied to the DPB 43.

The disparity prediction unit 131 is supplied with the current picture of the packed color image from the screen rearranging buffer 112.

The disparity prediction unit 131 performs disparity prediction of the current block of the current picture of the packed color image from the screen rearranging buffer 112, using the picture of the decoded middle viewpoint color image stored in the DPB 43 (picture of same point-in-time as current picture) as a reference image, and generates a prediction image of the current block.

That is to say, the disparity prediction unit 131 performs ME with the picture of the decoded middle viewpoint color image stored in the DPB 43 as a reference image, thereby obtaining a disparity vector of the current block.

Further, the disparity prediction unit 131 performs MC following the disparity vector of the current block, with the picture of the decoded middle viewpoint color image stored in the DPB 43 as a reference image, thereby generating a prediction image of the current block.

Also, the disparity prediction unit 131 calculates encoding cost needed for encoding of the current block using the prediction image obtained by disparity prediction from the reference image (prediction encoding), for each macroblock type.

The disparity prediction unit 131 then selects the macroblock type of which the encoding cost is smallest, as the optimal inter prediction mode, and supplies a prediction image generated in that optimal inter prediction mode (disparity prediction image) to the prediction image selecting unit 124.

Further, the disparity prediction unit 131 supplies information of the optimal inter prediction mode and so forth to the prediction image selecting unit 124 as header information.

Note that as described above, reference indices are assigned to reference images, with a reference index assigned to a reference image referred to at the time of generating a prediction image generated in the optimal inter prediction mode being selected at the disparity prediction unit 131 as the reference index for prediction of the current block, and supplied to the prediction image selecting unit 124 as one of header information.

The temporal prediction unit 132 is supplied from the screen rearranging buffer 112 with the current picture of the packed color image.

The temporal prediction unit 132 performs temporal prediction of the current block of the current picture of the packed color image from the screen rearranging buffer 112, using the picture of the decoded packed color image stored in the DPB 43 (picture at different point-in-time as current picture) as a reference, and generates a prediction image of the current block.

That is to say, the temporal prediction unit 132 performs ME with the picture of the decoded packed color image stored in the DPB 43 as a reference image, thereby obtaining a motion vector of the current block.

Further, the temporal prediction unit 132 performs MC following the motion vector of the current block, with the picture of the decoded packed color image stored in the DPB 43 as a reference image, thereby generating a prediction image of the current block.

Also, the temporal prediction unit 132 calculates encoding cost needed for encoding of the current block using the prediction image obtained by temporal prediction from the reference image (prediction encoding), for each macroblock type.

The temporal prediction unit 132 then selects the macroblock type of which the encoding cost is smallest, as the optimal inter prediction mode, and supplies a prediction image generated in that optimal inter prediction mode (temporal prediction image) to the prediction image selecting unit 124.

Further, the temporal prediction unit 132 supplies information of the optimal inter prediction mode and so forth to the prediction image selecting unit 124 as header information.

Note that as described above, reference indices are assigned to reference images, with a reference index assigned to a reference image referred to at the time of generating a prediction image generated in the optimal inter prediction mode being selected at the temporal prediction unit 132 as the reference index for prediction of the current block, and supplied to the prediction image selecting unit 124 as one of header information.

At the prediction image selecting unit 124, of the prediction images from the intra-screen prediction unit 122, and the disparity prediction unit 131 and temporal prediction unit 132 making up the inter prediction unit 123, for example, the prediction image of which the encoding cost is smallest is selected, and supplied to the computing units 113 and 120.

Now, with the present embodiment, we will say that a reference index of a value 1 is assigned to a reference image referred to in disparity prediction (here, the picture of the decoded middle viewpoint color image), for example, and a reference index of a value 0 is assigned to a reference image referred to in temporal prediction (here, the picture of the decoded packed color image).

[Configuration Example of Disparity Prediction Unit 131]

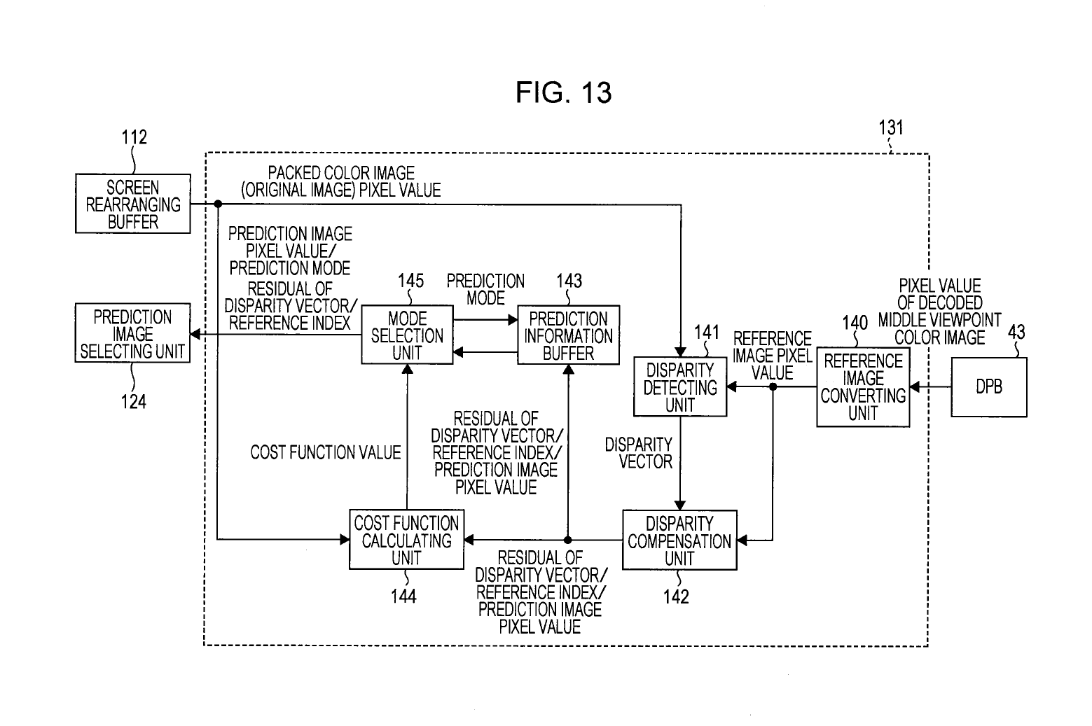

FIG. 13 is a block diagram illustrating a configuration example of the disparity prediction unit 131 in FIG. 12.

In FIG. 13, the disparity prediction unit 131 has a reference image converting unit 140, a disparity detecting unit 141, a disparity compensation unit 142, a prediction information buffer 143, a cost function calculating unit 144, and a mode selecting unit 145.

The reference image converting unit 140 is supplied from the DPB 43 with a picture of the decoded middle viewpoint color image, as a reference image.

In order to perform disparity prediction in fraction precision, which is sub-pixel prediction (a fineness equal to or smaller than the interval between the pixels of the reference image), at the disparity prediction unit 131, the reference image converting unit 140 subjects the reference image from the DPB 43 to filter processing where the picture of the decoded middle viewpoint color image serving as the reference image from the DPB 43 is subjected to interpolation of virtual pixels called sub pels (Sub pel), thereby converting the reference image into a reference image with high resolution (with a great number of pixels), which is supplied to the disparity detecting unit 141 and disparity compensation unit 142.

Now the filter used for filter processing to interpolate sub pels, on order to perform disparity prediction (and temporal prediction) with fraction precision as described above with MVC, is called an AIF (Adaptive Interpolation Filter).

Note that at the reference image converting unit 140, the reference image may be supplied to the disparity detecting unit 141 and disparity compensation unit 142 as it is, without subjecting to filter processing at the AIF.

The picture of the decoded middle viewpoint color image serving as the reference image is supplied from the reference image converting unit 140 to the disparity detecting unit 141, and also the picture of the packed color image to be encoded (current picture) is also supplied thereto from the screen rearranging buffer 112.

The disparity detecting unit 141 performs ME using the current block and the picture of the decoded middle viewpoint color image which is the reference image, thereby detecting, at the current block and picture of decoded middle viewpoint color image, a disparity vector my representing the shift as to the current block, which maximizes encoding efficiency such as minimizing SAD or the like as to the current block or the like for example, for each macroblock type, which are supplied to the disparity compensation unit 142.

The disparity compensation unit 142 is supplied from the disparity detecting unit 141 with disparity vectors mv, and also is supplied with the picture of the decoded middle viewpoint color image serving as the reference image from the reference image converting unit 140.

The disparity compensation unit 142 performs disparity compensation of the reference image from the reference image converting unit 140 using the disparity vectors my of the current block from the disparity detecting unit 141, thereby generating a prediction image of the current block, for each macroblock type.

That is to say, the disparity compensation unit 142 obtains a corresponding block which is a block (region) in the picture of the decoded middle viewpoint color image serving as the reference image, shifted by an amount equivalent to the disparity vector my from the position of the current block, as a prediction image.

Also, the disparity compensation unit 142 uses disparity vectors of macroblocks at the periphery of the current block, that have already been encoded, as necessary, thereby obtaining a prediction vector PMV of the disparity vector my of the current block.

Further, the disparity compensation unit 142 obtains a residual vector which is the difference between the disparity vector my of the current block and the prediction vector PMV.

The disparity compensation unit 142 then correlates the prediction image of the current block for each prediction mode, such as macroblock type, with the prediction mode, along with the residual vector of the current block and the reference index assigned to the reference image (here, the picture of the decoded middle viewpoint color image) used for generating the prediction image, and supplies to the prediction information buffer 143 and the cost function calculating unit 144.

The prediction information buffer 143 temporarily stores the prediction image correlated with the prediction mode, residual vector, and reference index, from the disparity compensation unit 142, along with the prediction mode thereof, as prediction information.

The cost function calculating unit 144 is supplied from the disparity compensation unit 142 with the prediction image correlated with the prediction mode, residual vector, and reference index, and is supplied from the screen rearranging buffer 112 with the current picture of the packed color image.

The cost function calculating unit 144 calculates the encoding cost needed to encode the current block of the current picture from the screen rearranging buffer 112 following a predetermined cost function for calculating encoding cost, for each macroblock type (FIG. 10) serving as prediction mode.

That is to say, the cost function calculating unit 144 obtains a value MV corresponding to the code amount of residual vector from the disparity compensation unit 142, and also obtains a value IN corresponding to the code amount of reference index (reference index for prediction) from the disparity compensation unit 142.

Further, the cost function calculating unit 144 obtains a SAD which is a value D corresponding to the code amount of residual of the current block, as to the prediction image from the disparity compensation unit 142.

The cost function calculating unit 144 then obtains the encoding cost (cost function value of the cost function) COST for each macroblock type, following an expression COST D+λ1×MV+λ2×IN, weighted by λ1 and λ2, for example.

Upon obtaining the encoding cost (cost function value) for each macroblock type, the cost function calculating unit 144 supplies the encoding cost to the mode selecting unit 145.

The mode selecting unit 145 detects the smallest cost which is the smallest value, from the encoding costs for each macroblock type from the cost function calculating unit 144.

Further, the mode selecting unit 145 selects the macroblock type of which the smallest cost has been obtained, as the optimal inter prediction mode.

The mode selecting unit 145 then reads out the prediction image correlated with the prediction mode which is the optimal inter prediction mode, residual vector, and reference index, from the prediction information buffer 143, and supplies to the prediction image selecting unit 124 along with the prediction mode which is the optimal inter prediction mode.

Now, the prediction mode (optimal inter prediction mode), residual vector, and reference index (reference index for prediction), supplied from the mode selecting unit 145 to the prediction image selecting unit 124, are prediction mode related information related to inter prediction (disparity prediction here), and at the prediction image selecting unit 124, the prediction mode related information relating to this inter prediction is supplied to the variable length encoding unit 216 as header information, as necessary.

Note that in the event that the reference index regarding which the smallest cost has been obtained is a reference index of a value 0, at the mode selecting unit 145 determination is made based on the smallest cost and so forth, for example, regarding whether to encode the current block as a skip macroblock.

In the event that determination is made at the mode selecting unit 145 to encode the current block as a skip macroblock, the optimal inter prediction mode is set to skip mode where the current block is encoded as a skip macroblock.

Also, the temporal prediction unit 132 in FIG. 12 performs the same processing as with the disparity prediction unit 131 in FIG. 13, except for that the reference image is a picture of a decoded packed color image rather than a picture of a decoded middle viewpoint color image.

[Filter Processing with MVC]

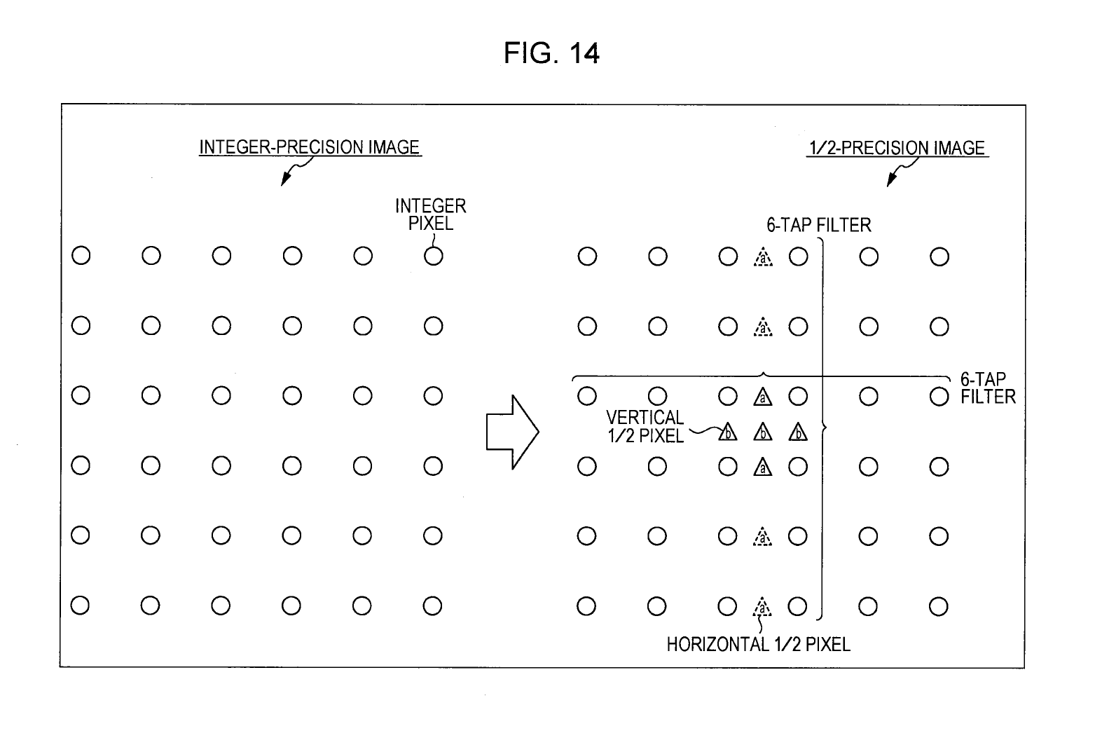

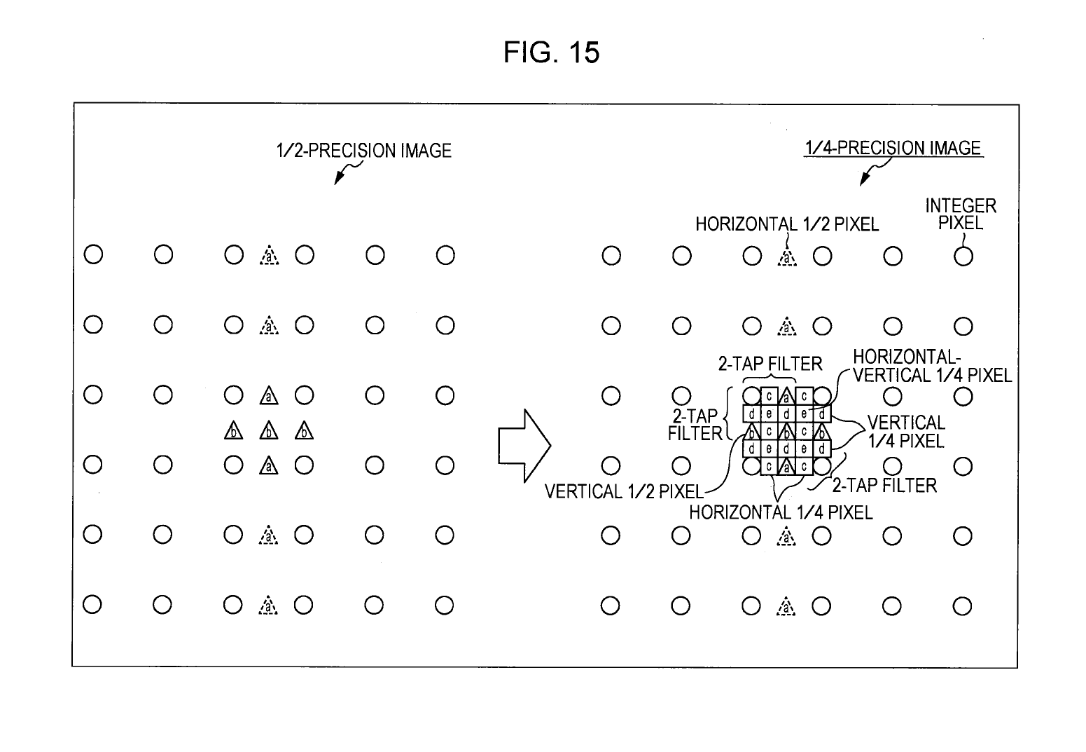

FIG. 14 and FIG. 15 are diagrams for describing filter processing performed at the reference image converting unit 140, i.e., filter processing with MVC where a reference image is interpolated with sub pels.

Note that in FIG. 14 and FIG. 15, the circle symbols represent original pixels of the reference image (pixels which are not sub pels).

If we say that the horizontal and vertical intervals between the original pixels of the reference image (hereinafter also referred to as original pixels) is 1, the positions of the original pixels can be represented in terms of coordinates using integers on a two-dimensional coordinate system where the position of a certain original pixel is the origin (0, 0), the horizontal direction is the x axis and the vertical direction is the y axis, so original pixels are also called integer pixels.

Also, a position which can be expressed by coordinates using integers is also called an integer position, and an image configured only of integer pixels is also called an integer precision image.

With MVC, as illustrated in FIG. 14, a filter process for filtering six integer pixels in a continuous array in the horizontal direction within a reference image which is an integer precision image, by a 6-tap filter (AIF) in the horizontal direction (hereinafter also referred to as horizontal ½ pixel generating filter processing) is performed to generate pixels as sub pels at a position a between the third and fourth integer pixel of the six integer pixels.

Now, a pixel generated (interpolated) by horizontal ½ pixel generating filter processing is also referred to as a horizontal ½ pixel.

Further, as illustrated in FIG. 14, with MVC, a filter process for filtering six integer pixels in a continuous array in the vertical direction within a reference image after horizontal ½ pixel generating filter processing, by a 6-tap filter (AIF) in the vertical direction (hereinafter also referred to as vertical ½ pixel generating filter processing) is performed to generate pixels as sub pels at a position a between the third and fourth integer pixel of the six integer pixels, or of the horizontal ½ pixels.

Now, a pixel generated by vertical ½ pixel generating filter processing is also referred to as a vertical ½ pixel.

Also, an image obtained by subjecting an integer precision image to horizontal ½ pixel generating filter processing, and then further vertical ½ pixel generating filter processing, is also referred to as a ½ precision image.

With a ½ precision image, horizontal and vertical intervals between pixels are ½, so the position of pixels can be expressed with coordinates using ½-inteval values including integers.

The precision of disparity prediction (detecting disparity vectors and generating prediction images) in a case of using an integer precision image is integer precision, but the precision of disparity prediction in a case of using a ½ precision image is ½ precision, so prediction precision can be improved by disparity prediction in a case of using a ½ precision image.

With MVC, not only can a reference image of a ½ precision image such as described above be used to perform ½ precision disparity prediction, a reference image with even higher precision (resolution) can be generated from the reference image of the ½ precision image, and that reference image used to perform disparity prediction with even higher precision.

That is, with MVC, as illustrated in FIG. 15, a filter process for filtering integer pixels and horizontal ½ pixel in a continuous array in the horizontal direction within a reference image which is a ½ precision image (pixels at position a in FIG. 15), or two vertical ½ pixels (pixels at position b in FIG. 15) by a 2-tap filter (AIF) in the horizontal direction (hereinafter also referred to as horizontal ¼ pixel generating filter processing) is performed to generate pixels as sub pels at a position between an integer pixel and horizontal ½ pixel to be subjected to filter processing, or at a position c between two vertical ½ pixels.

Now, a pixel generated by horizontal ¼ pixel generating filter processing is also referred to as a horizontal ¼ pixel.

Further, with MVC, as illustrated in FIG. 15, a filter process for filtering integer pixels and vertical ½ pixel in a continuous array in the horizontal direction within a reference image which is a ½ precision image (pixels at position b in FIG. 15), or a horizontal ½ pixel (pixel at position a in FIG. 15) and a vertical ½ pixel (pixels at position b in FIG. 15) by a 2-tap filter (AIF) in the vertical direction (hereinafter also referred to as vertical ¼ pixel generating filter processing) is performed to generate pixels as sub pels at a position between an integer pixel and horizontal ½ pixel to be subjected to filter processing, or at a position d between a horizontal ½ pixel and a vertical ½ pixel.

Now, a pixel generated by vertical ¼ pixel generating filter processing is also referred to as a vertical ¼ pixel.

Further, with MVC, as illustrated in FIG. 15, a filter process for filtering horizontal ½ pixels (pixel at position a in FIG. 15) and vertical ½ pixels (pixel at position b in FIG. 15) in a continuous array in an oblique direction within a reference image which is a ½ precision image by a 2-tap filter (AIF) in an oblique direction (hereinafter also referred to as horizontal-vertical ¼ pixel generating filter processing) is performed to generate pixels as sub pels at a position e between horizontal ½ pixels vertical ½ pixels in a continuous array in an oblique direction.

Now, a pixel generated by horizontal vertical ¼ pixel generating filter processing is also referred to as a horizontal vertical ¼ pixel.

Also, an image obtained by subjecting a ½ precision image to horizontal ¼ pixel generating filter processing, and then further vertical ¼ pixel generating filter processing, and then horizontal-vertical ¼-pixel generating filter processing, is also referred to as a ¼ precision image.

With a ¼ precision image, horizontal and vertical intervals between pixels are ¼, so the position of pixels can be expressed with coordinates using ¼-inteval values including integers.

The precision of disparity prediction in a case of using a reference image of a ¼ precision image is ¼ precision, so prediction precision can be further improved by disparity prediction in a case of using a reference image of a ¼ precision image.

Now, FIG. 14 is a diagram for describing generating of a reference image of a ½ precision image by subjecting a reference image of an integer precision image to horizontal ½ pixel generating filter processing and to vertical ½ pixel generating filter processing, and FIG. 15 is a diagram for describing generating of a reference image of a ¼ precision image by subjecting a reference image of a ½ precision image to horizontal ¼ pixel generating filter processing, vertical ¼ pixel generating filter processing, and horizontal-vertical ¼ pixel generating filter processing.

[Configuration Example of Reference Image Converting Unit 140]

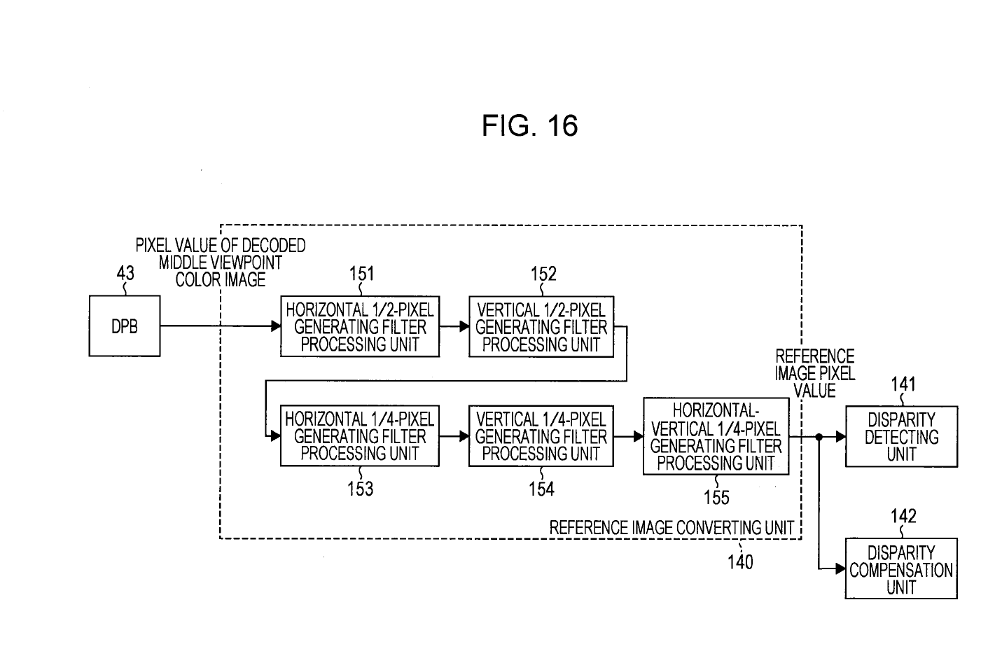

FIG. 16 is a block diagram illustrating a configuration example of the reference image converting unit 140 in FIG. 13.

The reference image converting unit 140 converts a reference image of an integer precision image into an image with high resolution (with a great number of pixels), i.e., a reference image of a ½ precision image or a reference image of a ¼ precision image, by subjecting the reference image to the MVC filter processing described with FIG. 14 and FIG. 15.

In FIG. 16, the reference image converting unit 140 has a horizontal ½-pixel generating filter processing unit 151, a vertical ½-pixel generating filter processing unit 152, a horizontal ¼-pixel generating filter processing unit 153, a vertical ¼-pixel generating filter processing unit 154, and a horizontal-vertical ¼-pixel generating filter processing unit 155.

The horizontal ½-pixel generating filter processing unit 151 is supplied with (a picture of) a decoded middle viewpoint color image from the DPB 43, as a reference image of an integer precision image.

The horizontal ½-pixel generating filter processing unit 151 subjects the reference image of an integer precision image to horizontal ½ pixel generating filter processing, and supplies the reference image of which the number of pixels in the horizontal direction is double that of the original, to the vertical ½-pixel generating filter processing unit 152.

The vertical ½-pixel generating filter processing unit 152 subjects the reference image from the horizontal ½-pixel generating filter processing unit 151 to vertical ½ pixel generating filter processing, and supplies the reference image of which the number of pixels in the horizontal direction and vertical direction is double that of the original, i.e., a reference image of a ½ precision image (FIG. 14), to the horizontal ¼-pixel generating filter processing unit 153.

The horizontal ¼-pixel generating filter processing unit 153 subjects the reference image of a ½ precision image from the vertical ½-pixel generating filter processing unit 152 to horizontal ¼ pixel generating filter processing, and supplies to the vertical ¼-pixel generating filter processing unit 154.

The vertical ¼-pixel generating filter processing unit 154 subjects the reference image from the horizontal ¼-pixel generating filter processing unit 153 to vertical ¼ pixel generating filter processing, and supplies to the horizontal-vertical ¼-pixel generating filter processing unit 155.

The horizontal-vertical ¼-pixel generating filter processing unit 155 subjects the reference image from the vertical ¼-pixel generating filter processing unit 154 to horizontal-vertical ¼ pixel generating filter processing, and outputs the reference image of which the number of pixels in the horizontal direction and vertical direction is quadruple that of the original, i.e., a reference image of a ¼ precision image (FIG. 15).

Note that with MVC, in a case of subjecting a reference image to filter processing where pixels are interpolated, filter processing is stipulated wherein the number of pixels in the horizontal direction and vertical direction are increased by the same multiple.

Accordingly, with MVC, disparity prediction (and temporal prediction) can be performed using a reference image of an integer precision image, a reference image of a ½ precision image, or a reference image of a ¼ precision image.

Accordingly, at the reference image converting unit 140, there are three cases: a case where none of horizontal ½ pixel generating filter processing, vertical ½ pixel generating filter processing, horizontal ¼ pixel generating filter processing, vertical ¼ pixel generating filter processing, and horizontal-vertical ¼ pixel generating filter processing is performed, and the reference image of an integer precision image is output as it is; a case where only horizontal ½ pixel generating filter processing and vertical ½ pixel generating filter processing is performed and the reference image of an integer precision image is converted into a reference image of a ½ precision image; and a case where all of horizontal ½ pixel generating filter processing, vertical ½ pixel generating filter processing, horizontal ¼ pixel generating filter processing, vertical ¼ pixel generating filter processing, and horizontal-vertical ¼ pixel generating filter processing is performed, and the reference image of an integer precision image is converted into a reference image of a ¼ precision image.

[Configuration Example of Decoding Device 32C]

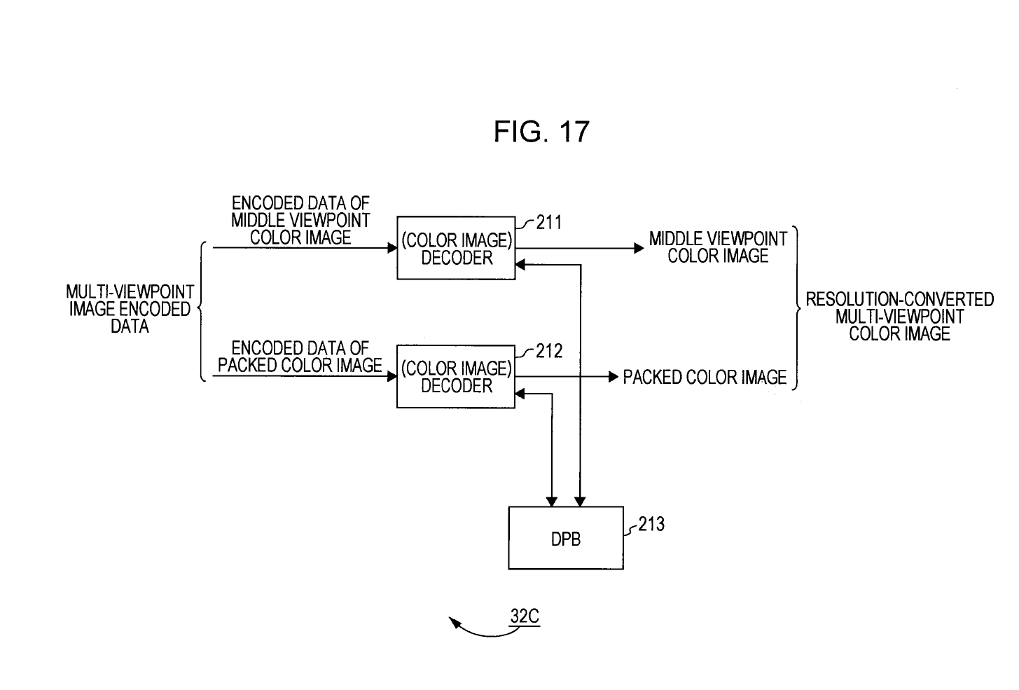

FIG. 17 is a block diagram illustrating a configuration example of the decoding device 32C in FIG. 3.

The decoding device 32C in FIG. 17 decodes, with MVC, a middle viewpoint color image which is multi-viewpoint color image encoded data from the inverse multiplexing device 31 (FIG. 3), and encoded data of a packed color image.

In FIG. 17, the decoding device 32C has decoders 211 and 212, and a DPB 213.

The decoder 211 is supplied with the encoded data of a middle viewpoint color which is a base view image, of multi-viewpoint color image encoded data from the inverse multiplexing device 31 (FIG. 3).

The decoder 211 decodes the encoded data of the middle viewpoint color image supplied thereto with MVC, and outputs the middle viewpoint color image obtained as the result thereof.

The decoder 212 is supplied with, of the multi-viewpoint color image encoded data from the inverse multiplexing device 31 (FIG. 3), encoded data of the packed color image which is a non base view image.

The decoder 212 decodes the encoded data of the packed color image supplied thereto, and outputs a packed color image obtained as the result thereof.

Now, the multi-viewpoint color image which the decoder 211 outputs and the packed color image which the decoder 212 outputs are supplied to the resolution inverse converting device 33C (FIG. 3) as a resolution-converted multi-viewpoint color image.

The DPB 213 temporarily stores the images after decoding (decoded images) obtained by decoding the images to be decoded at each of the decoders 211 and 212 as (candidates of) reference images to be referenced at the time of generating a prediction image.

That is to say, the decoders 211 and 212 each encode images subjected to prediction encoding at the encoders 41 and 42 in FIG. 5.

In order to decode an image subjected to prediction encoding, the prediction image used for the prediction encoding is necessary, so the decoders 211 and 212 decode the images to be decoded, and thereafter temporarily store the decoded images to be used for generating of a prediction image, in the DPB 213, to generate the prediction image used in the prediction encoding.

The DPB 213 is a shared buffer to temporarily store images after decoding (decoded images) obtained at each of the decoders 211 and 212, with each of the decoders 211 and 212 selecting a reference image to reference to decode the image to e decoded, from the decoded images stored in the DPB 213, and generating prediction images using the reference images.

The DPB 213 is shared between the decoders 211 and 212, so the decoders 211 and 212 can each reference, besides decoded images obtained from itself, decoded images obtained at the other decoder as well.

Note however, the decoder 211 decodes base view images, so only references decoded images obtained at the decoder 211.

[Configuration Example of Decoder 212]

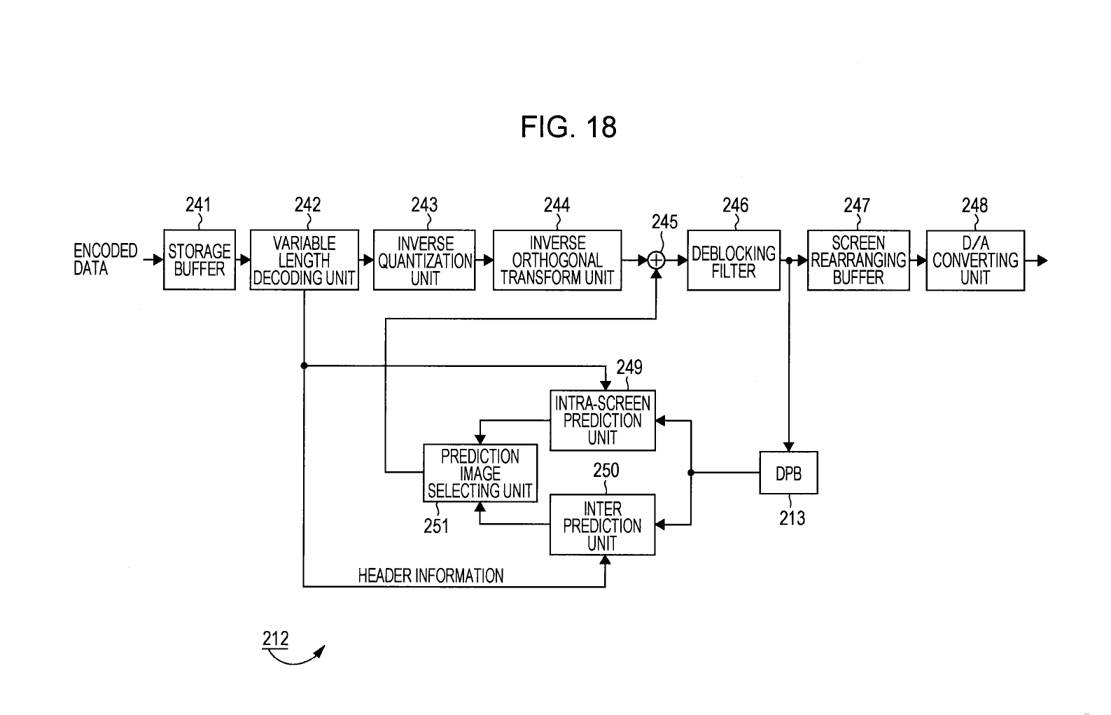

FIG. 18 is a block diagram illustrating a configuration example of the decoder 212 in FIG. 17.

In FIG. 18, the decoder 212 has a storage buffer 241, a variable length decoding unit 242, an inverse quantization unit 243, an inverse orthogonal transform unit 244, a computing unit 245, a deblocking filter 246, a screen rearranging buffer 247, a D/A conversion unit 248, an intra-screen prediction unit 249, an inter prediction unit 250, and a prediction image selecting unit 251.

The storage buffer 241 is supplied from the inverse multiplexing device 31 with, of the encoded data of the middle viewpoint color image and packed color image configuring the multi-viewpoint color image encoded data, the encoded data of the packed color image.

The storage buffer 241 temporarily stores the encoded data supplied thereto, and supplies to the variable length decoding unit 242.

The variable length decoding unit 242 performs variable length decoding of the encoded data from the storage buffer 241, thereby restoring quantization values and prediction mode related information which has been header information. The variable length decoding unit 242 then supplies quantization values to the inverse quantization unit 243, and supplies header information (prediction mode related information) to the intra-screen prediction unit 249 and inter prediction unit 250.

The inverse quantization unit 243 performs inverse quantization of the quantization values from the variable length decoding unit 242 into transform coefficients, and supplies to the inverse orthogonal transform unit 244.

The inverse orthogonal transform unit 244 performs inverse orthogonal transform of the transform coefficients from the inverse quantization unit 243 in increments of macroblocks, and supplies to the computing unit 245.

The computing unit 245 task a macroblock supplied from the inverse orthogonal transform unit 244 as a current block to be decoded, and adds the prediction image supplied from the prediction image selecting unit 251 to the current block as necessary, thereby obtaining a decoded image, which is supplied to the deblocking filter 246.

The deblocking filter 246 performs filtering on the decoded image from the computing unit 245 in the same way as with the deblocking filter 121 in FIG. 9 for example, and supplies a decoded image after this filtering to the screen rearranging buffer 247.

The screen rearranging buffer 247 temporarily s)ores and reads out pictures of decoded images from the deblocking filter 246, thereby rearranging the order of pictures in the original order (display order) and supplies to the D/A (Digital/Analog) conversion unit 248.

In the event that a picture from the screen rearranging buffer 247 needs to be output as analog signals, the D/A conversion unit 248 D/A converts the picture and outputs.

Also, the deblocking filter 246 supplies, of the decoded images after filtering, the decoded images of I picture, P pictures, and Bs pictures that are referable pictures, to the DPB 213.

Now, the DPB 213 stores pictures of decoded images from the deblocking filter 246, i.e., pictures of packed color images, as reference images to be referenced at the time of generating prediction images, to be used in decoding performed later in time.

As described with FIG. 17, the DPB 213 is shared between the decoders 211 and 212, and accordingly stores, besides pictures of packed color image (decoded packed color images) decoded at the decoder 212, pictures of middle viewpoint color images (decoded middle viewpoint color images) decoded at the decoder 211.

The intra-screen prediction unit 249 recognizes whether or not the current block has been encoded using a prediction image generated by intra prediction (intra-screen prediction), based on header information from the variable length decoding unit 242.

In the event that the current block has been encoded using a prediction image generated by intra prediction, in the same way as with the intra-screen prediction unit 122 in FIG. 9 the intra-screen prediction unit 249 reads out the already-decoded portion (decoded image) of the picture including the current block (current picture) from the DPB 213. The intra-screen prediction unit 249 then supplies the portion of the decoded image from the current picture that has been read out from the DPB 213 to the prediction image selecting unit 251, as a prediction image of the current block.

The inter prediction unit 250 recognizes whether or not the current block has been encoded using the prediction image generated by inter prediction, based on the header information from the variable length decoding unit 242.

In the event that the current block has been encoded using a prediction image generated by inter prediction, the inter prediction unit 250 recognizes a reference index for prediction, i.e., the reference index assigned to the reference image used to generate the prediction image of the current block, based on the header information (prediction mode related information) from the variable length decoding unit 242.

The inter prediction unit 250 then reads out, from the picture of the decoded packed color image and picture of the decoded middle viewpoint color image, stored in the DPB 213, the picture to which the reference index for prediction has been assigned, as the reference image.

Further, the inter prediction unit 250 recognizes the shift vector (disparity vector, motion vector) used to generate the prediction image of the current block, based on the header information from the variable length decoding unit 242, and in the same way as with the inter prediction unit 123 in FIG. 9 performs shift compensation of the reference image (motion compensation to compensate for shift equivalent to an amount moved, or disparity compensation to compensate for shift equivalent to amount of disparity) following the shift vector, thereby generating a prediction image.

That is to say, the inter prediction unit 250 acquires a block (current block) at a position moved (shifted) from the position of the current block in the reference image, in accordance with the shift vector of the current block, as a prediction image.

The inter prediction unit 250 then supplies the prediction image to the prediction image selecting unit 251.

In the event that the prediction image is supplied from the intra-screen prediction unit 249, the prediction image selecting unit 251 selects that prediction image, and in the event that the prediction image is supplied from the inter prediction unit 250, selects that prediction image, and supplies to the computing unit 245.

[Configuration Example of Inter Prediction Unit 250]

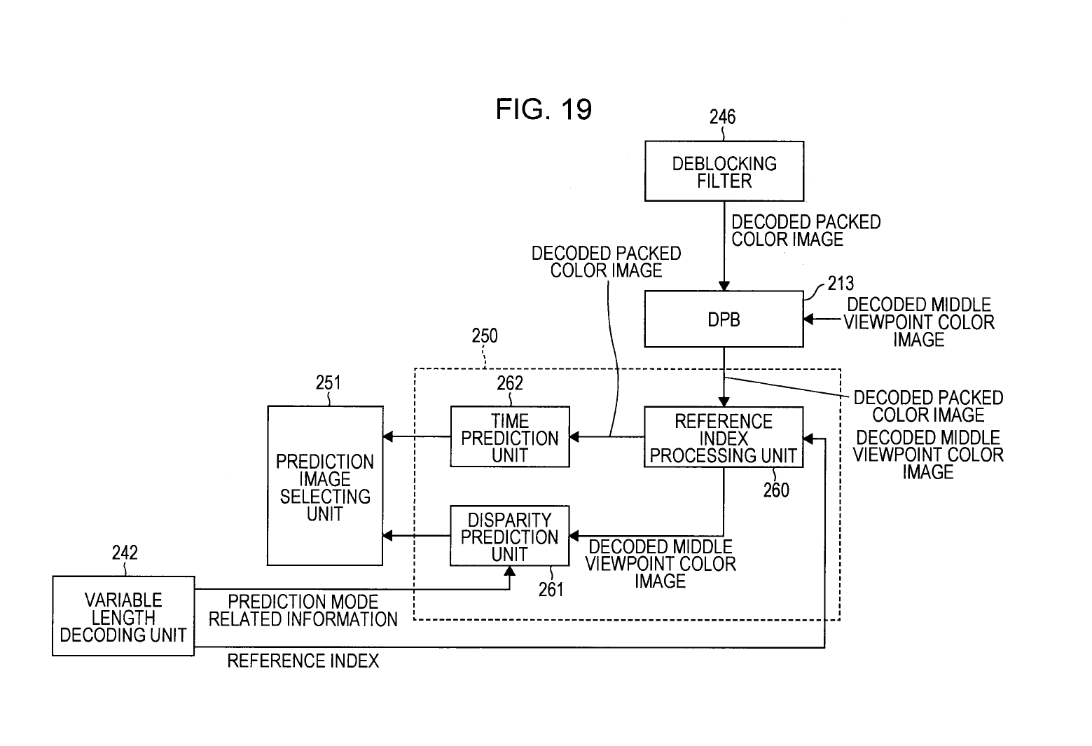

FIG. 19 is a block diagram illustrating a configuration example of the inter prediction unit 250 of the decoder 212 in FIG. 18.

In FIG. 19, the inter prediction unit 250 has a reference index processing unit 260, a disparity prediction unit 261, and a time prediction unit 262.

Now, in FIG. 19, the DPB 213 is supplied with a decoded image, i.e., the picture of a decoded packed color image decoded at the decoder 212, from the deblocking filter 246, which is stored as a reference image.

Also, as described with FIG. 17 and FIG. 18, the DPB 213 is supplied with the picture of a decoded middle viewpoint color image decoded at the decoder 211, and this is stored. Accordingly, in FIG. 19, an arrow is illustrated indicating that the decoded middle viewpoint color image obtained at the decoder 211 is supplied to the DPB 213.

The reference index processing unit 260 is supplied with, of the prediction mode related information which is header information from the variable length decoding unit 242, the reference index (for prediction) of the current block.

The reference index processing unit 260 reads out the picture of the decoded middle viewpoint color image to which the reference index for prediction of the current block from the variable length decoding unit 242 has been assigned, or decoded packed color image, from the DPB 213, and supplies to the disparity prediction unit 261 or the time prediction unit 262.

Now, with the present embodiment, a reference index of value 1 is assigned at the encoder 42 to a picture of the decoded middle viewpoint color image which is the reference image referenced in disparity prediction, and a reference index of value 0 is assigned to a picture of the decoded packed color image which is the reference image referenced in temporal prediction, as described with FIG. 12.

Accordingly, whether the reference image to be used for generating a prediction image of the current block is a picture of the decoded middle viewpoint color image or a picture of the decoded packed color image can be recognized by the reference index for prediction of the current block, and further, which of temporal prediction and disparity prediction the shift prediction is to be performed when generating a prediction image for the current block can also be recognized.

In the event that the picture to which the reference index for prediction of the current block has been assigned, from the variable length decoding unit 242, is a picture of the decoded middle viewpoint color image (in the event that the reference index for prediction is 1), the prediction image of the current block is generated by disparity prediction, so the reference index processing unit 260 reads out the picture of the decoded middle viewpoint color image to which the reference index for prediction has been assigned from the DPB 213 as a reference image, and supplies this to the disparity prediction unit 261.

Also, in the event that the picture to which the reference index for prediction of the current block has been assigned, from the variable length decoding unit 242, is a picture of the decoded packed color image (in the event that the reference index for prediction is 0), the prediction image of the current block is generated by temporal prediction, so the reference index processing unit 260 reads out the picture of the decoded packed color image to which the reference index for prediction has been assigned from the DPB 213 as a reference image, and supplies this to the time prediction unit 262.

The disparity prediction unit 261 is supplied with prediction mode related information which is header information from the variable length decoding unit 242.

The disparity prediction unit 261 recognizes whether the current block has been encoded using a prediction image generated by disparity prediction, based on the header information from the variable length decoding unit 242.

In the event that the current block is encoded using the prediction image generated with disparity prediction, the disparity prediction unit 261 restores the disparity vector used for generating the prediction image of the current block, based on the header information from the variable length decoding unit 242, and in the same way as with the disparity prediction unit 131 in FIG. 12, generates a prediction image by performing disparity prediction (disparity compensation) in accordance with that disparity vector.

That is to say, in the event that the current block has ben encoded using a prediction image generated by disparity prediction, the disparity prediction unit 261 is supplied from the reference index processing unit 260 with a picture of the decoded middle viewpoint color image as a reference image, as described above.

The disparity prediction unit 261 acquires a block (corresponding block) at a position moved (shifted) from the position of the current block in the picture of the decoded middle viewpoint color image serving as the reference image from the reference index processing unit 260, in accordance with the shift vector of the current block, as a prediction image.

The disparity prediction unit 261 then supplies the prediction image to the prediction image selecting unit 251.

The time prediction unit 262 is supplied with prediction mode related information which is header information from the variable length decoding unit 242.

The time prediction unit 262 recognizes whether the current block has been encoded using a prediction image generated by temporal prediction, based on the header information from the variable length decoding unit 242.

In the event that the current block is encoded using the prediction image generated with temporal prediction, the time prediction unit 262 restores the motion vector used for generating the prediction image of the current block, based on the header information from the variable length decoding unit 242, and in the same way as with the temporal prediction unit 132 in FIG. 12, generates a prediction image by performing temporal prediction (motion compensation) in accordance with that motion vector.

That is to say, in the event that the current block has ben encoded using a prediction image generated by temporal prediction, the time prediction unit 262 is supplied from the reference index processing unit 260 with a picture of the decoded packed color image as a reference image, as described above.

The time prediction unit 262 acquires a block (corresponding block) at a position moved (shifted) from the position of the current block in the picture of the decoded packed color image serving as the reference image from the reference index processing unit 260, in accordance with the shift vector of the current block, as a prediction image.

The time prediction unit 262 then supplies the prediction image to the prediction image selecting unit 251.

[Configuration Example of Disparity Prediction Unit 261]

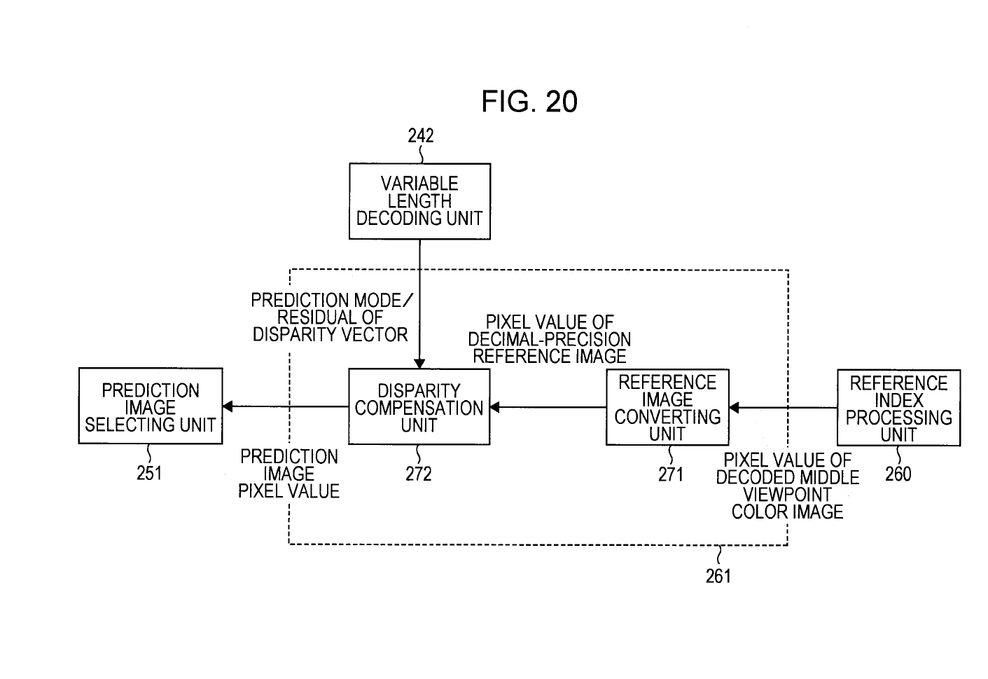

FIG. 20 is a block diagram illustrating a configuration example of the disparity prediction unit 261 in FIG. 19.

In FIG. 20, the disparity prediction unit 261 has a reference image converting unit 271 and a disparity compensation unit 272.

The reference image converting unit 271 is supplied from the reference index processing unit 260 with a picture of the decoded middle viewpoint color image serving as the reference image.

The reference image converting unit 271 is configured in the same way as the reference image converting unit 140 at the encoder 42 side, and in the same way as the reference image converting unit 140 converts the decoded multi-viewpoint color image serving as the reference image from the reference index processing unit 260.

That is to say, the reference image converting unit 271 supplies the reference image from the reference index processing unit 260 without change to the disparity compensation unit 272, or converts into a reference image of a ½ precision image or a reference image of a ¼ precision image and supplies thereto.

The disparity compensation unit 272 is supplied with the decoded multi-viewpoint color image serving as the reference image from the reference image converting unit 271, and also is supplied with the prediction mode and residual vector included in the mode related information serving as the header information from the variable length decoding unit 242.

The disparity compensation unit 272 obtains the prediction vector of the disparity vector of the current block, using the disparity vectors of macroblocks already decoded as necessary, and adds the prediction vector to the residual vector of the current block from the variable length decoding unit 242, thereby restoring the disparity vector my of the current block.

Further, the disparity compensation unit 272 performs disparity compensation of the picture of the decoded middle viewpoint color image serving as the reference image from the reference image converting unit 271 using the disparity vector my of the current block, thereby generating a prediction image of the current block for the macroblock type that the prediction mode from the variable length decoding unit 242 indicates.

That is to say, the disparity compensation unit 272 acquires the current block which is a block in the picture of the decoded middle viewpoint color image at a position shouted from the current block position by an amount equivalent to the disparity vector mv, as the prediction image.

The disparity compensation unit 272 then supplies the prediction image to the prediction image selecting unit 251.

Note that, with the time prediction unit 262 in FIG. 19, processing the same as with the disparity prediction unit 261 in FIG. 20 is performed, except that the reference image is a picture of a decoded packed color image, rather than a picture of the decoded middle viewpoint color image.

As described above, with MVC, disparity prediction can also be performed for non base view images besides temporal prediction, so encoding efficiency can be improved.

However, as described above, in the event that the non base view image is a packed color image, and the base view image which is referenced (can be referenced) in disparity prediction is a middle viewpoint color image, the prediction precision (prediction efficiency) of disparity prediction may deteriorate.

Accordingly, to simplify description, let us say now that the horizontal and vertical resolution ratio (the ratio of the number of horizontal pixels and the number of vertical pixels) of the middle viewpoint color image, left viewpoint color image, and right viewpoint color image, is 1:1.

As described with FIG. 4 for example, a packed color image is one viewpoint worth of image, where the vertical resolution of each of the left viewpoint color image and right viewpoint color image have been made to be ½, and the left viewpoint color image and right viewpoint color image of which the resolution has been made to be ½ are vertically arrayed.

Accordingly, at the encoder 42 (FIG. 9) the resolution ratio of the packed color image to be encoded (image to be encoded), and the resolution ratio of the middle viewpoint color image (decoded middle viewpoint color image) which is a reference image of a different viewpoint from the packed color image, to be referenced in disparity prediction at the time of generating a prediction image of that packed color image, do not agree (match).

That is to say, with the packed color image, the resolution in the vertical direction (vertical resolution) of each of the left viewpoint color image and right viewpoint color image is ½ of the original, and accordingly, the resolution ratio of the left viewpoint color image and right viewpoint color image that are the packed color image is 2:1.

On the other hand, the resolution ratio of the middle viewpoint color image serving as the reference image is 1:1, and this does not agree with resolution ratio of 2:1 of the left viewpoint color image and right viewpoint color image that are the packed color image.

In the event that the resolution ratio of the packed color image and the resolution ratio of the middle viewpoint color image do not agree, i.e., in the event that the resolution ratio of the left viewpoint color image and right viewpoint color image that are the packed color image and the resolution ratio of the middle viewpoint color image serving as the reference image do not agree, the prediction precision of disparity prediction deteriorates (the residual between the prediction image generated in disparity prediction and the current block becomes great), and encoding efficiency deteriorates.

[Configuration Example of Transmission Device 11]

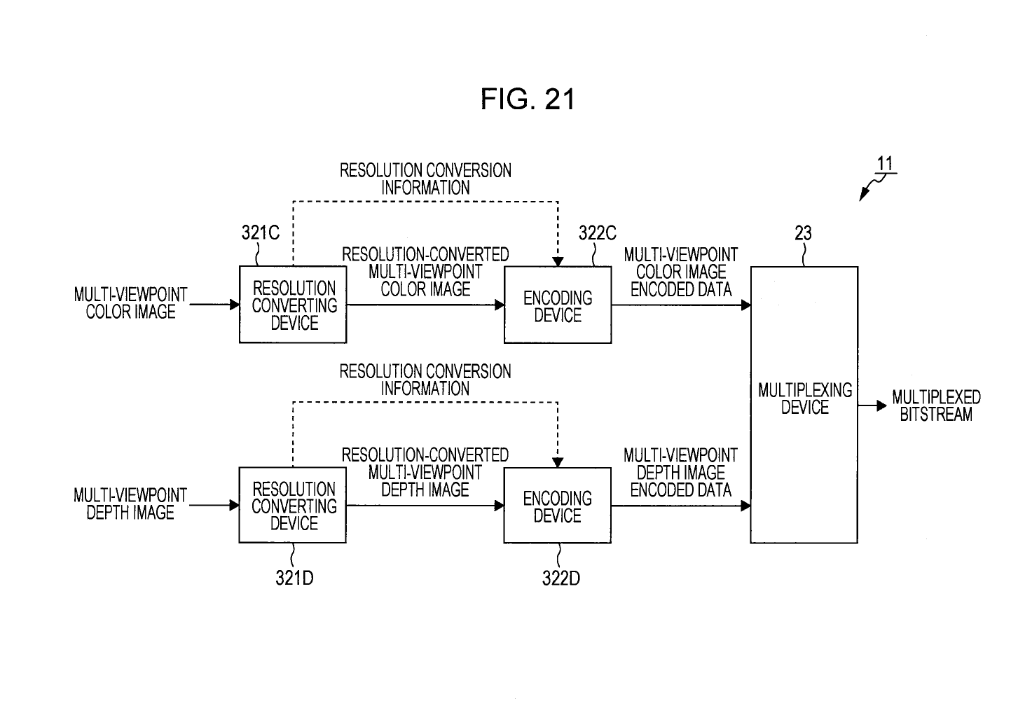

Accordingly, FIG. 21 is a block diagram illustrating another configuration example of the transmission device 11 in FIG. 1.

Note that portions corresponding to the case in FIG. 2 are denoted with the same symbols, and description hereinafter will be omitted as appropriate.

In FIG. 21, the transmission device 11 has resolution converting devices 321C and 321D, encoding devices 322C and 322D, and a multiplexing device 23.

Accordingly, the transmission device 11 in FIG. 21 has in common with the case in FIG. 2 the point of having the multiplexing device 23, and differs from the case in FIG. 2 regarding the point that the resolution converting devices 321C and 321D and encoding devices 322C and 322D have been provided instead of the resolution converting devices 21C and 21D and encoding devices 22C and 22D.

A multi-viewpoint color image is supplied to the resolution converting device 321C.

The resolution converting device 321C performs processing the same as each of the resolution converting devices 21C and 21D in FIG. 2, for example.

That is to say, the resolution converting device 321C performs resolution conversion of converting a multi-viewpoint color image supplied thereto into a resolution-converted multi-viewpoint color image having a low resolution lower than the original resolution, and supplies the resolution-converted multi-viewpoint color image obtained as a result thereof to the encoding device 322C.

Further, the resolution converting device 321C generates resolution conversion information, and supplies to the encoding device 322C.

Now, the resolution conversion information which the resolution converting device 321C generates is information relating to resolution conversion of the multi-viewpoint color image into a resolution-converted multi-viewpoint color image performed at the resolution converting device 321C, and includes resolution information relating to (the left viewpoint color image and right viewpoint color image configuring) the packed color image which is the image to be encoded at the downstream encoding device 322C, to be encoded using disparity prediction, and the middle viewpoint color image which is a reference image of a different viewpoint from the image to be encoded, referenced in the disparity prediction of that image to be encoded.

That is to say, with the encoding device 322C, the resolution-converted multi-viewpoint color image obtained as the result of resolution conversion at the resolution converting device 321C is encoded, and the resolution-converted multi-viewpoint color image to be encoded is the middle viewpoint color image and packed color image, as described with FIG. 4.

Of the middle viewpoint color image and packed color image, the image to be encoded using disparity prediction is the packed color image which is a non base view image, and the reference image referenced in the disparity prediction of the packed color image is the middle viewpoint color image.

Accordingly, the resolution conversion information which the resolution converting device 321C generates includes information relating to the resolution of the packed color image and the middle viewpoint color image.

The encoding device 322C encodes the resolution-converted multi-viewpoint color image supplied from the resolution converting device 321C with an extended format where a standard such as MVC or the like, which is a standard for transmitting images of multiple viewpoints, has been extended, for example, and middle viewpoint color image encoded data which is encoded data obtained as the result thereof is supplied to the multiplexing device 23.

Note that for the standard to serve as the basis for the extended format which is the encoding format of the encoding device 322C, besides MVC, a standard such as HEVC (High Efficiency Video Coding) or the like, which can transmit images of multiple viewpoints, and which subjects a reference image reference in disparity prediction to filter processing where pixels are interpolated to perform disparity prediction (disparity correction) at a precision of pixels or lower (fraction precision), can be employed.

A multi-viewpoint color image is supplied to the resolution converting device 321D.

The resolution converting device 321D and encoding device 322D each perform the same processing as the resolution converting device 321C and resolution converting device 321C, except that processing is performed on depth images (multi-viewpoint depth images), rather than color images (multi-viewpoint color images).

[Configuration Example of Reception Device 12]

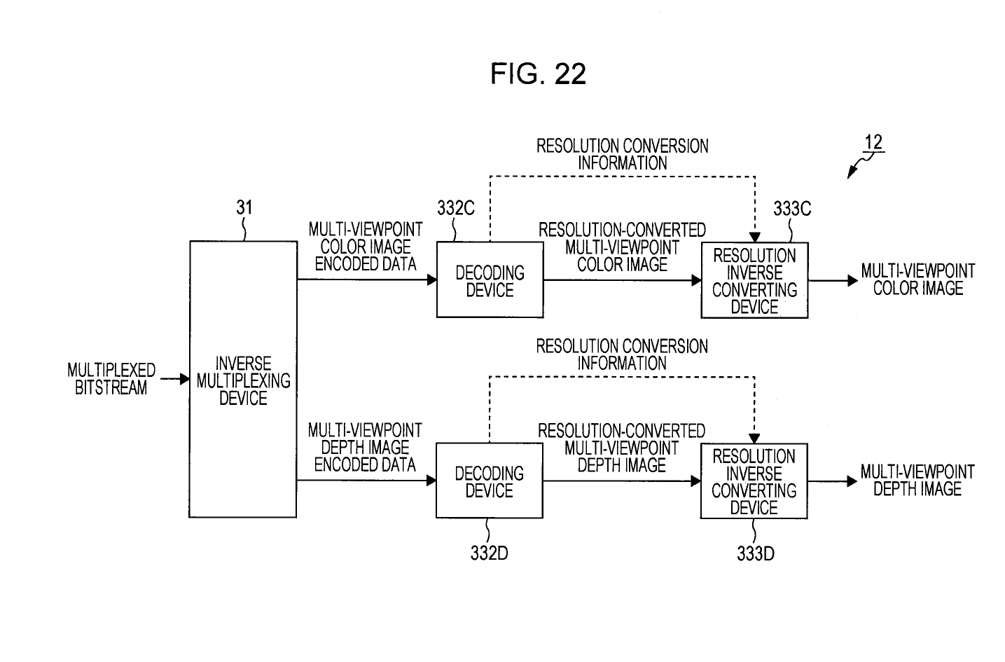

FIG. 22 is a diagram illustrating another configuration example of the reception device 12 in FIG. 1.

That is to say, FIG. 22 illustrates a configuration example of the reception device 12 in FIG. 1 in a case where the transmission device 11 in FIG. 1 has been configured as illustrated in FIG. 21.

Note that portions corresponding to the case in FIG. 3 are denoted with the same symbols, and description hereinafter will be omitted as appropriate.

In FIG. 22, the reception device 12 has an inverse multiplexing device 31, decoding devices 332C and 332D, and resolution inverse converting devices 333C and 333D.

Accordingly, the reception device 12 in FIG. 22 has in common with the case in FIG. 3 the point of having the inverse multiplexing device 31, and differs from the case in FIG. 3 that decoding devices 332C and 332D and resolution inverse converting devices 333C and 333D have been provided instead of the decoding devices 32C and 32D and resolution inverse converting devices 33C and 33D.

The decoding device 332C decodes the multi-viewpoint color image encoded data supplied from the inverse multiplexing device 31 with an extended format, and supplies the resolution-converted multi-viewpoint color image and resolution conversion information obtained as a result thereof to the resolution inverse converting device 333C.

The resolution inverse converting device 333C performs inverse resolution conversion to (inverse) convert the resolution-converted multi-viewpoint color image from the decoding device 332C into the original resolution, based on the resolution conversion information also from the decoding device 332C, and outputs the multi-viewpoint color image obtained as a result thereof.

The decoding device 332D and resolution inverse converting device 333D each perform the same processing as the decoding device 332C and resolution inverse converting device 333C, except that processing is performed on multi-viewpoint depth image encoded data (resolution-converted multi-viewpoint depth image) from the inverse multiplexing device 31 rather than multi-viewpoint color image encoded data (resolution-converted multi-viewpoint color image).

[Resolution Conversion and Resolution Inverse Conversion]

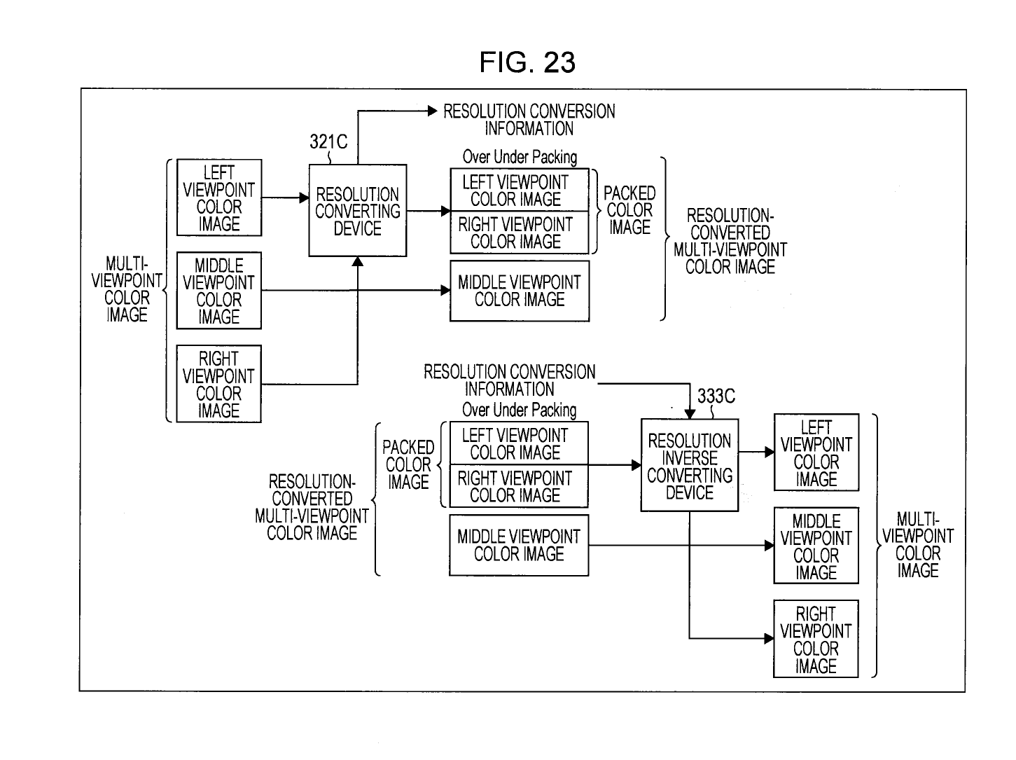

FIG. 23 is a diagram for describing resolution conversion which the resolution converting device 321C (and 321D) in FIG. 21 performs, and the resolution inverse conversion which the resolution inverse converting device 333C (and 333D) in FIG. 22 performs.

In the same way as with the resolution converting device 21C in FIG. 2 for example, the resolution converting device 321C (FIG. 21) outputs, of the middle viewpoint color image, left viewpoint color image, and right viewpoint color image, which are the multi-viewpoint color image supplied thereto, the middle viewpoint color image for example, as it is (without performing resolution conversion).

Also, in the same way as with the resolution converting device 21C in FIG. 2 for example, the resolution converting device 321C converts the resolution of the two of the remaining left viewpoint color image and right viewpoint color image of the multi-viewpoint color image to lower resolution, and packs by combining into one viewpoint worth of image, thereby generating and outputting a packed color image.

That is to say, the resolution converting device 321C converts the vertical resolution (number of pixels) of each of the left viewpoint color image and right viewpoint color image to ½, and for example vertically arrays the left viewpoint color image and right viewpoint color image of which the vertical resolution has been made to be ½, thereby generating a packed color image which is one viewpoint worth of image.

Now, with the packed color image in FIG. 23, the left viewpoint color image is situated at the upper side, and the right viewpoint color image is situated at the lower side, in the same way as with the case in FIG. 4.

The resolution converting device 321C further generates resolution conversion information indicating that the resolution of the middle viewpoint color image is unchanged, that the packed color image is one viewpoint worth of image where the left viewpoint color image and right viewpoint color image (of which the vertical resolution has been made to be ½), and so forth.

On the other hand, the resolution inverse converting device 333C (FIG. 22) recognizes, from the resolution conversion information supplied thereto, that the resolution of the middle viewpoint color image is unchanged, that the packed color image is one viewpoint worth of image where the left viewpoint color image and right viewpoint color image have been arrayed vertically, and so forth.

The resolution inverse converting device 333C then outputs, of the middle viewpoint color image and packed color image which are the multi-viewpoint color image supplied thereto, the middle viewpoint color image as it is, based on the information recognized from the resolution conversion information.

Also, the resolution inverse converting device 333C separates, of the middle viewpoint color image and packed color image which are the multi-viewpoint color image supplied thereto, the packed color image vertically, based on the resolution conversion information.

Further, the resolution inverse converting device 333C restores, to the original resolution, the vertical resolution of the left viewpoint color image and right viewpoint color image obtained by vertically separating the packed color image of which the vertical resolution had been made to be ½, and outputs.

Note that the multi-viewpoint color image (and multi-viewpoint depth image) may be an image of four or more viewpoints. In the event that the multi-viewpoint color image is an image of four or more viewpoints, two packed color images, where two viewpoint color images of which the vertical resolution has been made to be ½ are packed into one image worth (of data amount) as described above, can be generated. Also, a packed color image may be generated where an image of which three or more viewpoints of which the vertical resolution has been lowered beyond ½ are packed in one viewpoint worth of image, or packed color image may be generated where an image of which three or more viewpoints of which both the horizontal and vertical resolutions have been made to be low resolution are packed in one viewpoint worth of image.

[Processing of Transmission Device 11]

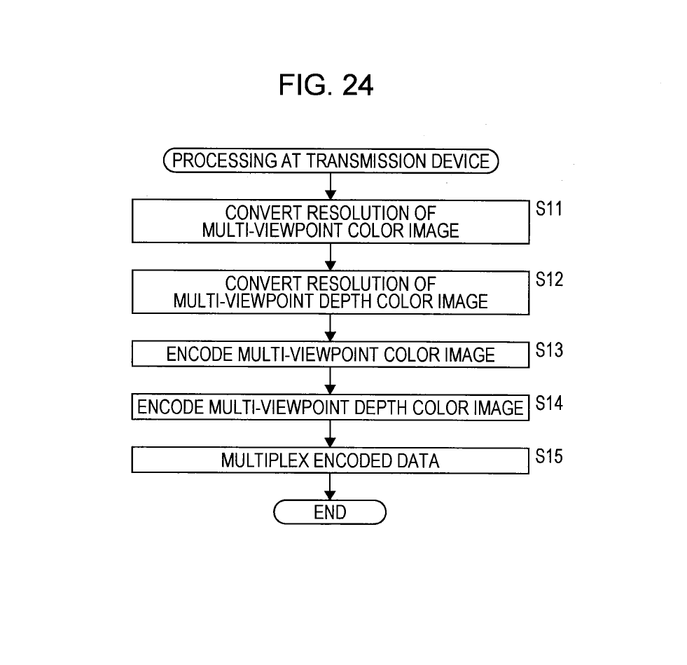

FIG. 24 is a flowchart for describing the processing of the transmission device 11 in FIG. 21.

In step S11, the resolution converting device 321C performs resolution conversion of a multi-viewpoint color image supplied thereto, and supplies the resolution-converted multi-viewpoint color image which is the middle viewpoint color image and packed color image obtained as a result thereof, to the encoding device 322C.

Further, the resolution converting device 321C generates resolution conversion information regarding the resolution-converted multi-viewpoint color image, supplies this to the encoding device 322C, and the flow advances from step S11 to step S12.

In step S12, the resolution converting device 321D performs resolution conversion of a multi-viewpoint depth image supplied thereto, and supplies the resolution-converted multi-viewpoint depth image which is the middle viewpoint color image and packed depth image obtained as a result thereof, to the encoding device 322D.

Further, the resolution converting device 321D generates resolution conversion information regarding the resolution-converted multi-viewpoint depth image, supplies this to the encoding device 322D, and the flow advances from step S12 to step S13.

In step S13, the encoding device 322C uses the resolution conversion information from the resolution converting device 321C as necessary to encode the resolution-converted multi-viewpoint color image from the resolution converting device 321C, supplies multi-viewpoint color image encoded data which is the encoded data obtained as a result thereof to the multiplexing device 23, and the flow advances to step S14.

In step S14, the encoding device 322D uses the resolution conversion information from the resolution converting device 321D as necessary to encode the resolution-converted multi-viewpoint depth image from the resolution converting device 321D, supplies multi-viewpoint depth image encoded data which is the encoded data obtained as a result thereof to the multiplexing device 23, and the flow advances to step S15.

In step S15, the multiplexing device 23 multiplexes the multi-viewpoint color image encoded data from the encoding device 322C and the multi-viewpoint depth image encoded data from the encoding device 322D, and outputs a multiplexed bitstream obtained as the result thereof.

[Processing of Reception Device 12]

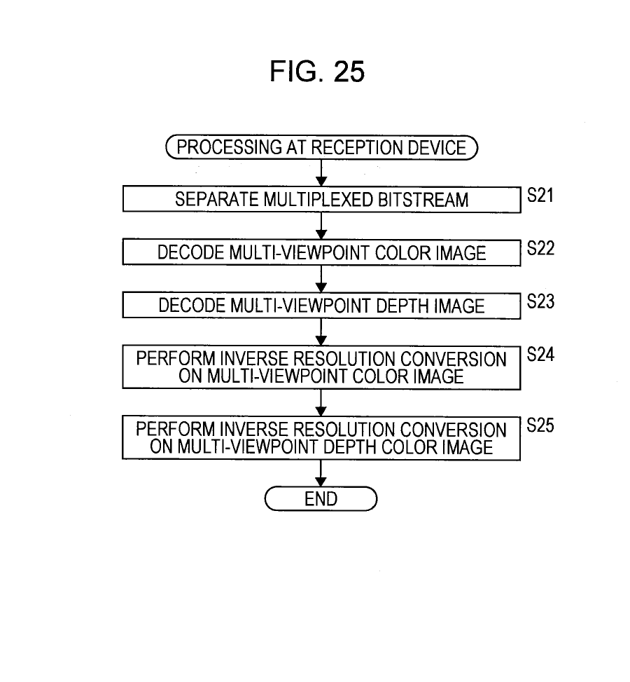

FIG. 25 is a flowchart for describing the processing of the reception device 12 in FIG. 22.

In step S21, the inverse multiplexing device 31 performs inverse multiplexing of the multiplexed bitstream supplied thereto, thereby separating the multiplexed bitstream into the multi-viewpoint color image encoded data and multi-viewpoint depth image encoded data.

The inverse multiplexing device 31 then supplies the multi-viewpoint color image encoded data to the decoding device 332C, supplies the multi-viewpoint depth image encoded data to the decoding device 332D, and the flow advances from step S21 to step S22.

In step S22, the decoding device 332C decodes the multi-viewpoint color image from the inverse multiplexing device 31 with an extended format, supplies the resolution-converted multi-viewpoint color image obtained as a result thereof, and resolution conversion information about the resolution-converted multi-viewpoint color image, to the resolution inverse converting device 333C, and the flow advances to step S23.

In step S23, the decoding device 332D decodes the multi-viewpoint depth image from the inverse multiplexing device 31 with an extended format, supplies the resolution-converted multi-viewpoint depth image obtained as a result thereof, and resolution conversion information about the resolution-converted multi-viewpoint depth image, to the resolution inverse converting device 333D, and the flow advances to step S24.

In step S24, the resolution inverse converting device 333C performs resolution inverse conversion to inverse-convert the resolution-converted multi-viewpoint color image from the decoding device 332C to the multi-viewpoint color image of the original resolution, based on the resolution conversion information also from the decoding device 332C, outputs the multi-viewpoint color image obtained as a result thereof, and the flow advances to step S25.

In step S25, the resolution inverse converting device 333D performs resolution inverse conversion to inverse-convert the resolution-converted multi-viewpoint depth image from the decoding device 332D to the multi-viewpoint depth image of the original resolution, based on the resolution conversion information also from the decoding device 332D, and outputs the multi-viewpoint depth image obtained as a result thereof.

[Configuration Example of Encoding Device 322C]

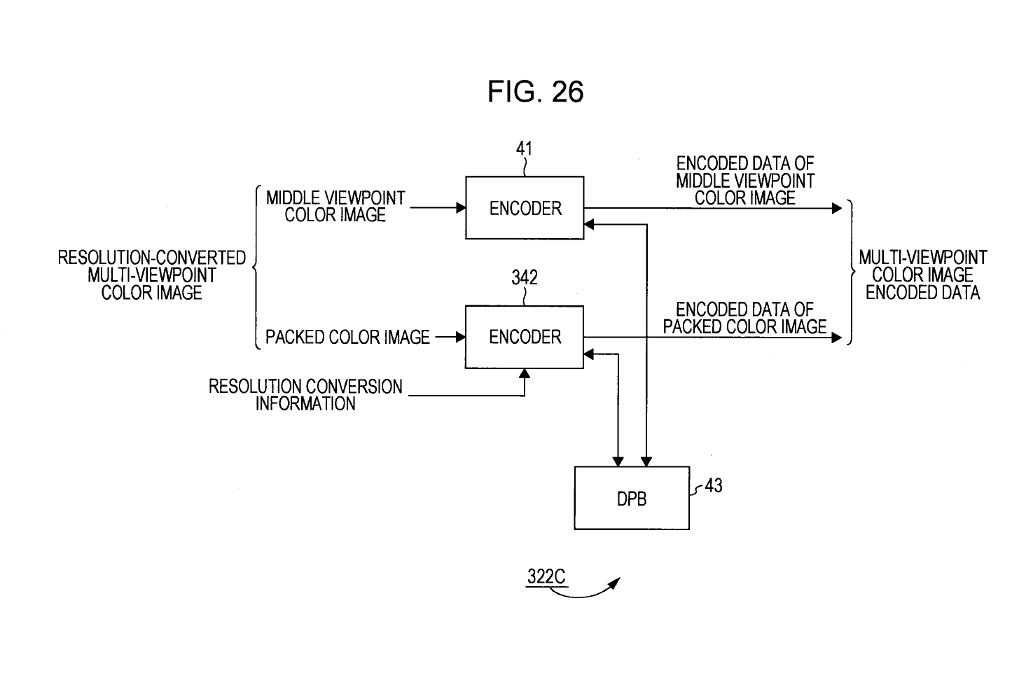

FIG. 26 is a block diagram illustrating a configuration example of the encoding device 322C in FIG. 21.

Note that portions corresponding to the case in FIG. 5 are denoted with the same symbols, and description hereinafter will be omitted as appropriate.

In FIG. 26, the encoding device 322C has the encoder 41, DPB 43, and an encoder 342.

Accordingly, the encoding device 322C in FIG. 26 has in common with the encoding device 22C in FIG. 5 the point of having the encoder 41 and DPB 43, and differs from the encoding device 22C in FIG. 5 in that the encoder 42 has been replaced by the encoder 342.

The encoder 41 is supplied with, of the middle viewpoint color image and packed color image configuring the resolution-converted multi-viewpoint color image from the resolution converting device 321C, the middle viewpoint color image.

The encoder 342 is supplied with, of the middle viewpoint color image and packed color image configuring the resolution-converted multi-viewpoint color image from the resolution converting device 321C, the packed color image.

The encoder 342 is further supplied with resolution conversion information from the resolution converting device 321C.

The encoder 41 takes the middle viewpoint color image as the base view image and encodes by MVC (AVC), and outputs encoded data of the middle viewpoint color image obtained as a result thereof, as described with FIG. 5.

The encoder 342 takes the packed color image as a non base view image and encodes by an extended format, based on the resolution conversion information, and outputs encoded data of the packed color image obtained as a result thereof.

The encoded data of the middle viewpoint color image output from the encoder 41 and the encoded data of the packed color image output from the encoder 342 are supplied to the multiplexing device 23 (FIG. 21) as multi-viewpoint color image encoded data.

Now, in FIG. 26, the DPB 43 is shared by the encoders 41 and 342.

That is to say, the encoders 41 and 342 perform prediction encoding of the image to be encoded. Accordingly, in order to generate a prediction image to be used for prediction encoding, the encoders 41 and 342 encode the image to be encoded, and thereafter perform local decoding, thereby obtaining a decoded image.

The DPB 43 temporarily stores decoded images obtained from each of the encoders 41 and 342.

The encoders 41 and 342 each select reference images to reference when encoding images to encode, from decoded images stored in the DPB 43. The encoders 41 and 342 then each generate prediction images using reference images, and perform image encoding (prediction encoding) using these prediction images.

Accordingly, the encoders 41 and 342 can reference, in addition to decoded images obtained at itself, decoded images obtained at the other encoder.

Note however, the encoder 41 encodes the base view image, and accordingly only references a decoded image obtained at the encoder 41.

[Configuration Example of Encoder 342]

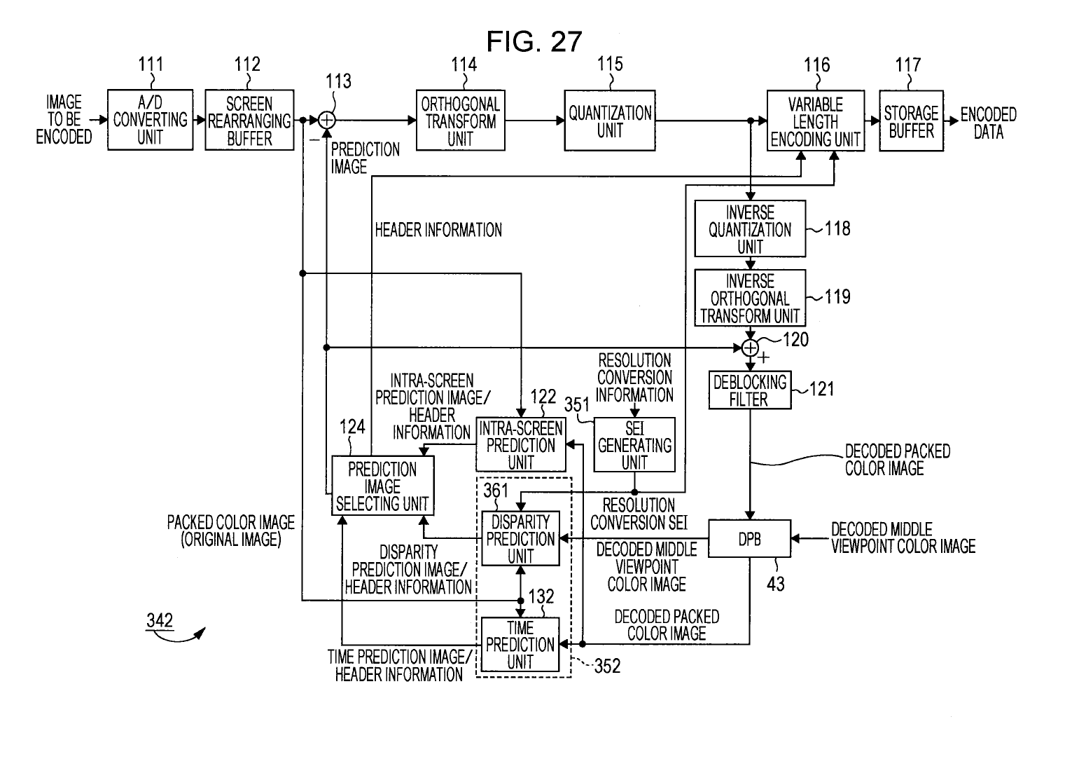

FIG. 27 is a block diagram illustrating a configuration example of the encoder 342 in FIG. 26.

Note that portions in the drawing corresponding to the case in FIG. 9 and FIG. 12 are denoted with the same symbols, and description hereinafter will be omitted as appropriate.

In FIG. 27, the encoder 342 has the A/D converting unit 111, screen rearranging buffer 112, computing unit 113, orthogonal transform unit 114, quantization unit 115, variable length encoding unit 116, storage buffer 117, inverse quantization unit 118, inverse orthogonal transform unit 119, computing unit 120, deblocking filter 121, intra-screen prediction unit 122, a prediction image selecting unit 124, a SEI (Supplemental Enhancement Information) generating unit 351, and an inter prediction unit 352.

Accordingly, the encoder 342 has in common with the encoder 42 in FIG. 9 the point of having the A/D converting unit 111 through the intra-screen prediction unit 122 and the prediction image selecting unit 124.

Note however, the encoder 342 differs from the encoder 42 in FIG. 9 with regard to the point that the SEI generating unit 351 has been newly provided, and the inter prediction unit 352 has been provided instead of the inter prediction unit 123.

The SEI generating unit 351 is supplied with the resolution conversion information regarding the resolution-converted multi-viewpoint color image from the resolution converting device 321C (FIG. 21).

The SEI generating unit 351 converts the format of the resolution conversion information supplied thereto into a SEI format according to MVC (AVC), and outputs the resolution conversion SEI obtained as a result thereof.

The resolution conversion SEI which the SEI generating unit 351 outputs is supplied to the variable length encoding unit 116 and (a disparity prediction unit 361 of) the inter prediction unit 352.

At the variable length encoding unit 116, the resolution conversion SEI from the SEI generating unit 351 is transmitted included in the encoded data.

The inter prediction unit 352 includes the temporal prediction unit 132 and disparity prediction unit 361.

Accordingly, the inter prediction unit 352 as in common with the inter prediction unit 123 in FIG. 12 the point of having the temporal prediction unit 132, and differs with the inter prediction unit 123 in FIG. 12 with regard to the point that the disparity prediction unit 361 has been provided instead of the disparity prediction unit 131.

The disparity prediction unit 361 is supplied with the current picture of the packed color image from the screen rearranging buffer 112.

In the same way as with the disparity prediction unit 131 in FIG. 12, the disparity prediction unit 361 performs disparity prediction of the current block of the current picture of the packed color image from the screen rearranging buffer 112, using the picture of the decoded middle viewpoint color image stored in the DPB 43 (picture of same point-in-time as current picture) as a reference image, and generates a prediction image of the current block.

The disparity prediction unit 361 then supplies the prediction image to the prediction image selecting unit 124 along with header information such as residual vector and so forth.

Also, the disparity prediction unit 361 is supplied with the resolution conversion SEI from the SEI generating unit 351.

The disparity prediction unit 361 controls the filter processing to be applied to the picture of the decoded middle viewpoint color image serving as a reference image to be referenced in the disparity prediction, in accordance with the resolution conversion SEI from the SEI generating unit 351.

That is to say, as described above, when subjecting a reference image to filter processing where pixels are interpolated, with MVC there is a stipulation that filter processing is to be performed such that the number of pixels in the horizontal direction and vertical direction are to be increased by the same multiple, so at the disparity prediction unit 361, the filter processing to be applied to the picture of the decoded middle viewpoint color image serving as a reference image to be referenced in the disparity prediction is controlled in accordance with the resolution conversion SEI from the SEI generating unit 351, and accordingly the reference image is converted into a converted reference image of a resolution ratio matching the horizontal and vertical resolution ratio of the picture of the packed color image to be encoded (the ratio of the number or horizontal pixels and the number of vertical pixels).

[Resolution Conversion SEI]

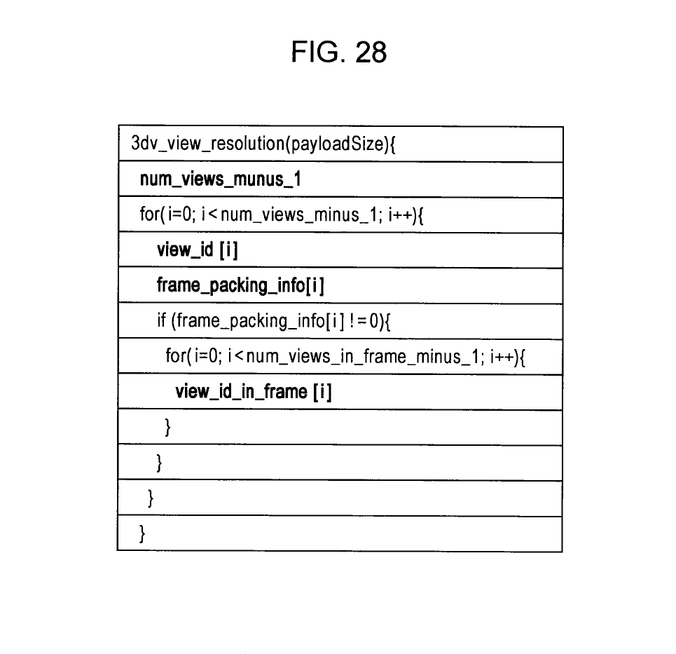

FIG. 28 is a diagram for describing the resolution conversion SEI generated at the SEI generating unit 351.

That is to say, FIG. 28 is a diagram illustrating an example of the syntax (syntax) of 3dv_view_resolution(payloadSize) serving as the resolution conversion SEI.

The 3dv_view_resolution(payloadSize) serving as the resolution conversion SEI has parameters num_views_minus_{—}1, view_id[i], frame_packing_info[i], and view_id_in_frame[i].

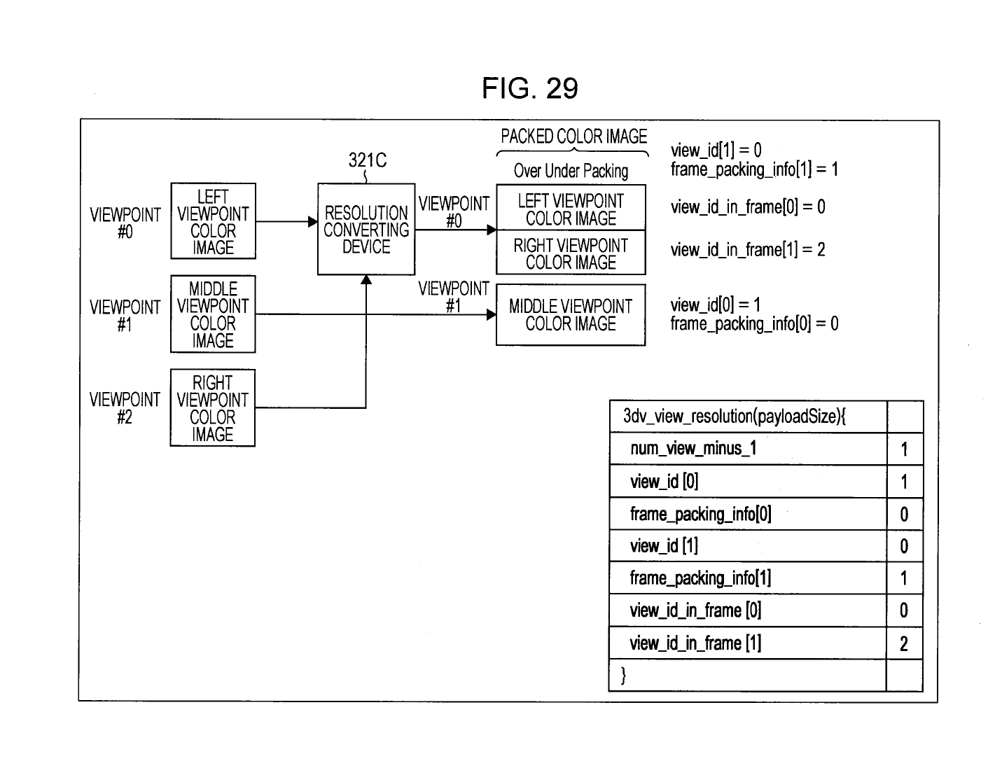

FIG. 29 is a diagram for describing values set to the resolution conversion SEI has parameters num_views_minus_{—}1, view_id[i], frame_packing_info[i], and view_id_in_frame[i], generated from the resolution conversion information regarding the resolution-converted multi-viewpoint color image.

The parameter num_views_minus_{—}1 represents a value obtained by subtracting 1 from the number of viewpoints making up the resolution-converted multi-viewpoint color image.

With the present embodiment, the resolution-converted multi-viewpoint color image is an image of two viewpoints, of the middle viewpoint color image, and a packed color image of the left viewpoint color image and right viewpoint color image packed into one viewpoint worth of image, so num_views_minus_{—}1=2−1=1 is set to num_views_minus_{—}1.

The parameter view_id[i] indicates an index identifying the i+1'th (i=0, 1, . . . ) image making up the resolution-converted multi-viewpoint color image.

That is, let us say that here, for example, the left viewpoint color image is an image of viewpoint #0 represented by No. 0 (left viewpoint), the middle viewpoint color image is an image of viewpoint #1 represented by No. 1 (middle viewpoint), and the right viewpoint color image is an image of viewpoint #2 represented by No. 2 (right viewpoint).

Also, let us say that at the resolution converting device 321C, the Nos. representing viewpoints are reassigned regarding the middle viewpoint color image and packed color image making up the resolution-converted multi-viewpoint color image obtained by performing resolution conversion on the multi-viewpoint color image, left viewpoint color image, and right viewpoint color image, so that the middle viewpoint color image is assigned No. 1 representing viewpoint #1, and the packed color image is assigned No. 0 representing viewpoint #0.

Further, let us say that the middle viewpoint color image is the 1st image configuring the resolution-converted multi-viewpoint color image (image of i=0), and that the packed color image is the 2nd image configuring the resolution-converted multi-viewpoint color image (image of i=1).

In this case, the view_id[0] of the middle viewpoint color image which is the 1(=i+1=0+1)st image configuring the resolution-converted multi-viewpoint color image has the No. 1 representing viewpoint #1 of the middle viewpoint color image set (view_id[0]=1).

Also, the view_id[1] of the packed color image which is the 2(=i+1=1+1)nd image configuring the resolution-converted multi-viewpoint color image has the No. 0 representing viewpoint #0 of the packed color image set (view_id[1]=0).

The parameter frame_packing_info[i] represents whether or not there is packing of the i+1'th image making up the resolution-converted multi-viewpoint color image, and the pattern of packing (packing pattern).

Now, the parameter frame_packing_info[i] of which the value is 0 indicates that there is no packing.

Also, the parameter frame_packing_info[i] of which the value is 1 or 2, for example, indicates that there is packing.

The parameter frame_packing_info[i] of which the value is 1 indicates Over Under Packing (Over Under Packing), where the vertical resolution of each of images of two viewpoints has been lowered to ½, and the images of two viewpoints of which the resolution has been made to be ½ are vertically arrayed, thereby forming an image of one viewpoint worth (of data amount).

Also, the parameter frame_packing_info[i] of which the value is 2 indicates Side By Side Packing (Side By Side Packing), where the horizontal resolution of each of images of two viewpoints has been lowered to ½, and the images of two viewpoints of which the resolution has been made to be ½ are horizontal arrayed, thereby forming an image of one viewpoint worth (of data amount).

With the present embodiment, the middle viewpoint color image which is the 1(=i+1=0+1)st image configuring the resolution-converted multi-viewpoint color image is not packed, so the value 0 is set to the parameter frame_packing_info[0] of the middle viewpoint color image, indicating that there is no packing (frame_packing_info[0]=0).

Also, with the present embodiment, the packed color image which is the 2(=i+1=1+1)nd image configuring the resolution-converted multi-viewpoint color image is packed by Over Under Packing, so the value 1 is set to the parameter frame_packing_info[1] of the packed color image, indicating that there is Over Under Packing (frame_packing_info[1]=1).

Now, in the resolution conversion SEI (3dv_view_resolution(payloadSize)) in FIG. 28, a variable num_views_in_frame_minus_{—}1 of the loop for (i=0;<num_views_in_frame_minus_{—}1;i++) indicates a value obtained by subtracting 1 from the number (of viewpoints) of images packed in the i+1'th image configuring the resolution conversion information multi-viewpoint color image.

Accordingly, in the event that frame_packing_info[i] is 0, the i+1'th image configuring the resolution conversion information multi-viewpoint color image is not packed (an image of one viewpoint is packed in the i+1'th image), so 0=1−1 is set to the variable num_views_in_frame_minus 1.

Also, in the event that frame_packing_info[i] is 1 or 2, the i+1'th image configuring the resolution conversion information multi-viewpoint color image has images of two viewpoints packed in the i+1'th image, so 1=2−1 is set to the variable num_views_in_frame_minus 1.

The parameter view_id_in_frame[i] represents an index identifying images packed in the packed color image.

Now, the argument i of the parameter view_id_in_frame[i] differs from the argument i of the other parameters view_id[i] and frame_packing_info[i], so we will notate the argument i of the parameter view_id_in_frame[i] as j to facilitate description, and thus notate the parameter view_id_in_frame[i] as view_id_in_frame[j].

The parameter view_id_in_frame[j] is transmitted only for images configuring the resolution-converted multi-viewpoint color image where the parameter frame_packing_info[i] is not 0, i.e., for packed color images.

In the event that the parameter frame_packing_info[i] of the packed color image is 1, i.e., in the event that the packed color image is an image subjected to Over Under Packing where images of two viewpoints are vertically arrayed, the parameter view_id_in_frame[0] where the argument j=0 represents an index identifying, of the images subjected to Over Under Packing in the packed color image, the image situated above, and the parameter view_id_in_frame[1] where the argument j=1 represents an index identifying, of the images subjected to Over Under Packing in the packed color image, the image situated below.

Also, in the event that the parameter frame_packing_info[i] of the packed color image is 2, i.e., in the event that the packed color image is an image subjected to Side By Side where images of two viewpoints are horizontally arrayed, the parameter view_id_in_frame[0] where the argument j=0 represents an index identifying, of the images subjected to Side By Side in the packed color image, the image situated to the left, and the parameter view_id_in_frame[1] where the argument j=1 represents an index identifying, of the images subjected to Side By Side in the packed color image, the image situated to the right.

With the present embodiment, the packed color image is an image where Over Under Packing has been performed in which the left viewpoint color image is situated above and the right viewpoint color image is situated above, so the No. 0 representing viewpoint #0 of the left viewpoint color image is set to the parameter view_id_in_frame[0] of the argument j=0 identifying the image situated above, and the No. 2 representing viewpoint #2 of the right viewpoint color image is set to the parameter view_id_in_frame[1] of the argument j=1 identifying the image situated below.

[Configuration Example of Disparity Prediction Unit 131]

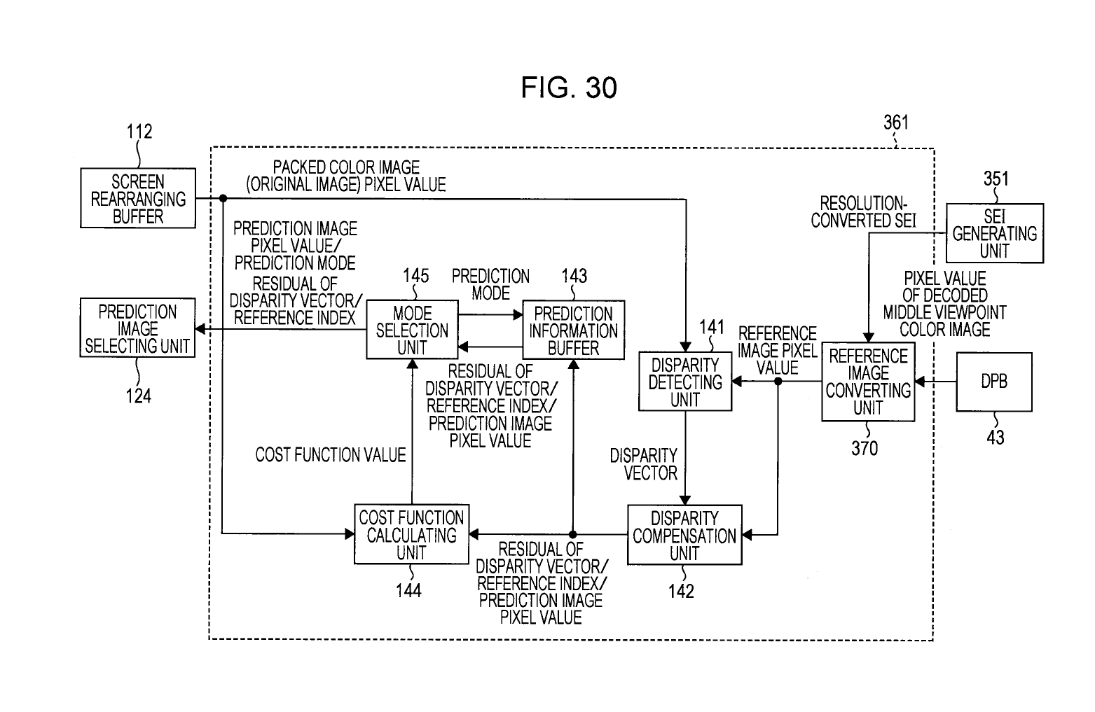

FIG. 30 is a block diagram illustrating a configuration example of the disparity prediction unit 361 in FIG. 27.

Note that portions in the drawing corresponding to the case in FIG. 13 are denoted with the same symbols, and description hereinafter will be omitted as appropriate.

In FIG. 30, the disparity prediction unit 361 has the disparity detecting unit 141, disparity compensation unit 142, prediction information buffer 143, cost function calculating unit 144, mode selecting unit 145, and a reference image converting unit 370.

Accordingly, the disparity prediction unit 361 in FIG. 30 has in common with the disparity prediction unit 131 in FIG. 13 the point of having the disparity detecting unit 141 through mode selecting unit 145.

However, the disparity prediction unit 361 in FIG. 30 differs from the disparity prediction unit 131 in FIG. 13 with regard to the point that the reference image converting unit 140 has been replaced with the reference image converting unit 370.

The reference image converting unit 370 is supplied with the picture of the decoded middle viewpoint color image as a reference image from the DPB 43, and also is supplied with the resolution conversion SEI from the SEI generating unit 351.

The reference image converting unit 370 controls the filter processing to be applied to the picture of the decoded middle viewpoint color image serving as a reference image to be referenced in the disparity prediction, in accordance with the resolution conversion SEI from the SEI generating unit 351, and accordingly the reference image is converted into a converted reference image of a resolution ratio matching the horizontal and vertical resolution ratio of the picture of the packed color image to be encoded, and supplied to the disparity detecting unit 141 and disparity compensation unit 142.

[Configuration Example of Reference Image Converting Unit 370]

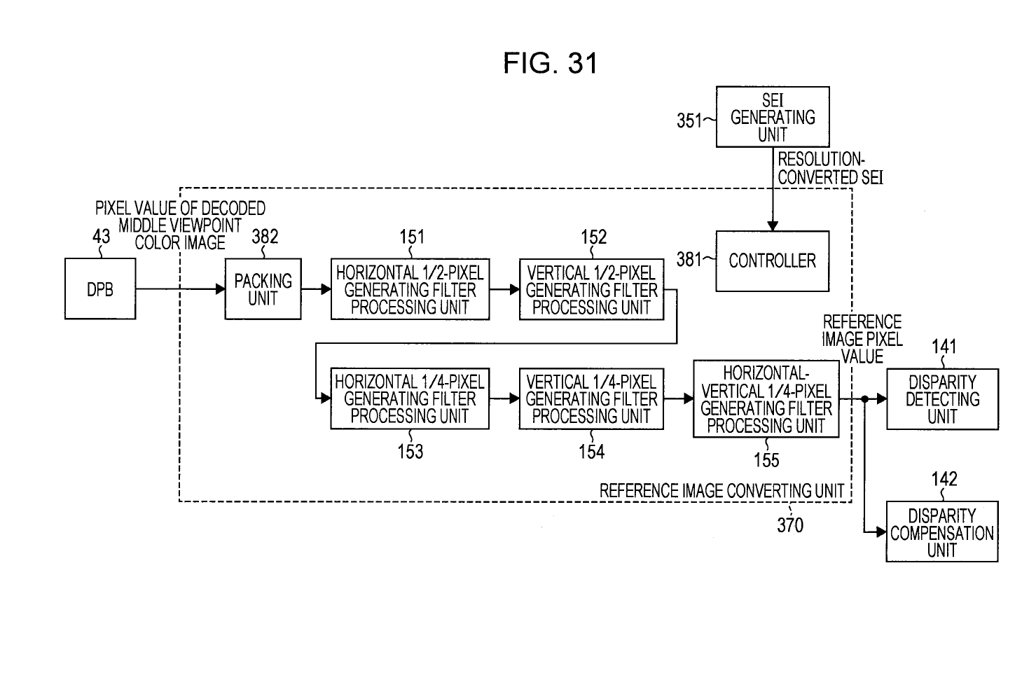

FIG. 31 is a block diagram illustrating a configuration example of the reference image converting unit 370 in FIG. 30.

Note that portions in the drawing corresponding to the case in FIG. 16 are denoted with the same symbols, and description hereinafter will be omitted as appropriate.

In FIG. 31, the reference image converting unit 370 has the horizontal ½-pixel generating filter processing unit 151, vertical ½-pixel generating filter processing unit 152, horizontal ¼-pixel generating filter processing unit 153, vertical ¼-pixel generating filter processing unit 154, horizontal-vertical ¼-pixel generating filter processing unit 155, a controller 381, and a packing unit 382.

Accordingly, the reference image converting unit 370 in FIG. 31 has in common with the reference image converting unit 140 in FIG. 16 the point of having the horizontal ½-pixel generating filter processing unit 151 through horizontal-vertical ¼-pixel generating filter processing unit 155.

However, the reference image converting unit 370 in FIG. 31 differs from the reference image converting unit 140 in FIG. 16 with regard to the point that the controller 381 and packing unit 382 have been added.

The resolution conversion SEI from the SEI generating unit 351 is supplied to the controller 381.

In response to the resolution conversion SEI from the SEI generating unit 351, the controller 381 controls the filer processing of each of the horizontal ½-pixel generating filter processing unit 151 through horizontal-vertical ¼-pixel generating filter processing unit 155, and the packing by the packing unit 382.

The packing unit 382 is supplied with the decoded middle viewpoint color image as a reference image from the DPB 43.

The packing unit 382 follows the control of the controller 381 and performs packing to generate a packed reference image where the reference image from the DPB 43 and a copy thereof are arrayed vertically or horizontally, and the packed reference image obtained as a result thereof is supplied to the horizontal ½-pixel generating filter processing unit 151.

That is to say, the controller 381 recognizes the packing pattern of the packed color image (Over Under Packing or Side By Side Packing) from (the parameter frame_packing_info[i] of) the resolution conversion SEI, and controls the packing unit 382 so as to perform packing the same as the packing of the packed color image.

The packing unit 382 generates a copy of the reference image from the DPB 43, and generates a packed reference image by performing Over Under Packing where the reference image and the copy thereof are arrayed vertically, or Side By Side Packing where these are arrayed horizontally, following control of the controller 381.

Note that the packing unit 382 performs packing of the reference image and its copy without changing the resolution of the reference image and its copy.

Also, while the packing unit 382 is provided upstream from the horizontal ½-pixel generating filter processing unit 151 in FIG. 31, the packing unit 382 may be provided downstream from the horizontal-vertical ¼-pixel generating filter processing unit 155, so that packing by the packing unit 382 is performed on the output of the horizontal-vertical ¼-pixel generating filter processing unit 155.

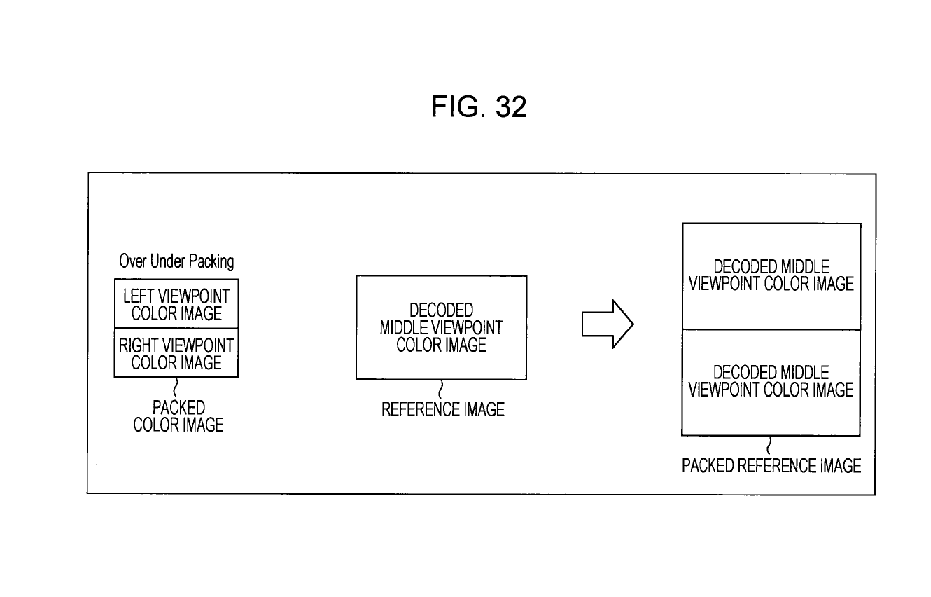

FIG. 32 is a diagram for describing packing by the packing unit 382 under control of the controller 381 in FIG. 31.

With the present embodiment, the packed color image has been subjected to Over Under Packing, so the controller 381 controls the packing unit 382 so as to perform Over Under Packing the same as with the packed color image.

The packing unit 382 generates a packed referenced image by performing Over Under Packing where the decoded middle viewpoint color image serving as the reference image, and a copy thereof, are arrayed vertically, following control of the controller 381.

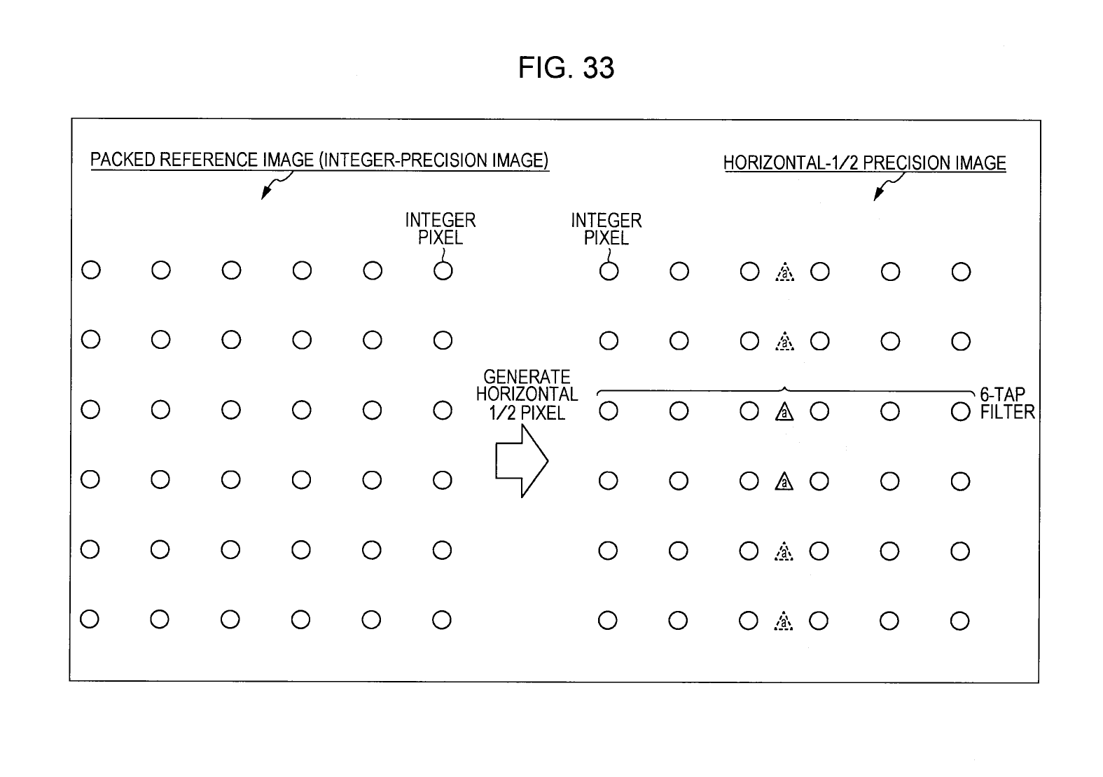

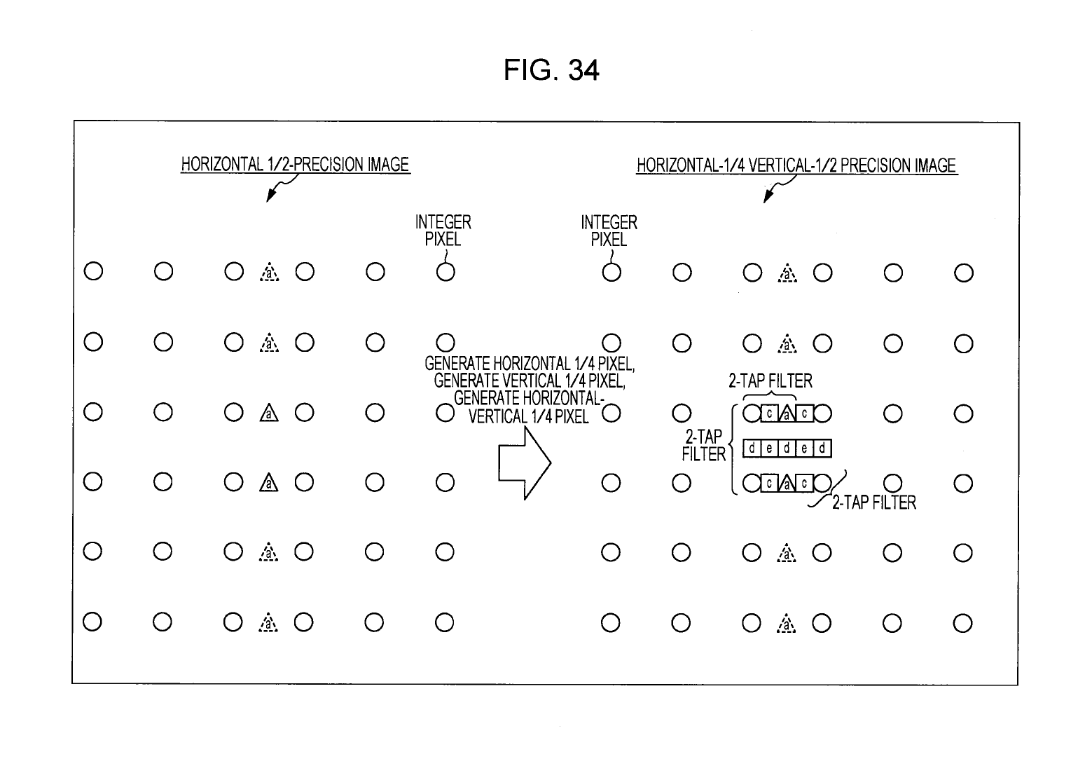

FIG. 33 and FIG. 34 are diagrams for describing filter processing by the horizontal ½-pixel generating filter processing unit 151 through horizontal-vertical ¼-pixel generating filter processing unit 155 following the control of the controller 381 in FIG. 31.

Note that in FIG. 33 and FIG. 34, the circle symbols represent original pixels of the reference image (pixels which are not sub pels).

If we say that the horizontal and vertical intervals between the original pixels of the packed reference image (original pixels) is 1, the original pixels are integer pixels at integer positions as described with FIG. 14 and FIG. 15, and accordingly, the packed reference image is an integer precision image configured only of integer pixels.

In the event that the packed color image has been packed by Over Under Packing, the controller 381 recognizes from the resolution conversion SEI that in the packed color image, the vertical resolution of the left viewpoint color image and the right viewpoint color image configuring the packed color image has been made to be ½ of the original (of one viewpoint color image).

In this case, the controller 381 controls, of the horizontal ½-pixel generating filter processing unit 151 through horizontal-vertical ¼-pixel generating filter processing unit 155, the vertical ½-pixel generating filter processing unit 152 so as to not perform filter processing, and controls the remaining horizontal ½-pixel generating filter processing unit 151, horizontal ¼-pixel generating filter processing unit 153, vertical ¼-pixel generating filter processing unit 154, and horizontal-vertical ¼-pixel generating filter processing unit 155 so as to perform filter processing.

As a result, the horizontal ½-pixel generating filter processing unit 151 subjects the packed reference image which is an integer prediction image from the packing unit 382 to vertical ½-pixel generating filter processing, following the control of the controller 381.

In this case, according to the horizontal ½-pixel generating filter processing, pixels serving as sub pels (horizontal ½ pixels) are interpolated at coordinate positions a of which x coordinates are expressed in terms of an added value of an integer and ½, and y coordinates expressed in terms of integers, as illustrated in FIG. 33.

The horizontal ½-pixel generating filter processing unit 151 supplies an image where pixels (horizontal ½ pixels) have been interpolated at the position a in FIG. 33, obtained by the horizontal ½-pixel generating filter processing, i.e., a horizontal ½-precision image where the horizontal interval between pixels is ½ and the vertical interval is 1, to the vertical ½-pixel generating filter processing unit 152.

Now, the resolution ratio of the vertically-situated reference image and the copy thereof (hereinafter also referred to as copy reference image), making up the horizontal ½ precision image is 2:1 for both.

Under control of the controller 381, the vertical ½-pixel generating filter processing unit 152 does not subject the horizontal ½ precision image from the horizontal ½-pixel generating filter processing unit 151 to vertical ½-pixel generating filter processing, and supplies to the horizontal ¼-pixel generating filter processing unit 153 without change.

The horizontal ¼-pixel generating filter processing unit 153 subjects the horizontal ½ precision image from the vertical ½-pixel generating filter processing unit 152 to horizontal ¼-pixel generating filter processing, following control of the controller 381.

In this case, the image (horizontal ½ precision image) from the vertical ½-pixel generating filter processing unit 152 which is to be subjected to horizontal ¼-pixel generating filter processing has not been subjected to the vertical ½-pixel generating filter processing by the vertical ½-pixel generating filter processing unit 152, so according to the horizontal ¼-pixel generating filter processing, pixels serving as sub pels (horizontal ¼ pixels) are interpolated at coordinate positions c of which x coordinates are expressed in terms of an added value of an integer and ¼ or an integer and −¼, and y coordinates are expressed in terms of integers, as illustrated in FIG. 34.

The horizontal ¼-pixel generating filter processing unit 153 supplies the image where pixels (horizontal ¼ pixels) have been interpolated at the position c in FIG. 34, obtained by the horizontal ¼-pixel generating filter processing, i.e., an image where the horizontal interval between pixels is ¼ and the vertical interval is 1, to the vertical ¼-pixel generating filter processing unit 154.

The vertical ¼-pixel generating filter processing unit 154 subjects the image from the horizontal ¼-pixel generating filter processing unit 153 to vertical ¼-pixel generating filter processing, following control of the controller 381.

In this case, the image from the horizontal ¼-pixel generating filter processing unit 153 which is to be subjected to vertical ¼-pixel generating filter processing has not been subjected to vertical ½-pixel generating filter processing by the vertical ½-pixel generating filter processing unit 152, so according to the vertical ¼-pixel generating filter processing, pixels serving as sub pels (vertical ¼ pixels) are interpolated at coordinate positions d at which x coordinates are expressed in terms of integers or an added value of an integer and ½, and y coordinates are expressed in terms of an added value of an integer and ½, as illustrated in FIG. 34.

The vertical ¼-pixel generating filter processing unit 154 supplies an image where pixels (vertical ¼ pixels) have been interpolated at positions d in FIG. 34, obtained by the horizontal ¼-pixel generating filter processing, to the horizontal-vertical ¼-pixel generating filter processing unit 155.

The horizontal-vertical ¼-pixel generating filter processing unit 155 subjects the image from the vertical ¼-pixel generating filter processing unit 154 to horizontal-vertical ¼-pixel generating filter processing, following control of the controller 381.

In this case, the image from vertical ¼-pixel generating filter processing unit 154 which is to be subjected to horizontal-vertical ¼-pixel generating filter processing has not been subjected to vertical ½-pixel generating filter processing by the vertical ½-pixel generating filter processing unit 152, so according to the horizontal-vertical ¼-pixel generating filter processing, pixels serving as sub pels (horizontal-vertical ¼ pixels) are interpolated at coordinate positions e at which x coordinates are expressed in terms of an added value of an integer and ¼ or an added value of an integer and −¼, and y coordinates are expressed in terms of an added value of an integer and ½, as illustrated in FIG. 34.

The horizontal-vertical ¼-pixel generating filter processing unit 155 supplies the image where pixels (horizontal-vertical ¼ pixels) have been interpolated at the positions e in FIG. 34, obtained by the horizontal-vertical ¼-pixel generating filter processing, i.e., a horizontal ¼ vertical ½ precision image where the horizontal intervals between pixels are ¼ and the vertical intervals ½, to the disparity detecting unit 141 and disparity compensation unit 142 as a converted reference image.

Now, the resolution ratio of the vertically-situated reference image and copy reference image, making up the horizontal ¼ vertical ½ precision image is 2:1 for both.

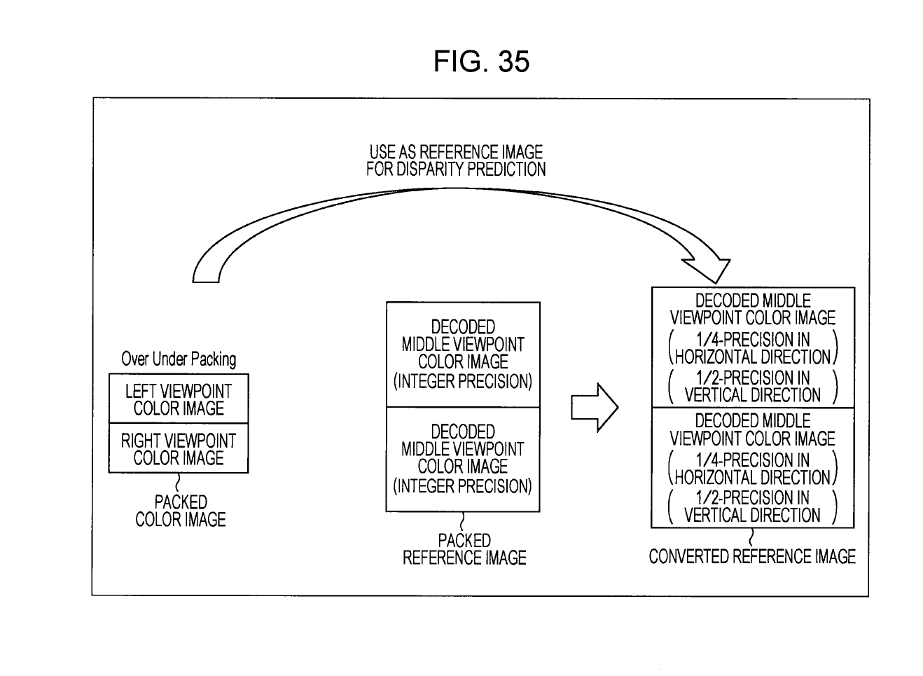

FIG. 35 illustrates a converted reference image obtained by not performing vertical ½-pixel generating filter processing but performing horizontal ½-pixel generating filter processing, horizontal ¼-pixel generating filter processing, vertical ¼-pixel generating filter processing, and horizontal-vertical ¼-pixel generating filter processing, at the reference image converting unit 370 (FIG. 31).

In a case of not performing vertical ½-pixel generating filter processing and performing horizontal ½-pixel generating filter processing, horizontal ¼-pixel generating filter processing, vertical ¼-pixel generating filter processing, and horizontal-vertical ¼-pixel generating filter processing, at the reference image converting unit 370, a horizontal ¼ vertical ½ precision image, of which the horizontal intervals between pixels (horizontal direction precision) is ¼ and vertical intervals (vertical direction precision) is ½ can be obtained as a converted reference image, as described with FIG. 33 and FIG. 34.

The converted reference image obtained as described above is a horizontal ¼ vertical ½ precision image where the decoded middle viewpoint color image serving as the (original) reference image, and a copy thereof, have been arrayed vertically, in the same way as with the packed color image.

On the other hand, as described with FIG. 23 for example, the packed color image is one viewpoint worth of image, where the vertical resolution of the left viewpoint color image and right viewpoint color image have each been made to be ½, and the left viewpoint color image and right viewpoint color image of which the vertical resolution has been made to be ½ are vertically arrayed.

Accordingly, with the encoder 342 (FIG. 27), the resolution ratio of the packed color image (image to be encoded) which is to be encoded, and the resolution ratio of the converted reference image to be referenced at the time of generating a prediction image for the packed color image in the disparity prediction at the disparity prediction unit 361 (FIG. 30), agree (match).

That is to say, the vertical resolution of the left viewpoint color image and right viewpoint color image arrayed vertically is ½ that of the original, and accordingly, the resolution ratio of the left viewpoint color image and right viewpoint color image making up the packed color image is 2:1 for either.

On the other hand, the resolution ratio of the decoded middle viewpoint color image and the copy thereof arrayed vertically is also 2:1 for either, matching the resolution ratio of 2:1 of the left viewpoint color image and right viewpoint color image making up the packed color image.

As described above, the resolution ratio of the packed color image and the resolution ratio of the converted reference image agree, so that is to say, with the packed color image the left viewpoint color image and right viewpoint color image are arrayed vertically, and with the converted reference image the decoded middle viewpoint color image and a copy thereof are arrayed vertically in the same way as with the packed color image, and also, the resolution ratio of the left viewpoint color image and right viewpoint color image thus arrayed vertically in the packed color image, and the resolution ratio of the decoded middle viewpoint color image and a copy thereof arrayed vertically in the converted reference image each agree, so prediction precision of disparity prediction can be improved (the residual between the prediction image generated in disparity prediction and the current block becomes small), and encoding efficiency can be improved.

As a result, deterioration in image quality in the decoded image obtained at the reception device 12, due to resolution conversion where the base band data amount is reduced from the multi-viewpoint color image (and multi-viewpoint depth image) described above, can be prevented.

Note that in FIG. 33 through FIG. 35, a horizontal ¼ vertical ½ precision image (FIG. 34) is obtained at the reference image converting unit 370 (FIG. 31) as a converted reference image, but a horizontal ½ precision image (FIG. 33) may be obtained as a converted reference image.

A horizontal ½ precision image can be obtained by performing control of the horizontal ½-pixel generating filter processing unit 151 through horizontal-vertical ¼-pixel generating filter processing unit 155 with the controller 381 of the reference image converting unit 370 (FIG. 31) such that, of the horizontal ½-pixel generating filter processing unit 151 through horizontal-vertical ¼-pixel generating filter processing unit 155, filter processing is performed only at the horizontal ½-pixel generating filter processing unit 151, and filter processing is not performed a the vertical ½-pixel generating filter processing unit 152 through horizontal-vertical ¼-pixel generating filter processing unit 155.

[Encoding Processing of Packed Color Image]

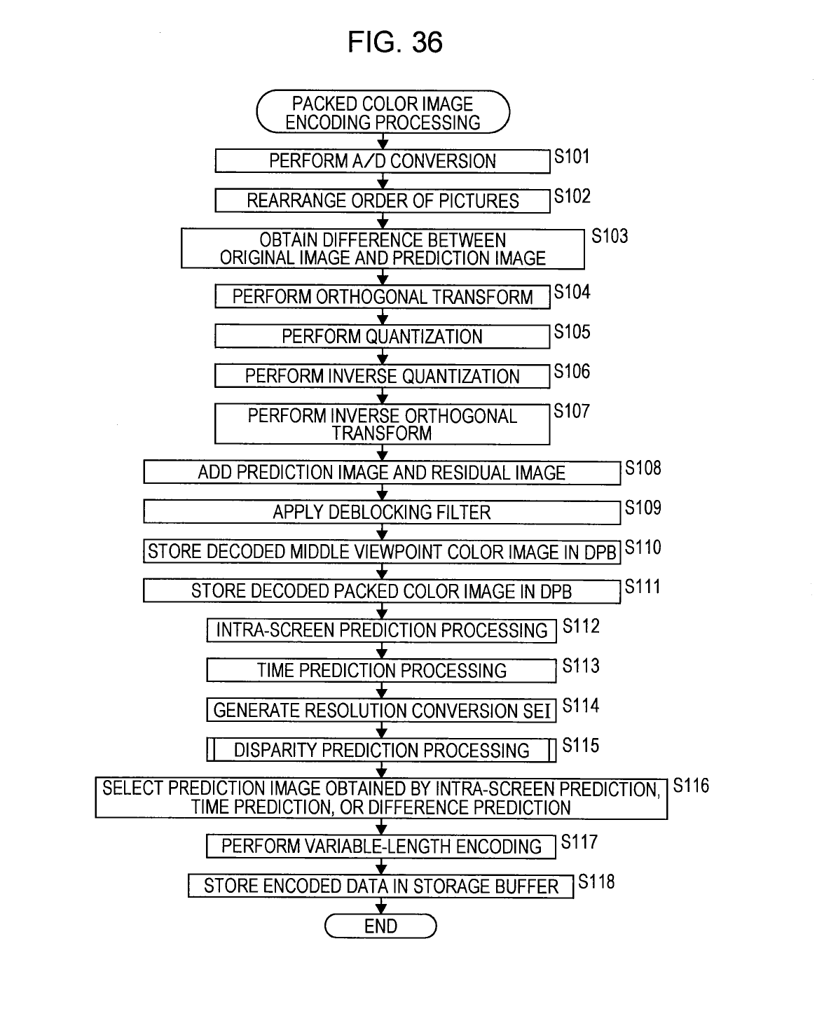

FIG. 36 is a flowchart for describing the encoding processing to encode the packed color image, which the encoder 342 in FIG. 27 performs.

In step S101, the A/D converting unit 111 performs A/D conversion of analog signals of pictures of a packed color image supplied thereto, supplies to the screen rearranging buffer 112, and the flow advances to step S102.

In step S102, the screen rearranging buffer 112 temporarily stores pictures of middle viewpoint color images from the A/D converting unit 111, and performs rearranging where the order of pictures is rearranged from display order to encoding order (decoding order), by reading out the pictures in accordance with a predetermined GOP structure.

The pictures read out from the screen rearranging buffer 112 are supplied to the computing unit 113, intra-screen prediction unit 122, disparity prediction unit 361 of the inter prediction unit 352, and the temporal prediction unit 132, and the flow advances from step S102 to step S103.

In step S103, the computing unit 113 takes a picture of a middle viewpoint color image from the screen rearranging buffer 112 to be a current picture to be encoded, and further, sequentially takes macroblocks configuring the current picture as current blocks to be encoded.

The computing unit 113 then computes the difference (residual) between the pixel values of the current block and pixel values of a prediction image supplied from the prediction image selecting unit 124 as necessary, supplies to the orthogonal transform unit 114, and the flow advances from step S103 to step S104.

In step S104, the orthogonal transform unit 114 subjects the current block from the computing unit 113 to orthogonal transform, supplies transform coefficients obtained as a result thereof to the quantization unit 115, and the flow advances to step S105.

In step S105, the quantization unit 115 performs quantization of the transform coefficients supplied from the orthogonal transform unit 114, supplies the quantization values obtained as a result thereof to the inverse quantization unit 118 and variable length encoding unit 116, and the flow advances to step S106.

In step S106, the inverse quantization unit 118 performs inverse quantization of the quantization values from the quantization unit 115 into transform coefficients, supplies to the inverse orthogonal transform unit 119, and the flow advances to step S107.

In step S107, the inverse orthogonal transform unit 119 performs inverse orthogonal transform of the transform coefficients from the inverse quantization unit 118, supplies to the computing unit 120, and the flow advances to step S108.

In step S108, the computing unit 120 adds the pixels values of the prediction image supplied from the prediction image selecting unit 124 to the data supplied from the inverse orthogonal transform unit 119 as necessary, thereby obtaining a decoded packed color image where the current block has been decoded (locally decoded). The computing unit 120 then supplies the decoded packed color image where the current block has been locally decoded to the deblocking filter 121, and the flow advances from step S108 to step S109.

In step S109, the deblocking filter 121 performs filtering of the decoded packed color image from the computing unit 120, supplies to the DPB 43, and the flow advances to step S110.

In step S110, the DPB 43 awaits supply of a decoded middle viewpoint color image obtained by encoding and locally decoding the middle viewpoint color image, from the encoder 41 (FIG. 26) which encodes the middle viewpoint color image, stores the decoded middle viewpoint color image, and the flow advances to step S111.

In step S111, the DPB 43 stores the decoded packed color image from the deblocking filter 121, and the flow advances to step S112.

In step S112 the intra-screen prediction unit 122 performs intra prediction processing (intra-screen prediction processing) for the next current block.

That is to say, the intra-screen prediction unit 122 performs intra prediction processing (intra-screen prediction processing) to generate a prediction image (intra-predicted prediction image) from the picture of the decoded packed color image stored in the DPB 43, for the next current block.

The intra-screen prediction unit 122 then uses the intra-predicted prediction image to obtain the encoding costs needed to encode the next current block, supplies this to the prediction image selecting unit 124 along with (information relating to intra-prediction serving as) header information and the intra-predicted prediction image, and the flow advances from step S112 to step S113.

In step S113, the temporal prediction unit 132 performs temporal prediction processing regarding the next current block, with the picture of the decoded packed color image as a reference image.

That is to say, the temporal prediction unit 132 uses the decoded packed color image stored in the DPB 43 to perform temporal prediction regarding the next current block, thereby obtaining prediction image, encoding cost, and so forth, for each inter prediction mode with different macroblock type and so forth.

Further, the temporal prediction unit 132 takes the inter prediction mode of which the encoding cost is the smallest as being the optimal inter prediction mode, supplies the prediction image of that optimal prediction mode to the prediction image selecting unit 124 along with (information relating to intra-prediction serving as) header information and the encoding cost, and the flow advances from step S113 to step S114.

In step S114, the SEI generating unit 351 generates the resolution conversion SEI described with FIG. 28 and FIG. 29, supplies this to the variable length encoding unit 116 and disparity prediction unit 361, and the processing advances to step S115.

In step S115, the disparity prediction unit 361 performs disparity prediction information of the next current block, with the decoded middle viewpoint color image as a reference image.

That is to say, the disparity prediction unit 361 takes the picture of the decoded middle viewpoint color image stored in the DPS 43 as a reference image, and converts that reference image into a converted reference image, in accordance to the resolution conversion information SET from the SEI generating unit 351.

Further, the disparity prediction unit 361 performs disparity prediction for the next current block using the converted reference image, thereby obtaining a prediction image, encoding cost, and so forth, for each inter prediction mode of which the macroblock type and so forth differ.

Further, the disparity prediction unit 361 takes the inter prediction mode of which the encoding cost is the smallest as the optimal inter prediction mode, supplies the prediction image of that optimal inter prediction mode to the prediction image selecting unit 124 along with (information relating to inter prediction serving as) header information and the encoding cost, and the flow advances from step S115 to step S116.

In step S116, the prediction image selecting unit 124 selects, from the prediction image from the intra-screen prediction unit 122 (intra-predicted prediction image), prediction image from the temporal prediction unit 132 (temporal prediction image), and prediction image from the disparity prediction unit 361 (disparity prediction image), the prediction image of which the encoding cost is the smallest for example, supplies this to the computing units 113 and 220, and the flow advances to step S117.

Now, the prediction image which the prediction image selecting unit 124 selects in step S116 is used in the processing of steps S103 and S108 performed for encoding of the next current block.

Also, the prediction image selecting unit 124 selects, of the header information supplied from the intra-screen prediction unit 122, temporal prediction unit 132, and disparity prediction unit 361, the header information supplied along with the prediction image of which the encoding cost is the smallest, and supplies to the variable length encoding unit 116.

In step S117, the variable length encoding unit 116 subjects the quantization values from the quantization unit 115 to variable-length encoding, and obtains encoded data.

Further, the variable length encoding unit 116 includes the header information from the prediction image selecting unit 124 and the resolution conversion SEI from the SEI generating unit 351, in the header of the encoded data.

The variable length encoding unit 116 then supplies the encoded data to the storage buffer 117, and the flow advances from step S117 to step S118.

In step S118, the storage buffer 117 temporarily stores the encoded data from the variable length encoding unit 116.

The encoded data stored at the storage buffer 117 is supplied (transmitted) to the multiplexing device 23 (FIG. 21) at a predetermined transmission rate.

The processing of steps S101 through S118 above is repeatedly performed as appropriate at the encoder 342.

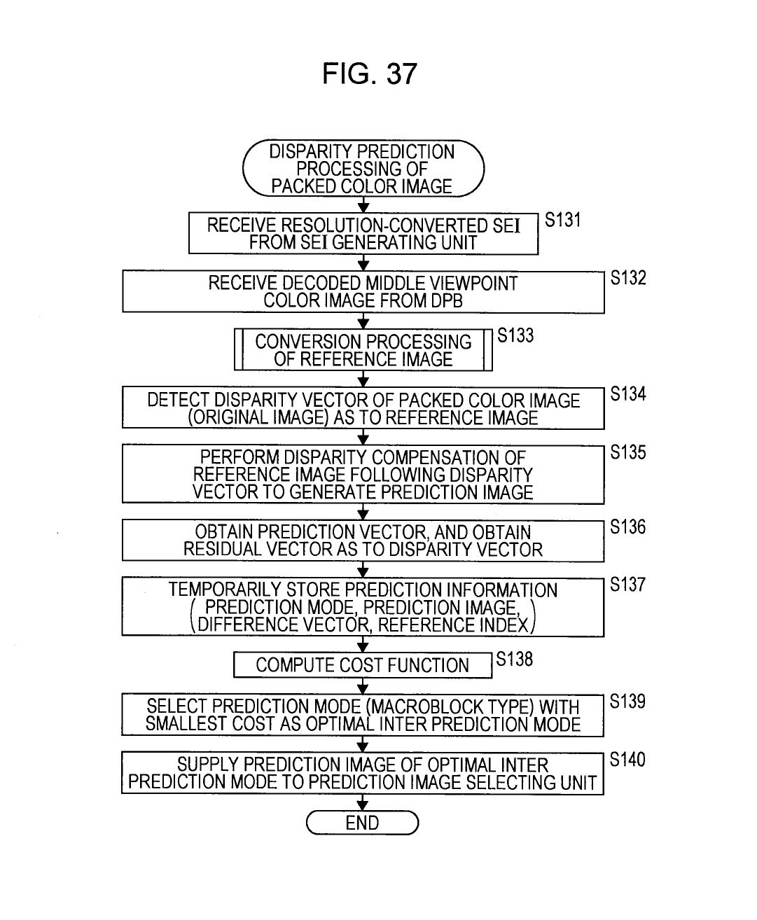

FIG. 37 is a flowchart for describing disparity prediction processing which the disparity prediction unit 361 in FIG. 30 performs in step S115 in FIG. 36.

In step S131, the reference image converting unit 370 receives the resolution conversion SEI supplied from the SEI generating unit 351, and the flow advances to step S132.

In step S132, the reference image converting unit 370 receives the picture of the decoded middle viewpoint color image serving as the reference image from the DPB 43, and the flow advances to step S133.

In step S133, the reference image converting unit 370 controls filter processing to be performed on the picture of the decoded middle viewpoint color image serving as the reference image from the DPB 43, in accordance with the resolution conversion SEI from the SEI generating unit 351, and accordingly performs conversion processing of the reference image to convert the reference image into a converted reference image of which the resolution ratio matches the horizontal and vertical resolution ratio of the picture of the packed color image to be encoded.

The reference image converting unit 370 then supplies the converted reference image obtained by performing conversion processing of the reference image, to the disparity detecting unit 141 and disparity compensation unit 142, and the flow advances from step S133 to step S134.

In step S134, the disparity detecting unit 141 performs ME using the current block supplied from the screen rearranging buffer 112 converted reference image from the reference image converting unit 370, thereby detecting the disparity vector my representing the shift at the current block as to the converted reference image, for each macroblock type, which is supplied to the disparity compensation unit 142, and the flow advances to step S135.

In step S135, the disparity compensation unit 142 performs disparity compensation of the converted reference image from the reference image converting unit 370 using the disparity vector my of the current block from the disparity detecting unit 141, thereby generating a prediction image of the current block, for each macroblock type, and the flow advances to step S136.

That is to say, the disparity compensation unit 142 obtains a corresponding block which is a block in the converted reference image, shifted by an amount equivalent to the disparity vector my from the position of the current block, as a prediction image.

In step S136, the disparity compensation unit 142 uses disparity vectors and so forth of macroblocks at the periphery of the current block, that have already been encoded, as necessary, thereby obtaining a prediction vector PMV of the disparity vector my of the current block.

Further, the disparity compensation unit 142 obtains a residual vector which is the difference between the disparity vector my of the current block and the prediction vector PMV.

The disparity compensation unit 142 then correlates the prediction image of the current block for each prediction mode, such as macroblock type, with the prediction mode, along with the residual vector of the current block and the reference index assigned to the reference image (and consequently the picture of the decoded middle viewpoint color image serving as the reference image) used for generating the prediction image, and supplies to the prediction information buffer 143 and the cost function calculating unit 144, and the flow advances from step S136 to step S137.

In step S137, the prediction information buffer 143 temporarily stores the prediction image correlated with the prediction mode, residual vector, and reference index, from the disparity compensation unit 142, as prediction information, and the flow advances to step S138.

In step S138, the cost function calculating unit 144 obtains the encoding cost (cost function value) needed to encode the current block of the current picture from the screen rearranging buffer 112 by calculating a cost function, for each macroblock type serving as a prediction mode, supplies this to the mode selecting unit 145, and the flow advances to step S139.

In step S139, the mode selecting unit 145 detects the smallest cost which is the smallest value, from the encoding costs for each macroblock type from the cost function calculating unit 144.

Further, the mode selecting unit 145 selects the macroblock type of which the smallest cost has been obtained, as the optimal inter prediction mode.

The mode selecting unit 145 then reads out the prediction image correlated with the prediction mode which is the optimal inter prediction mode, residual vector, and reference index, from the prediction information buffer 143, supplies to the prediction image selecting unit 124 as prediction information, and the processing returns.

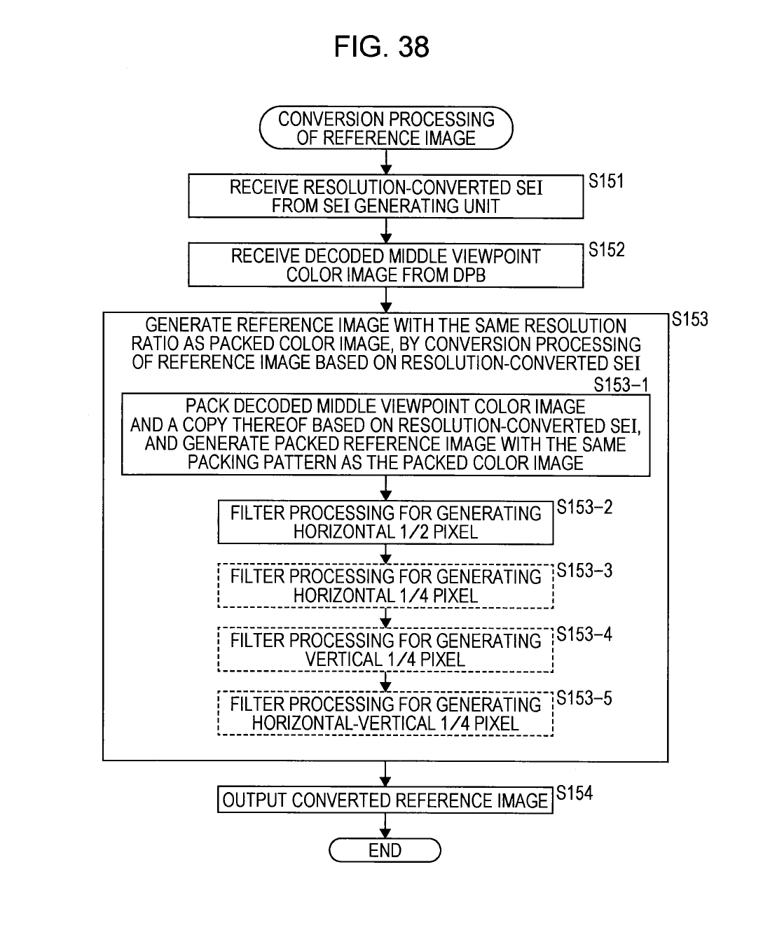

FIG. 38 is a flowchart for describing the conversion processing of a reference image which the reference image converting unit 370 in FIG. 31 performs in step S133 in FIG. 37.

In step S151, the controller 381 receives the resolution conversion SEI from the SEI generating unit 351 and the flow advances to step S152.

In step S152, the packing unit 382 receives the decoded middle viewpoint color image serving as the reference image from the DPB 43, and the flow advances to step S153.

In step S153, the controller 381 controls the filter processing of each of the horizontal ½-pixel generating filter processing unit 151 through horizontal-vertical ¼-pixel generating filter processing unit 155 and the packing of the packing unit 382, in accordance with the resolution conversion SEI from the SEI generating unit 351, and accordingly, the reference image from the DPB 43 is converted into a converted reference image of a resolution ratio matching the horizontal and vertical resolution ratio of the picture of the packed color image to be encoded.

That is to say, in step S153, in step S153-1 the packing unit 382 packs the reference image from the DPB 43 and a copy thereof, and generates a packed reference image having the same packing pattern as the packed color image to be encoded.

Now, with the present embodiment, the packing unit 382 performs packing of the reference image from the DPB 43 and the copy thereof arrayed vertically (Over Under Packing).

The packing unit 382 supplies the packed reference image obtained by packing to the horizontal ½-pixel generating filter processing unit 151, and the flow advances from step S153-1 to step S153-2.

In step S153-2, the horizontal ½-pixel generating filter processing unit 151 subjects the packed reference image which is an integer precision image from the packing unit 382, to horizontal ½-pixel generating filter processing.

The horizontal ½ precision image (FIG. 33) which is an image obtained by the horizontal ½-pixel generating filter processing is supplied from the horizontal ½-pixel generating filter processing unit 151 to the vertical ½-pixel generating filter processing unit 152, but under control of the controller 381, the vertical ½-pixel generating filter processing unit 152 does not subject the horizontal ½ precision image from the horizontal ½-pixel generating filter processing unit 151 to vertical ½-pixel generating filter processing, and instead supplies to the horizontal ¼-pixel generating filter processing unit 153 as it is.

Subsequently, the flow advances from step S153-2 to step S153-3, where the horizontal ¼-pixel generating filter processing unit 153 subjects the horizontal ½ precision image from the vertical ½-pixel generating filter processing unit 152 to horizontal ¼-pixel generating filter processing, supplies the image obtained as a result thereof to the vertical ¼-pixel generating filter processing unit 154, and the flow advances to step S153-4.

In step S153-4, the vertical ¼-pixel generating filter processing unit 154 subjects the image from the horizontal ¼-pixel generating filter processing unit 153 to vertical ¼-pixel generating filter processing, supplies the image obtained as a result thereof to the horizontal-vertical ¼-pixel generating filter processing unit 155, and the flow advances to step S153-5.

In step S153-5, the horizontal-vertical ¼-pixel generating filter processing unit 155 subjects the image from the vertical ¼-pixel generating filter processing unit 154 to horizontal-vertical ¼-pixel generating filter processing, and the flow advances to step S154.

In step S154, the horizontal-vertical ¼-pixel generating filter processing unit 155 supplies the horizontal ¼ vertical ½ precision image (FIG. 34) obtained by the horizontal-vertical ¼-pixel generating filter processing to the disparity detecting unit 141 and disparity compensation unit 142 as a converted reference image, and the processing returns.

Note that with the conversion processing of the reference image in FIG. 38, the processing of steps S153-3 through S153-5 may be skipped, with the horizontal ½ precision image (FIG. 33) obtained by the horizontal ½-pixel generating filter processing performed by the horizontal ½-pixel generating filter processing unit 151 being supplied in step S153-2 to the disparity detecting unit 141 and disparity compensation unit 142 as a converted reference image.

[Configuration Example of Decoding Device 332C]

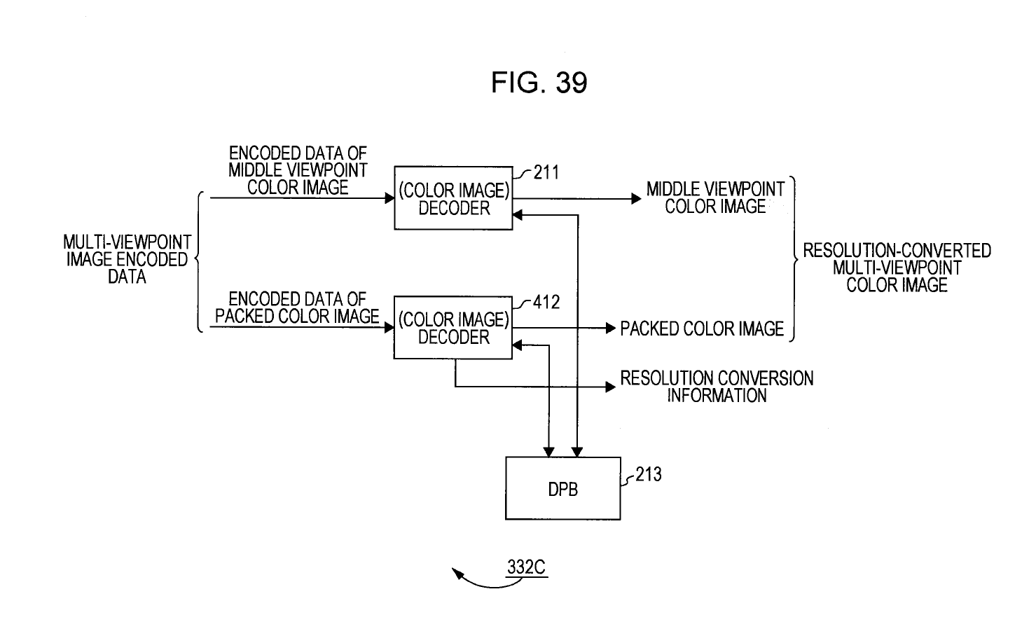

FIG. 39 is a block diagram illustrating a configuration example of the decoding device 332C in FIG. 22.

Note that portions in the drawing corresponding to the case in FIG. 17 are denoted with the same symbols, and description thereof will be omitted as appropriate hereinafter.

In FIG. 39, the decoding device 332C has decoders 211 and 412, and a DPB 213.

Accordingly, the decoding device 332C in FIG. 39 has in common with the decoding device 32C in FIG. 17 the point of sharing the decoder 211 and DPB 213, but differs from the decoding device 32C in FIG. 17 in that the decoder 412 has been provided instead of the decoder 212.

The decoder 412 is supplied with, of the multi-viewpoint color image encoded data from the inverse multiplexing device 31 (FIG. 22), encoded data of the packed color image which is a non base view image.

The decoder 412 decodes the encoded data of the packed color image supplied thereto with an extended format, and outputs a packed color image obtained as the result thereof.

The decoder 211 now decodes, of the multi-viewpoint color image encoded data, encoded data of the middle viewpoint color image which is a base view image, by MVC, and outputs the middle viewpoint color image.

The multi-viewpoint color image which the decoder 211 outputs and the packed color image which the decoder 412 outputs are then supplied to the resolution inverse converting device 333C (FIG. 22) as a resolution-converted multi-viewpoint color image.

Also, the decoders 211 and 412 each decode an image regarding which prediction encoding has been performed at the encoders 41 and 342 in FIG. 26.

In order to decode an image subjected to prediction encoding, the prediction image used for the prediction encoding is necessary, so the decoders 211 and 412 decode the images to be decoded, and thereafter temporarily store the decoded images to be used for generating of a prediction image, in the DPB 213, to generate the prediction image used in the prediction encoding.

The DPB 213 is shared by the decoders 211 and 412, and temporarily stores images after decoding (decoded images) obtained at each of the decoders 211 and 412.

Each of the decoders 211 and 412 select a reference image to reference to decode the image to be decoded, from the decoded images stored in the DPB 213, and generate prediction images using the reference images.

The DPB 213 is thus shared between the decoders 211 and 412, so the decoders 211 and 412 can each reference, besides decoded images obtained from itself, decoded images obtained at the other decoder as well.

Note however, as described above, the decoder 211 decodes base view images, so only references decoded images obtained at the decoder 211.

[Configuration Example of Decoder 412]

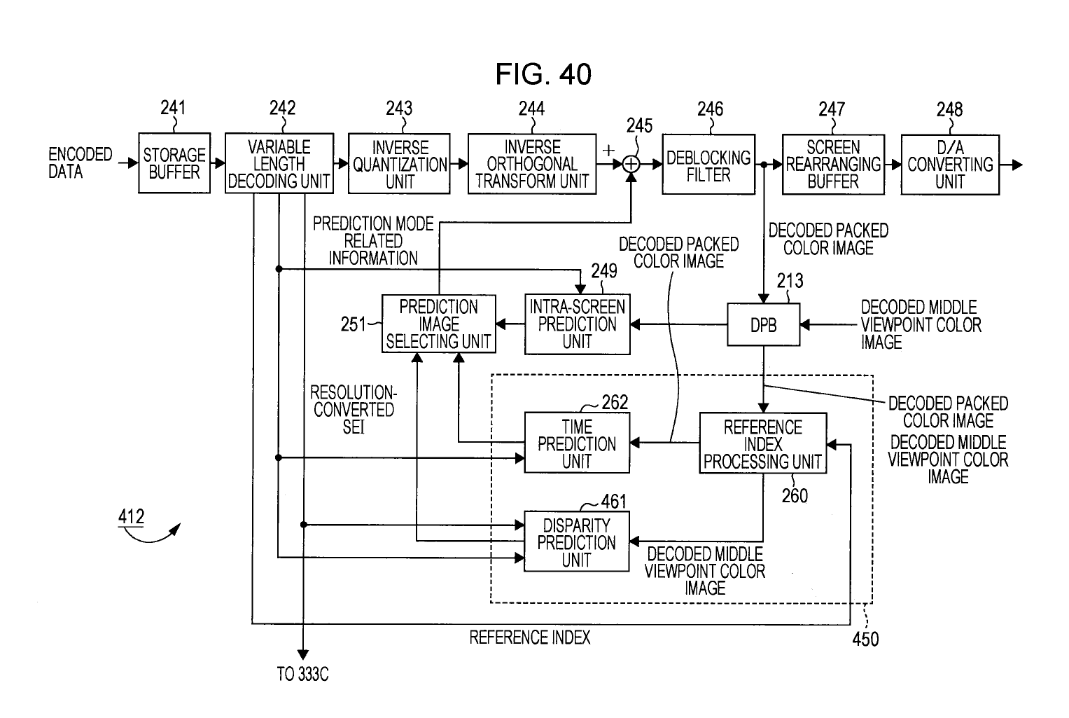

FIG. 40 is a block diagram illustrating a configuration example of the decoder 412 in FIG. 39.

Note that portions in the drawing corresponding to the case in FIG. 18 and FIG. 19 are denoted with the same symbols, and description thereof will be omitted as appropriate hereinafter.

In FIG. 40, the decoder 412 has a storage buffer 241, a variable length decoding unit 242, an inverse quantization unit 243, an inverse orthogonal transform unit 244, a computing unit 245, a deblocking filter 246, a screen rearranging buffer 247, a D/A conversion unit 248, an intra-screen prediction unit 249, a prediction image selecting unit 251, and an inter prediction unit 450.

Accordingly, the decoder 412 in FIG. 40 has in common with the decoder 212 in FIG. 18 the point of having the storage buffer 241 through intra-screen prediction unit 249 and the prediction image selecting unit 251.

However, the decoder 412 in FIG. 40 differs from the decoder 212 in FIG. 18 in the point that the inter prediction unit 450 has been provided instead of the inter prediction unit 250.

The inter prediction unit 450 has the reference index processing unit 260, temporal prediction unit 262, and a disparity prediction unit 461.

Accordingly, the inter prediction unit 450 has in common with the inter prediction unit 250 in FIG. 19 the point of having the reference index processing unit 260 and the temporal prediction unit 262, but differs from the inter prediction unit 250 in FIG. 19 in the point that the disparity prediction unit 461 has been provided instead of the disparity prediction unit 261 (FIG. 19).

With the decoder 412 in FIG. 40, the variable length decoding unit 242 receives encoded data of the packed color image including the resolution conversion SEI from the storage buffer 241, and supplies the resolution conversion SEI included in that encoded data to the disparity prediction unit 461.

Also, the variable length decoding unit 242 supplies the resolution conversion SEI to the resolution inverse converting device 333C (FIG. 22) as resolution conversion information.

Further, the variable length decoding unit 242 supplies header information (prediction mode related information) included in the encoded data to the intra-screen prediction unit 249, and to the reference index processing unit 260, temporal prediction unit 262, and disparity prediction unit 461 configuring the inter prediction unit 450.

The disparity prediction unit 461 is supplied with prediction mode related information and resolution conversion SEI from the variable length decoding unit 242, and also is supplied with a picture of the decoded middle viewpoint color image serving as a reference image from the reference index processing unit 260.

The disparity prediction unit 461 converts the picture of the decoded middle viewpoint color image serving as a reference image from the reference index processing unit 260 into a converted reference image based on the resolution conversion SEI from the variable length decoding unit 242, in the same way as with the disparity prediction unit 361 in FIG. 27.

Further, the disparity prediction unit 461 restores the disparity vector used to generate the prediction image of the current block, based on the prediction mode related information from the variable length decoding unit 242, and in the same way as with the disparity prediction unit 361 in FIG. 27, generates a prediction image by performing disparity prediction (disparity compensation) on the converted reference image, and supplies this to the prediction image selecting unit 251.

[Configuration Example of Disparity Prediction Unit 461]

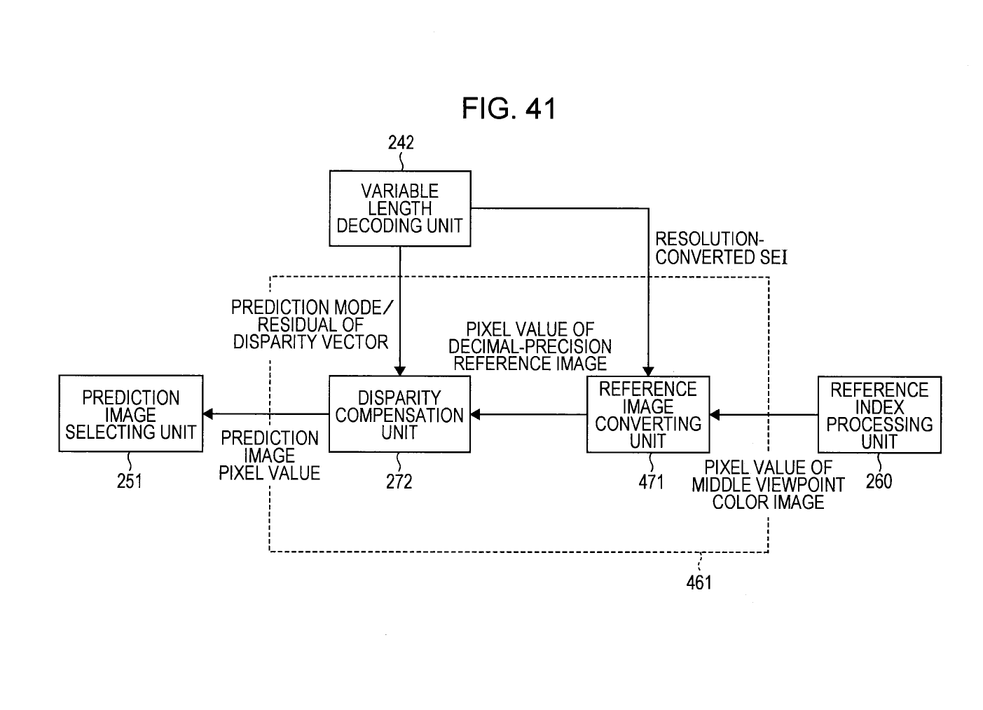

FIG. 41 is a block diagram illustrating a configuration example of the disparity prediction unit 461 in FIG. 40.

Note that in the drawing, portions which correspond to portions in the case in FIG. 20 are denoted with the same symbols, and description thereof will be omitted as appropriate hereinafter.

In FIG. 41, the disparity prediction unit 461 has the disparity compensation unit 272 and a reference image converting unit 471.

Accordingly, the disparity prediction unit 461 in FIG. 41 has in common with the disparity prediction unit 261 in FIG. 20 the point of having the disparity compensation unit 272, but differs from the disparity prediction unit 261 in FIG. 20 with regard to the point that the reference image converting unit 471 has been provided instead of the reference image converting unit 271.

The reference image converting unit 471 is supplied with the picture of the decoded middle viewpoint color image from the reference index processing unit 260, as a reference image, and is also supplied with resolution conversion SEI from the variable length decoding unit 242.

The reference image converting unit 471 controls filter processing to be applied to the picture of the decoded middle viewpoint color image serving as a reference image to be referenced in prediction processing, in accordance with the resolution conversion SEI from the variable length decoding unit 242, in the same way as with the reference image converting unit 370 in FIG. 30, and accordingly converts the reference image into a converted reference image of a resolution ratio matching the horizontal and vertical resolution ratio of the picture of the packed color image to be decoded, and supplies to the disparity compensation unit 272.

[Configuration Example of Reference Image Converting Unit 471]

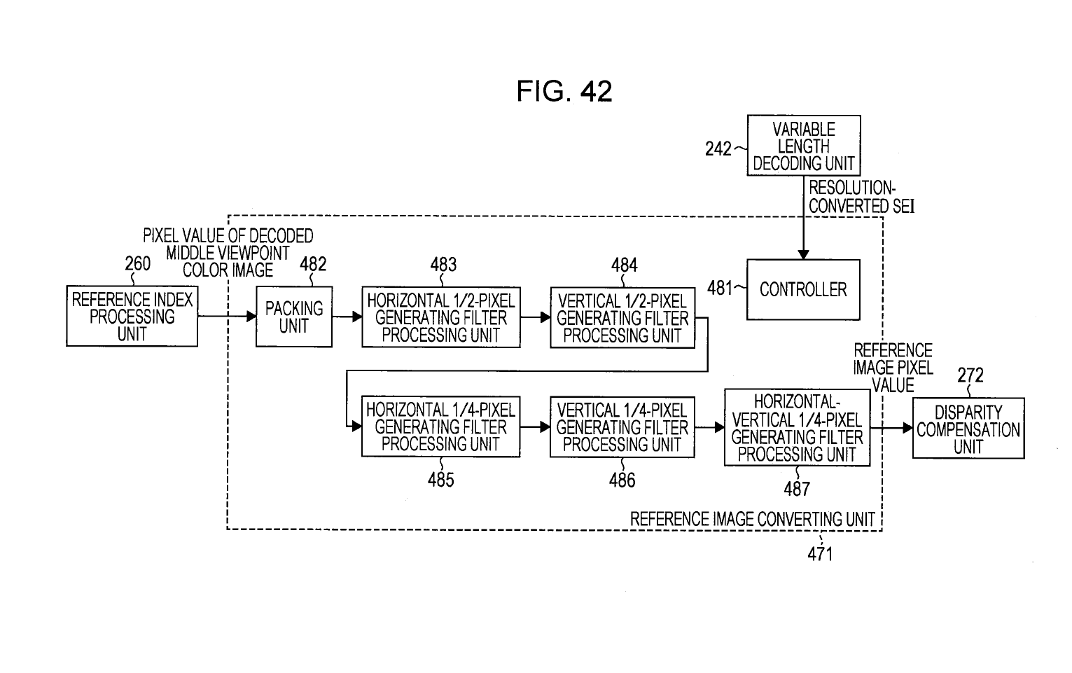

FIG. 42 is a block diagram illustrating a configuration example of the reference image converting unit 471 in FIG. 41.

In FIG. 42, the reference image converting unit 471 has a controller 481, a packing unit 482, a horizontal ½-pixel generating filter processing unit 483, a vertical ½-pixel generating filter processing unit 484, a horizontal ¼-pixel generating filter processing unit 485, a vertical ¼-pixel generating filter processing unit 486, and a horizontal-vertical ¼-pixel generating filter processing unit 487.

The controller 481 through horizontal-vertical ¼-pixel generating filter processing unit 487 each perform the same processing as the controller 381, packing unit 382, and horizontal ½-pixel generating filter processing unit 151 through horizontal-vertical ¼-pixel generating filter processing unit 155.

That is to say, the controller 481 is supplied with resolution conversion SEI from the variable length decoding unit 242.

The controller 481 controls packing of the packing unit 482, and filter processing of the horizontal ½-pixel generating filter processing unit 483 through horizontal-vertical ¼-pixel generating filter processing unit 487, in the same way as with the controller 381 in FIG. 31.

The packing unit 482 is supplied with the decoded middle viewpoint color image serving as the reference image from the reference index processing unit 260.

The packing unit 482 performs packing to generate a packed reference image where the reference image from the reference index processing unit 260 and a copy thereof are arrayed vertically or horizontally, following control of the controller 481, and supplies the packed reference image obtained as a result thereof to the horizontal ½ pixel generating filter processing unit 483.

That is to say, the controller 481 recognizes the packing pattern of the packed color image (Over Under Packing or Side By Side Packing) from (the parameter frame_packing_info[i] of) (in FIGS. 28, 29) the resolution conversion SEI, and controls the packing unit 482 so as to perform packing the same way as with packing of the packed color image.

The packing unit 482 generates a copy of the reference image from the reference index processing unit 260, generates a packed reference image by performing Over Under Packing where the reference image and the copy thereof are arrayed vertically, or Side By Side Packing where arrayed horizontally, following control of the controller 481, and supplies to the horizontal ½-pixel generating filter processing unit 483.

The horizontal ½-pixel generating filter processing unit 483 through horizontal-vertical ¼-pixel generating filter processing unit 487 perform filter processing the same as the respective of the horizontal ½-pixel generating filter processing unit 151 through horizontal-vertical ¼-pixel generating filter processing unit 155 in FIG. 31, following the control of the controller 481.

The converted reference image obtained as a result of the filter processing at the horizontal ½-pixel generating filter processing unit 483 through horizontal-vertical ¼-pixel generating filter processing unit 487 is supplied to the disparity compensation unit 272, and disparity compensation is performed at the disparity compensation unit 272 using the converted reference image.

[Decoding Processing of Packed Color Image]

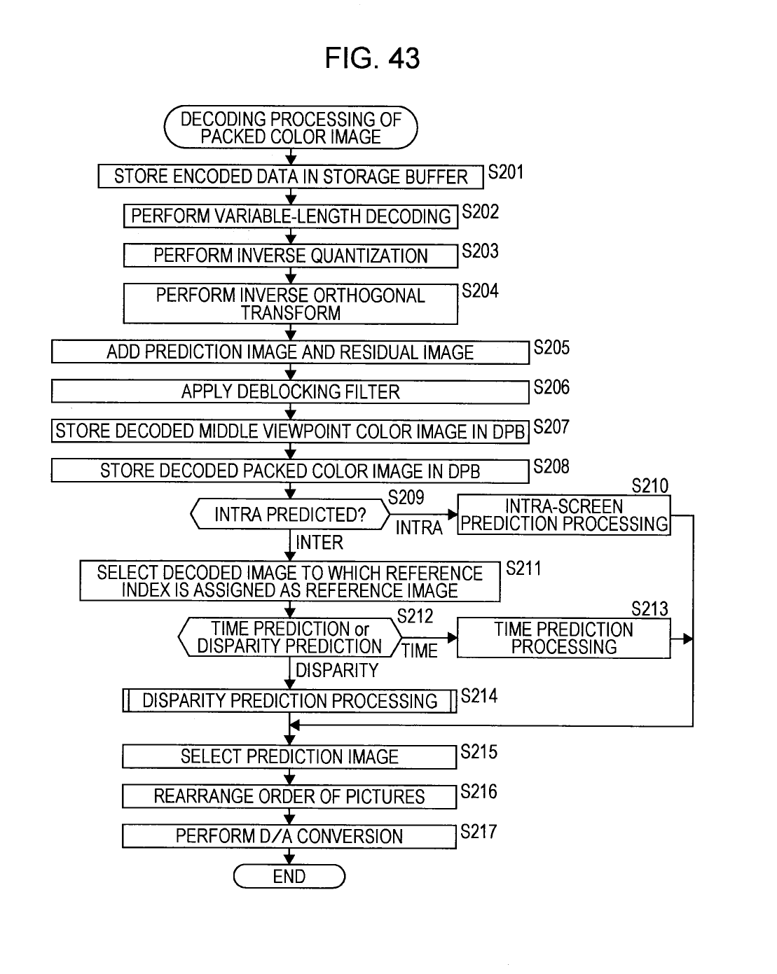

FIG. 43 is a flowchart for describing decoding processing to decode the encoded data of the packed color image, which the decoder 412 in FIG. 40 performs.

In step S201, the storage buffer 241 stores encoded data of the packed color image supplied thereto, and the flow advances to step S202.

In step S202, the variable length decoding unit 242 reads out and performs variable-length decoding on the encoded data stored in the storage buffer 241, thereby restoring the quantization value, prediction mode related information, and resolution conversion SEI. The variable length decoding unit 242 then supplies the quantization values to the inverse quantization unit 243, the prediction mode related information to the intra-screen prediction unit 249, reference index processing unit 260, time prediction unit 262, and disparity prediction unit 461, respectively, and the flow advances to step S203.

In step S203, The inverse quantization unit 243 performs inverse quantization of the quantization value from the variable length decoding unit 242 into transform coefficients, supplies to the inverse orthogonal transform unit 244, and the flow advances to step S204.

In step S204, the inverse orthogonal transform unit 244 performs inverse orthogonal transform of the transform coefficients from the inverse quantization unit 243, supplies to the computing unit 245 in increments of macroblocks, and the flow advances to step S205.

In step S205, the computing unit 245 takes the macroblock from the inverse orthogonal transform unit 244 as a current block (residual image) to be decoded, and adds the prediction image supplied from the prediction image selecting unit 251 to the current block as necessary, thereby obtaining a decoded image. The computing unit 245 then supplies the decoded image to the deblocking filter 246, and the flow advances from step S205 to step S206.

In step S206, the deblocking filter 246 performs filtering on the decoded image from the computing unit 245, supplies the decoded image after filtering (decoded packed color image) to the DPB 213 and the screen rearranging buffer 247, and the flow advances to step S207.

In step S207, the DPB 213 awaits for the decoded middle viewpoint color image to be supplied from the decoder 211 (FIG. 39) which decodes the multi-viewpoint color image, stores the decoded middle viewpoint color image, and the flow advances to step S208.

In step S208, the DPB 213 stores the decoded packed color image from the deblocking filter 246, and the flow advances to step S209.

In step S209, the intra-screen prediction unit 249 and (the temporal prediction unit 262 and disparity prediction unit 461 making up) the inter prediction unit 450 determine which of intra prediction (intra-screen prediction) and inter prediction the prediction image has been generated with, that has been used to encode the next current block (the macroblock to be decoded next), based on the prediction mode related information supplied from the variable length decoding unit 242.

In the event that determination is then made in step S209 that the next current block has been encoded using a prediction image generated with intra-screen prediction, the flow advances to step S210, and the intra-screen prediction unit 249 performs intra prediction processing (intra screen prediction processing).

That is to say, with regard to the next current block, the intra-screen prediction unit 249 performs intra prediction (intra-screen prediction) to generated a prediction image (intra-predicted prediction image) from the picture of the decoded packed color image stored in the DPB 213, supplies that prediction image to the prediction image selecting unit 251, and the flow advances from step S210 to step S215.

Also, in the event that determination is made in step S209 that the next current block has been encoded using a prediction image generated in inter prediction, the flow advances to step S211, where the reference index processing unit 260 reads out the picture of the decoded middle viewpoint color image to which a reference index (for prediction) included in the prediction mode related information from the variable length decoding unit 242 has been assigned, or the picture of the decoded packed color image, from the DPB 213, so as to be selected as a reference image, and the flow advances to step S212.

In step S212, the reference index processing unit 260 determines which of temporal prediction which format of intra prediction and disparity prediction the prediction image has been generated with, that has been used to encode the next current block, based on the reference index (for prediction) included in the prediction mode related information supplied from the variable length decoding unit 242.

In the event that determination is made in step S212 that the next current block has been determined to have been encoded using a prediction image generated by temporal prediction, i.e., in the event that the picture to which the reference index for prediction, for the (next) current block from the variable length decoding unit 242, has been assigned, is the picture of the decoded packed color image, and this picture of the decoded packed color image has been selected in step S211 as a reference image, the reference index processing unit 260 supplies the picture of the decoded packed color image to the temporal prediction unit 262 as a reference image, and the flow advances to step S213.

In step S213, the temporal prediction unit 262 performs temporal prediction processing.

That is to say, with regard to the next current block, the temporal prediction unit 262 performs motion compensation of the picture of the decoded packed color image serving as the reference image from the reference index processing unit 260, using the prediction mode related information from the variable length decoding unit 242, thereby generating a prediction image, supplies the prediction image to the prediction image selecting unit 251, and the processing advances from step S213 to step S215.

Also, in the event that determination is made in step S212 that the next current block has been encoded using a prediction image generated by disparity prediction, i.e., in the event that the picture to which the reference index for prediction, for the (next) current block from the variable length decoding unit 242, has been assigned, is the picture of the decoded middle viewpoint color image, and this picture of the decoded middle viewpoint color image has been selected as a reference image in step S211, the reference index processing unit 260 supplies the picture of the decoded middle viewpoint color image to the disparity prediction unit 461 as a reference image, and the flow advances to step S214.

In step S214, the disparity prediction unit 461 performs disparity prediction processing.

That is to say, the disparity prediction unit 461 converts the picture of the decoded middle viewpoint color image serving as the reference image from the reference index processing unit 260, to a converted reference image, in accordance with the resolution conversion SEI from the variable length decoding unit 242.

Further, the disparity prediction unit 461 performs disparity compensation on the converted reference image for the next current block, using the prediction mode related information from the variable length decoding unit 242, thereby generating a prediction image, and supplies the prediction image to the prediction image selecting unit 251, and the flow advances from step S214 to step S215.

In step S215, the prediction image selecting unit 251 selects a prediction image from the one of the intra-screen prediction unit 249, temporal prediction unit 262, and the disparity prediction unit 461, which as supplied a prediction image, supplies to the computing unit 245, and the flow advances to step S216.

Now, the prediction image which the prediction image selecting unit 251 selects in step S215 is used in the processing of step S205 performed for decoding of the next current block.

In step S216, the screen rearranging buffer 247 temporarily stores and reads out pictures of decoded packed color images from the deblocking filter 246, thereby rearranging the order of pictures to the original order, supplies to the D/A conversion unit 248, and the flow advances to step S217.

In step S217, in the event that it is necessary to output the pictures from the screen rearranging buffer 247 in analog, the D/A conversion unit 248 performs D/A conversion of the pictures and outputs.

At the decoder 412, the processing of the above steps S201 through S217 is repeatedly performed.

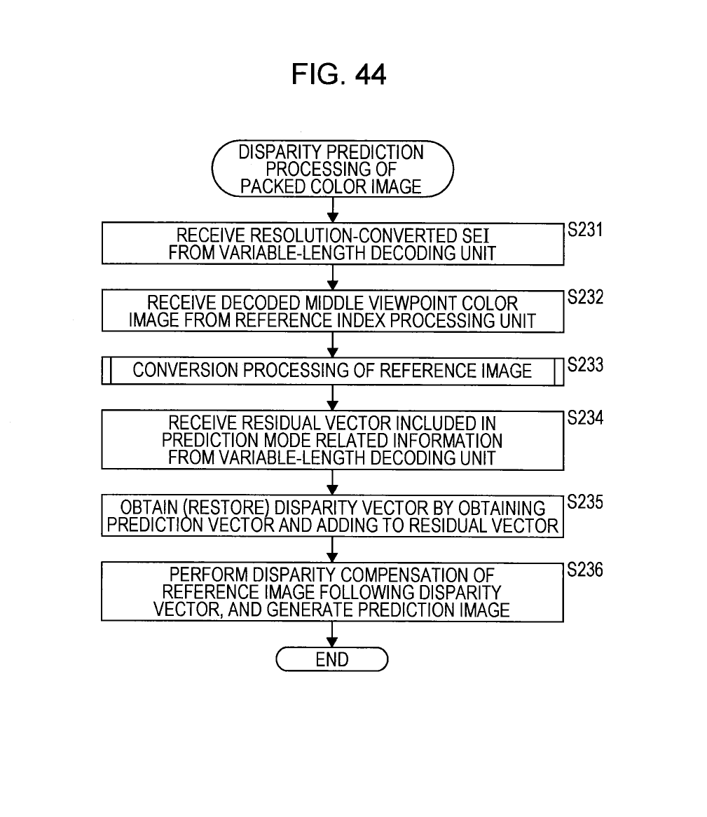

FIG. 44 is a flowchart for describing the disparity prediction processing which the disparity prediction unit 461 in FIG. 41 performs in step S214 in FIG. 43.

In step S231, the reference image converting unit 471 receives the resolution conversion SEI supplied from the variable length decoding unit 242, and the flow advances to step S232.

In step S232, the reference image converting unit 471 receives the picture of the decoded middle viewpoint color image serving as the reference image from the reference index processing unit 260, and the flow advances to step S233.

In step S233, the reference image converting unit 471 controls the filter processing to apply to the picture of the decoded middle viewpoint color image serving as the reference image from the reference index processing unit 260 in accordance with the resolution conversion SEI from the variable length decoding unit 242, thereby performing reference image conversion processing to convert the reference image into a converted reference image of a resolution ratio matching the horizontal and vertical resolution ratio of the picture of the packed color image to be decoded.

The reference image converting unit 471 then supplies the converted reference image obtained by the reference image conversion processing to the disparity compensation unit 272, and the flow advances from step S233 to step S234.

In step S234, the disparity compensation unit 272 receives the residual vector of the (next) current block included in the prediction mode related information from the variable length decoding unit 242, and the flow advances to step S235.

In step S235, the disparity compensation unit 272 uses the disparity vectors of already-decoded macroblocks in the periphery of the current block, and so forth, to obtain a prediction vector of the current block regarding the macroblock type which the prediction mode (optimal inter prediction mode) included in the prediction mode related information from the variable length decoding unit 242 indicates.

Further, the disparity compensation unit 272 adds the prediction vector of the current block and the residual vector from the variable length decoding unit 242, thereby restoring the disparity vector my of the current block, and the flow advances from step S235 to step S236.

In step S236, the disparity compensation unit 272 performs disparity compensation of the converted reference image from the reference image converting unit 471 using the disparity vector my of the current block, thereby generating a prediction image of the current block, supplies to the prediction image selecting unit 251, and the flow returns.

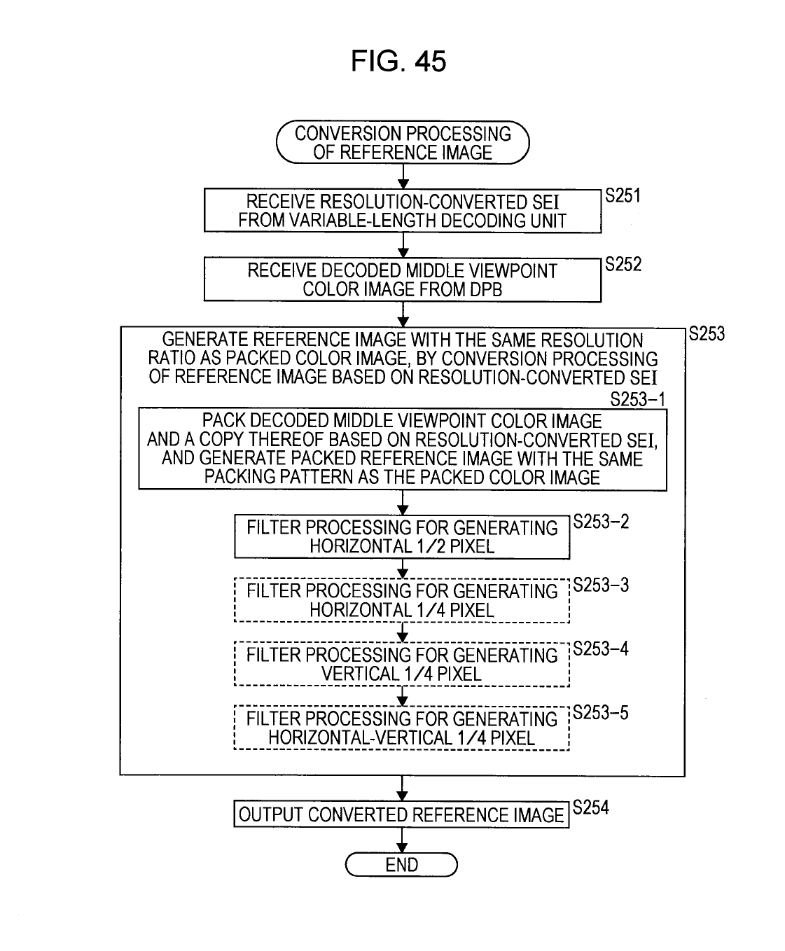

FIG. 45 is a flowchart for describing reference image conversion processing which the reference image converting unit 471 in FIG. 42 performs in step S233 in FIG. 44.

In step S251 through S254, the reference image converting unit 471 performs processing the same as with the processing which the reference image converting unit 370 in FIG. 31 performs in step S151 through S154 in FIG. 38, respectively.

That is to say, in step S251, the controller 481 receives the resolution conversion SEI from the variable length decoding unit 242, and the flow advances to step S252.

In step S252, the packing unit 482 receives the decoded middle viewpoint color image serving as the reference image from the reference index processing unit 260, and the flow advances to step S253.

In step S253, the controller 481 controls, in accordance with resolution conversion SEI from the variable length decoding unit 242, the packing by the packing unit 482 and the filter processing of each of the horizontal ½-pixel generating filter processing unit 483 through horizontal vertical ¼-pixel generating filter processing unit 487, and accordingly the reference image from the reference index processing unit 260 is converted into a converted reference image of a resolution ratio matching the horizontal and vertical resolution ratio of the picture of the packed color image to be decoded.

That is to say, in step S253, in step S253-1, the packing unit 482 packs the reference image from the reference index processing unit 260 and a copy thereof, and generates a packed reference image having the same packing pattern as the packed color image to be encoded.

Now, with the present embodiment, the packing unit 482 performs packing to generate a packed reference image of the reference image from the reference index processing unit 260 and the copy thereof arrayed vertically.

The packing unit 482 supplies the packed reference image obtained by packing to the horizontal ½-pixel generating filter processing unit 483, and the flow advances from step S253-1 to step S253-2.

In step S253-2, the horizontal ½-pixel generating filter processing unit 483 subjects the packed reference image which is an integer precision image from the packing unit 482, to horizontal ½-pixel generating filter processing.

The horizontal ½ precision image (FIG. 33) which is an image obtained by the horizontal ½-pixel generating filter processing is supplied from the horizontal ½-pixel generating filter processing unit 483 to the vertical ½-pixel generating filter processing unit 484, but under control of the controller 481, the vertical ½-pixel generating filter processing unit 484 does not subject the horizontal ½ precision image from the horizontal ½-pixel generating filter processing unit 483 to vertical ½-pixel generating filter processing, and instead supplies to the horizontal ¼-pixel generating filter processing unit 485 as it is.

Subsequently, the flow advances from step S253-2 to step S253-3, where the horizontal ¼-pixel generating filter processing unit 485 subjects the horizontal ½ precision image from the vertical ½-pixel generating filter processing unit 484 to horizontal ¼-pixel generating filter processing, supplies the image obtained as a result thereof to the vertical ¼-pixel generating filter processing unit 486, and the flow advances to step S253-4.

In step S253-4, the vertical ¼-pixel generating filter processing unit 486 subjects the image from the horizontal ¼-pixel generating filter processing unit 485 to vertical ¼-pixel generating filter processing, supplies the image obtained as a result thereof to the horizontal-vertical ¼-pixel generating filter processing unit 487, and the flow advances to step S253-5.

In step S253-5, the horizontal-vertical ¼-pixel generating filter processing unit 487 subjects the image from the vertical ¼-pixel generating filter processing unit 486 to horizontal-vertical ¼-pixel generating filter processing, and the flow advances to step S254.

In step S254, the horizontal-vertical ¼-pixel generating filter processing unit 487 supplies the horizontal ¼ vertical ½ precision image (FIG. 34) obtained by the horizontal-vertical ¼-pixel generating filter processing to the disparity compensation unit 272 as a converted reference image, and the processing returns.

Note that with the conversion processing of the reference image in FIG. 45, in the same way as with the case in FIG. 38, the processing of steps S253-3 through S253-5 may be skipped, with the horizontal ½ precision image (FIG. 33) obtained by the horizontal ½-pixel generating filter processing performed by the horizontal ½-pixel generating filter processing unit 483 being supplied in step S253-2 to the disparity compensation unit 272 as a converted reference image.

[Side By Side Packing]

While Over Under Packing is performed at the resolution converting device 321C in FIG. 23, the resolution converting device 321C may perform Side By Side Packing described with FIG. 29 besides Over Under Packing, to generate a resolution-converted multi-viewpoint color image of which the base band data amount of a multi-viewpoint color image has been reduced.

Now, the processing of the transmission system in FIG. 1 according to claim 1, in a case of performing Side By Side Packing at the resolution converting device 321C, different from the case of Over Under Packing, will be described.

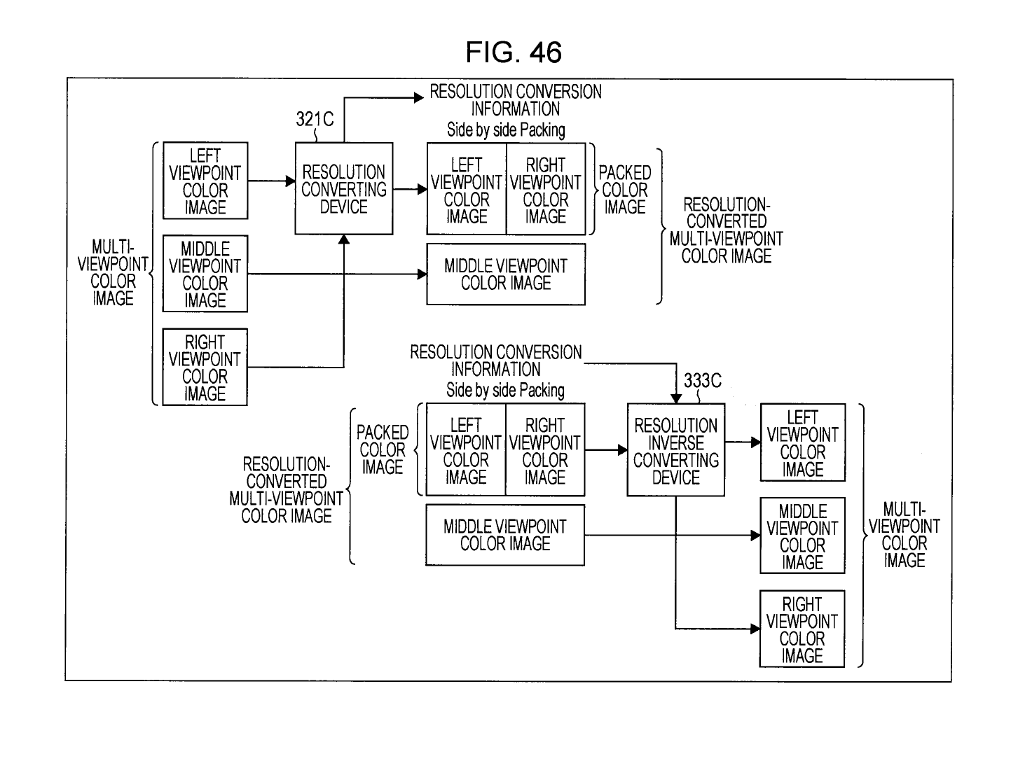

FIG. 46 is a diagram for describing resolution conversion which the resolution converting device 321C (and 321D) in FIG. 21 performs, and the resolution inverse conversion which the resolution inverse converting device 333C (and 333D) in FIG. 22 performs.

That is to say, FIG. 46 is a diagram for describing resolution conversion which the resolution converting device 321C (FIG. 21) performs, and the resolution inverse conversion which the resolution inverse converting device 333C (FIG. 22) performs, in a case of performing Side By Side Packing at the resolution converting device 321C.

In the same way as with the resolution converting device 21C in FIG. 2 for example, in FIG. 46 the resolution converting device 321C outputs, of the middle viewpoint color image, left viewpoint color image, and right viewpoint color image, which are the multi-viewpoint color image supplied thereto, the middle viewpoint color image for example, as it is (without performing resolution conversion).

Also, in FIG. 46, regarding the remaining left viewpoint color image and right viewpoint color image of the multi-viewpoint color image, the resolution converting device 321C converts the horizontal resolution (number of pixels) of the left viewpoint color image and right viewpoint color image to ½, and packs by arraying the left viewpoint color image and right viewpoint color image of which the horizontal resolution has been made to be ½ horizontally, thereby generating a packed color image which is one viewpoint worth of image.

Now, with the packed color image in FIG. 46, the left viewpoint color image is situated at the left side, and the right viewpoint color image is situated at the right side.

The resolution converting device 321C further generates resolution conversion information indicating that the resolution of the middle viewpoint color image is unchanged, that the packed color image is one viewpoint worth of image where the left viewpoint color image and right viewpoint color image (of which the horizontal resolution has been made to be ½) arrayed horizontally, and so forth.

On the other hand, the resolution inverse converting device 333C recognizes, from the resolution conversion information supplied thereto, that the resolution of the middle viewpoint color image is unchanged, that the packed color image is one viewpoint worth of image where the left viewpoint color image and right viewpoint color image have been arranged horizontally, and so forth.

The resolution inverse converting device 333C then outputs, of the middle viewpoint color image and packed color image which are the resolution-converted multi-viewpoint color image supplied thereto, the middle viewpoint color image as it is, based on the information recognized from the resolution conversion information.

Also, the resolution inverse converting device 333C separates, of the middle viewpoint color image and packed color image which are the resolution-converted multi-viewpoint color image supplied thereto, the packed color image horizontally, based on information recognized from the resolution conversion information.

Further, the resolution inverse converting device 333C restores by interpolation or the like, to the original resolution, the horizontal resolution of the left viewpoint color image and right viewpoint color image obtained by horizontally separating the packed color image of which the horizontal resolution had been made to be ½, and outputs.

[Resolution Conversion SEI]

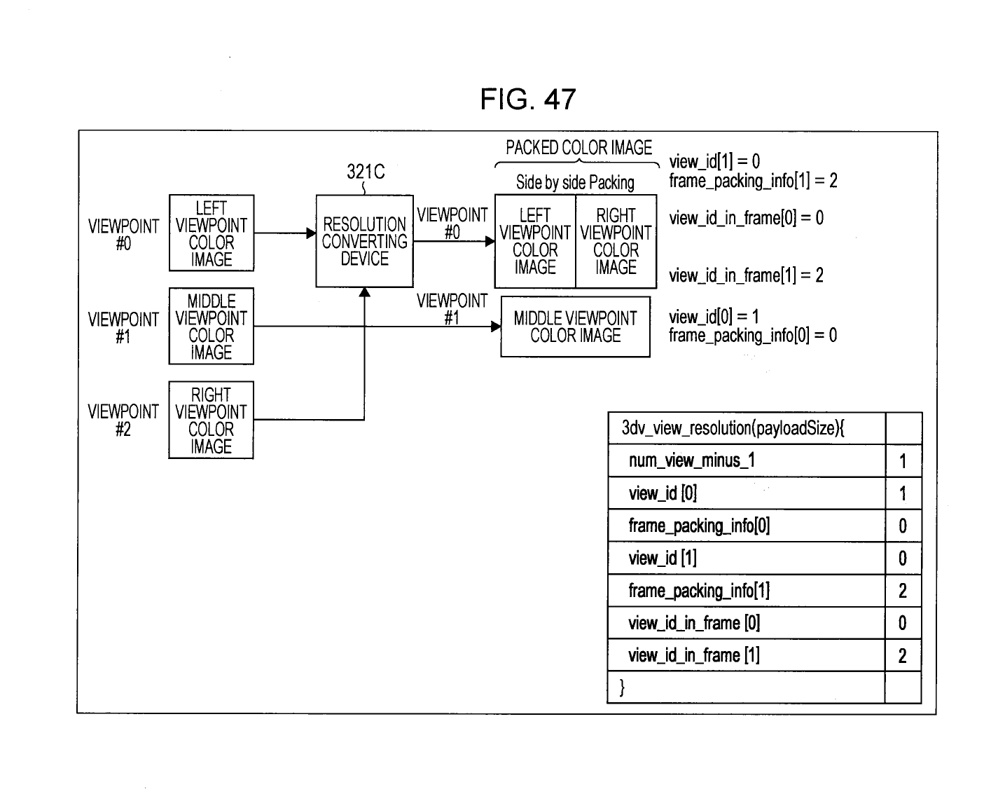

FIG. 47 is a diagram describing, in a case that Side By Side Packing is performed as the resolution conversion described in FIG. 46 at the resolution converting device 321C in FIG. 21, the values set to the parameters num_views_minus_{—}1, view_id[i], frame_packing_info[i], and view_id_in_frame[i]m of the 3dv_view_resolution(payloadSize) serving as the resolution conversion SEI (FIG. 28) which the SEI generating unit 351 in FIG. 27 generates from the resolution conversion information output from the resolution inverse converting device 333C.

In the same way as described with FIG. 29, the parameter num_views_minus_{—}1 represents a value obtained by subtracting 1 from the number of viewpoints making up the resolution-converted multi-viewpoint color image, so num_views_minus_{—}1=2−1=1 is set to the parameter num_views_minus_{—}1 in the event that Side By Side Packing in FIG. 46 is to be performed, in the same way as with the Over Under Packing in FIG. 29.

In the same way as described with FIG. 29, the parameter view_id[i] indicates an index identifying the i+1'th (i=0, 1, . . . ) image making up the resolution-converted multi-viewpoint color image.

That is, let us say that for example here, in the same way as with the Over Under Packing in FIG. 29, the left viewpoint color image is an image of viewpoint #0 represented by No. 0, the middle viewpoint color image is an image of viewpoint #1 represented by No. 1, and the right viewpoint color image is an image of viewpoint #2 represented by No. 2.

Also, let is say that at in the same with the Over Under Packing in FIG. 29, at the resolution converting device 321C, the Nos. representing viewpoints are reassigned regarding the middle viewpoint color image and packed color image making up the resolution-converted multi-viewpoint color image obtained by performing resolution conversion on the multi-viewpoint color image, left viewpoint color image, and right viewpoint color image, so that the middle viewpoint color image is assigned No. 1 representing viewpoint #1, and the packed color image is assigned No. 0 representing viewpoint #0, for example.

Further, let us say that in the same way as with the case of Over Under Packing in FIG. 29, the middle viewpoint color image is the 1st image configuring the resolution-converted multi-viewpoint color image (image of i=0), and that the packed color image is the 2nd image configuring the resolution-converted multi-viewpoint color image (image of 1=1).

In this case, the parameter view_id[0] of the middle viewpoint color image which is the 1(=i+1=0+1)st image configuring the resolution-converted multi-viewpoint color image has the No. 1 representing viewpoint #1 of the middle viewpoint color image set (view_id[0]=1).

Also, the parameter view_id[1] of the packed color image which is the 2(=i+1=1+1)nd image configuring the resolution-converted multi-viewpoint color image has the No. 0 representing viewpoint #0 of the packed color image set (view_id[1]=0).

The parameter frame_packing_info[i] represents whether or not there is packing of the i+1'th image making up the resolution-converted multi-viewpoint color image, and the pattern of packing, as described with FIG. 29.

Then, as described with FIG. 29, the parameter frame_packing_info[i] of which the value is 0, indicates that there is no packing, the parameter frame_packing_info[i] of which the value is 1, indicates that there is Over Under Packing, and the parameter frame_packing_info[i] of which the value is 2, indicates that there is Side By Side Packing.

With FIG. 47, the middle viewpoint color image which is the 1(=i+1=0+1)st image configuring the resolution-converted multi-viewpoint color image is not packed, so the value 0 is set to the parameter frame_packing_info[0] of the middle viewpoint color image, indicating that there is no packing (frame_packing_info[0]=0).

Also, with FIG. 47, the packed color image which is the 2(=i+1=1+1)nd image configuring the resolution-converted multi-viewpoint color image is packed by Side By Side Packing, so the value 2 is set to the parameter frame_packing_info[1] of the packed color image, indicating that there is Side By Side Packing (frame_packing_info[1]=2).

As described with FIG. 29, the parameter view_id_in_frame[j] represents an index identifying an image packed in the packed color image, and is transmitted only for images configuring the resolution-converted multi-viewpoint color image where the parameter frame_packing_info[i] is not 0, i.e., for packed color images.

As described with FIG. 29, in the event that the parameter frame_packing_info[i] of the packed color image is 1, i.e., in the event that the packed color image is an image subjected to Over Under Packing where images of two viewpoints are vertically arrayed, the parameter view_id_in_frame[0] where the argument j=0 represents an index identifying, of the images subjected to Over Under Packing in the packed color image, the image situated above, and the parameter view_id_in_frame[1] where the argument j=1 represents an index identifying, of the images subjected to Over Under Packing in the packed color image, the image situated below.

Also, described with FIG. 29, in the event that the parameter frame_packing_info[i] of the packed color image is 2, i.e., in the event that the packed color image is an image subjected to Side By Side Packing where images of two viewpoints are horizontally arrayed, the parameter view_id_in_frame[0] where the argument j=0 represents an index identifying, of the images subjected to Side By Side in the packed color image, the image situated to the left, and the parameter view_id_in_frame[i] where the argument j=1 represents an index identifying, of the images subjected to Side By Side Packing in the packed color image, the image situated to the right.

With the present embodiment, the packed color image in FIG. 47 is an image where Side By Side Packing has been performed in which the left viewpoint color image is situated to the left and the right viewpoint color image is situated to the right, so the No. 0 representing viewpoint #0 of the left viewpoint color image is set to the parameter view_id_in_frame[0] of the argument j=0 representing the index identifying the image situated to the left, and the No. 2 representing viewpoint #2 of the right viewpoint color image is set to the parameter view_id_in_frame[1] of the argument j=1 representing the index identifying the image situated to the right.

[Converted Reference Image in Case that Packed Color Image has been Side By Side Packed]

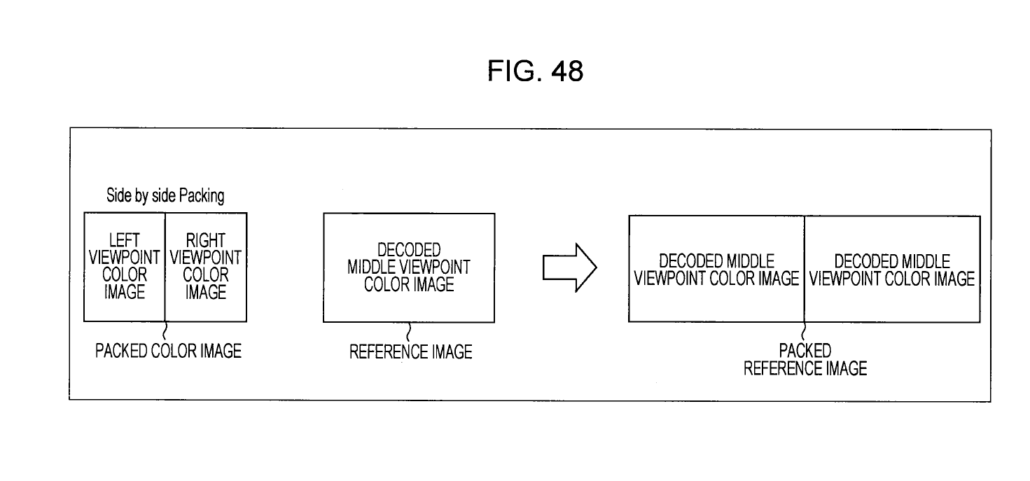

FIG. 48 is a diagram for describing packing by the packing unit 382 under control of the controller 381 in FIG. 31.

That is to say, FIG. 48 is a diagram describing packing which the packing unit 382 (FIG. 31) performs following control of the controller 381 (FIG. 31) in a case where the resolution conversion SEI described with FIG. 47 is generated at the SEI generating unit 351 in FIG. 27.

The controller 381 recognizes that the packed color image has been subjected to Side By Side Packing, from the resolution conversion SEI in FIG. 47, supplied from the SEI generating unit 351. In the event that the packed color image has been subjected to Side By Side Packing, the controller 381 controls the packing unit 382 so as t perform Side By Side Packing the same as with the packed color image.

The packing unit 382 generates a packed referenced image by performing Side By Side Packing where the decoded middle viewpoint color image serving as the reference image, and a copy thereof, are arrayed horizontally, following control of the controller 381.

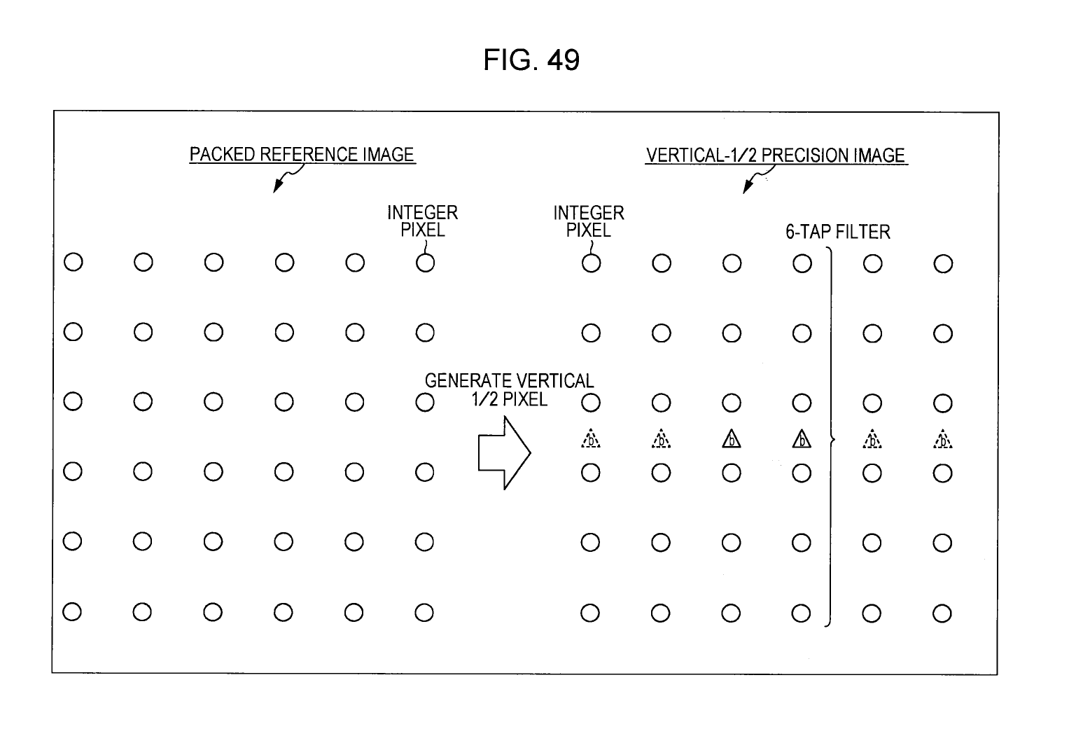

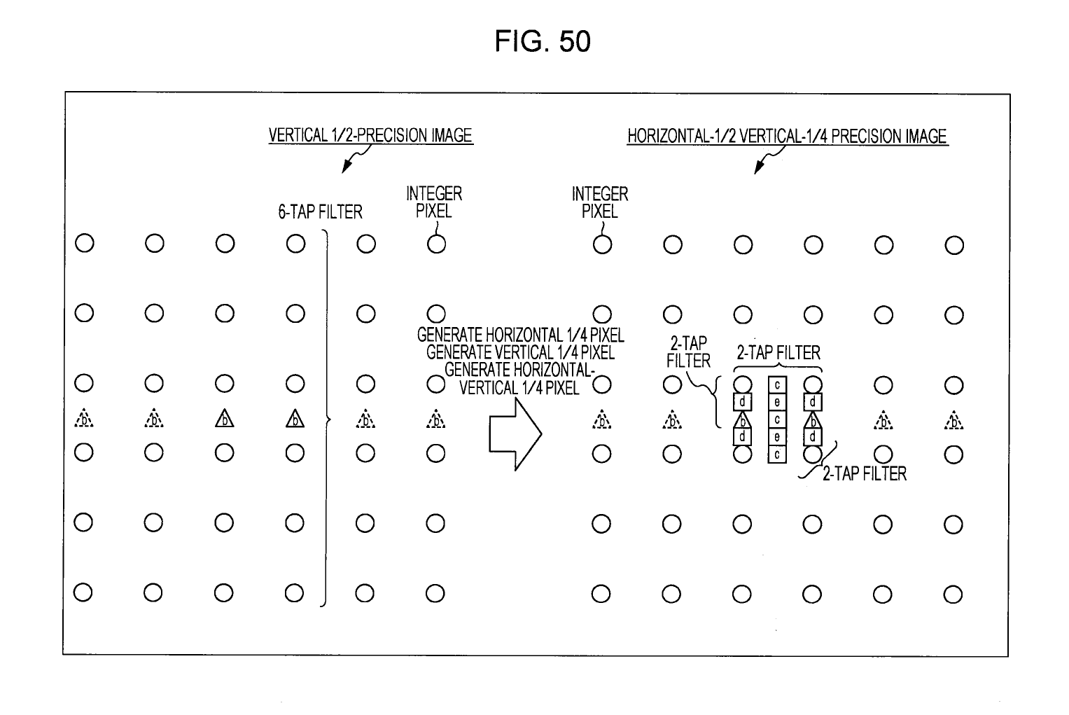

FIG. 49 and FIG. 50 are diagrams for describing filter processing by the horizontal ½-pixel generating filter processing unit 151 through horizontal-vertical ¼-pixel generating filter processing unit 155 following the control of the controller 381 in FIG. 31.

That is to say, FIG. 49 and FIG. 50 are diagrams describing filter processing which the horizontal ½-pixel generating filter processing unit 151 through horizontal-vertical ¼-pixel generating filter processing unit 155 (FIG. 31) perform following control of the controller 381 (FIG. 31) in a case where the resolution conversion SEI described with FIG. 47 is generated at the SEI generating unit 351 in FIG. 27.

Note that in FIG. 49 and FIG. 50, the circle symbols represent original pixels of the packed reference image (pixels which are not sub pels).

If we say that the horizontal and vertical intervals between the original pixels of the packed reference image (original pixels) is 1, the original pixels are integer pixels at integer positions as described with FIG. 14 and FIG. 15, and accordingly, the packed reference image is an integer precision image configured only of integer pixels.

In the event that the packed color image has been packed by Side By Side Packing, the controller 381 (FIG. 31) recognizes from the resolution conversion SEI that in the packed color image, the horizontal resolution of the left viewpoint image and the right viewpoint image configuring the packed color image has been made to be ½ of the original (of one viewpoint image).

In this case, the controller 381 controls, of the horizontal ½-pixel generating filter processing unit 151 through horizontal-vertical ¼-pixel generating filter processing unit 155, the horizontal ½-pixel generating filter processing unit 151 so as to not perform filter processing, and controls the remaining vertical ½-pixel generating filter processing unit 152 through horizontal-vertical ¼-pixel generating filter processing unit 155 so as to perform filter processing.

As a result, the horizontal ½-pixel generating filter processing unit 151 follows the control of the controller 381 and does not subject the packed reference image which is the integer precision image from the packing unit 382 to horizontal ½-pixel generating filter processing, and supplies to the vertical ½-pixel generating filter processing unit 152 without change.

The vertical ½-pixel generating filter processing unit 152 subjects the packed reference image which is an integer prediction image from the horizontal ½-pixel generating filter processing unit 151 to vertical ½-pixel generating filter processing, following the control of the controller 381.

In this case, according to the vertical ½-pixel generating filter processing, pixels serving as sub pels (vertical ½ pixels) are interpolated at coordinate positions b of which x coordinates are expressed in terms of integers, and y coordinates expressed in terms of an added value of an integer and ½, as illustrated in FIG. 49.

The vertical ½-pixel generating filter processing unit 152 supplies an image where pixels (vertical ½ pixels) have been interpolated at the position b in FIG. 49, obtained by the vertical ½-pixel generating filter processing, i.e., a vertical ½-precision image where the horizontal interval between pixels is 1 and the vertical interval is ½, to the horizontal ¼-pixel generating filter processing unit 153.

Now, the resolution ratio of the horizontally-situated reference image and the copy thereof (hereinafter also referred to as copy reference image), making up the vertical ½ precision image is 1:2 for both.

The horizontal ¼-pixel generating filter processing unit 153 subjects the vertical ½ precision image from the vertical ½-pixel generating filter processing unit 152 to horizontal ¼-pixel generating filter processing, following control of the controller 381.

In this case, the image (vertical ½ precision image) from the vertical ½-pixel generating filter processing unit 152 which is to be subjected to horizontal ¼-pixel generating filter processing has not been subjected to the horizontal ½-pixel generating filter processing by the horizontal ½-pixel generating filter processing unit 151, so according to the horizontal ¼-pixel generating filter processing, pixels serving as sub pels (horizontal ¼ pixels) are interpolated at coordinate positions c of which x coordinates are expressed in terms of an added value of an integer and ½, and y coordinates are expressed in terms of integers or an added value of an integer and ½, as illustrated in FIG. 50.

The horizontal ¼-pixel generating filter processing unit 153 supplies the image where pixels (horizontal ¼ pixels) have been interpolated at the position c in FIG. 50, obtained by the horizontal ¼-pixel generating filter processing, i.e., an image where the horizontal interval between pixels is ½ and the vertical interval is ½, to the vertical ¼-pixel generating filter processing unit 154.

The vertical ¼-pixel generating filter processing unit 154 subjects the image from the horizontal ¼-pixel generating filter processing unit 153 to vertical ¼-pixel generating filter processing, following control of the controller 381.

In this case, the image from the horizontal ¼-pixel generating filter processing unit 153 which is to be subjected to vertical ¼-pixel generating filter processing has not been subjected to horizontal ½-pixel generating filter processing by the horizontal ½-pixel generating filter processing unit 151, so according to the vertical ¼-pixel generating filter processing, pixels serving as sub pels (vertical ¼ pixels) are interpolated at coordinate positions d at which x coordinates are expressed in terms of integers, and y coordinates are expressed in terms of an added value of an integer and ¼ or an integer and −¼, as illustrated in FIG. 50.

The vertical ¼-pixel generating filter processing unit 154 supplies an image where pixels (vertical ¼ pixels) have been interpolated at positions d in FIG. 50, obtained by the vertical ¼-pixel generating filter processing, to the horizontal-vertical ¼-pixel generating filter processing unit 155.

The horizontal-vertical ¼-pixel generating filter processing unit 155 subjects the image from the vertical ¼-pixel generating filter processing unit 154 to horizontal-vertical ¼-pixel generating filter processing, following control of the controller 381.

In this case, the image from vertical ¼-pixel generating filter processing unit 154 which is to be subjected to horizontal-vertical ¼-pixel generating filter processing has not been subjected to horizontal ½-pixel generating filter processing by the horizontal ½-pixel generating filter processing unit 151, so according to the horizontal-vertical ¼-pixel generating filter processing, pixels serving as sub pels (horizontal-vertical ¼ pixels) are interpolated at coordinate positions e at which x coordinates are expressed in terms of an added value of an integer and ½, and y coordinates are expressed in terms of an added value of an integer and ¼ or an added value of an integer and −¼, as illustrated in FIG. 50.

The horizontal-vertical ¼-pixel generating filter processing unit 155 supplies the image where pixels (horizontal-vertical ¼ pixels) have been interpolated at the positions e in FIG. 50, obtained by the horizontal-vertical ¼-pixel generating filter processing, i.e., a horizontal ½ vertical ¼ precision image where the horizontal intervals between pixels are ½ and the vertical intervals ¼, to the disparity detecting unit 141 and disparity compensation unit 142 as a converted reference image.

Now, the resolution ratio of the vertically-situated reference image and copy reference image, making up the converted reference image which is a horizontal ½ vertical ¼ precision image is 1:2 for both.

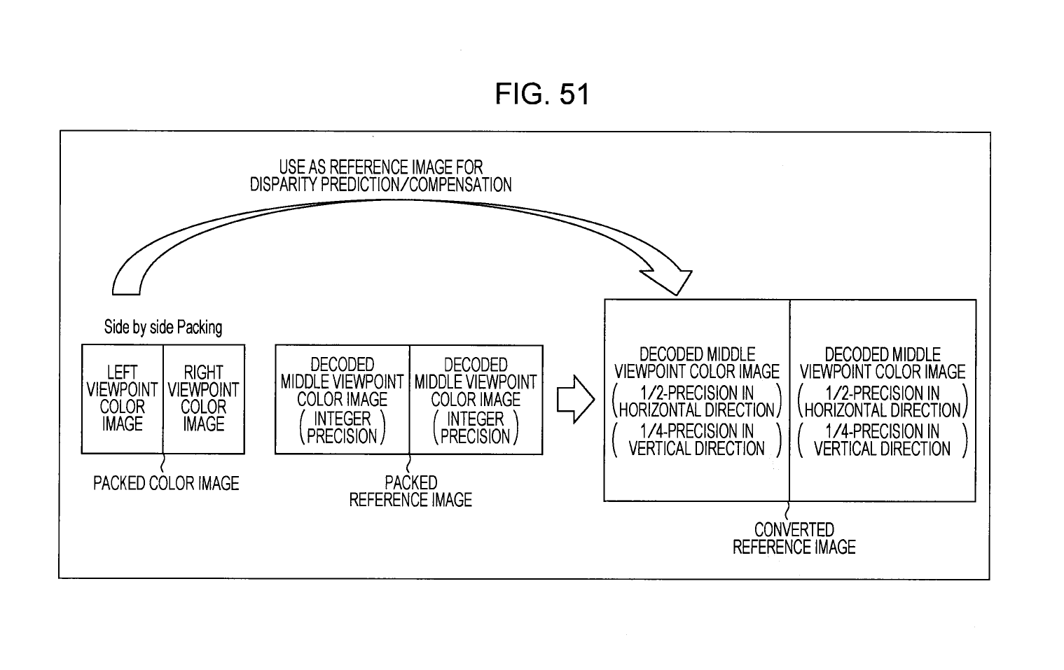

FIG. 51 illustrates a converted reference image obtained by not performing horizontal ½-pixel generating filter processing but performing vertical ½-pixel generating filter processing, horizontal ¼-pixel generating filter processing, vertical ¼-pixel generating filter processing, and horizontal-vertical ¼-pixel generating filter processing, at the reference image converting unit 370 (FIG. 31).

In a case of not performing horizontal ½-pixel generating filter processing and vertical ½-pixel generating filter processing, horizontal ¼-pixel generating filter processing, vertical ¼-pixel generating filter processing, and horizontal-vertical ¼-pixel generating filter processing, at the reference image converting unit 370, a horizontal ½ vertical ¼ precision image, of which the horizontal intervals between pixels (horizontal direction precision) is ½ and vertical intervals (vertical direction precision) is ¼ can be obtained as a converted reference image, as described with FIG. 49 and FIG. 50.

The converted reference image obtained as described above is a horizontal ½ vertical ¼ precision image where the decoded middle viewpoint image serving as the (original) reference image, and a copy thereof, have been arrayed horizontally, in the same way as with the packed color image.

On the other hand, as described with FIG. 46 for example, the packed color image obtained by Side By Side Packing is one viewpoint worth of image, where the horizontal resolution of the left viewpoint color image and right viewpoint color image have each been made to be ½, and the left viewpoint color image and right viewpoint color image of which the horizontal resolution has been made to be ½ are horizontally arrayed.

Accordingly, with the encoder 342 (FIG. 27), the resolution ratio of the packed color image (image to be encoded) which is to be encoded, and the resolution ratio of the converted reference image to be referenced at the time of generating a prediction image for the packed color image in the disparity prediction at the disparity prediction unit 361 (FIG. 30), agree (match).

That is to say, the horizontal resolution of the left viewpoint color image and right viewpoint color image arrayed horizontally is ½ that of the original, and accordingly, the resolution ratio of the left viewpoint color image and right viewpoint color image making up the packed color image is 1:2 for either.

On the other hand, the resolution ratio of the decoded middle viewpoint color image and the copy thereof arrayed horizontally is also 1:2 for either, matching the resolution ratio of 1:2 of the left viewpoint color image and right viewpoint color image making up the packed color image.

As described above, the resolution ratio of the packed color image and the resolution ratio of the converted reference image agree, so that is to say, with the packed color image the left viewpoint color image and right viewpoint color image are arrayed horizontally, and with the converted reference image the decoded middle viewpoint color image and a copy thereof are arrayed horizontally in the same way as with the packed color image, and also, the resolution ratio of the left viewpoint color image and right viewpoint color image thus arrayed horizontally in the packed image, and the resolution ratio of the decoded middle viewpoint color image and a copy thereof arrayed horizontally in the converted reference image each agree, so prediction precision of disparity prediction can be improved (the residual between the prediction image generated in disparity prediction and the current block becomes small), and encoding efficiency can be improved.

As a result, deterioration in image quality in the decoded image obtained at the reception device 12, due to resolution conversion where the base band data amount is reduced from the multi-viewpoint color image (and multi-viewpoint depth image) described above, can be prevented.

Note that in FIG. 49 through FIG. 51, a horizontal ½ vertical ¼ precision image (FIG. 49) is obtained at the reference image converting unit 370 (FIG. 31) as a converted reference image, but a vertical ½ precision image (FIG. 49) may be obtained as a converted reference image, in a case of Side By Side Packing.

A vertical ½ precision image can be obtained by performing control of the horizontal ½-pixel generating filter processing unit 151 through horizontal-vertical ¼-pixel generating filter processing unit 155 with the controller 381 of the reference image converting unit 370 (FIG. 31) such that, of the horizontal ½-pixel generating filter processing unit 151 through horizontal-vertical ¼-pixel generating filter processing unit 155, filter processing is performed only at the vertical ½-pixel generating filter processing unit 152, and filter processing is not performed at the horizontal ½-pixel generating filter processing unit 151 and the horizontal ¼-pixel generating filter processing unit 153 through horizontal-vertical ¼-pixel generating filter processing unit 155.

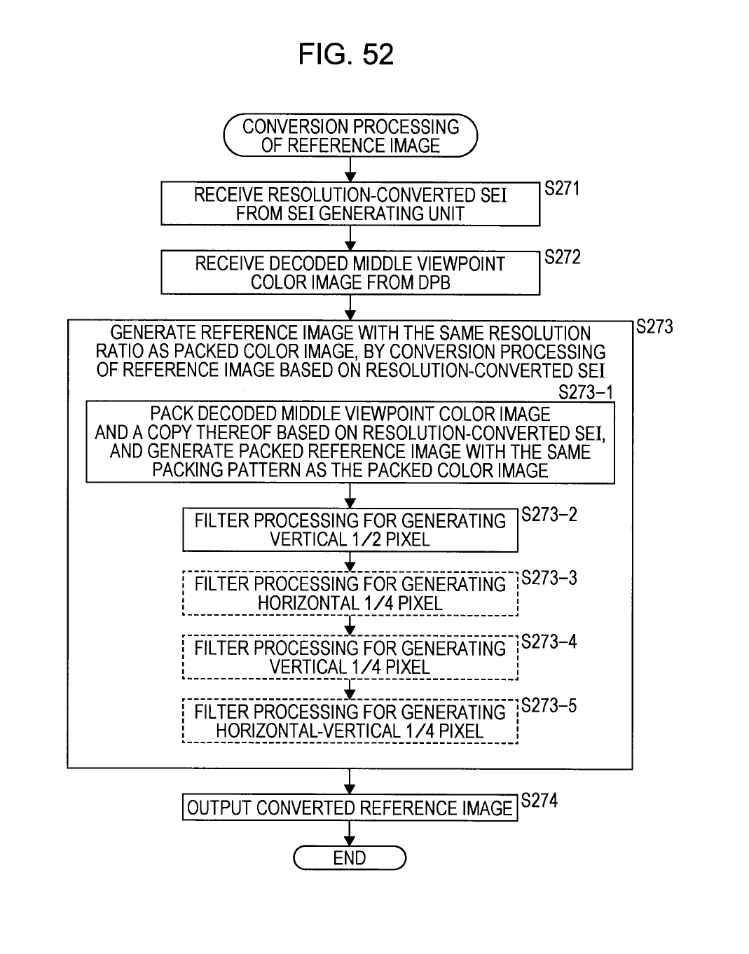

FIG. 52 is a flowchart for describing the conversion processing of a reference image which the reference image converting unit 370 in FIG. 31 performs in step S133 in FIG. 37, with a case that the packed color image has been obtained by Side By Side Packing.

In step S271, the controller 381 receives the resolution conversion SEI from the SEI generating unit 351 and the flow advances to step S272.

In step S272, the packing unit 382 receives the decoded middle viewpoint color image serving as the reference image from the DPB 43, and the flow advances to step S273.

In step S273, the controller 381 controls the filter processing of each of the horizontal ½-pixel generating filter processing unit 151 through horizontal-vertical ¼-pixel generating filter processing unit 155 and the packing of the packing unit 382, in accordance with the resolution conversion SEI from the SEI generating unit 351, and accordingly, the reference image from the DPB 43 is converted into a converted reference image of a resolution ratio matching the horizontal and vertical resolution ratio of the picture of the packed color image to be encoded.

That is to say, in step S273, in step S273-1 the packing unit 382 packs the reference image from the DPB 43 and a copy thereof, and generates a packed reference image having the same packing pattern as the packed color image to be encoded.

Now, in FIG. 52, the packing unit 382 performs packing to generate a packed reference image of the reference image from the DPB 43 and the copy thereof arrayed horizontally (Side By Side Packing).

The packing unit 382 supplies the packed reference image, which is an integer precision image, obtained by packing to the horizontal ½-pixel generating filter processing unit 151.

Under control of the controller 381, the horizontal ½-pixel generating filter processing unit 151 does not subject the packed reference image from the packing unit 382 to horizontal ½-pixel generating filter processing, and instead supplies to the vertical ½-pixel generating filter processing unit 152 as it is, and the flow advances from step S273-1 to step S273-2.

In step S273-2, the vertical ½-pixel generating filter processing unit 152 subjects the packed reference image which is an integer precision image from the horizontal ½-pixel generating filter processing unit 151, to vertical ½-pixel generating filter processing, supplies the vertical ½ precision image (FIG. 49) obtained as a result thereof to the horizontal ¼-pixel generating filter processing unit 153, and the flow advances to step S273-3.

Subsequently, the flow advances from step S273-2 to step S273-3, where the horizontal ¼-pixel generating filter processing unit 153 subjects the vertical ½ precision image from the vertical ½-pixel generating filter processing unit 152 to horizontal ¼-pixel generating filter processing, supplies the image obtained as a result thereof to the vertical ¼-pixel generating filter processing unit 154, and the flow advances to step S273-4.

In step S273-4, the vertical ¼-pixel generating filter processing unit 154 subjects the image from the horizontal ¼-pixel generating filter processing unit 153 to vertical ¼-pixel generating filter processing, supplies the image obtained as a result thereof to the horizontal-vertical ¼-pixel generating filter processing unit 155, and the flow advances to step S273-5.

In step S273-5, the horizontal-vertical ¼-pixel generating filter processing unit 155 subjects the image from the vertical ¼-pixel generating filter processing unit 154 to horizontal-vertical ¼-pixel generating filter processing, and the flow advances to step S274.

In step S274, the horizontal-vertical ¼-pixel generating filter processing unit 155 supplies the horizontal ½ vertical ¼ precision image (FIG. 50) obtained by the horizontal-vertical ¼-pixel generating filter processing to the disparity detecting unit 141 and disparity compensation unit 142 as a converted reference image, and the processing returns.

Note that with the conversion processing of the reference image in FIG. 52, the processing of steps S273-3 through S273-5 may be skipped, with the vertical ½ precision image (FIG. 49) obtained by the vertical ½-pixel generating filter processing performed by the vertical ½-pixel generating filter processing unit 151 being supplied in step S273-2 to the disparity detecting unit 141 and disparity compensation unit 142 as a converted reference image.

Also, in the event that the packed color image has been subjected to Side By Side Packing, in step S253 of the reference image conversion processing in FIG. 45 performed as step S233 in FIG. 44, processing the same as with step S273 in FIG. 27 is performed at the reference image converting unit 471 (FIG. 42) of the decoder 39 (FIG. 39).

[Case of Performing No Packing]

With FIG. 23 and FIG. 46, description has been made that the resolution of the left viewpoint color image and right viewpoint color image is made to be low resolution at the resolution converting device 321C, thereby reducing the data amount at baseband, and packing the left viewpoint color image and right viewpoint color image of which the resolution has been lowered to a packed color image of one viewpoint worth, but with the resolution converting device 321C, an arrangement may be made where only the resolution of the left viewpoint color image and right viewpoint color image is lowered, and packing is not performed.

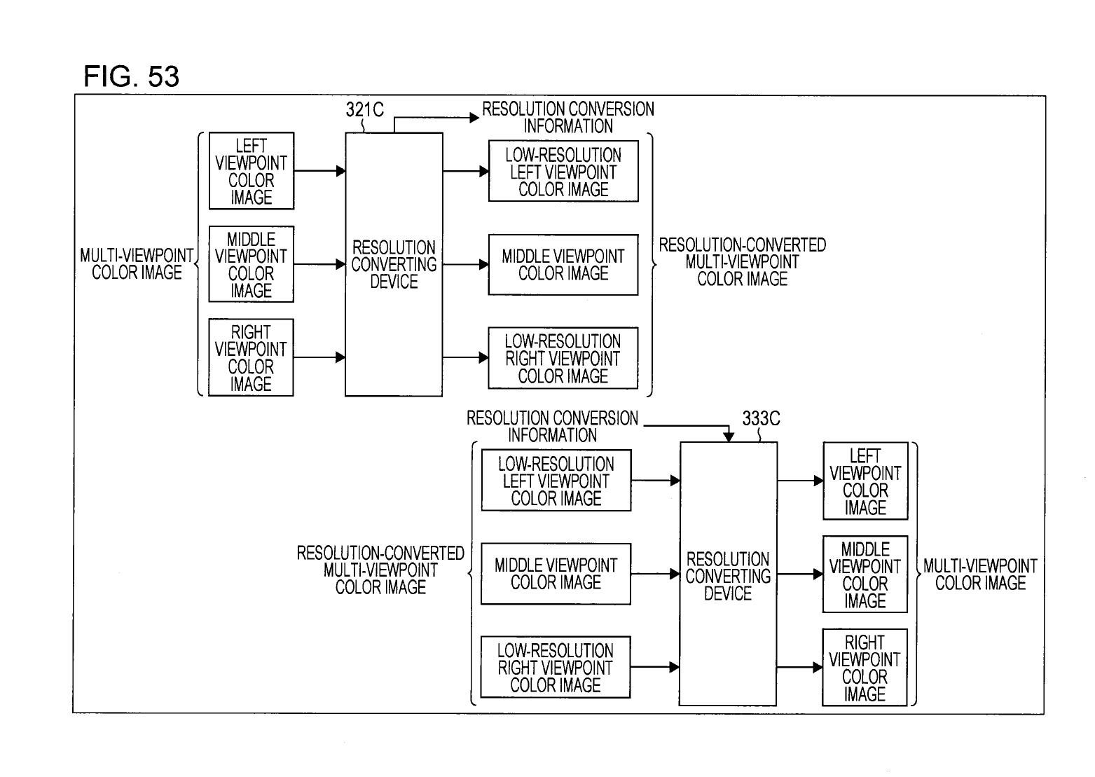

FIG. 53 is a diagram for describing resolution conversion which the resolution converting device 321C (and 321D) in FIG. 21 performs and inverse resolution conversion which the resolution inverse converting device 333C (and 333D) in FIG. 22 performs.

That is to say, FIG. 53 is a diagram for describing resolution conversion which the resolution converting device 321C (FIG. 21) performs and inverse resolution conversion which the resolution inverse converting device 333C (FIG. 22) performs in a case where only resolution reduction to reduce baseband data amount is performed at the resolution converting device 321, and no packing is performed.

In the same way as with the resolution converting device 21C in FIG. 2, for example, the resolution converting device 321C outputs, of the middle viewpoint color image, left viewpoint color image, and right viewpoint color image, which are the multi-viewpoint color image supplied thereto, the middle viewpoint color image as it is (without resolution conversion).

Also, in the same way as with the resolution converting device 21C in FIG. 2, for example, the resolution converting device 321C converts the resolution of the two viewpoint color images with regard to the remaining left viewpoint color image and right viewpoint color image of the multi-viewpoint color image, and outputs the low-resolution left viewpoint color image and right viewpoint color image (hereinafter, also referred to as low-resolution left viewpoint color image and low-resolution right viewpoint color image) obtained as a result thereof, without packing.

That is to say, the resolution converting device 321C changes the vertical resolution (number of pixels) of each of the left viewpoint color image and right viewpoint color image to ½, and outputs the low-resolution left viewpoint color image and low-resolution right viewpoint color image which are the left viewpoint color image and right viewpoint color image of which the vertical direction resolution (vertical resolution) has been made to be ½, without packing.

The middle viewpoint color image, low-resolution left viewpoint color image, and low-resolution right viewpoint color image, which the resolution converting device 321C outputs, are supplied to the encoding device 322C (FIG. 21) as a resolution-converted multi-viewpoint color image.

Now, the resolution converting device 321C may change the horizontal resolution of the left viewpoint color image and right viewpoint color image to ½, rather than the vertical resolution thereof.

The resolution converting device 321C further generates resolution conversion information to the effect that the middle viewpoint color image is of the original resolution, and that the low-resolution left viewpoint color image and low-resolution right viewpoint color image are images of which the vertical resolution (or horizontal resolution) has been made to be ½ (the original), and outputs this.

On the other hand, the resolution inverse converting device 333C recognizes, from the resolution conversion information supplied thereto, the indication that the middle viewpoint color image is of the original resolution, and the indication that the low-resolution left viewpoint color image and low-resolution right viewpoint color image are images of which the vertical resolution has been made to be ½.

Based on the information recognized from the resolution conversion information, the resolution inverse converting device 333C outputs, of the middle viewpoint color image, low-resolution left viewpoint color image, and low-resolution right viewpoint color image, which are the resolution-converted multi-viewpoint color image supplied thereto, the middle viewpoint color image as it is.

Also, based on the information recognized from the resolution conversion information, the resolution inverse converting device 333C returns, of the middle viewpoint color image, low-resolution left viewpoint color image, and low-resolution right viewpoint color image supplied thereto, the vertical resolution of the low-resolution left viewpoint color image and low-resolution right viewpoint color image to the original resolution by interpolation or the like, and outputs.

Note that the multi-viewpoint color image (and multi-viewpoint depth image) may be an image of four viewpoints or more.

Also, while FIG. 53 illustrates changing the vertical resolution of the left viewpoint color image and right viewpoint color image, out of the middle viewpoint color image, left viewpoint color image, and right viewpoint color image which are the multi-viewpoint color image, to low resolution, the resolution converting device 321C can perform resolution conversion of just one image or all images of the middle viewpoint color image, left viewpoint color image, and right viewpoint color image, to lower resolution, and the resolution inverse converting device 333C can perform inverse resolution conversion to return the resolution conversion at the resolution converting device 321C to the original.

[Configuration Example of Encoding Device 322C]

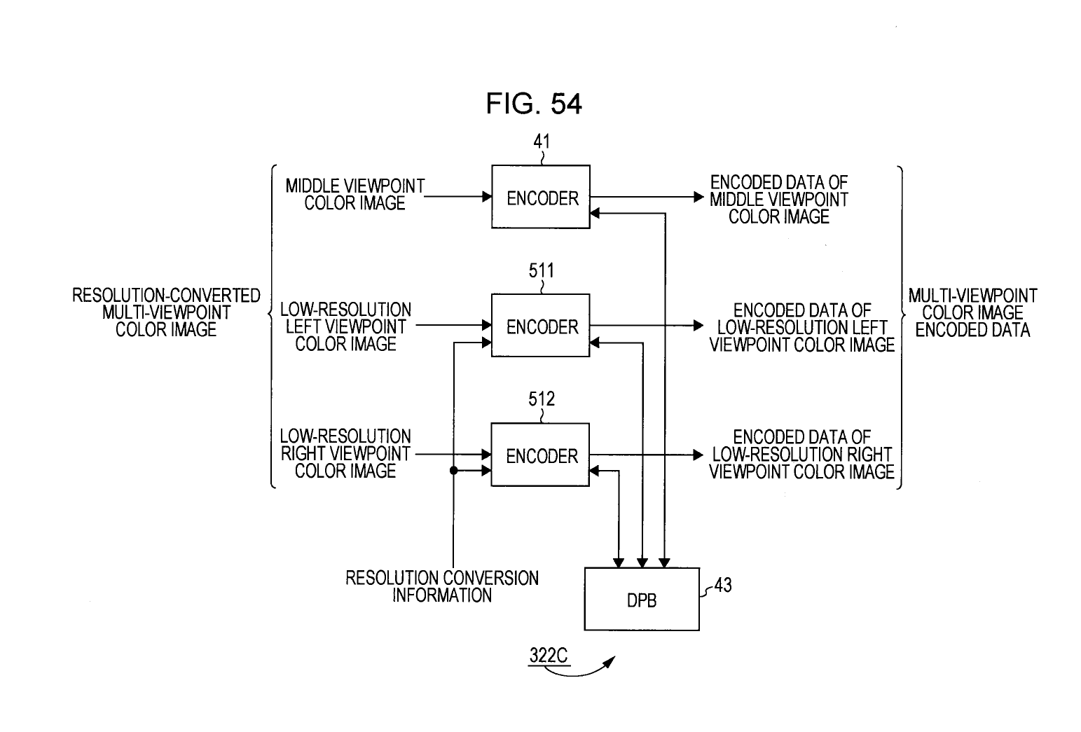

FIG. 54 is a block diagram illustrating a configuration example of the encoding device 322C in FIG. 21, in a case where the resolution-converted multi-viewpoint color image is the middle viewpoint color image, low-resolution left viewpoint color image, and low-resolution right viewpoint color image described with FIG. 53.

Note that portions corresponding to the case in FIG. 26 are denoted with the same symbols, and description hereinafter will be omitted as appropriate.

In FIG. 54, the encoding device 322C has the encoder 41, DPB 43, and encoders 511 and 512.

Accordingly, the encoding device 322C in FIG. 54 has in common with the case in FIG. 26 the point of having the encoder 41 and DPB 43, and differs from the encoding device 322C in FIG. 26 in that the encoder 342 has been replaced by the encoders 511 and 512.

The encoder 41 is supplied with, of the middle viewpoint color image, low-resolution left viewpoint color image, and low-resolution right viewpoint color image, configuring the resolution-converted multi-viewpoint color image, from the resolution converting device 321C, the middle viewpoint color image.

The encoder 511 is supplied with, of the middle viewpoint color image, low-resolution left viewpoint color image, and low-resolution right viewpoint color image, configuring the resolution-converted multi-viewpoint color image from the resolution converting device 321C, the low-resolution left viewpoint color image.

The encoder 512 is supplied with, of the middle viewpoint color image, low-resolution left viewpoint color image, and low-resolution right viewpoint color image, configuring the resolution-converted multi-viewpoint color image from the resolution converting device 321C, the low-resolution right viewpoint color image.

The encoders 511 and 512 are further supplied with resolution conversion information from the resolution converting device 321C.

The encoder 41 takes the middle viewpoint color image as the base view image and encodes by MVC (AVC), and outputs encoded data of the middle viewpoint color image obtained as a result thereof, as described with FIG. 5 and FIG. 26.

The encoder 511 takes the low-resolution left viewpoint color image as a non base view image and encodes by an extended format, based on the resolution conversion information, and outputs encoded data of the low-resolution left viewpoint color image obtained as a result thereof.

The encoder 512 takes the low-resolution right viewpoint color image as a non base view image and encodes by an extended format, based on the resolution conversion information, and outputs encoded data of the low-resolution right viewpoint color image obtained as a result thereof.

Now, the encoder 512 performs the same processing as with the encoder 511, except that the object of processing thereof is the low-resolution right viewpoint color image instead of the low-resolution left viewpoint color image, so description thereof will be omitted hereinafter as appropriate.

The encoded data of the middle viewpoint color image output from the encoder 41, the encoded data of the low-resolution left viewpoint color image output from the encoding 511, and the encoded data of the low-resolution right viewpoint color image output from the encoding 512, are supplied to the multiplexing device 23 (FIG. 21) as multi-viewpoint color image encoded data.

Now, in FIG. 54, the DPB 43 is shared by the encoders 41 and 511 and 512.

That is to say, the encoders 41 and 511 and 512 perform prediction encoding of the image to be encoded. Accordingly, in order to generate a prediction image to be used for prediction encoding, the encoders 41, 511, and 512 encode the image to be encoded, and thereafter perform local decoding, thereby obtaining a decoded image.

The DPB 43 temporarily stores decoded images obtained from each of the encoders 41 and 511 and 512.

The encoders 41 and 511 and 512 each select reference images to reference when encoding images to encode, from decoded images stored in the DPB 43. The encoders 41 and 511 and 512 then each generate prediction images using reference images, and perform image encoding (prediction encoding) using these prediction images.

Accordingly, each of the encoders 41 and 511 and 512 can reference, in addition to decoded images obtained at itself, decoded images obtained at the other encoders.

[Configuration Example of Encoder 511]

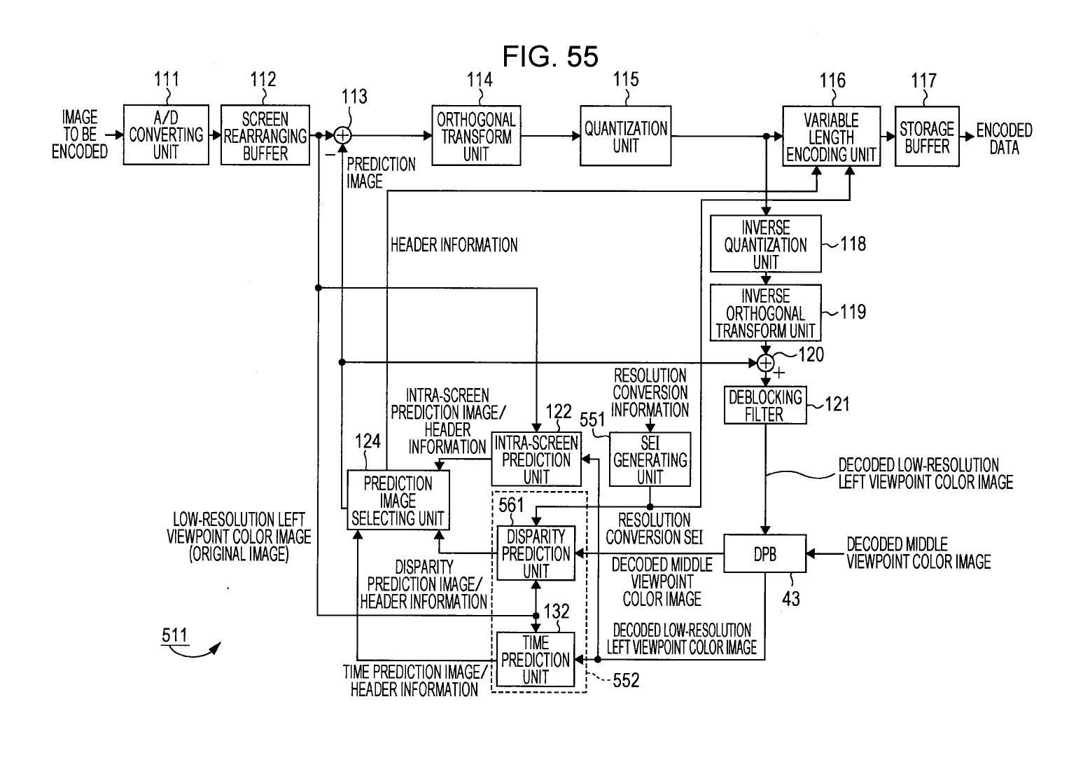

FIG. 55 is a block diagram illustrating a configuration example of the encoder 511 in FIG. 54.

Note that portions in the drawing corresponding to the case in FIG. 27 are denoted with the same symbols, and description hereinafter will be omitted as appropriate.

In FIG. 55, the encoder 511 has the A/D converting unit 111, screen rearranging buffer 112, computing unit 113, orthogonal transform unit 114, quantization unit 115, variable length encoding unit 116, storage buffer 117, inverse quantization unit 118, inverse orthogonal transform unit 119, computing unit 120, deblocking filter 121, intra-screen prediction unit 122, a prediction image selecting unit 124, a SEI generating unit 551, and an inter prediction unit 552.

Accordingly, the encoder 511 has in common with the encoder 342 in FIG. 27 the point of having the A/D converting unit 111 through the intra-screen prediction unit 122 and the prediction image selecting unit 124.

Note however, the encoder 511 differs from the encoder 342 in FIG. 27 with regard to the point that the SEI generating unit 551 and inter prediction unit 552 have been provided instead of the SEI generating unit 351 and inter prediction unit 352.

The SEI generating unit 511 is supplied with the resolution conversion information regarding the resolution-converted multi-viewpoint color image from the resolution converting device 321C (FIG. 21).

The SEI generating unit 551 converts the format of the resolution conversion information supplied thereto into a SEI format according to MVC (AVC), and outputs the resolution conversion SEI obtained as a result thereof.

The resolution conversion SEI which the SEI generating unit 551 outputs is supplied to the variable length encoding unit 116 and (a disparity prediction unit 561 of) the inter prediction unit 552.

At the variable length encoding unit 116, the resolution conversion SEI from the SEI generating unit 551 is transmitted included in the encoded data.

The inter prediction unit 552 includes the temporal prediction unit 132 and disparity prediction unit 561.

Accordingly, the inter prediction unit 552 has in common with the inter prediction unit 352 in FIG. 27 the point of having the temporal prediction unit 132, and differs with the inter prediction unit 352 in FIG. 27 with regard to the point that the disparity prediction unit 561 has been provided instead of the disparity prediction unit 361.

The disparity prediction unit 561 is supplied with the current picture of the low-resolution left viewpoint color image from the screen rearranging buffer 112.

In the same way as with the disparity prediction unit 361 in FIG. 27, the disparity prediction unit 561 performs disparity prediction of the current block of the current picture of the low-resolution left viewpoint color image from the screen rearranging buffer 112, using the picture of the decoded middle viewpoint color image stored in the DPB 43 (picture of same point-in-time as current picture) as a reference image, and generates a prediction image of the current block.

The disparity prediction unit 561 then supplies the prediction image to the prediction image selecting unit 124 along with header information such as residual vector and so forth.

Also, the disparity prediction unit 561 is supplied with the resolution conversion SEI from the SEI generating unit 551.

The disparity prediction unit 561 controls the filter processing to be applied to the picture of the decoded middle viewpoint color image serving as a reference image to be referenced in the disparity prediction, in accordance with the resolution conversion SEI from the SEI generating unit 551.

That is to say, as described above, when subjecting a reference image to filter processing where pixels are interpolated, with MVC there is a stipulation that filter processing is to be performed such that the number of pixels in the horizontal direction and vertical direction are to be increased by the same multiple, so at the disparity prediction unit 561, the filter processing to be applied to the picture of the decoded middle viewpoint color image serving as a reference image to be referenced in the disparity prediction is controlled in accordance with the resolution conversion SEI from the SEI generating unit 551, and accordingly the reference image is converted into a converted reference image of a resolution ratio matching the horizontal and vertical resolution ratio of the picture of the low-resolution left viewpoint color image to be encoded (the ratio of the number or horizontal pixels and the number of vertical pixels).

Note that, in the event that a picture of a low-resolution right viewpoint color image at the same point-in-time as the low-resolution left viewpoint color image which is to be encoded by the encoder 511, has been already encoded with the encoder 512 (FIG. 54) encoding the low-resolution right viewpoint color image and locally decoded, before the current picture, and the picture of the decoded low-resolution right viewpoint color image obtained as a result thereof is stored in the DPB 43, the disparity prediction unit 561 of the encoder 511 encoding the low-resolution left viewpoint color image can use, for disparity prediction, the picture of the decoded low-resolution right viewpoint color image stored in the DPB 43 (the picture at the same point-in-time as the current picture), as a reference image, besides the picture of the decoded middle viewpoint color image.

[Resolution Conversion SEI]

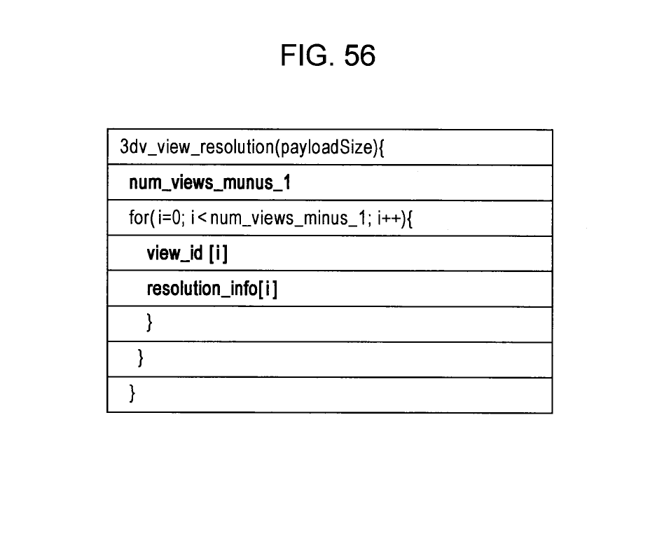

FIG. 56 is a diagram for describing the resolution conversion SEI generated at the SEI generating unit 551 in FIG. 55.

That is to say, FIG. 56 is a diagram illustrating an example of the syntax (syntax) of 3dv_view_resolution(payloadSize) serving as the resolution conversion SEI, in a case that the resolution converting device 321C performs only reduction in resolution and does not perform packing, as described with FIG. 53.

In FIG. 56, the 3dv_view_resolution(payloadSize) serving as the resolution conversion SEI has parameters num_views_minus_{—}1, view_id[i], and resolution_info[i].

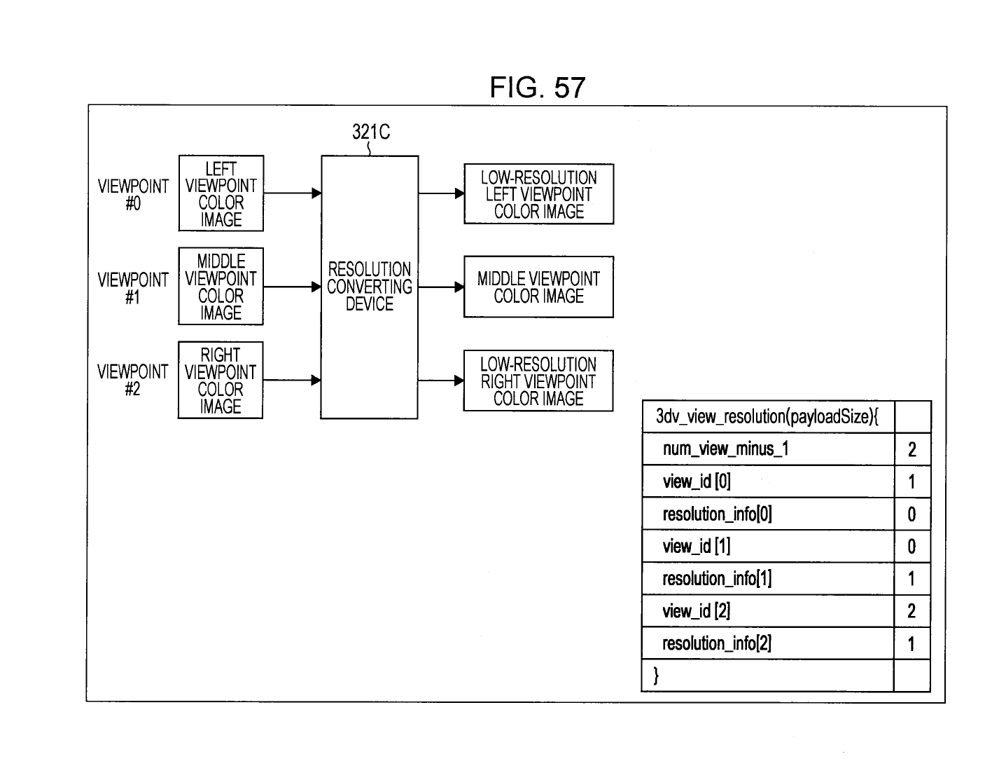

FIG. 57 is a diagram for describing values set to the resolution conversion SEI parameters num_views_minus_{—}1, view_id[i], and resolution_info[i], generated from the resolution conversion information regarding the resolution-converted multi-viewpoint color image at the SEI generating unit 551 (FIG. 55).

In the same way as with the case in FIG. 29, the parameter num_views_minus_{—}1 represents a value obtained by subtracting 1 from the number of viewpoints making up the resolution-converted multi-viewpoint color image.

With FIG. 57, the resolution-converted multi-viewpoint color image is an image of three viewpoints, of the middle viewpoint color image, low-resolution left viewpoint color image, and low-resolution right viewpoint color image, so num_views_minus_{—}1=3−1=2 is set to the parameter num_views_minus_{—}1.

In the same way as with the case in FIG. 29, the parameter view_id[i] indicates an index identifying the i+1'th (i=0, 1, . . . ) image making up the resolution-converted multi-viewpoint color image.

That is, let us say that here, for example, in the same way as with the case in FIG. 29, the left viewpoint color image is an image of viewpoint #0 represented by No. 0, the middle viewpoint color image is an image of viewpoint #1 represented by No. 1, and the right viewpoint color image is an image of viewpoint #2 represented by No. 2.

Also, let is say that at the resolution converting device 321C, the Nos. representing viewpoints are not reassigned regarding the middle viewpoint color image, low-resolution left viewpoint color image, and low-resolution right viewpoint color image, making up the resolution-converted multi-viewpoint color image obtained by performing resolution conversion on the middle viewpoint color image, left viewpoint color image, and right viewpoint color image, such as has been described with FIG. 29.

Further, let us say that the middle viewpoint color image is the 1st image configuring the resolution-converted multi-viewpoint color image (image of i=0), that the low-resolution left viewpoint color image is the 2nd image configuring the resolution-converted multi-viewpoint color image (image of i=1), and that the low-resolution right viewpoint color image is the 3rd image configuring the resolution-converted multi-viewpoint color image (image of i=2).

In this case, the parameter view_id[0] of the middle viewpoint color image which is the 1(=i+1=0+1)st image configuring the resolution-converted multi-viewpoint color image has the No. 1 representing viewpoint #1 of the middle viewpoint color image set (view_id[0]=1).

Also, the parameter view_id[1] of the low-resolution left viewpoint color image which is the 2(=i+1=1+1)nd image configuring the resolution-converted multi-viewpoint color image has the No. 0 representing viewpoint #0 of the low-resolution left viewpoint color image set (view_id[1]=0).

Further, the view_id[2] of the low-resolution right viewpoint color image which is the 3(=i+1=2+1)rd image configuring the resolution-converted multi-viewpoint color image has the No. 2 representing viewpoint #2 of the low-resolution left viewpoint color image set (view_id[2]=2).

The parameter resolution_info[i] represents whether or not there is reduction in resolution of the i+1'th image making up the resolution-converted multi-viewpoint color image, and the pattern of resolution reduction (resolution reduction pattern).

Here, the parameter resolution_info[i] of which the value is 0 represents that the resolution is not reduced.

Also, the parameter resolution_info[i] of other than 0, for example 1 or 2, represents that the resolution is reduced.

The parameter resolution_info[i] of which the value is 1 further represents that the vertical resolution has been reduced to ½ the (original) resolution, and the parameter resolution_info[i] of which the value is 2 represents that the horizontal resolution has been reduced to ½ the resolution.

In FIG. 57, the resolution has not been reduced for the middle viewpoint color image which is the 1(=i+1=0+1)'th image making up the resolution-converted multi-viewpoint color image, so 0 is set to the parameter resolution_info[0] of the middle viewpoint color image, indicating that resolution has not been reduced (resolution_info[0]=0).

Also, in FIG. 57, the vertical resolution has been reduced to ½ for the low-resolution left viewpoint color image which is the 2(=i+1=1+1)nd image making up the resolution-converted multi-viewpoint color image, so 1 is set to the parameter resolution_info[i] of the low-resolution left viewpoint color image, indicating that the vertical resolution has been reduced to ½ (resolution_info[1]=1).

Further, in FIG. 57, the vertical resolution has been reduced to ½ for the low-resolution right viewpoint color image which is the 3(=i+1=2+1)rd image making up the resolution-converted multi-viewpoint color image, so 1 is set to the parameter resolution_info[2] of the low-resolution right viewpoint color image, indicating that the vertical resolution has been reduced to ½ (resolution_info[2]=1).

[Configuration Example of Disparity Prediction Unit 361]

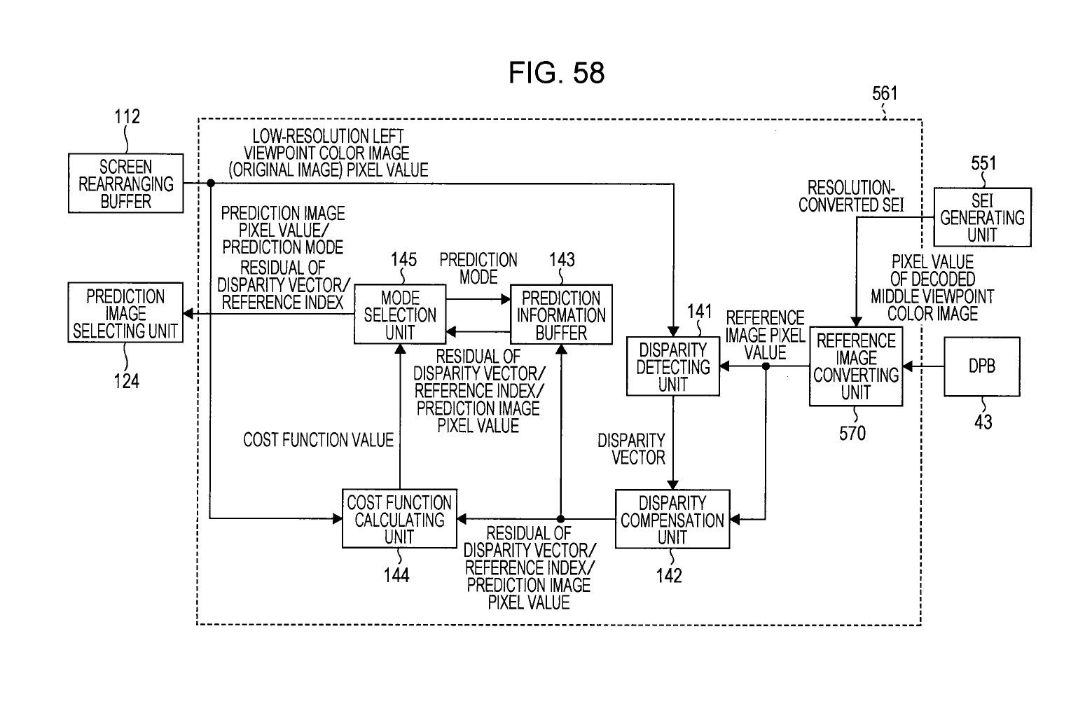

FIG. 58 is a block diagram illustrating a configuration example of the disparity prediction unit 561 in FIG. 55.

Note that portions in the drawing corresponding to the case in FIG. 30 are denoted with the same symbols, and description hereinafter will be omitted as appropriate.

In FIG. 58, the disparity prediction unit 531 has the disparity detecting unit 141, disparity compensation unit 142, prediction information buffer 143, cost function calculating unit 144, mode selecting unit 145, and a reference image converting unit 570.

Accordingly, the disparity prediction unit 561 in FIG. 58 has in common with the disparity prediction unit 361 in FIG. 30 the point of having the disparity detecting unit 141 through mode selecting unit 145.

However, the disparity prediction unit 561 in FIG. 58 differs from the disparity prediction unit 361 in FIG. 30 with regard to the point that the reference image converting unit 370 has been replaced with the reference image converting unit 570.

The reference image converting unit 570 is supplied with the picture of the decoded middle viewpoint color image as a reference image from the DPB 43, and also is supplied with the resolution conversion SEI from the SEI generating unit 551.

The reference image converting unit 570 controls the filter processing to be applied to the picture of the decoded middle viewpoint color image serving as a reference image to be referenced in the disparity prediction, in accordance with the resolution conversion SEI from the SEI generating unit 551, and accordingly the reference image is converted into a converted reference image of a resolution ratio matching the horizontal and vertical resolution ratio of the picture of the low-resolution left viewpoint color image to be encoded, and supplied to the disparity detecting unit 141 and disparity compensation unit 142.

[Configuration Example of Reference Image Converting Unit 570]

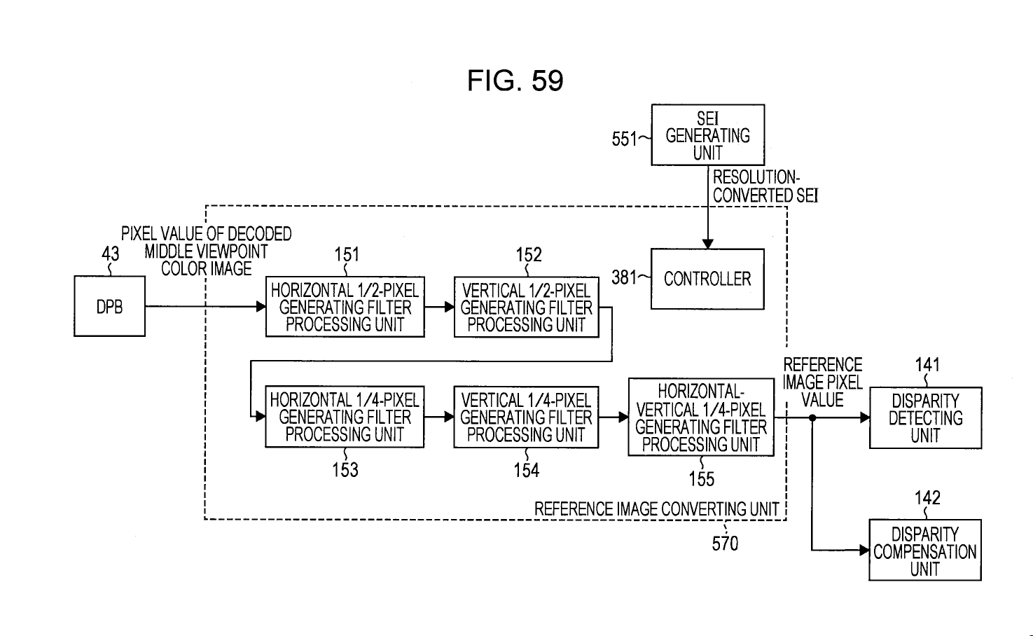

FIG. 59 is a block diagram illustrating a configuration example of the reference image converting unit 570 in FIG. 58.

Note that portions in the drawing corresponding to the case in FIG. 31 are denoted with the same symbols, and description hereinafter will be omitted as appropriate.

In FIG. 59, the reference image converting unit 570 has the horizontal ½-pixel generating filter processing unit 151, vertical ½-pixel generating filter processing unit 152, horizontal ¼-pixel generating filter processing unit 153, vertical ¼-pixel generating filter processing unit 154, horizontal-vertical ¼-pixel generating filter processing unit 155, and the controller 381.

Accordingly, the reference image converting unit 570 in FIG. 59 has in common with the reference image converting unit 370 in FIG. 31 the point of having the horizontal ½-pixel generating filter processing unit 151 through horizontal-vertical ¼-pixel generating filter processing unit 155 and the reference image converting unit 370.

However, the reference image converting unit 570 in FIG. 59 differs from the reference image converting unit 370 in FIG. 31 with regard to the point that the packing unit 382 is not provided.

With the reference image converting unit 570 in FIG. 59, the controller 381 controls the filter processing of the horizontal ½-pixel generating filter processing unit 151 through horizontal-vertical ¼-pixel generating filter processing unit 155 in accordance with the resolution conversion SEI from the SEI generating unit 551.

The horizontal ½-pixel generating filter processing unit 151 through horizontal-vertical ¼-pixel generating filter processing unit 155 then follow the control of the controller 381 to subject the decoded middle viewpoint color image supplied from the DPB 43, serving as a reference image, to filter processing, and supplies the converted reference image obtained as a result thereof to the disparity detecting unit 141 and disparity compensation unit 142.

[Encoding Processing of Low-Resolution Left Viewpoint Color Image]

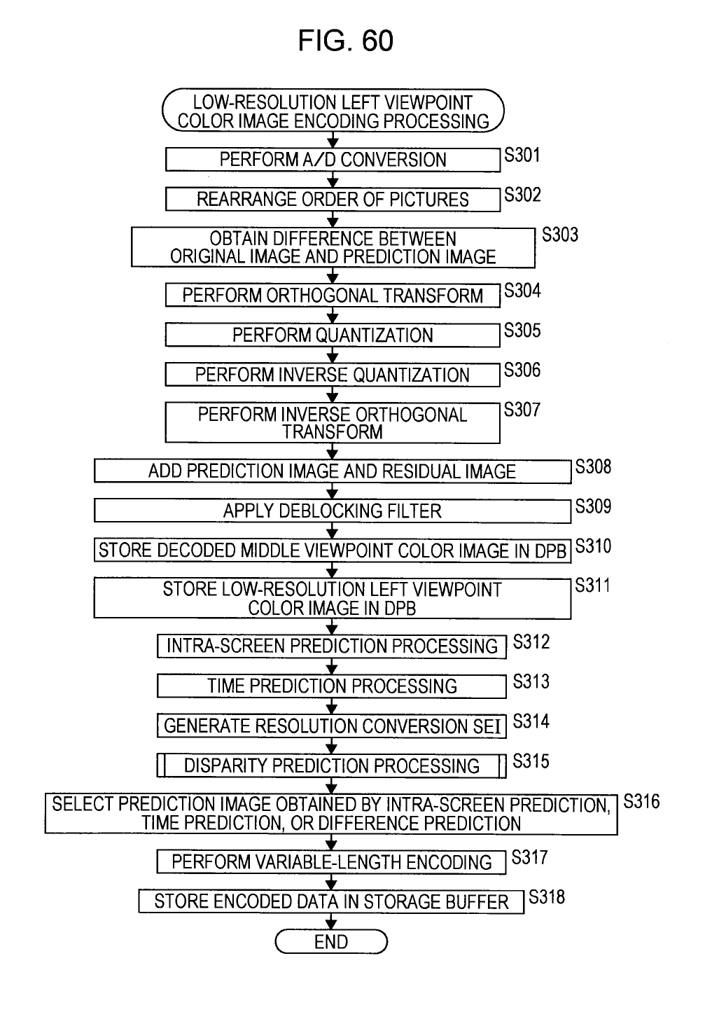

FIG. 60 is a flowchart for describing the encoding processing to encode the low-resolution left viewpoint color image, which the encoder 511 in FIG. 55 performs.

In steps S301 through S309, processing the same as with steps S101 through S109 in FIG. 36 is performed, and accordingly, the decoded current block of the low-resolution left viewpoint color image obtained by decoding (locally decoding) the current block of the low-resolution left viewpoint color image is filtered at the deblocking filter 121, and supplied to the DPB 43.

Thereafter, the flow advances to step S310, where the DPB 43 awaits supply of a decoded middle viewpoint color image obtained by encoding and locally decoding the middle viewpoint color image, from the encoder 41 (FIG. 54) which encodes the middle viewpoint color image, stores the decoded middle viewpoint color image, and the flow advances to step S311.

In step S311, the DPB 43 stores the decoded low-resolution left viewpoint color image from the deblocking filter 121, and the flow advances to step S312.

In step S312 the intra-screen prediction unit 122 performs intra prediction processing (intra-screen prediction processing) for the next current block.

That is to say, the intra-screen prediction unit 122 performs intra prediction processing (intra-screen prediction processing) to generate a prediction image (intra-predicted prediction image) from the picture of the decoded low-resolution left viewpoint color image stored in the DPB 43, for the next current block.

The intra-screen prediction unit 122 then uses the intra-predicted prediction image to obtain the encoding costs needed to encode the next current block, supplies this to the prediction image selecting unit 124 along with (information relating to intra-prediction serving as) header information and the intra-predicted prediction image, and the flow advances from step S312 to step S313.

In step S313, the temporal prediction unit 132 performs temporal prediction processing regarding the next current block, with the picture of the decoded low-resolution left viewpoint color image (the picture encoded and locally decoded before the current picture) as a reference image.

That is to say, the temporal prediction unit 132 uses the decoded low-resolution left viewpoint color image stored in the DPB 43 to perform temporal prediction regarding the next current block, thereby obtaining prediction image, encoding cost, and so forth, for each inter prediction mode with different macroblock type and so forth.

Further, the temporal prediction unit 132 takes the inter prediction mode of which the encoding cost is the smallest as being the optimal inter prediction mode, supplies the prediction image of that optimal prediction mode to the prediction image selecting unit 124 along with (information relating to intra-prediction serving as) header information and the encoding cost, and the flow advances from step S313 to step S314.

In step S314, the SEI generating unit 551 generates the resolution conversion SEI described with FIG. 56 and FIG. 57, supplies this to the variable length encoding unit 116 and disparity prediction unit 561, and the processing advances to step S315.

In step S315, the disparity prediction unit 561 performs disparity prediction information of the next current block, with the decoded middle viewpoint color image (picture at the same point-in-time as the current picture) as a reference image.

That is to say, the disparity prediction unit 561 takes the picture of the decoded middle viewpoint color image stored in the DPB 43 as a reference image, and converts that reference image into a converted reference image, in accordance to the resolution conversion information SET from the SEI generating unit 551.

Further, the disparity prediction unit 561 performs disparity prediction for the next current block using the converted reference image, thereby obtaining a prediction image, encoding cost, and so forth, for each inter prediction mode of which the macroblock type and so forth differ.

Further, the disparity prediction unit 561 takes the inter prediction mode of which the encoding cost is the smallest as the optimal inter prediction mode, supplies the prediction image of that optimal inter prediction mode to the prediction image selecting unit 124 along with (information relating to inter prediction serving as) header information and the encoding cost, and the flow advances from step S315 to step S316.

In step S316, the prediction image selecting unit 124 selects, from the prediction image from the intra-screen prediction unit 122 (intra-predicted prediction image), prediction image from the temporal prediction unit 132 (temporal prediction image), and prediction image from the disparity prediction unit 561 (disparity prediction image), the prediction image of which the encoding cost is the smallest for example, supplies this to the computing units 113 and 220, and the flow advances to step S317.

Now, the prediction image which the prediction image selecting unit 124 selects in step S316 is used in the processing of steps S303 and S308 performed for encoding of the next current block.

Also, the prediction image selecting unit 124 selects, of the header information supplied from the intra-screen prediction unit 122, temporal prediction unit 132, and disparity prediction unit 561, the header information supplied along with the prediction image of which the encoding cost is the smallest, and supplies to the variable length encoding unit 116.

In step S317, the variable length encoding unit 116 subjects the quantization values from the quantization unit 115 to variable-length encoding, and obtains encoded data.

Further, the variable length encoding unit 116 includes the header information from the prediction image selecting unit 124 and the resolution conversion SEI from the SEI generating unit 551, in the header of the encoded data.

The variable length encoding unit 116 then supplies the encoded data to the storage buffer 117, and the flow advances from step S317 to step S318.

In step S318, the storage buffer 117 temporarily stores the encoded data from the variable length encoding unit 116.

The encoded data stored at the storage buffer 117 is supplied (transmitted) to the multiplexing device 23 (FIG. 21) at a predetermined transmission rate.

The processing of steps S301 through S318 above is repeatedly performed as appropriate at the encoder 511.

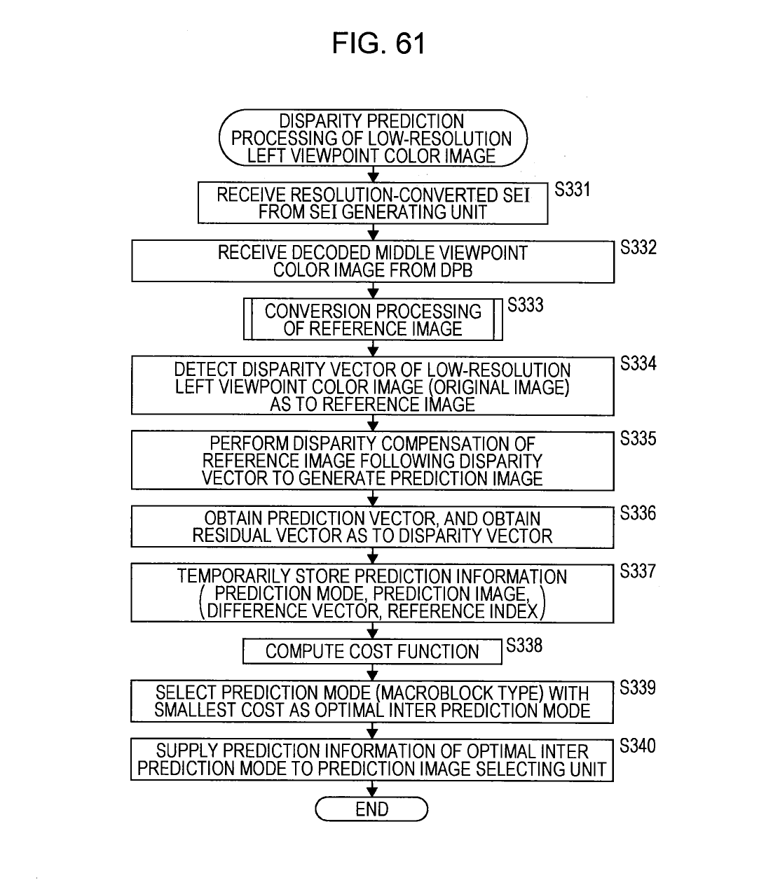

FIG. 61 is a flowchart for describing disparity prediction processing which the disparity prediction unit 561 in FIG. 58 performs in step S315 in FIG. 60.

In step S331, the reference image converting unit 570 receives the resolution conversion SEI supplied from the SEI generating unit 551, and the flow advances to step S332.

In step S332, the reference image converting unit 570 receives the picture of the decoded middle viewpoint color image serving as the reference image from the DPB 43, and the flow advances to step S333.

In step S333, the reference image converting unit 570 controls filter processing to be performed on the picture of the decoded middle viewpoint color image serving as the reference image from the DPB 43, in accordance with the resolution conversion SEI from the SEI generating unit 551, and accordingly performs conversion processing of the reference image to convert the reference image into a converted reference image of which the resolution ratio matches the horizontal and vertical resolution ratio of the picture of the low-resolution left viewpoint color image to be encoded.

The reference image converting unit 570 then supplies the converted reference image obtained by performing conversion processing of the reference image, to the disparity detecting unit 141 and disparity compensation unit 142, and the flow advances from step S333 to step S334.

In step S334 through step S340, processing the same as each of step S134 through S140 in FIG. 37 is performed.

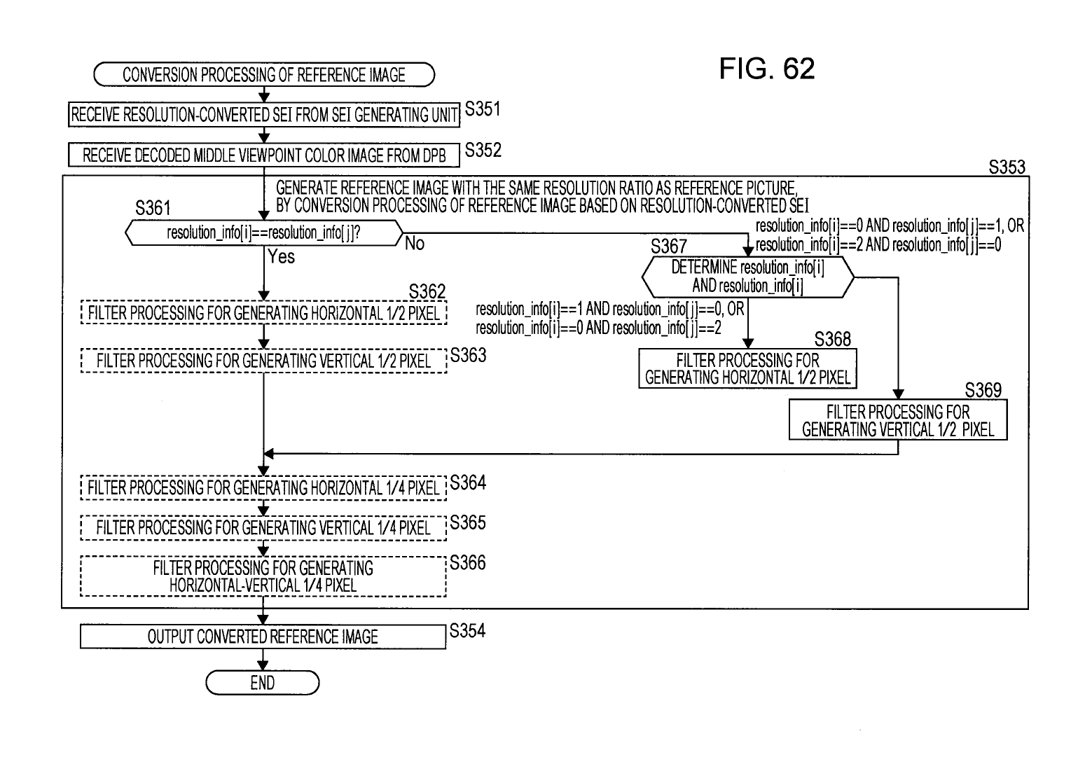

FIG. 62 is a flowchart for describing the conversion processing of a reference image which the reference image converting unit 570 in FIG. 59 performs in step S333 in FIG. 61.

Now, description has been made so far that the disparity prediction unit 561 (FIG. 55) performs disparity prediction of a low-resolution left viewpoint color image to be encoded at the encoder 511, where the vertical resolution of the left viewpoint color image has been reduced to ½ resolution, using the (decoded) middle viewpoint color image of which the resolution has not been reduced as a reference image, in order to facilitate description, but an arrangement may be made where disparity prediction of the low-resolution left viewpoint color image to be encoded at the encoder 511 is performed using a (decoded) low-resolution right viewpoint color image of which the resolution of the right viewpoint color image has been reduced, as a reference image, as described with FIG. 55.

That is to say, with the encoder 511, disparity prediction of the low-resolution left viewpoint color image to be encoded at the encoder 511 may be performed using the low-resolution right viewpoint color image of which the resolution has been reduced the same as with the low-resolution left viewpoint color image to be encoded, as a reference image, besides the multi-viewpoint color image of which the resolution has not been reduced.

With the encoder 511, in the event of taking a low-resolution left viewpoint color image where the vertical resolution of a left viewpoint color image has been reduced to ½ resolution as an image to be encoded, and performing disparity prediction of this image to be encoded using the middle viewpoint color image of which the resolution has not been reduced as a reference image, the image to be encoded is an image of low resolution where the vertical resolution has been made to be ½ (of the original), and the reference image is an image of which the resolution has not been reduced, so the image to be encoded is an image having ½ the vertical resolution as that of the reference image, and accordingly the resolution ratio of the image to be encoded and the resolution ratio of the reference image are not the same.

On the other hand, with the encoder 511, in the event of taking a low-resolution left viewpoint color image where the vertical resolution of a left viewpoint color image has been reduced to ½ resolution as an image to be encoded, and performing disparity prediction of this image to be encoded using the low-resolution right viewpoint color image of which the vertical resolution of the right viewpoint image has been reduced to ½ as a reference image, the image to be encoded is an image of low resolution where the vertical resolution has been made to be ½, and the reference image also is an image of which the vertical resolution has been made to be ½, so the resolution ratio of the image to be encoded and the resolution ratio of the reference image agree.

Also, with the encoding device 322C in FIG. 54, description has been made where, at the encoder 41, the middle viewpoint color image is encoded as a base view image, and at the encoders 511 and 512, the low-resolution left viewpoint color image and low-resolution right viewpoint color image are each encoded as non base view images, but an arrangement may be made with the encoding device 322C where, alternatively, one of the low-resolution left viewpoint color image and low-resolution right viewpoint color image, the low-resolution left viewpoint color image for example, is encoded as a base view image, and at the encoder 511 the middle viewpoint color image is encoded as a non base view image, and at the encoder 512 the other of the low-resolution left viewpoint color image and low-resolution right viewpoint color image, which is the low-resolution right viewpoint color image, is encoded as a non base view image.

At the encoder 511, in the event of encoding the middle viewpoint color image as a non base view image, disparity prediction of the middle viewpoint color image to be encoded of which resolution has not been reduced is performed using the low-resolution left viewpoint color image of which the vertical resolution of the left viewpoint color image has been reduced to ½ resolution (or the low-resolution right viewpoint color image of which the vertical resolution of the right viewpoint color image has been reduced to ½ resolution).

With the encoder 511, in the event of taking the middle viewpoint color image of which the resolution has not been reduced as an image to be encoded, and performing disparity prediction of this image to be encoded using a low-resolution left viewpoint color image where the vertical resolution has been reduced to ½ resolution as a reference image, the image to be encoded is an image of which the resolution has not been reduced, and the reference image is an image of low resolution where the vertical resolution has been made to be ½, so the image to be encoded is an image having twice the vertical resolution as that of the reference image, and accordingly the resolution ratio of the image to be encoded and the resolution ratio of the reference image are not the same.

As described above, with regard to the image to be encoded at the encoder 511, and the reference image used for disparity prediction of the image to be decoded, there are cases where the resolution ratio of the image to be encoded and the resolution ratio of the reference image are not the same, and cases where the resolution ratio of the image to be encoded and the resolution ratio of the reference image match, due to the image to be encoded being an image with ½ or an image with twice the vertical resolution as to the reference image, and so forth.

Also, as described with FIG. 53, the resolution converting device 321C can reduce the horizontal resolution of the left viewpoint color image and right viewpoint color image to ½, besides reducing the vertical resolution of each to ½.

The conversion processing of the reference image in FIG. 62 is processing capable of handling any of the cases of a case where the resolution ratio of the image to be encoded and the resolution ratio of the reference image are not the same due to the image to be encoded being an image with ½ or an image with twice the vertical resolution as to the reference image, a case where the resolution ratio of the image to be encoded and the resolution ratio of the reference image match; and a case where reduction in resolution has been performed to reduce the vertical resolution of the left viewpoint color image and right viewpoint color image to ½ resolution, and a case where reduction in resolution has been performed to reduce the horizontal resolution of the left viewpoint color image and right viewpoint color image to ½ resolution.

In the conversion processing of the reference image in FIG. 62, in step S351, the controller 381 (FIG. 59) receives the resolution conversion SEI from the SEI generating unit 551 and the flow advances to step S352.

In step S352, the horizontal ½-pixel generating filter processing unit 151 (FIG. 59) receives the decoded middle viewpoint color image serving as the reference image from the DPB 43, and the flow advances to step S353.

In step S353, the controller 381 controls the filter processing of each of the horizontal ½-pixel generating filter processing unit 151 through horizontal-vertical ¼-pixel generating filter processing unit 155, in accordance with the resolution conversion SEI from the SEI generating unit 551, and accordingly, the reference image from the DPB 43 is converted into a converted reference image of a resolution ratio matching the horizontal and vertical resolution ratio of the picture of the image to be encoded.

That is to say, in step S353, in step S361 the controller 381 determines whether or not the resolution_info[i] (FIG. 56, FIG. 57) of the image to be encoded at the encoder 511 and the resolution_info[j] of the reference image for the disparity prediction thereof (decoded image which has already been encoded and locally decoded) are equal.

Now, we will say that the image to be encoded at the encoder 511 is the i+1'th image configuring the resolution-converted multi-viewpoint color image, and the reference image used for the disparity prediction thereof is the j(≠i)+1'th image configuring the resolution-converted multi-viewpoint color image (j=0, 1, . . . ).

In step S361, in the event that determination is made that the resolution_info[i] of the image to be encoded at the encoder 511 and the resolution_info[j] of the reference image to be used for the disparity prediction thereof are equal, i.e., in the event that both the image to be encoded and the reference image to be used for the disparity prediction thereof are images of which the resolution has not been reduced, or both are image of which the resolution has been reduced, so that the resolution ratio of the image to be encoded and the resolution ratio of the reference image to be used for the disparity prediction thereof agree, the flow advances to step S362, and thereafter, the reference image from the DPB 43 is subjected to filter processing following MVC described with FIG. 14 and FIG. 15 (filter processing where the number of pixels in each of the horizontal direction and vertical direction are increased by the same multiple), in step S362 through S366.

That is to say, in step S362, the horizontal ½-pixel generating filter processing unit 151 subjects the reference image which is an integer precision image from the DPB 43, to horizontal ½-pixel generating filter processing, supplies the image obtained as a result thereof to the vertical ½-pixel generating filter processing unit 152, and the flow advances to step S363.

In step S363, the vertical ½-pixel generating filter processing unit 152 subjects the image from the horizontal ½-pixel generating filter processing unit 151 to vertical ½-pixel generating filter processing, supplies the ½ precision image (FIG. 14) obtained as a result thereof to the horizontal ¼-pixel generating filter processing unit 153, and the flow advances to step S364.

In step S364, the horizontal ¼-pixel generating filter processing unit 153 subjects the ½ precision image from the vertical ½-pixel generating filter processing unit 152 to horizontal ¼-pixel generating filter processing, supplies the image obtained as a result thereof to the vertical ¼-pixel generating filter processing unit 154, and the flow advances to step S365.

In step S365, the vertical ¼-pixel generating filter processing unit 154 subjects the image from the horizontal ¼-pixel generating filter processing unit 153 to vertical ¼-pixel generating filter processing, supplies the image obtained as a result thereof to the horizontal-vertical ¼-pixel generating filter processing unit 155, and the flow advances to step S366.

In step S366, the horizontal-vertical ¼-pixel generating filter processing unit 155 subjects the image from the vertical ¼-pixel generating filter processing unit 154 to horizontal-vertical ¼-pixel generating filter processing, and the flow advances to step S354.

In step S354, the horizontal-vertical ¼-pixel generating filter processing unit 155 supplies the ¼ precision image (FIG. 15) obtained by the horizontal-vertical ¼-pixel generating filter processing to the disparity detecting unit 141 and disparity compensation unit 142 as a converted reference image, and the flow returns.

Note that in the event that determination is made in the conversion processing of the reference image in FIG. 62 that the resolution_info[i] of the image to be encoded and the resolution_info[j] of the reference image to be used for the disparity prediction thereof are equal, i.e., in the event that the resolution ratio of the image to be encoded and the resolution ratio of the reference image to be used for the disparity prediction thereof agree, the filter processes of step S364 through S366 out of the steps S362 through S366 may be skipped, with the ½ precision image obtained at step S363 being supplied to the disparity detecting unit 141 and disparity compensation unit 142 as a converted reference image, or all processing of the steps S362 through S366 may be skipped, with the unchanged reference image being supplied to the disparity detecting unit 141 and disparity compensation unit 142 as a converted reference image.

In the event that determination is made in step S361 that the resolution_info[i] of the image to be encoded and the resolution_info[j] of the reference image to be used for the disparity prediction thereof are not equal, i.e., in the event that the resolution ratio of the image to be encoded and the resolution ratio of the reference image to be used for the disparity prediction thereof do not agree, the flow advances to step S367, and the controller 381 determines the resolution_info[i] of the image to be encoded at the encoder 511 and the resolution_info[j] of the reference image to be used for the disparity prediction thereof.

In step S367, in the event that determination is made that the resolution_info[i] of the image to be encoded is 1 and the resolution_info[j] of the reference image to be used for disparity prediction is 0, or the resolution_info[i] of the image to be encoded is 0 and the resolution_info[j] of the reference image to be used for disparity prediction is 2, the flow advances to step S368, where the horizontal ½-pixel generating filter processing unit 151 subjects the reference image which is an integer precision image from the DPB 43 to horizontal ½-pixel generating filter processing, and the horizontal ½ precision image (FIG. 33) obtained as a result thereof is supplied to the vertical ½-pixel generating filter processing unit 152.

The vertical ½-pixel generating filter processing unit 152 does not perform (skips) vertical ½-pixel generating filter processing on the horizontal ½ precision image from the horizontal ½-pixel generating filter processing unit 151, and supplies to the horizontal ¼-pixel generating filter processing unit 153 as it is, and the flow advances from step S368 to step S364.

Thereafter, in steps S364 through S366, the horizontal ½ precision image is subjected to each of the horizontal ¼-pixel generating filter processing by the horizontal ¼-pixel generating filter processing unit 153, the vertical ¼-pixel generating filter processing by the vertical ¼-pixel generating filter processing unit 154, and the horizontal-vertical ¼-pixel generating filter processing by the horizontal-vertical ¼-pixel generating filter processing unit 155, the same as with the cases described above, thereby obtaining a horizontal ¼ vertical ½ precision image (FIG. 34).

The flow then advances from step S366 to step S354, where the horizontal-vertical ¼-pixel generating filter processing unit 155 supplies the horizontal ¼ vertical ½ precision image to the disparity detecting unit 141 and disparity compensation unit 142 as converted reference image, and the flow returns.

That is to say, in the event that the resolution_info[i] of the image to be encoded is 1, and the resolution_info[j] of the reference image to be used for disparity prediction thereof is 0, from what has been described with FIG. 56 and FIG. 57 the image to be encoded is an image of reduced resolution of which the vertical resolution has been made to be ½ (resolution_info[i]=1), and the reference image to be used for disparity prediction is an image of which the resolution has not been reduced (resolution_info[j] is 0), so while the resolution ratio of the reference image to be used for disparity prediction is 1:1, the resolution ratio of the image to be encoded is 2:1.

Accordingly, the reference image converting unit 570 (FIG. 59) converts the vertical and horizontal ratio of the number of pixels to be interpolated (hereinafter also referred to as interpolation pixel ratio) of the reference image of which the resolution ratio is 1:1, to a horizontal ¼ vertical ½ precision image of 2:1, thereby obtaining a converted reference image matching the interpolation pixel ratio of 2:1 of the image to be encoded.

Also, in the event that the resolution_info[i] of the image to be encoded is 0, and the resolution_info[j] of the reference image to be used for disparity prediction thereof is 2, from what has been described with FIG. 56 and FIG. 57 the image to be encoded is an image of which the resolution has not been reduced (resolution_info[i] is 0), and the reference image to be used for disparity prediction is an image of reduced resolution of which the horizontal resolution has been made to be ½ (resolution_info[j]=2), so while the resolution ratio of the image to be encoded is 1:1, the resolution ratio of the reference image to be used for disparity prediction is 1:2.

Accordingly, the reference image converting unit 570 (FIG. 59) converts the interpolation pixel ratio of the reference image of which the resolution ratio is 1:2, to a horizontal ¼ vertical ½ precision image of which the interpolation pixel ratio is 2:1, thereby obtaining a converted reference image matching the interpolation pixel ratio of 1:1 (=2:2) of the image to be encoded.

Note that in the event that in the conversion processing of the reference image in FIG. 62, in a case where the resolution_info[i] of the image to be encoded is 1 and the resolution_info[j] of the reference image to be used for the disparity prediction is 0, and a case where the resolution_info[i] of the image to be encoded is 0 and the resolution_info[j] of the reference image to be used for the disparity prediction is 2, the filter processes of step S364 through S366 out of the steps S362 through S366 may be skipped, with the horizontal ½ precision image (FIG. 33) obtained at step S368 being supplied to the disparity detecting unit 141 and disparity compensation unit 142 as a converted reference image.

On the other hand, in step S367, in the event that determination is made that the resolution_info[i] of the image to be encoded is 0 and the resolution_info[j] of the reference image to be used for disparity prediction is 1, or the resolution_info[i] of the image to be encoded is 2 and the resolution_info[j] of the reference image to be used for disparity prediction is 0, the horizontal ½-pixel generating filter processing unit 151 does not perform (skips) horizontal ½-pixel generating filter processing on the reference image which is an integer precision image from the DPB 43, and supplies to the vertical ½-pixel generating filter processing unit 152 as it is, and the flow advances to step S369.

In step S369, the vertical ½-pixel generating filter processing unit 152 performs vertical ½-pixel generating filter processing on the reference image which is the integer precision image from the horizontal ½-pixel generating filter processing unit 151, and supplies the vertical ½ precision image (FIG. 49) obtained as a result thereof to the horizontal ¼-pixel generating filter processing unit 153, and the flow advances to step S364.

Thereafter, in steps S364 through S366, the horizontal ½ precision image is subjected to each of the horizontal ¼-pixel generating filter processing by the horizontal ¼-pixel generating filter processing unit 153, the vertical ¼-pixel generating filter processing by the vertical ¼-pixel generating filter processing unit 154, and the horizontal-vertical ¼-pixel generating filter processing by the horizontal-vertical ¼-pixel generating filter processing unit 155, the same as with the cases described above, thereby obtaining a horizontal ½ vertical ¼ precision image (FIG. 50).

The flow then advances from step S366 to step S354, where the horizontal-vertical ¼-pixel generating filter processing unit 155 supplies the horizontal ½ vertical ¼ precision image to the disparity detecting unit 141 and disparity compensation unit 142 as a converted reference image, and the flow returns.

That is to say, in the event that the resolution_info[i] of the image to be encoded is 0, and the resolution_info[j] of the reference image to be used for disparity prediction is 1, from what has been described with FIG. 56 and FIG. 57 the image to be encoded is an image of which the resolution has not been reduced (resolution_info[i] is 0), and the reference image to be used for disparity prediction is an image of reduced resolution of which the vertical resolution has been made to be ½ (resolution_info[j]=1), so while the resolution ratio of the reference image to be used for disparity prediction is 1:1, the resolution ratio of the image to be encoded is 2:1.

Accordingly, the reference image converting unit 570 (FIG. 59) converts the interpolation pixel ratio of the reference image of which the resolution ratio is 2:1, to a horizontal ½ vertical ¼ precision image of an interpolation pixel ratio of 1:2, thereby obtaining a converted reference image matching the interpolation pixel ratio of 1:1 (=2:2) of the image to be encoded.

Also, in the event that the resolution_info[i] of the image to be encoded is 2, and the resolution_info[j] of the reference image to be used for disparity prediction thereof is 0, from what has been described with FIG. 56 and FIG. 57 the image to be encoded is an image of reduced resolution of which the horizontal resolution has been made to be ½ (resolution_info[i]=2), and the reference image to be used for disparity prediction is an image of which the resolution has not been reduced (resolution_info[j] is 0), so while the resolution ratio of the image to be encoded is 1:1, the resolution ratio of the reference image to be used for disparity prediction is 1:2.

Accordingly, the reference image converting unit 570 (FIG. 59) converts the interpolation pixel ratio of the reference image of which the resolution ratio is 1:1, to a horizontal ½ vertical ¼ precision image of which the interpolation pixel ratio is 1:2, thereby obtaining a converted reference image matching the interpolation pixel ratio of 1:2 of the image to be encoded.

Note that in the event that in the conversion processing of the reference image in FIG. 62, in a case where the resolution_info[i] of the image to be encoded is 0 and the resolution_info[j] of the reference image to be used for the disparity prediction is 0, and a case where the resolution_info[i] of the image to be encoded is 2 and the resolution_info[j] of the reference image to be used for the disparity prediction is 0, the filter processes of step S364 through S366 out of the steps S362 through S366 may be skipped, with the vertical ½ precision image (FIG. 49) obtained at step S369 being supplied to the disparity detecting unit 141 and disparity compensation unit 142 as a converted reference image.

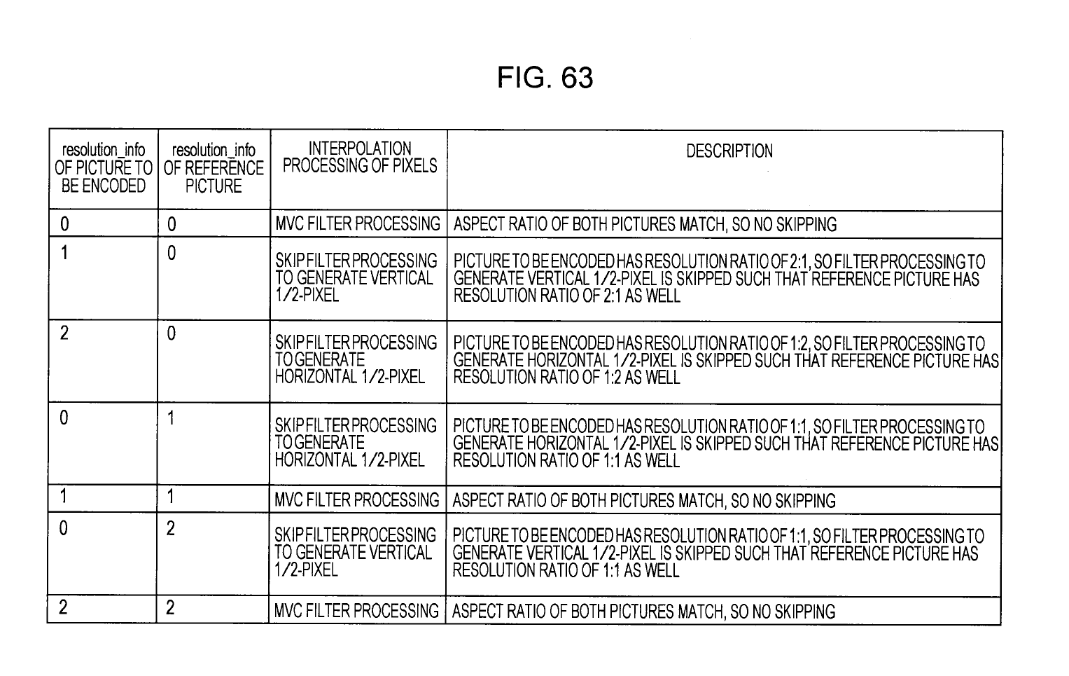

FIG. 63 is a diagram for describing control of filter processing at each of the horizontal ½-pixel generating filter processing unit 151 through horizontal-vertical ¼-pixel generating filter processing unit 155 by the controller 381, in a case where the reference image conversion processing in FIG. 62 is performed by the reference image converting unit 570 (FIG. 59).

In the event that the resolution_info[i] of the image (picture) to be encoded by the encoder 511 and the resolution_info[j] of the reference image (picture) to be used for the disparity prediction thereof are equal, i.e., in the event that the resolution_info[i] and resolution_info[j] are both 0, 1, or 2, the resolution ratio of the image to be encoded and the resolution ratio of the reference image to be used for disparity prediction thereof agree, so the controller 381 controls the horizontal ½-pixel generating filter processing unit 151 through horizontal-vertical ¼-pixel generating filter processing unit 155 so as to perform all filter processing of, for example, horizontal ½-pixel generating filter processing, vertical ½-pixel generating filter processing horizontal ¼-pixel generating filter processing, vertical ¼-pixel generating filter processing, and horizontal-vertical ¼-pixel generating filter processing, that is to say the filter processing following MVC described in FIG. 14 and FIG. 15 (filter processing to increase the number of pixels in the horizontal direction and vertical direction each by the same multiple).

In the event that the resolution_info[i] of the image to be encoded at the encoder 511 is 1 and the resolution_info[j] of the reference image to be used for disparity prediction thereof is 0, the resolution ratio of the image to be encoded is 2:1, and the resolution ratio of the reference image to be used for disparity prediction thereof is 1:1, so the controller 381 controls the horizontal ½-pixel generating filter processing unit 151 through horizontal-vertical ¼-pixel generating filter processing unit 155 so as to perform filter processing in which, of the horizontal ½-pixel generating filter processing, vertical ½-pixel generating filter processing, horizontal ¼-pixel generating filter processing, vertical ¼-pixel generating filter processing, and horizontal-vertical ¼-pixel generating filter processing, just the vertical ½-pixel generating filter processing is skipped for example, and the other filter processing is performed, i.e., so as to perform the filter processing described with FIG. 33 and FIG. 34, so that the reference image of which the resolution ratio is 1:1 is converted into a converted reference image of a resolution ratio matching the resolution ratio of 2:1 of the image to be encoded.

In the event that the resolution_info[i] of the image to be encoded at the encoder 511 is 2 and the resolution_info[j] of the reference image to be used for disparity prediction thereof is 0, the resolution ratio of the image to be encoded is 1:2, and the resolution ratio of the reference image to be used for disparity prediction thereof is 1:1, so the controller 381 controls the horizontal ½-pixel generating filter processing unit 151 through horizontal-vertical ¼-pixel generating filter processing unit 155 so as to perform filter processing in which, of the horizontal ½-pixel generating filter processing, vertical ½-pixel generating filter processing, horizontal ¼-pixel generating filter processing, vertical ¼-pixel generating filter processing, and horizontal-vertical ¼-pixel generating filter processing, just the horizontal ½-pixel generating filter processing is skipped for example, and the other filter processing is performed, i.e., so as to perform the filter processing described with FIG. 49 and FIG. 50, so that the reference image of which the resolution ratio is 1:1 is converted into a converted reference image of a resolution ratio matching the resolution ratio of 1:2 of the image to be encoded.

In the event that the resolution_info[i] of the image to be encoded at the encoder 511 is 0 and the resolution_info[j] of the reference image to be used for disparity prediction thereof is 1, the resolution ratio of the image to be encoded is 1:1, and the resolution ratio of the reference image to be used for disparity prediction thereof is 2:1, so the controller 381 controls the horizontal ½-pixel generating filter processing unit 151 through horizontal-vertical ¼-pixel generating filter processing unit 155 so as to perform filter processing in which, of the horizontal ½-pixel generating filter processing, vertical ½-pixel generating filter processing, horizontal ¼-pixel generating filter processing, vertical ¼-pixel generating filter processing, and horizontal-vertical ¼-pixel generating filter processing, just the horizontal ½-pixel generating filter processing is skipped for example, and the other filter processing is performed, i.e., so as to perform the filter processing described with FIG. 49 and FIG. 50, so that the reference image of which the resolution ratio is 2:1 is converted into a converted reference image of a resolution ratio matching the resolution ratio of 1:1 of the image to be encoded.

In the event that the resolution_info[i] of the image to be encoded at the encoder 511 is 0 and the resolution_info[j] of the reference image to be used for disparity prediction thereof is 2, the resolution ratio of the image to be encoded is 1:1, and the resolution ratio of the reference image to be used for disparity prediction thereof is 1:2, so the controller 381 controls the horizontal ½-pixel generating filter processing unit 151 through horizontal-vertical ¼-pixel generating filter processing unit 155 so as to perform filter processing in which, of the horizontal ½-pixel generating filter processing, vertical ½-pixel generating filter processing, horizontal ¼-pixel generating filter processing, vertical ¼-pixel generating filter processing, and horizontal-vertical ¼-pixel generating filter processing, just the vertical ½-pixel generating filter processing is skipped for example, and the other filter processing is performed, i.e., so as to perform the filter processing described with FIG. 33 and FIG. 34, so that the reference image of which the resolution ratio is 1:2 is converted into a converted reference image of a resolution ratio matching the resolution ratio of 1:1 of the image to be encoded.

[Configuration Example of Decoding Device 332C]

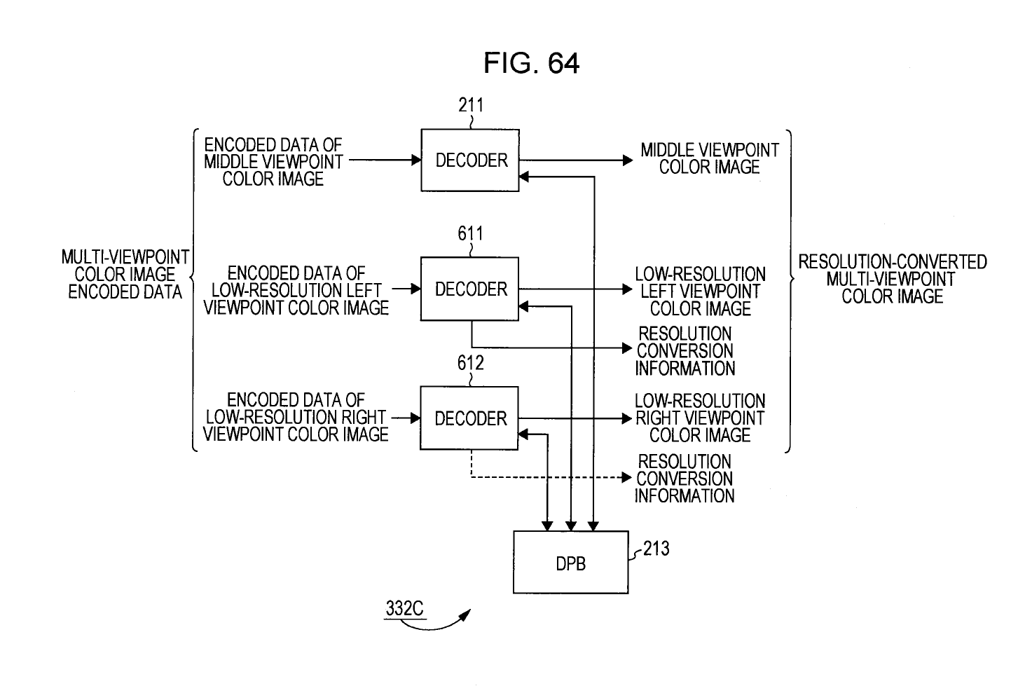

FIG. 64 is a block diagram illustrating a configuration example of the decoding device 332C in FIG. 22 in a case where the resolution-converted multi-viewpoint color image is the middle viewpoint color image, low-resolution left viewpoint color image, and low-resolution right viewpoint color image, described with FIG. 53, i.e., in a case that the encoding device 322C (FIG. 21) is configured as illustrated in FIG. 54.

Note that portions in the drawing corresponding to the case in FIG. 39 are denoted with the same symbols, and description thereof will be omitted as appropriate hereinafter.

In FIG. 64, the decoding device 332C has decoders 211, 611, and 612, and the DPB 213.

Accordingly, the decoding device 332C in FIG. 64 has in common with the decoding device 332C in FIG. 39 the point of sharing the decoder 211 and DPB 213, but differs from the decoding device 332C in FIG. 39 in that the decoders 611 and 612 have been provided instead of the decoder 412.

The decoder 211 is supplied with, of the multi-viewpoint color image encoded data from the inverse multiplexing device 31 (FIG. 22), encoded data of the middle viewpoint color image which is a base view image.

Also, the decoder 611 is supplied with, of the multi-viewpoint color image encoded data from the inverse multiplexing device 31, encoded data of low-resolution left viewpoint color image which is a non base view image, and the decoder 612 is supplied with, of the multi-viewpoint color image encoded data from the inverse multiplexing device 31, encoded data of low-resolution right viewpoint color image which is a non base view image.

The decoder 211 decodes the encoded data of the middle viewpoint color image supplied thereto with an extended format, and outputs a middle viewpoint color image obtained as the result thereof.

The decoder 611 decodes the encoded data of the low-resolution left viewpoint color image supplied thereto with an extended format, and outputs a low-resolution left viewpoint color image obtained as the result thereof.

The decoder 612 decodes the encoded data of the low-resolution right viewpoint color image supplied thereto with an extended format, and outputs a low-resolution right viewpoint color image obtained as the result thereof.

The middle viewpoint color image which the decoder 211 outputs, the low-resolution left viewpoint color image which the decoder 611 outputs, and the low-resolution right viewpoint color image which the decoder 612 outputs, are supplied to the resolution inverse converting device 333C (FIG. 22) as a resolution-converted multi-viewpoint color image.

Also, the decoders 211, 611, and 612 each decode an image regarding which prediction encoding has been performed at the encoders 41, 511, and 512, in FIG. 26.

In order to decode an image subjected to prediction encoding, the prediction image used for the prediction encoding is necessary, so the decoders 211, 611, and 612 decode the images to be decoded, and thereafter temporarily store the decoded images to be used for generating of a prediction image, in the DPB 213, to generate the prediction image used in the prediction encoding.

The DPB 213 is shared by the decoders 211, 611, and 612, and temporarily stores images after decoding (decoded images) obtained at each of the decoders 211, 611, and 612.

Each of the decoders 211, 611, and 612 select a reference image to reference to decode the image to be decoded, from the decoded images stored in the DPB 213, and generate prediction images using the reference images.

The DPB 213 is thus shared between the decoders 211, 611, and 612, so the decoders 211, 611, and 612 can each reference, besides decoded images obtained from itself, decoded images obtained at the other decoder as well.

Note that the decoder 612 performs processing the same as with the decoder 611 except that the object of processing is a low-resolution left viewpoint color image instead of a low-resolution right viewpoint color image, so description thereof will be omitted hereinafter as appropriate.

[Configuration Example of Decoder 611]

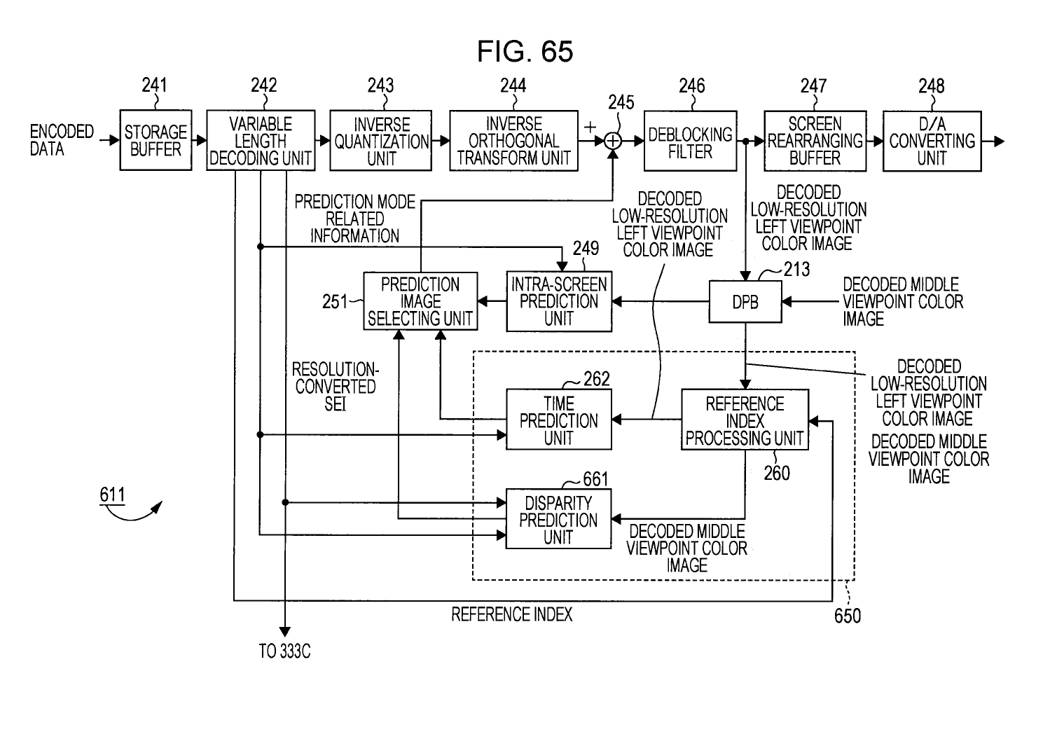

FIG. 65 is a block diagram illustrating a configuration example of the decoder 611 in FIG. 64.

Note that portions in the drawing corresponding to the case in FIG. 40 are denoted with the same symbols, and description thereof will be omitted as appropriate hereinafter.

In FIG. 65, the decoder 611 has a storage buffer 241, a variable length decoding unit 242, an inverse quantization unit 243, an inverse orthogonal transform unit 244, a computing unit 245, a deblocking filter 246, a screen rearranging buffer 247, a D/A conversion unit 248, an intra-screen prediction unit 249, a prediction image selecting unit 251, and an inter prediction unit 650.

Accordingly, the decoder 412 in FIG. 40 has in common with the decoder 212 in FIG. 18 the point of having the storage buffer 241 through intra-screen prediction unit 249 and the prediction image selecting unit 251.

However, the decoder 611 in FIG. 65 differs from the decoder 611 in FIG. 40 in the point that the inter prediction unit 650 has been provided instead of the inter prediction unit 450.

The inter prediction unit 650 has the reference index processing unit 260, temporal prediction unit 262, and a disparity prediction unit 661.

Accordingly, the inter prediction unit 650 has in common with the inter prediction unit 450 in FIG. 40 the point of having the reference index processing unit 260 and the temporal prediction unit 262, but differs from the inter prediction unit 450 in FIG. 40 with regard to the point that the disparity prediction unit 661 has been provided instead of the disparity prediction unit 461 (FIG. 40).

With the decoder 611 in FIG. 65, the variable length decoding unit 242 receives encoded data of the packed color image including the resolution conversion SEI from the storage buffer 241, and supplies the resolution conversion SEI included in that encoded data to the disparity prediction unit 661.

Also, the variable length decoding unit 242 supplies the resolution conversion SEI to the resolution inverse converting device 333C (FIG. 22) as resolution conversion information.

Further, the variable length decoding unit 242 supplies header information (prediction mode related information) included in the encoded data to the intra-screen prediction unit 249, and to the reference index processing unit 260, temporal prediction unit 262, and disparity prediction unit 661 configuring the inter prediction unit 650.

The disparity prediction unit 661 is supplied with prediction mode related information and resolution conversion SEI from the variable length decoding unit 242, and also is supplied with a picture of the decoded middle viewpoint color image serving as a reference image from the reference index processing unit 260.

The disparity prediction unit 661 converts the picture of the decoded middle viewpoint color image serving as a reference image from the reference index processing unit 260 into a converted reference image based on the resolution conversion SEI from the variable length decoding unit 242, in the same way as with the disparity prediction unit 561 in FIG. 55.

Further, the disparity prediction unit 661 restores the disparity vector used to generate the prediction image of the current block, based on the prediction mode related information from the variable length decoding unit 242, and in the same way as with the disparity prediction unit 561 in FIG. 55, generates a prediction image by performing disparity prediction (disparity compensation) on the converted reference image, and supplies this to the prediction image selecting unit 251.

[Configuration Example of Disparity Prediction Unit 661]

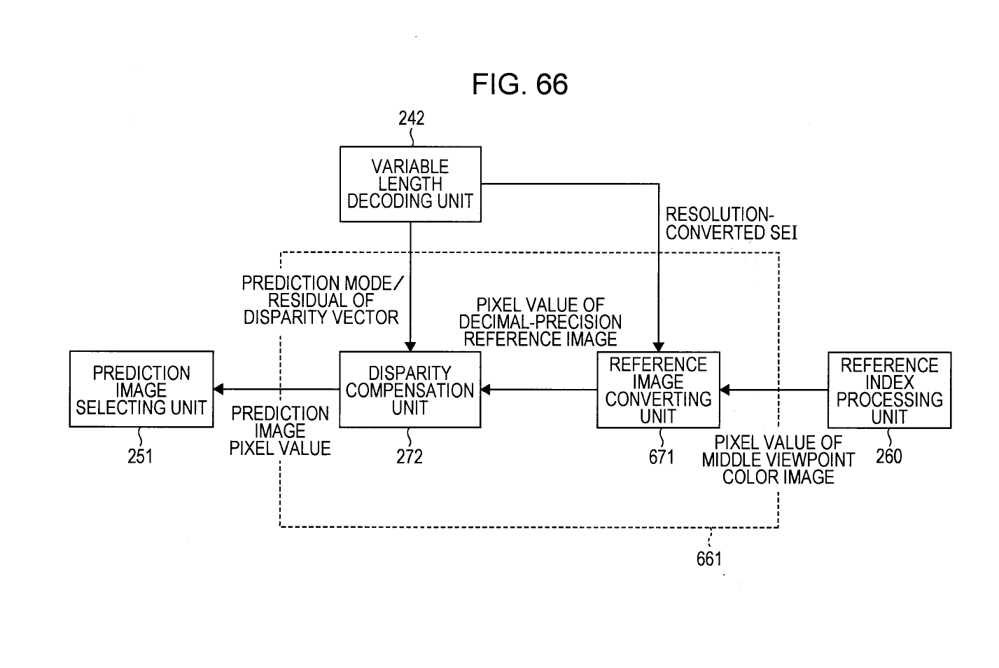

FIG. 66 is a block diagram illustrating a configuration example of the disparity prediction unit 661 in FIG. 65.

Note that in the drawing, portions which correspond to portions in the case in FIG. 41 are denoted with the same symbols, and description thereof will be omitted as appropriate hereinafter.

In FIG. 66, the disparity prediction unit 661 has the disparity compensation unit 272 and a reference image converting unit 671.

Accordingly, the disparity prediction unit 661 in FIG. 66 has in common with the disparity prediction unit 461 in FIG. 41 the point of having the disparity compensation unit 272, but differs from the disparity prediction unit 461 in FIG. 41 with regard to the point that the reference image converting unit 671 has been provided instead of the reference image converting unit 471.

The reference image converting unit 671 is supplied with the picture of the decoded middle viewpoint color image from the reference index processing unit 260, as a reference image, and is also supplied with resolution conversion SEI from the variable length decoding unit 242.

The reference image converting unit 671 is configured in the same way as the reference image converting unit 570 in FIG. 59.

The reference image converting unit 671 also controls filter processing to be applied to the picture of the decoded middle viewpoint color image serving as a reference image to be referenced in prediction processing, in accordance with the resolution conversion SEI from the variable length decoding unit 242, in the same way as with the reference image converting unit 570 in FIG. 59, and accordingly converts the reference image into a converted reference image of a resolution ratio matching the horizontal and vertical resolution ratio of the picture of the packed color image to be decoded, and supplies to the disparity compensation unit 272.

[Decoding Processing of Low-Resolution Left Viewpoint Color Image]

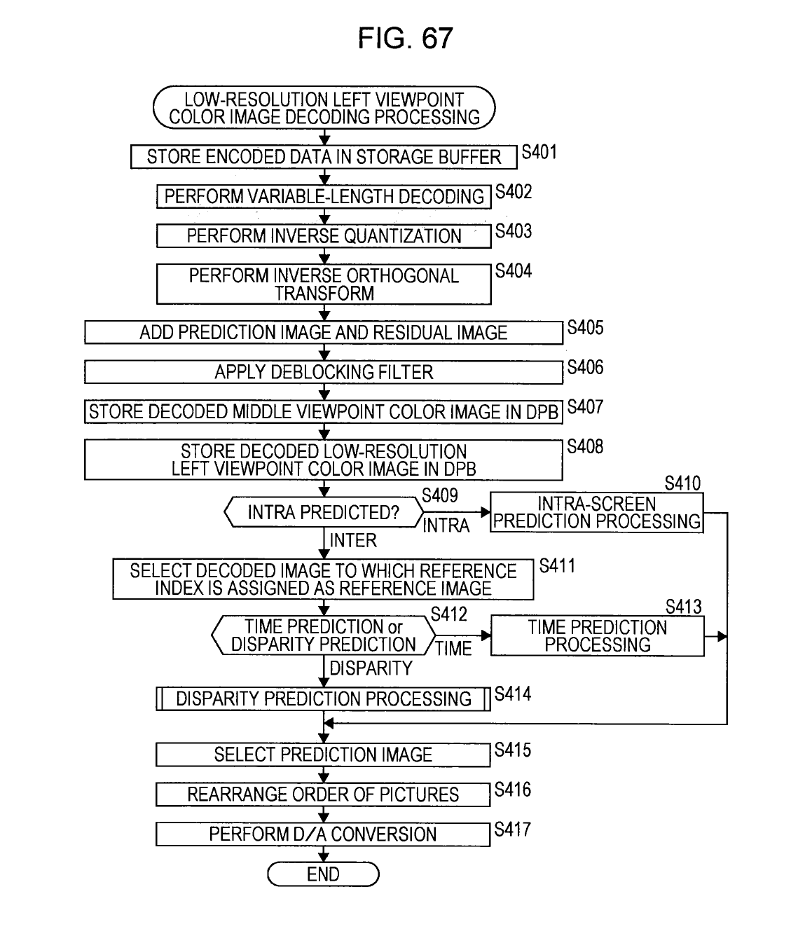

FIG. 67 is a flowchart for describing decoding processing to decode the encoded data of the low-resolution left viewpoint color image, which the decoder 611 in FIG. 65 performs.

In steps S401 through S406, processing the same as with steps S201 through S206 in FIG. 43 is performed, whereby the decoded low-resolution left viewpoint color image where the current block of the low-resolution left viewpoint color image has been decoded is filtered at the deblocking filter 246, and supplied to eth DPB 213 and screen rearranging buffer 247.

Subsequently, the flow advances to step S407, where the DPB 213 awaits for the decoded middle viewpoint color image to be supplied from the decoder 211 (FIG. 64) which decodes the multi-viewpoint color image, stores the decoded middle viewpoint color image, and the flow advances to step S408.

In step S408, the DPB 213 stores the decoded packed color image from the deblocking filter 246, and the flow advances to step S409.

In step S409, the intra-screen prediction unit 249 and (the temporal prediction unit 262 and disparity prediction unit 461 making up) the inter prediction unit 650 determine which of intra prediction (intra-screen prediction) and inter prediction the prediction image has been generated with, that has been used to encode the next current block (the macroblock to be decoded next), based on the prediction mode related information supplied from the variable length decoding unit 242.

In the event that determination is then made in step S409 that the next current block has been encoded using a prediction image generated with intra-screen prediction, the flow advances to step S410, and the intra-screen prediction unit 249 performs intra prediction processing (intra screen prediction).

That is to say, the intra-screen prediction unit 249 performs intra prediction (intra-screen prediction) to generated a prediction image (intra-predicted prediction image) from the picture of the decoded packed color image stored in the DPB 213, supplies that prediction image to the prediction image selecting unit 251, and the flow advances from step S410 to step S415.

Also, in the event that determination is made in step S409 that the next current block has been encoded using a prediction image generated in inter prediction, the flow advances to step S411, where the reference index processing unit 260 reads out the picture of the decoded middle viewpoint color image to which a reference index (for prediction) included in the prediction mode related information from the variable length decoding unit 242 has been assigned, or the picture of the decoded packed color image, from the DPB 213, as a reference image, and the flow advances to step S412.

In step S412, the reference index processing unit 260 determines which of temporal prediction which is intra prediction and disparity prediction the prediction image has been generated with, that has been used to encode the next current block, based on the reference index (for prediction) included in the prediction mode related information supplied from the variable length decoding unit 242.

In the event that determination is made in step S412 that the next current block has been determined to have been encoded using a prediction image generated by temporal prediction, i.e., in the event that the picture to which the reference index for prediction, for the (next) current block from the variable length decoding unit 242, has been assigned, is the picture of the decoded low-resolution left viewpoint color image, and this picture of the decoded low-resolution left viewpoint color image has been selected in step S411 as a reference image, the reference index processing unit 260 supplies the picture of the decoded packed color image to the temporal prediction unit 262 as a reference image, and the flow advances to step S413.

In step S413, the temporal prediction unit 262 performs temporal prediction processing (inter prediction processing).

That is to say, with regard to the next current block, the temporal prediction unit 262 performs motion compensation of the picture of the decoded low-resolution left viewpoint color image serving as the reference image from the reference index processing unit 260, using the prediction mode related information from the variable length decoding unit 242, thereby generating a prediction image, supplies the prediction image to the prediction image selecting unit 251, and the processing advances from step S413 to step S415.

Also, in the event that determination is made in step S412 that the next current block has been encoded using a prediction image generated by disparity prediction, i.e., in the event that the picture to which the reference index for prediction, for the (next) current block from the variable length decoding unit 242, has been assigned, is the picture of the decoded middle viewpoint color image, and this picture of the decoded middle viewpoint color image has been selected as a reference image in step S411, the reference index processing unit 260 supplies the decoded middle viewpoint color image to the disparity prediction unit 461 as a reference image, and the flow advances to step S414.

In step S414, the disparity prediction unit 461 performs disparity prediction processing (inter prediction processing).

That is to say, the disparity prediction unit 661 converts the picture of the decoded middle viewpoint color image serving as the reference image from the reference index processing unit 260, to a converted reference image, in accordance with the resolution conversion SEI from the variable length decoding unit 242.

Further, the disparity prediction unit 661 performs disparity compensation on the converted reference image for the next current block, using the prediction mode related information from the variable length decoding unit 242, thereby generating a prediction image, and supplies the prediction image to the prediction image selecting unit 251, and the flow advances from step S414 to step S415.

Thereafter, in steps S415 through S417, processing the same as with steps S215 through S217 in FIG. 43 is performed.

At the decoder 611, the processing of the above steps S401 through S417 is repeatedly performed.

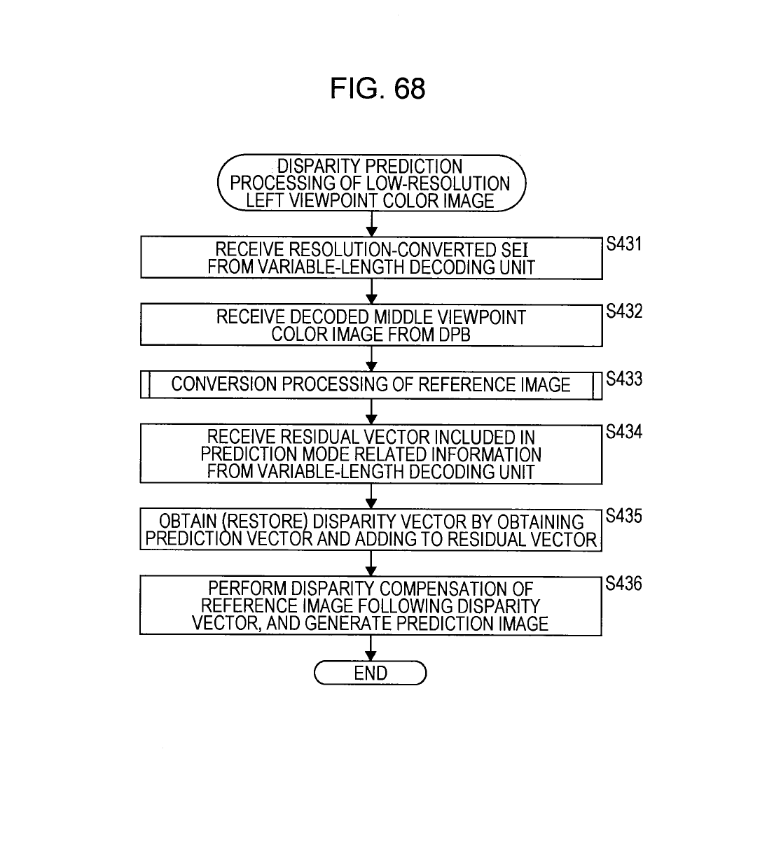

FIG. 68 is a flowchart for describing the disparity prediction processing which the disparity prediction unit 661 in FIG. 66 performs in step S414 in FIG. 67.

In step S431, the reference image converting unit 671 receives the resolution conversion SEI supplied from the variable length decoding unit 242, and the flow advances to step S432.

In step S432, the reference image converting unit 671 receives the picture of the decoded middle viewpoint color image serving as the reference image from the reference index processing unit 260, and the flow advances to step S433.

In step S433, the reference image converting unit 671 controls the filter processing to apply to the picture of the decoded middle viewpoint color image serving as the reference image from the reference index processing unit 260 in accordance with the reference image from the reference index processing unit 260, thereby performing reference image conversion processing to convert the reference image into a converted reference image of a resolution ratio matching the horizontal and vertical resolution ratio of the picture of the low-resolution left viewpoint color image to be decoded.

The reference image converting unit 671 then supplies the converted reference image obtained by converting the reference image to the same resolution ratio as with the low-resolution left viewpoint color image, to the disparity compensation unit 272, and the flow advances from step S433 to step S434.

Thereafter, in steps S434 through S436, processing the same as with steps S234 through S236 in FIG. 44 is performed.

[Description of Computer to which the Present Technology has Been Applied]

The above-described series of processing may be executed by hardware, or may be executed by software. In the event of executing the series of processing by software, a program making up the software thereof is installed in a general-purpose computer.

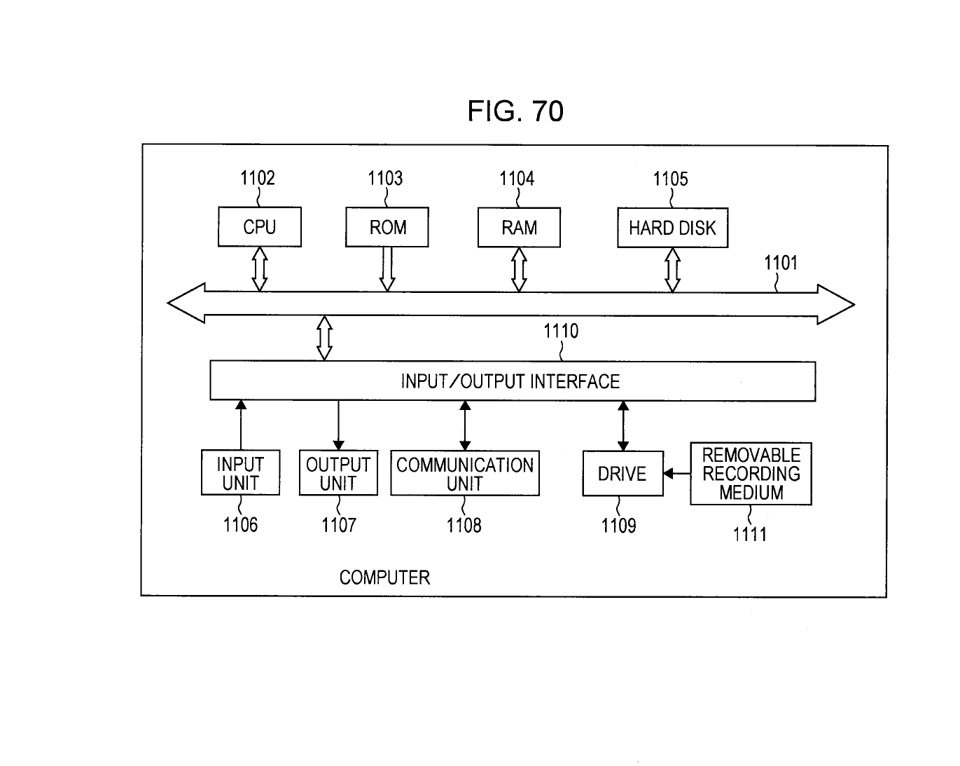

Accordingly, FIG. 70 illustrates a configuration example of an embodiment of a computer to which a program to execute the above-described series of the processing is installed.

The program can be recorded beforehand in a hard disk 1105 or ROM 1103 serving as a recording medium built into the computer.

Alternatively, the program may be stored in a removable recording medium 1111. Such a removable recording medium 1111 can be provided as so-called packaged software. Examples of the removable recording medium 1111 here include a flexible disk, CD-ROM (Compact Disc Read Only Memory), MO (Magneto Optical) disk, DVD (Digital Versatile Disc), magnetic disk, semiconductor memory, and so forth.

Note that besides from being installed in the computer from a removable recording medium 1111 such as described above, the program can be downloaded to the computer via a communication network or broadcast network, and installed in a built-in hard disk 1105. That is, the program can be wirelessly transmitted to the computer from a download site via satellite for digital satellite broadcasting, or transmitted to the computer over cable via a network such as LAN (Local Area Network), the Internet, for example.

The computer has a CPU (Central Processing Unit) 1102 built in, with an input/output interface 1110 connected to the CPU 1102 via a bus 1101.

Upon an instruction being input via the input/output interface 1110, by a user operating an input unit 1107 or the like, the CPU 1102 accordingly executes a program stored in ROM (Read Only Memory) 1103. Alternatively, the CPU 1102 loads a program stored in the hard disk 1105 to RAM (Random Access Memory) 1104 and executes this.

Accordingly, the CPU 1102 performs processing following the above-described flowcharts, or processing performed by the configuration of the block diagrams described above. The CPU 1102 then outputs the processing results from an output unit 1106, or transmits from a communication unit 1108, or further records in the hard disk 1105, or the like, via the input/output interface 1110, for example, as necessary.

Note that the input unit 1107 is configured of a keyboard, mouse, microphone, and so forth. Also, the output unit 1106 is configured of an LCD (Liquid Crystal Display) and speaker or the like.

Now, with the Present Specification, processing which the computer performs following the program does not necessarily have to be performed in the time sequence following the order described in the flowcharts. That is to say, the processing which the computer performs following the flowcharts includes processing executed in parallel or individually (e.g., parallel processing or object-oriented processing).

Also, the program may be processed by one computer (processor), or may be processed in a decentralized manner by multiple computers. Further, the program may be transferred to and executed by a remote computer.

The present technology may be applied to an image processing system used in communicating via network media such as cable TV (television), the Internet, and cellular phones or the like, or in processing on recording media such as optical or magnetic disks, flash memory, or the like.

Also note that at least part of the above-described image processing system may be applied to optionally selected electronic devices. The following is a description of examples thereof.

### [Configuration Example of TV]

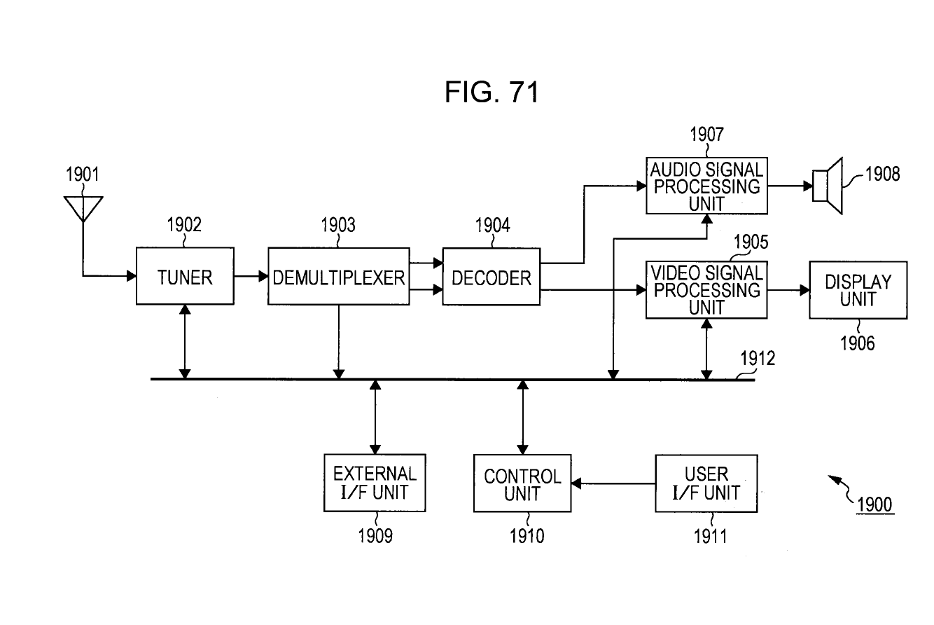

FIG. 71 shows an example of a schematic configuration of a TV to which the present technology has been applied.

The TV 1900 is configured of an antenna 1901, a tuner 1902, a demultiplexer 1903, a decoder 1904, a image signal processing unit 1905, a display unit 1906, an audio signal processing unit 1907, a speaker 1908, and an external interface unit 1909. The TV 1900 further has a control unit 1910, a user interface unit 1911, and so forth.

The tuner 1902 tunes to a desired channel from the broadcast signal received via the antenna 1901, and performs demodulation, and outputs an obtained encoded bit stream to the demultiplexer 1903.

The demultiplexer 1903 extracts packets of images and audio which are a program to be viewed, from the encoded bit stream, and outputs data of the extracted packets to the decoder 1904. Also, the demultiplexer 1903 supplies packets of data such as EPG (Electronic Program Guide) to the control unit 1910. Note that the demultiplexer or the like may perform descrambling when scrambled.

The decoder 1904 performs packet decoding processing, and outputs image data generated by decoding processing to the image signal processing unit 1905, and audio data to the audio signal processing unit 1907.

The image signal processing unit 1905 performs noise reduction and image processing according to user settings on the image data. The image signal processing unit 1905 generates image data of programs to display on the display unit 1906, image data according to processing based on applications supplied via a network, and so forth. Also, the image signal processing unit 1905 generates image data for displaying a menu screen or the like for selecting items or the like, and superimpose these on the program image data. The image signal processing unit 1905 performs generates driving signals based on the image data generated in this way, and drives the display unit 1906.

The display unit 1906 is driven by driving signals supplied from the image signal processing unit 1905, and drives a display device (e.g., liquid crystal display device or the like) to display images of the program and so forth.

The audio signal processing unit 1907 subjects audio data to predetermined processing such as noise removal and the like, performs D/A conversion processing and amplification processing on the processed audio data, and performs audio output by supplying to the speaker 1908.

The external interface unit 1909 is an interface to connect to external devices or a network, and performs transmission/reception of data such as image data, audio data, and so forth.

The user interface unit 1911 is connected to the control unit 1910. The user interface unit 1911 is configured of operating switches, a remote control signal receiver unit, and so forth, and supplies operating signals corresponding to user operations to the control unit 1910.

The control unit 1910 is configured of a CPU (Central Processing Unit), and memory and so forth. The memory stores programs to be executed by the CPU, various types of data necessary for the CPU to perform processing, EPG data, data acquired through a network, and so forth. Programs stored in the memory are read and executed by the CPU at a predetermined timing, such as starting up the TV 1900. The CPU controls each part such that the operation of the TV 1900 is according to user operations, by executing programs.

The TV 1900 is further provided with a bus 1912 connecting the tuner 1902, demultiplexer 1903, image signal processing unit 1905, audio signal processing unit 1907, external interface unit 1909, and so forth, with the control unit 1910.

With the TV 1900 thus configured, the decoder 1904 is provided with a function of the present technology.

### [Configuration Example of Cellular Telephone]

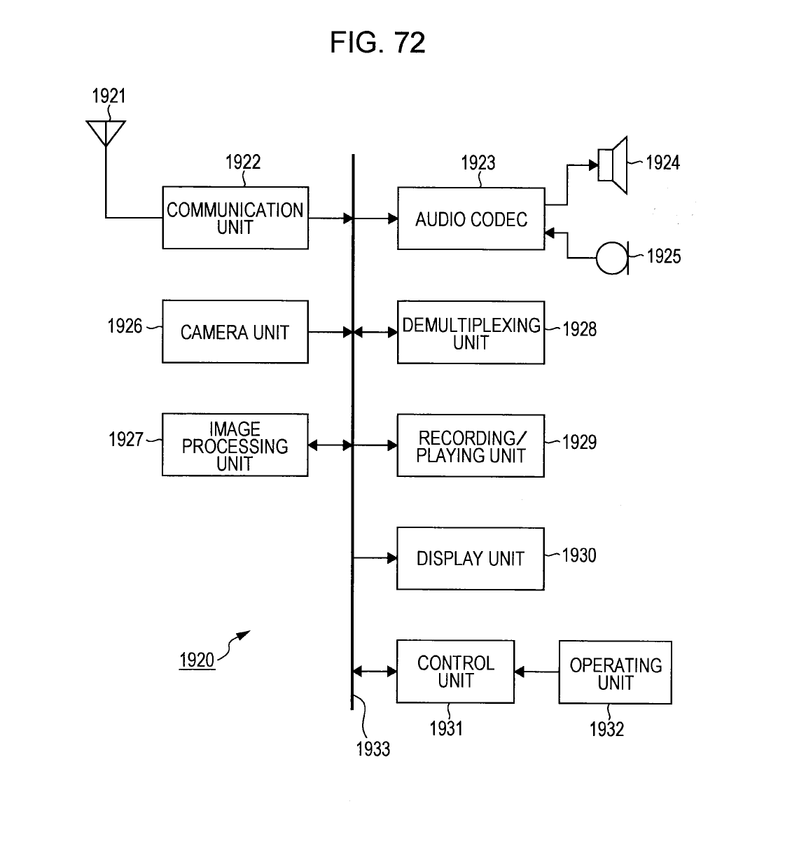

FIG. 72 is a diagram illustrating an example of a schematic configuration of the cellular telephone to which the present technology has been applied.

The cellular telephone 1920 is configured of a communication unit 1922, an audio codec 1923, a camera unit 1926, an image processing unit 1927, a multiplex separating unit 1928, a recording/playback unit 1929, a display unit 1930, and a control unit 1931. These are mutually connected via a bus 1933.

An antenna 1921 is connected to the communication unit 1922, and a speaker 1924 and a microphone 1925 are connected to the audio codec 1923. Further, an operating unit 1932 is connected to the control unit 1931.

The cellular telephone 1920 performs various operations such as transmission and reception of audio signals, transmission and reception of e-mails or image data, imaging of an image, recording of data, and so forth, in various operation modes including a voice call mode, a data communication mode, and so forth.

In voice call mode, the audio signal generated by the microphone 1925 is converted at the audio codec 1923 into audio data and subjected to data compression, and is supplied to the communication unit 1922. The communication unit 1922 performs modulation processing and frequency conversion processing and the like of the audio data, and generates transmission signals. The communication unit 1922 also supplies the transmission signals to the antenna 1921 so as to be transmitted to an unshown base station. The communication unit 1922 also performs amplifying, frequency conversion processing, demodulation processing, and so forth, of reception signals received at the antenna 1921, and supplies the obtained audio data to the audio codec 1923. The audio codec 1923 decompresses the audio data and performs conversion to analog audio signals, and outputs to the speaker 1924.

Also, in the data communication mode, in the event of performing e-mail transmission, the control unit 1931 accepts character data input by operations at the operating unit 1932, and displays the input characters on the display unit 1930. Also, the control unit 1931 generates e-mail data based on user instructions at the operating unit 1932 and so forth, and supplies to the communication unit 1922. The communication unit 1922 performs modulation processing and frequency conversion processing and the like of the e-mail data, and transmits the obtained transmission signals from the antenna 1921. Also, the communication unit 1922 performs amplifying and frequency conversion processing and demodulation processing and so forth as to reception signals received at the antenna 1921, and restores the e-mail data. This e-mail data is supplied to the display unit 1930 and the contents of the e-mail are displayed.

Note that cellular telephone 1920 may store received e-mail data in a recording medium at the recording/playback unit 1929. The storage medium may be any storage medium that is rewritable. For example, the storage medium may be semiconductor memory such as RAM or built-in flash memory, or a hard disk, a magnetic disk, magneto-optical disk, optical disc, USB memory, or a memory card or like removable media.

In the event of transmitting image data in the data communication mode, image data generated at the camera unit 1926 is supplied to the image processing unit 1927. The image processing unit 1927 performs encoding processing of the image data, and generates encoded data.

The multiplex separation unit 1928 multiplexes encoded data generated at the image processing unit 1927 and audio data supplied from the audio codec 1923, according to a predetermined format, supplies to the communication unit 1922. The communication unit 1922 performs modulation processing and frequency conversion processing and so forth of the multiplexed data, and transmits the obtained transmission signals from the antenna 1921. Also, the communication unit 1922 performs amplifying and frequency conversion processing and demodulation processing and so forth as to reception signals received at the antenna 1921, and restores the multiplexed data. This multiplexed data is supplied to the multiplex separation unit 1928. The multiplex separation unit 1928 separates the multiplexed data, and supplies the encoded data to the image processing unit 1927, and the audio data to the audio codec 1923. This image processing unit 1927 performs decoding processing of the encoded data and generates image data. This image data is supplied to the display unit 1930 and the received image is displayed. The audio codec 1923 converts the audio data into analog audio signals and supplies to the speaker 1924 to output the received audio.

With the cellular telephone device 1920 thus configured, the image processing unit 1927 is provided with a function of the present technology.

### [Configuration Example of Recording/Playback Device]

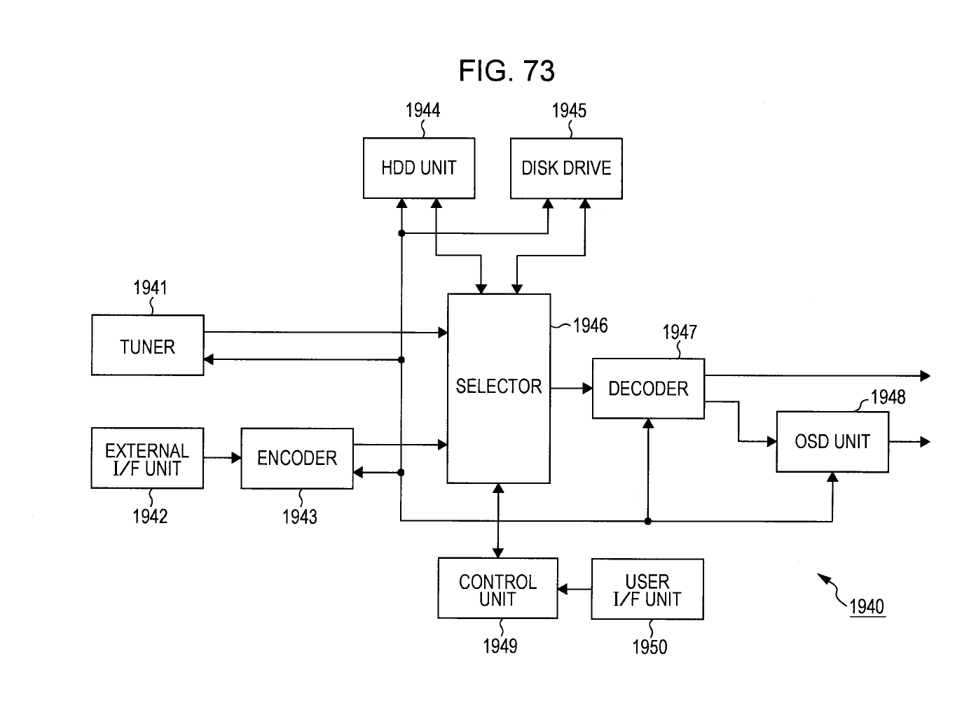

FIG. 73 is a diagram illustrating a schematic configuration example of a recording/playback device to which the present technology has been applied.

The recording/playback device 1940 records audio data and video data of a received broadcast program, for example, in a recording medium, and provide the recorded data to the user at a timing instructed by the user. Also, the recording/playback device 1940 may acquire audio data and video data from other devices, for example, and may record these to the recording medium. Further, the recording/playback device 1940 can decode and output audio data and video data recorded in the recording medium, so that image display and audio output can be performed at a monitor device or the like.

The recording/playback device 1940 includes a tuner 1941, an external interface unit 1942, an encoder 1943, an HDD (Hard Disk Drive) unit 1944, a disc drive 1945, a selector 1946, a decoder 1947, an OSD (On-Screen Display) unit 1948, a control unit 1949 and an user interface unit 1950.

The tuner 1941 tunes a desired channel from broadcast signals received via an unshown antenna. The tuner 1941 outputs to the selector 1946 an encoded bit stream obtained by demodulation of reception signals of a desired channel.

The external interface 1942 is configured of at least one of an IEEE1394 interface, network interface unit, USB interface, and flash memory interface or the like. The external interface unit 1942 is an interface to connect to external deices and network, memory cards, and so forth, and receives data such s image data and audio data and so forth to be recorded.

When the image data and audio data supplied from the external interface unit 1942 are not encoded, the encoder 1943 performs encoding with a predetermined format, and outputs an encoded bit stream to the selector 1946.

The HDD unit 1944 records content data of images and audio and so forth, various programs, other data, and so forth, an internal hard disk, and also reads these from the hard disk at the time of playback or the like.

The disc drive 1945 performs recording and playing of signals to and from the mounted optical disc. The optical disc, for example, DVD disc (DVD-Video, DVD-RAM, DVD-R, DVD-RW, DVD+R, DVD+RW or the like) or Blu-ray disc or the like.

The selector 1946 selects an encoded bit stream input either from the tuner 1941 or the encoder 1943 at the time of the recording of images and audio, and supplies to the HDD unit 1944 or the disc drive 1945. Also, the selector 1946 supplies the encoded bit stream output from the HDD unit 1944 or the disc drive 1945 to the decoder 1947 at the time of the playback of images or audio.

The decoder 1947 performs decoding processing of the encoded bit stream. The decoder 1947 supplies image data generated by performing decoding processing to the OSD unit 1948. Also, the decoder 1947 outputs audio data generated by performing decoding processing.

The OSD unit 1948 generates image data to display menu screen and the like of item selection and so forth, and superimposes on image data output from the decoder 1947, and outputs.

The user interface unit 1950 is connected to the control unit 1949. The user interface unit 1950 is configured of operating switches and a remote control signal reception unit and so forth, and operation signals in accordance with user operations are supplied to the control unit 1949.

The control unit 1949 is configured of a CPU and memory and so forth. The memory stores programs executed by the CPU, and various types of data necessary for the CPU to perform processing. Programs stored by memory are read out by the CPU at a predetermined timing, such as at the time of startup of the recording/playback device 1940, and executed. The CPU controls each part so that the operation of the recording/playback device 1940 is in accordance with the user operations, by executing the programs.

With the recording/playback device 1940 thus configured, the decoder 1947 is provided with a function of the present technology.

### [Configuration Example of Imaging Apparatus]

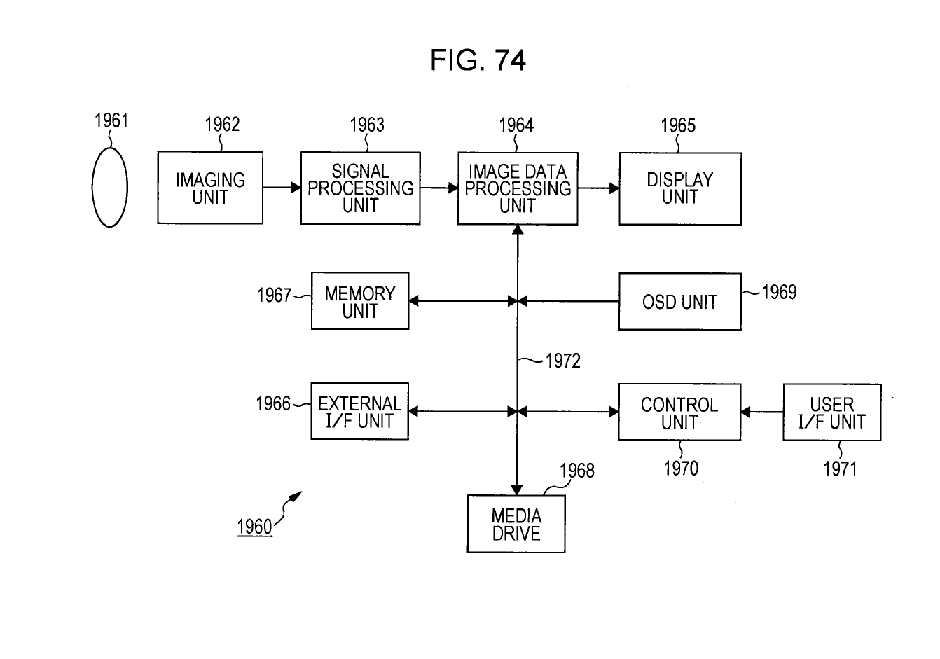

FIG. 74 is a diagram illustrating a schematic configuration example of an imaging apparatus to which the present technology has been applied.

The imaging apparatus 1960 images a subject, and displays an image of the subject on a display unit, or records this as image data to a recording medium.

The imaging apparatus 1960 is configured of an optical block 1961, an imaging unit 1962, a camera signal processing unit 1963, an image data processing unit 1964, a display unit 1965, an external interface unit 1966, a memory unit 1967, a media drive 1968, an OSD unit 1969, and a control unit 1970. Also, a user interface unit 1971 is connected to the control unit 1970. Further, the image data processing unit 1964, external interface unit 1966, memory unit 1967, media drive 1968, OSD unit 1969, control unit 1970, and so forth, are connected via a bus 1972.

The optical block 1961 is configured using a focusing lens and diaphragm mechanism and so forth. The optical block 1961 images an optical image of the subject on an imaging face of the imaging unit 1962. The imaging unit 1962 has an image sensor such as a CCD or a CMOS, generates electric signals in accordance to a light image by photoelectric conversion, and supplies to the signal processing unit 1963.

The camera signal processing unit 1963 performs various kinds of camera signal processing such as KNEE correction, gamma correction, color correction, and so forth, on electric signals supplied from the imaging unit 1962. The camera signal processing unit 1963 supplies image data after the camera signal processing to the image data processing unit 1964.

The image data processing unit 1964 performs encoding processing on the image data supplied from the camera signal processing unit 1963. The image data processing unit 1964 supplies the encoded data generated by performing the encoding processing to the external interface unit 1966 or media drive 1968. Also, the image data processing unit 1964 performs decoding processing of encoded data supplied from the external interface unit 1966 or the media drive 1968. The image data processing unit 1964 supplies the image data generated by performing the decoding processing to the display unit 1965. Also, the image data processing unit 1964 performs processing of supplying image data supplied from the camera signal processing unit 1963 to the display unit 1965, and superimposes data for display acquired from the OSD unit 1969 on image data, and supplies to the display unit 1965.

The OSD unit 1969 generates data for display such as a menu screen or icons or the like, formed of symbols, characters, and shapes, and outputs to the image data processing unit 1964.

The external interface unit 1966 is configured, for example, as a USB input/output terminal, and connects to a printer at the time of printing of an image. Also, a drive is connected to the external interface unit 1966 as necessary, removable media such as a magnetic disk or an optical disc or the like is mounted on the drive as appropriate, and a computer program read out from the removable media is installed as necessary. Furthermore, the external interface unit 1966 has a network interface which is connected to a predetermined network such as a LAN or the Internet or the like. The control unit 1970 can read out encoded data from the memory unit 1967 following instructions from the user interface unit 1971, for example, and supply this to another device connected via network from the external interface unit 1966. Also, the control unit 1970 can acquire encoded data and image data supplied from another device via network by way of the external interface unit 1966, and supply this to the image data processing unit 1964.

For example, the recording medium driven by the media drive 1968 may be any readable/writable removable media, such as a magnetic disk, a magneto-optical disk, an optical disc, semiconductor memory, or the like. Also, for the recording media, the type of removable media is optional, and may be a tape device, or may be a disk, or may be a memory card. As a matter of course, this may be a contact-free IC card or the like.

Also, the media drive 1968 and recording media may be integrated, and configured of a non-portable storage medium, such as a built-in hard disk drive or SSD (Solid State Drive) or the like, for example.

The control unit 1970 is configured using CPU and memory and the like. The memory stores programs to be executed by the CPU, and various types of data necessary for the CPU to perform the processing. A program stored in memory is read out by the CPU at a predetermined timing such as at startup of the imaging apparatus 1960, and is executed. The CPU controls the parts as that the operations of the imaging apparatus 1960 correspond to the user operations, by executing the program.

With the imaging apparatus 1960 thus configured, the image data processing unit 1964 is provided with a function of the present technology.

Note that embodiments of the present technology are not restricted to the above-described embodiments, and that various modifications can be made without departing from the essence of the present technology.

That is to say, while an arrangement has been made with the present embodiment in which a filter (AIF) used for filter processing at the time of performing disparity prediction in decimal prediction is controlled at the MVC, thereby converting a reference image into a converted reference image of a resolution ratio matching the resolution ratio of an image to be encoded, but a dedicated interpolation filter may be provided for the filter used for conversion of the converted reference image, and performing filter processing on the reference image using the dedicated interpolation filter, thereby converting into a converted reference image.

Also, a converted reference image of a resolution ratio matching the resolution ratio of an image to be encoded includes, as a matter of course, a converted reference image where horizontal and vertical resolution matches the resolution of an image to be encoded.

Note that the present technology may assume the following configurations.

[1]

An image processing device comprising:

a converting unit configured to convert a reference image, of a different viewpoint from an image to be encoded, which is referenced at the time of generating a prediction image of the image to be encoded which is to be encoded, by controlling filter processing applied to the reference image in accordance with the reference image and resolution information relating to resolution of the image to be encoded, so that the reference image is converted into a converted reference image of a resolution ratio agreeing with a horizontal and vertical resolution ratio of the image to be encoded;

a compensating unit configured to generate the prediction image by performing disparity compensation using the converted reference image that has been converted by the converting unit; and

an encoding unit configured to encode the image to be encoded using the prediction image generated by the compensating unit.

[2]

The image processing device according to [1],

wherein the converting unit controls the filter processing of filtering used at the time of performing disparity compensation of pixel precision or lower.

[3]

The image processing device according to either [1] or [2],

wherein the image to be encoded is a packed image obtained by converting resolution of images of two viewpoints, and packing by combining into one viewpoint worth of image;

and wherein the resolution information includes a packing pattern representing how the images of the two viewpoints have been packed in the packing image;

and wherein the converting unit controls the filter processing in accordance with the packing pattern.

[4]

The image processing device according to [3],

wherein the image to be encoded is a packed image where images of the two viewpoints of which vertical direction resolution has been made to be ½ are arrayed vertically, or a packed image where images of the two viewpoints of which horizontal direction resolution has been made to be ½ are arrayed horizontally;

and wherein the converting unit
generates a packed reference image by arraying the reference image and a copy thereof vertically or horizontally, and
subjects the packed reference image to filter processing by a filter which interpolates pixels, thereby obtaining the converted reference image.

[5]

The image processing device according to any one of [1] through [4], further comprising:

a transmitting unit configured to transmit the resolution information and an encoded stream encoded by the encoding unit.

[6]

An image processing method comprising the steps of:

converting a reference image, of a different viewpoint from an image to be encoded, which is referenced at the time of generating a prediction image of the image to be encoded which is to be encoded, by controlling filter processing applied to the reference image in accordance with the reference image and resolution information relating to resolution of the image to be encoded, so that the reference image is converted into a converted reference image of a resolution ratio agreeing with a horizontal and vertical resolution ratio of the image to be encoded;

generating the prediction image by performing disparity compensation using the converted reference image; and

encoding the image to be encoded using the prediction image.

[7]

An image processing device comprising:

a converting unit configured to convert a reference image, of a different viewpoint from an image to be decoded, which is referenced at the time of generating a prediction image of the image to be decoded which is to be decoded, by controlling filter processing applied to the reference image in accordance with the reference image and resolution information relating to resolution of the image to be decoded, so that the reference image is converted into a converted reference image of a resolution ratio agreeing with a horizontal and vertical resolution ratio of the image to be decoded;

a compensating unit configured to generate the prediction image by performing disparity compensation using the converted reference image that has been converted by the converting unit; and

a decoding unit configured to decode an encoded stream in which images have been encoded including the image to be decoded, using the reference image generated by the compensating unit.

[8]

The image processing device according to [7],

wherein the converting unit controls the filter processing of filtering used at the time of performing disparity compensation of pixel precision or lower.

[9]

The image processing device according to either [7] or [8],

wherein the image to be decoded is a packed image obtained by converting resolution of images of two viewpoints, and packing by combining into one viewpoint worth of image;

and wherein the resolution information includes a packing pattern representing how the images of the two viewpoints have been packed in the packing image;

and wherein the converting unit controls the filter processing in accordance with the packing pattern.

[10]

The image processing device according to [9],

wherein the image to be decoded is a packed image where images of the two viewpoints of which vertical direction resolution has been made to be ½ are arrayed vertically, or a packed image where images of the two viewpoints of which horizontal direction resolution has been made to be ½ are arrayed horizontally;

and wherein the converting unit
generates a packed reference image by arraying the reference image and a copy thereof vertically or horizontally, and
subjects the packed reference image to filter processing by a filter which interpolates pixels, thereby obtaining the converted reference image.

[11]

The image processing device according to any one of [7] through [10], further comprising:

a receiving unit configured to receive the resolution information and the encoded stream.

[12]

An image processing method comprising the steps of:

converting a reference image, of a different viewpoint from an image to be decoded, which is referenced at the time of generating a prediction image of the image to be decoded which is to be decoded, by controlling filter processing applied to the reference image in accordance with the reference image and resolution information relating to resolution of the image to be decoded, so that the reference image is converted into a converted reference image of a resolution ratio agreeing with a horizontal and vertical resolution ratio of the image to be decoded;

generating the prediction image by performing disparity compensation using the converted reference image; and

decoding an encoded stream in which images have been encoded including the image to be decoded, using the prediction image.

### REFERENCE SIGNS LIST

11 transmission device
12 reception device
21C, 21D resolution converting device
22C, 22D encoding device
23 multiplexing device
31 inverse multiplexing device
32C, 32D decoding device
33C, 33D resolution inverse converting device
41, 42 encoder
43 DPB
111 A/D converting unit
112 screen rearranging buffer
113 computing unit
114 orthogonal transform unit
115 quantization unit
116 variable length encoding unit
117 storage buffer
118 inverse quantization unit
119 inverse orthogonal transform unit
120 computing unit
121 deblocking filter
122 intra-screen prediction unit
123 inter prediction unit
124 prediction image selecting unit
131 disparity prediction unit
132 temporal prediction unit
140 reference image converting unit
141 disparity detecting unit
142 disparity compensation unit
143 prediction information buffer
144 cost function calculating unit
145 mode selecting unit
151 horizontal ½-pixel generating filter processing unit
152 vertical ½-pixel generating filter processing unit
153 horizontal ¼-pixel generating filter processing unit
154 vertical ¼-pixel generating filter processing unit
155 horizontal-vertical ¼-pixel generating filter processing unit
211, 212 decoder
213 DPB
241 storage buffer
242 variable length decoding unit
243 inverse quantization unit
244 inverse orthogonal transform unit
245 computing unit
246 deblocking filter
247 screen rearranging buffer
248 D/A conversion unit
249 intra-screen prediction unit
250 inter prediction unit
251 SEI generating unit
260 reference index processing unit
261 disparity prediction unit
262 temporal prediction unit
271 reference image converting unit
272 disparity compensation unit
321C, 321D resolution converting device
322C, 322D encoding device
323 multiplexing device
332C, 332D decoding device
333C, 333D resolution inverse converting device
342 encoder
351 SEI generating unit
352 inter prediction unit
361 disparity prediction unit
370 reference image converting unit
381 controller
382 packing unit
412 decoder
450 inter prediction unit
461 disparity prediction unit
471 reference image converting unit
481 controller
482 packing unit
483 horizontal ½-pixel generating filter processing unit
484 vertical ½-pixel generating filter processing unit
485 horizontal ¼-pixel generating filter processing unit
486 vertical ¼-pixel generating filter processing unit
487 horizontal-vertical ¼-pixel generating filter processing unit
511, 512 encoder
551 SEI generating unit
552 inter prediction unit
561 disparity prediction unit
570 reference image converting unit
611, 612 decoder
650 inter prediction unit
661 disparity prediction unit
671 reference image converting unit
1101 bus
1102 CPU
1103 ROM
1104 RAM
1105 hard disk
1106 output unit
1107 input unit
1108 communication unit
1109 drive
1110 input/output interface
1111 removable recording medium

1. An image processing device comprising:
a converting unit configured to convert a reference image, of a different viewpoint from an image to be encoded, which is referenced at the time of generating a prediction image of the image to be encoded which is to be encoded, by controlling filter processing applied to the reference image in accordance with the reference image and resolution information relating to resolution of the image to be encoded, so that the reference image is converted into a converted reference image of a resolution ratio agreeing with a horizontal and vertical resolution ratio of the image to be encoded;
a compensating unit configured to generate the prediction image by performing disparity compensation using the converted reference image that has been converted by the converting unit; and
an encoding unit configured to encode the image to be encoded using the prediction image generated by the compensating unit.

2. The image processing device according to claim 1,
wherein the converting unit controls the filter processing of filtering used at the time of performing disparity compensation of pixel precision or lower.

3. The image processing device according to claim 2,
wherein the image to be encoded is a packed image obtained by converting resolution of images of two viewpoints, and packing by combining into one viewpoint worth of image;
and wherein the resolution information includes a packing pattern representing how the images of the two viewpoints have been packed in the packing image;
and wherein the converting unit controls the filter processing in accordance with the packing pattern.

4. The image processing device according to claim 3,
wherein the image to be encoded is a packed image where images of the two viewpoints of which vertical direction resolution has been made to be ½ are arrayed vertically, or a packed image where images of the two viewpoints of which horizontal direction resolution has been made to be ½ are arrayed horizontally;
and wherein the converting unit
generates a packed reference image by arraying the reference image and a copy thereof vertically or horizontally, and
subjects the packed reference image to filter processing by a filter which interpolates pixels, thereby obtaining the converted reference image.

5. The image processing device according to claim 2, further comprising:
a transmitting unit configured to transmit the resolution information and an encoded stream encoded by the encoding unit.

6. An image processing method comprising the steps of:
converting a reference image, of a different viewpoint from an image to be encoded, which is referenced at the time of generating a prediction image of the image to be encoded which is to be encoded, by controlling filter processing applied to the reference image in accordance with the reference image and resolution information relating to resolution of the image to be encoded, so that the reference image is converted into a converted reference image of a resolution ratio agreeing with a horizontal and vertical resolution ratio of the image to be encoded;
generating the prediction image by performing disparity compensation using the converted reference image; and
encoding the image to be encoded using the prediction image.

7. An image processing device comprising:
a converting unit configured to convert a reference image, of a different viewpoint from an image to be decoded, which is referenced at the time of generating a prediction image of the image to be decoded which is to be decoded, by controlling filter processing applied to the reference image in accordance with the reference image and resolution information relating to resolution of the image to be decoded, so that the reference image is converted into a converted reference image of a resolution ratio agreeing with a horizontal and vertical resolution ratio of the image to be decoded;
a compensating unit configured to generate the prediction image by performing disparity compensation using the converted reference image that has been converted by the converting unit; and
a decoding unit configured to decode an encoded stream in which images have been encoded including the image to be decoded, using the prediction image generated by the compensating unit.

8. The image processing device according to claim 7,
wherein the converting unit controls the filter processing of filtering used at the time of performing disparity compensation of pixel precision or lower.

9. The image processing device according to claim 8,
wherein the image to be decoded is a packed image obtained by converting resolution of images of two viewpoints, and packing by combining into one viewpoint worth of image;
and wherein the resolution information includes a packing pattern representing how the images of the two viewpoints have been packed in the packing image;
and wherein the converting unit controls the filter processing in accordance with the packing pattern.

10. The image processing device according to claim 9,
wherein the image to be decoded is a packed image where images of the two viewpoints of which vertical direction resolution has been made to be ½ are arrayed vertically, or a packed image where images of the two viewpoints of which horizontal direction resolution has been made to be ½ are arrayed horizontally;
and wherein the converting unit
generates a packed reference image by arraying the reference image and a copy thereof vertically or horizontally, and
subjects the packed reference image to filter processing by a filter which interpolates pixels, thereby obtaining the converted reference image.

11. The image processing device according to claim 8, further comprising:
a receiving unit configured to receive the resolution information and the encoded stream.

12. An image processing method comprising the steps of:
converting a reference image, of a different viewpoint from an image to be decoded, which is referenced at the time of generating a prediction image of the image to be decoded which is to be decoded, by controlling filter processing applied to the reference image in accordance with the reference image and resolution information relating to resolution of the image to be decoded, so that the reference image is converted into a converted reference image of a resolution ratio agreeing with a horizontal and vertical resolution ratio of the image to be decoded;
generating the prediction image by performing disparity compensation using the converted reference image; and
decoding an encoded stream in which images have been encoded including the image to be decoded, using the prediction image.
